(19) United States
(12) Patent Application Publication
(10) Pub. No.: US 2026/0007133 A1
(43) Pub. Date: Jan. 8, 2026

(54) HERBICIDAL COMPOSITION COMPRISING AZINE COMPOUNDS

(71) Applicant: BASF SE, Ludwigshafen (DE)

(72) Inventors: Martin Hartmueller, Limburgerhof (DE); Annina Burhop, Ludwigshafen (DE); Matthias Witschel, Ludwigshafen (DE); Veronica Lopez Carrillo, Limburgerhof (DE); Peter Dombo, Limburgerhof (DE); Thomas Seitz, Ludwigshafen (DE)

(21) Appl. No.: 18/992,056

(22) PCT Filed: Jul. 3, 2023
(86) PCT No.: PCT/EP2023/068144

§ 371 Date: Jan. 7, 2025

(30) Foreign Application Priority Data
Jul. 13, 2022 (EP) 22184617.3

(51) Int. Cl. A01N 43/68; A01N 43/80; A01P 13/02

(52) U.S. Cl. CPC A01N 43/68; A01N 43/80; A01P 13/02

(57) ABSTRACT

The present invention relates to herbicidal compositions comprising at least one compound of formula (I) wherein the variables are defined as given in the specification, and at least one further active compound selected from herbicides of classes b1) to b15) and safeners C.

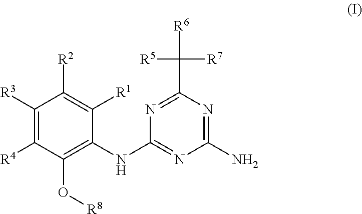

The present invention relates to herbicidal compositions comprising at least one compound of formula (I) and at least one further compound selected from herbicidally active compounds and safeners.

In the case of crop protection compositions, it is desirable in principle to increase the specific activity of an active compound and the reliability of the effect. It is particularly desirable for the crop protection composition to control the harmful plants effectively, but at the same time to be compatible with the useful plants in question. Also desirable is a broad spectrum of activity allowing the simultaneous control of harmful plants. Frequently, this cannot be achieved using a single herbicidally active compound.

With many highly effective herbicides, there is the problem that their compatibility with useful plants, in particular dicotyledonous crop plants, such as soybean, sunflower, cotton, oilseed rape and graminaceous plants, such as barley, millet, corn, rice, wheat and sugar cane, is not always satisfactory, i.e. in addition to the harmful plants, the crop plants, too, are damaged on a scale which cannot be tolerated. By reducing the application rates, the useful plants are spared; however, naturally, the extent of the control of harmful plants decreases, too.

Frequently, it is a problem that herbicides can only be applied within a narrow time frame in order to achieve the desired herbicidal action, which time frame may be unpredictably influenced by weather conditions.

It is known that special combinations of different specifically active herbicides result in enhanced activity of an herbicide component in the sense of a synergistic effect. In this manner, it is possible to reduce the application rates of herbicidally active compounds required for controlling the harmful plants.

Furthermore, it is known that in some cases joint application of specifically acting herbicides with organic active compounds, some of which may also have herbicidal activity, allows better crop plant compatibility to be achieved. In these cases, the active compounds act as antidotes or antagonists and are also referred to as safeners, since they reduce or even prevent damage to the crop plants.

It is an object of the present invention to provide herbicidal compositions which are highly active against unwanted harmful plants. At the same time, the compositions should have good compatibility with useful plants. In addition, the compositions according to the invention should have a broad spectrum of activity.

This and further objects are achieved by the herbicidal compositions below.

Accordingly, the present invention relates to herbicidal compositions comprising: at least one compound A) of the formula (I)

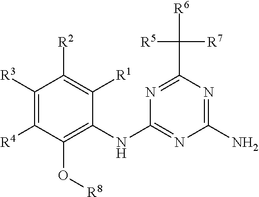

wherein
R¹ is F;
R² is selected from the group consisting of H, halogen, CR^{2A};
   wherein R^{2A} is H or halogen;
R³ is H, F;
R⁴ is selected from the group consisting of F, Cl, Br, I, CR^{4A};
   wherein R^{4A} is H or halogen;
R⁵ is selected from the group consisting of H, halogen, CN, C₁-C₆-alkyl, (C₁-C₆-alkoxy)-C₁-C₆-alkyl, C₃-C₆-cycloalkyl, (C₃-C₆-cycloalkyl)-C₁-C₄-alkyl, C₁-C₆-alkoxy, C₂-C₆-alkenyloxy, C₂-C₆-alkynyloxy, C₃-C₆-cycloalkoxy, (C₃-C₆-cycloalkyl)-C₁-C₄-alkoxy, where the aliphatic and cycloaliphatic parts of the radicals are unsubstituted, partly or completely halogenated;
R⁶ is selected from the group consisting of H, halogen, CN, C₁-C₆-alkyl, C₁-C₆-haloalkyl, C₁-C₆-alkoxy and C₁-C₆-haloalkoxy;
R⁷ is selected from the group consisting of halogen, CN, C₁-C₆-alkyl, C₂-C₆-alkenyl, C₃-C₆-alkynyl, C₃-C₆-cycloalkyl, (C₃-C₆-cycloalkyl)-C₁-C₄-alkyl, C₃-C₆-cycloalkenyl and C₁-C₆-alkoxy-C₁-C₆-alkyl, where the aliphatic and cycloaliphatic parts of the radicals are unsubstituted, partly or completely halogenated;
R⁶ and R⁷ together with the carbon atom to which they are attached form a moiety selected from the group consisting of carbonyl, C₃-C₆-cycloalkyl, C₃-C₆-cycloalkenyl, three- to six-membered saturated or partially unsaturated heterocyclyl, and the moiety >C=CR^{x}R^{y}, where R^{x} and R^{y} are hydrogen, C₁-C₄-alkyl, C₁-C₄-haloalkyl, C₃-C₆-cycloalkyl or CR^{x}R^{y} form a 3- to 6-membered cycloalkyl;
R⁸ is selected from the group consisting of C₁-C₆-alkyl, C₂-C₆-alkenyl, C₂-C₆-alkynyl, (C₁-C₆-alkoxy)-C₁-C₆-alkyl, (C₁-C₆-alkoxy)-C₂-C₆-alkenyl, (C₁-C₆-alkoxy)-C₂-C₆-alkynyl, (C₁-C₆-cycloalkyl)-C₂-C₆-alkynyl, (C₃-C₆-cycloalkyl)-C₁-C₄-alkyl, (C₃-C₆-cycloalkoxy)-C₁-C₄-alkyl, where the aforementioned radicals are unsubstituted, partly or completely halogenated and where the cycloaliphatic parts of the last 6 mentioned radicals may carry 1, 2, 3, 4, 5 or 6 methyl groups,
and at least one further compound selected from herbicide compounds b) and safeners c) and mixtures thereof:
wherein the further herbicidally active compounds b) is selected from the compounds of the following class b1) to b15):
b1) lipid biosynthesis inhibitors;
b2) acetolactate synthase inhibitors;
b3) photosynthesis inhibitors;
b4) protoporphyrinogen-IX oxidase inhibitors,
b5) bleacher herbicides;
b6) enolpyruvyl shikimate 3-phosphate synthase inhibitors;
b7) glutamine synthetase inhibitors;
b8) 7,8-dihydropteroate synthase inhibitors;
b9) mitosis inhibitors;
b10) inhibitors of the synthesis of very long chain fatty acids;
b11) cellulose biosynthesis inhibitors;
b12) decoupler herbicides;
b13) auxinic herbicides;
b14) auxin transport inhibitors and
b15) other herbicides selected from the group consisting of bromobutide, chlorflurenol, chlorflurenol-methyl, cinmethylin, cumyluron, dalapon, dazomet, difenzoquat, difenzoquat-metilsulfate, dimethipin, DSMA, dymron, endothal and its salts, etobenzanid, flamprop, flamprop-isopropyl, flamprop-methyl, flamprop-M-isopropyl, flamprop-M-methyl, flurenol, flurenol-butyl, flurprimidol, fosamine, fosamine-ammonium, indanofan, indaziflam, maleic hydrazide, mefluidide, metam, methiozolin, methyl azide, methyl bromide, methyl-dymron, methyl iodide, MSMA, oleic acid, oxaziclomefone, pelargonic acid, pyributicarb, quinoclamine, tetflupyrolimet, triaziflam, tridiphane and 6-chloro-3-(2-cyclopropyl-6-methylphenoxy)-4-pyridazinol and its salts and esters including their agriculturally acceptable salts or derivatives; and wherein
compound C) is selected from the group consisting of benoxacor, cloquintocet, cyometrinil, cyprosulfamide, dichlormid, dicyclonon, dietholate, fenchlorazole, fenclorim, flurazole, fluxofenim, furilazole, isoxadifen, mefenpyr, mephenate, naphthalic anhydride, oxabetrinil, 4-(dichloroacetyl)-1-oxa-4-azaspiro[4.5]decane, 2,2,5-trimethyl-3-(dichloroacetyl)-1,3-oxazolidine and N-(2-methoxybenzoyl)-4-[(methylaminocarbonyl)amino]benzenesulfon-amide.

The invention relates in particular to compositions in the form of herbicidal active agrochemical compositions comprising a herbicidally effective amount of an active compound combination comprising at least one compound of formula (I) and at least one further compound selected from the herbicides B and the safeners C, as defined above, and also at least one liquid and/or solid carrier and/or one or more surfactants and, if desired, one or more further auxiliaries customary for agrochemical compositions.

The invention also relates to compositions in the form of a agrochemical composition formulated as a 1-component composition comprising an active compound combination comprising at least one compound of formula (I) and at least one further active compound selected from the herbicides B and the safeners C, and at least one solid or liquid carrier and/or one or more surfactants and, if desired, one or more further auxiliaries customary for agrochemical compositions.

The invention also relates to compositions in the form of a agrochemical composition formulated as a 2-component composition comprising a first component comprising at least one compound of formula (I), a solid or liquid carrier and/or one or more surfactants, and a second component comprising at least one further active compound selected from the herbicides B and safeners C, a solid or liquid carrier and/or one or more surfactants, where additionally both components may also comprise further auxiliaries customary for agrochemical compositions.

Surprisingly, the compositions according to the invention comprising at least one compound of formula (I) and at least one herbicide B have better herbicidal activity, i.e. better activity against harmful plants, than would have been expected based on the herbicidal activity observed for the individual compounds, or a broader activity spectrum. The herbicidal activity to be expected for mixtures based on the individual compound can be calculated using Colby's formula (see below). If the activity observed exceeds the expected additive activity of the individual compounds, synergism is said to be present.

Moreover, the time frame, within which the desired herbicidal action can be achieved, may be expanded by the compositions according to the invention comprising at least one compound of formula (I) and at least one herbicide B and optionally a safener C. This allows a more flexibly timed application of the compositons according to the present invention in comparison with the single compounds.

The compositions according to the invention comprising both at least one compound of formula (1) and at least one of the compounds mentioned under C also have good herbicidal activity against harmful plants and better compatibility with useful plants.

Surprisingly, the compositions according to the invention comprising at least one compound of formula (I), at least one herbicide B and at least one of the compounds mentioned under C have better herbicidal activity, i.e. better activity against harmful plants, than would have been expected based on the herbicidal activity observed for the individual compounds, or a broader activity spectrum, and show better compatibility with useful plants than compositions comprising only one compound I and one herbicide B.

The invention furthermore relates to a method for controlling unwanted vegetation, in particular where crop plants are cultivated.

The invention also relates to a method for the desiccation or defoliation of plants.

As used herein, the terms “controlling” and “combating” are synonyms.

As used herein, the terms “undesirable vegetation” and “harmful plants” are synonyms.

If the compounds of formula (I), the herbicidal compounds B and/or the safeners C as described herein are capable of forming geometrical isomers, for example E/Z isomers, it is possible to use both, the pure isomers and mixtures thereof, in the compositions according to the invention.

If the compounds of formula (I), the herbicidal compounds B and/or the safeners C as described herein have one or more centers of chirality and, as a consequence, are present as enantiomers or diastereomers, it is possible to use both, the pure enantiomers and diastereomers and their mixtures, in the compositions according to the invention.

Within the substituents of the compounds of formula (I), instead of hydrogen also the corresponding isotope deuterium can be used.

If the compounds of formula (I), the herbicidal compounds B and/or the safeners C as described herein have ionizable functional groups, they can also be employed in the form of their agriculturally acceptable salts. Suitable are, in general, the salts of those cations and the acid addition salts of those acids whose cations and anions, respectively, have no adverse effect on the activity of the active compounds.

Preferred cations are the ions of the alkali metals, preferably of lithium, sodium and potassium, of the alkaline earth metals, preferably of calcium and magnesium, and of the transition metals, preferably of manganese, copper, zinc and iron, further ammonium and substituted ammonium in which one to four hydrogen atoms are replaced by C₁-C₄-alkyl, hydroxy-C₁-C₄-alkyl, C₁-C₄-alkoxy-C₁-C₄-alkyl, hydroxy-C₁-C₄-alkoxy-C₁-C₄-alkyl, phenyl or benzyl, preferably ammonium, methylammonium, isopropylammonium, dimethylammonium, diethylammonium, diisopropylammonium, trimethylammonium, triethylammonium, tris(isopropyl)ammonium, heptylammonium, dodecylammonium, tetradecylammonium, tetramethylammonium, tetraethylammonium, tetrabutylammonium, 2-hydroxyethylammonium (olamine salt), 2-(2-hydroxyeth-1-oxy)eth-1-ylammonium (diglycolamine salt), di(2-hydroxyeth-1-yl)ammonium (diolamine salt), tris(2-hydroxyethyl)ammonium (trolamine salt), tris(2-hydroxypropyl)ammonium, benzyltrimethylammonium, benzyltriethylammonium, N,N,N-trimethylethanolammonium (choline salt), furthermore phosphonium ions, sulfonium ions, preferably tri(C₁-C₄-alkyl)sulfonium, such as trimethylsulfonium, and sulfoxonium ions, preferably tri(C₁-C₄-alkyl)sulfoxonium, and finally the salts of polybasic amines such as N,N-bis-(3-aminopropyl)methylamine and diethylenetriamine.

Anions of useful acid addition salts are primarily chloride, bromide, fluoride, iodide, hydrogensulfate, methylsulfate, sulfate, dihydrogenphosphate, hydrogenphosphate, nitrate, bicarbonate, carbonate, hexafluorosilicate, hexafluorophosphate, benzoate and also the anions of C₁-C₄-alkanoic acids, preferably formate, acetate, propionate and butyrate.

Compound of formula (I), herbicidal compounds B and/or safeners C as described herein having a carboxyl group can be employed in the form of the acid, in the form of an agriculturally suitable salt as mentioned above or else in the form of an agriculturally acceptable derivative, for example as amides, such as mono- and di-C₁-C₆-alkylamides or arylamides, as esters, for example as allyl esters, propargyl esters, C₁-C₁₀-alkyl esters, alkoxyalkyl esters, tefuryl ((tetrahydrofuran-2-yl)methyl) esters and also as thioesters, for example as C₁-C₁₀-alkylthio esters. Preferred mono- and di-C₁-C₆-alkylamides are the methyl and the dimethylamides. Preferred arylamides are, for example, the anilides and the 2-chloroanilides. Preferred alkyl esters are, for example, the methyl, ethyl, propyl, isopropyl, butyl, isobutyl, pentyl, mexyl (1-methylhexyl), meptyl (1-methylheptyl), heptyl, octyl or isooctyl (2-ethylhexyl) esters. Preferred C₁-C₄-alkoxy-C₁-C₄-alkyl esters are the straight-chain or branched C₁-C₄-alkoxy ethyl esters, for example the 2-methoxyethyl, 2-ethoxyethyl, 2-butoxyethyl (butotyl), 2-butoxypropyl or 3-butoxypropyl ester. An example of a straight-chain or branched C₁-C₁₀-alkylthio ester is the ethylthio ester.

Further embodiments of the present invention are evident from the claims, the description and the examples. It is to be understood that the features mentioned above and still to be illustrated below of the subject matter of the invention can be applied not only in the combination given in each particular case but also in other combinations, without leaving the scope of the invention.

The organic moieties mentioned in the definition of the variables R¹ to R⁶ and R^{a} to R^{e}, are—like the term halogen—collective terms for individual enumerations of the individual group members. The term halogen denotes in each case fluorine, chlorine, bromine or iodine. All hydrocarbon chains can be straight-chain or branched, the prefix Cₙ-Cₘ denoting in each case the possible number of carbon atoms in the group.

Examples of such meanings are:
C₁-C₃-alkyl and also the C₁-C₃-alkyl moieties of di(C₁-C₃-alkyl)amino, C₁-C₃-alkoxy-C₁-C₃-alkyl: for example CH₃, C₂H₅, n-propyl and CH(CH₃)₂;
C₁-C₄-alkyl: for example CH₃, C₂H₅, n-propyl, CH(CH₃)₂, n-butyl, CH(CH₃)—C₂H₅, CH₂—CH(CH₃)₂ and C(CH₃)₃;
C₁-C₆-alkyl and also the C₁-C₆-alkyl moieties of C₁-C₆-cyanoalkyl, C₁-C₆-alkyoxy-C₁-C₆-alkyl, C₁-C₆-alkoxy-C₁-C₆-alkoxy-C₁-C₆-alkyl, di(C₁-C₆-alkoxy)C₁-C₆-alkyl, C₁-C₆-haloalkoxy-C₁-C₆-alkyl, C₃-C₆-alkenyloxy-C₁-C₆-alkyl, C₃-C₆-haloalkenyloxy-C₁-C₆-alkyl, C₃-C₆-alkenyloxy-C₁-C₆-alkoxy-C₁-C₆-alkyl, C₁-C₆-alkylthio-C₁-C₆-alkyl, C₁-C₆-alkylsulfinyl-C₁-C₆-alkyl, C₁-C₆-alkylsulfonyl-C₁-C₆-alkyl, C₁-C₆-alkylcarbonyl-C₁-C₆-alkyl, C₁-C₆-alkoxycarbonyl-C₁-C₆-alkyl, C₁-C₆-haloalkoxycarbonyl-C₁-C₆-alkyl, C₃-C₆-alkenyloxycarbonyl-C₁-C₆-alkyl, C₃-C₆-alkynyloxycarbonyl-C₁-C₆-alkyl: C₁-C₄-alkyl as mentioned above, and also, for example, n-pentyl, 1-methylbutyl, 2-methylbutyl, 3-methylbutyl, 2,2-dimethylpropyl, 1-ethylpropyl, n-hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl or 1-ethyl-2-methylpropyl, preferably methyl, ethyl, n-propyl, 1-methylethyl, n-butyl, 1,1-dimethylethyl, n-pentyl or n-hexyl;
C₁-C₃-haloalkyl: C₁-C₃-alkyl as mentioned above which is partially or fully substituted by fluorine, chlorine, bromine and/or iodine, for example, chloromethyl, dichloromethyl, trichloromethyl, fluoromethyl, difluoromethyl, trifluoromethyl, chlorofluoromethyl, dichlorofluoromethyl, chlorodifluoromethyl, bromomethyl, iodomethyl, 2-fluoroethyl, 2-chloroethyl, 2-bromoethyl, 2-iodoethyl, 1,1-difluoroethyl, 2,2-difluoroethyl, 2,2,2-trifluoroethyl, 2-chloro-2-fluoroethyl, 2-chloro-2,2-difluoroethyl, 2,2-dichloro-2-fluoroethyl, 2,2,2-trichloroethyl, pentafluoroethyl, 2-fluoropropyl, 3-fluoropropyl, 2,2-difluoropropyl, 2,3-difluoropropyl, 2-chloropropyl, 3-chloropropyl, 2,3-dichloropropyl, 2-bromopropyl, 3-bromopropyl, 3,3,3-trifluoropropyl, 3,3,3-trichloropropyl, 2,2,3,3,3-pentafluoropropyl, heptafluoropropyl, 1-(fluoromethyl)-2-fluoroethyl, 1-(chloromethyl)-2-chloroethyl, 1-(bromomethyl)-2-bromoethyl;
C₁-C₄-haloalkyl: C₁-C₄-alkyl as mentioned above which is partially or fully substituted by fluorine, chlorine, bromine and/or iodine, for example, chloromethyl, dichloromethyl, trichloromethyl, fluoromethyl, difluoromethyl, trifluoromethyl, chlorofluoromethyl, dichlorofluoromethyl, chlorodifluoromethyl, bromomethyl, iodomethyl, 2-fluoroethyl, 2-chloroethyl, 2-bromoethyl, 2-iodoethyl, 2,2-difluoroethyl, 2,2,2-trifluoroethyl, 2-chloro-2-fluoroethyl, 2-chloro-2,2-difluoroethyl, 2,2-dichloro-2-fluoroethyl, 2,2,2-trichloroethyl, pentafluoroethyl, 2-fluoropropyl, 3-fluoropropyl, 2,2-difluoropropyl, 2,3-difluoropropyl, 2-chloropropyl, 3-chloropropyl, 2,3-dichloropropyl, 2-bromopropyl, 3-bromopropyl, 3,3,3-trifluoropropyl, 3,3,3-trichloropropyl, 2,2,3,3,3-pentafluoropropyl, heptafluoropropyl, 1-(fluoromethyl)-2-fluoroethyl, 1-(chloromethyl)-2-chloroethyl, 1-(bromomethyl)-2-bromoethyl, 4-fluorobutyl, 4-chlorobutyl, 4-bromobutyl, nonafluorobutyl, 1,1,2,2,-tetrafluoroethyl and 1-trifluoromethyl-1,2,2,2-tetrafluoroethyl;
C₁-C₆-haloalkyl: C₁-C₄-haloalkyl as mentioned above, and also, for example, 5-fluoropentyl, 5-chloropentyl, 5-bromopentyl, 5-iodopentyl, undecafluoropentyl, 6-fluorohexyl, 6-chlorohexyl, 6-bromohexyl, 6-iodohexyl and dodecafluorohexyl;
C₃-C₆-alkenyl and also the C₃-C₆-alkenyl moieties of C₃-C₆-alkenyloxy-C₁-C₆-alkyl, C₃-C₆-alkenyloxy-C₁-C₆-alkoxy-C₁-C₆-alkyl, C₃-C₆-alkenyloxycarbonyl-C₁-C₆-alkyl: for example 1-propenyl, 2-propenyl, 1-methylethenyl, 1-butenyl, 2-butenyl, 3-butenyl, 1-methyl-1-propenyl, 2-methyl-1-propenyl, 1-methyl-2-propenyl, 2-methyl-2-propenyl, 1-pentenyl, 2-pentenyl, 3-pentenyl, 4-pentenyl, 1-methyl-1-butenyl, 2-methyl-1-butenyl, 3-methyl-1-butenyl, 1-methyl-2-butenyl, 2-methyl-2-butenyl, 3-methyl-2-butenyl, 1-methyl-3-butenyl, 2-methyl-3-butenyl, 3-methyl-3-butenyl, 1,1-dimethyl-2-propenyl, 1,2-dimethyl-1-propenyl, 1,2-dimethyl-2-propenyl, 1-ethyl-1-propenyl, 1-ethyl-2-propenyl, 1-hexenyl, 2-hexenyl, 3-hexenyl, 4-hexenyl, 5-hexenyl, 1-methyl-1-pentenyl, 2-methyl-1-pentenyl, 3-methyl-1-pentenyl, 4-methyl-1-pentenyl, 1-methyl-2-pentenyl, 2-methyl-2-pentenyl, 3-methyl-2-pentenyl, 4-methyl-2-pentenyl, 1-methyl-3-pentenyl, 2-methyl-3-pentenyl, 3-methyl-3-pentenyl, 4-methyl-3-pentenyl, 1-methyl-4-pentenyl, 2-methyl-4-pentenyl, 3-methyl-4-pentenyl, 4-methyl-4-pentenyl, 1,1-dimethyl-2-butenyl, 1,1-dimethyl-3-butenyl, 1,2-dimethyl-1-butenyl, 1,2-dimethyl-2-butenyl, 1,2-dimethyl-3-butenyl, 1,3-dimethyl-1-butenyl, 1,3-dimethyl-2-butenyl, 1,3-dimethyl-3-butenyl, 2,2-dimethyl-3-butenyl, 2,3-dimethyl-1-butenyl, 2,3-dimethyl-2-butenyl, 2,3-dimethyl-3-butenyl, 3,3-dimethyl-1-butenyl, 3,3-dimethyl-2-butenyl, 1-ethyl-1-butenyl, 1-ethyl-2-butenyl, 1-ethyl-3-butenyl, 2-ethyl-1-butenyl, 2-ethyl-2-butenyl, 2-ethyl-3-butenyl, 1,1,2-trimethyl-2-propenyl, 1-ethyl-1-methyl-2-propenyl, 1-ethyl-2-methyl-1-propenyl and 1-ethyl-2-methyl-2-propenyl;
C₃-C₆-haloalkenyl and also the C₃-C₆-haloalkenyl moieties of C₃-C₆-haloalkenyloxy-C₁-C₆-alkyl: a C₃-C₆-alkenyl radical as mentioned above which is partially or fully substituted by fluorine, chlorine, bromine and/or iodine, for example 2-chloroprop-2-en-1-yl, 3-chloroprop-2-en-1-yl, 2,3-dichloroprop-2-en-1-yl, 3,3-dichloroprop-2-en-1-yl, 2,3,3-trichloro-2-en-1-yl, 2,3-dichlorobut-2-en-1-yl, 2-bromoprop-2-en-1-yl, 3-bromoprop-2-en-1-yl, 2,3-dibromoprop-2-en-1-yl, 3,3-dibromoprop-2-en-1-yl, 2,3,3-tribromo-2-en-1-yl or 2,3-dibromobut-2-en-1-yl;
C₃-C₆-alkynyl and also the C₃-C₆-alkynyl moieties of C₃-C₆-alkynyloxycarbonyl-C₁-C₆-alkyl: for example 1-propynyl, 2-propynyl, 1-butynyl, 2-butynyl, 3-butynyl, 1-methyl-2-propynyl, 1-pentynyl, 2-pentynyl, 3-pentynyl, 4-pentynyl, 1-methyl-2-butynyl, 1-methyl-3-butynyl, 2-methyl-3-butynyl, 3-methyl-1-butynyl, 1,1-dimethyl-2-propynyl, 1-ethyl-2-propynyl, 1-hexynyl, 2-hexynyl, 3-hexynyl, 4-hexynyl, 5-hexynyl, 1-methyl-2-pentynyl, 1-methyl-3-pentynyl, 1-methyl-4-pentynyl, 2-methyl-3-pentynyl, 2-methyl-4-pentynyl, 3-methyl-1-pentynyl, 3-methyl-4-pentynyl, 4-methyl-1-pentynyl, 4-methyl-2-pentynyl, 1,1-dimethyl-2-butynyl, 1,1-dimethyl-3-butynyl, 1,2-dimethyl-3-butynyl, 2,2-dimethyl-3-butynyl, 3,3-dimethyl-1-butynyl, 1-ethyl-2-butynyl, 1-ethyl-3-butynyl, 2-ethyl-3-butynyl and 1-ethyl-1-methyl-2-propynyl;
C₃-C₆-haloalkynyl: a C₃-C₆-alkynyl radical as mentioned above which is partially or fully substituted by fluorine, chlorine, bromine and/or iodine, for example 1,1-difluoroprop-2-yn-1-yl, 3-chloroprop-2-yn-1-yl, 3-bromoprop-2-yn-1-yl, 3-iodoprop-2-yn-1-yl, 4-fluorobut-2-yn-1-yl, 4-chlorobut-2-yn-1-yl, 1,1-difluorobut-2-yn-1-yl, 4-iodobut-3-yn-1-yl, 5-fluoropent-3-yn-1-yl, 5-iodopent-4-yn-1-yl, 6-fluorohex-4-yn-1-yl or 6-iodohex-5-yn-1-yl;
C₁-C₃-alkoxy and also the C₁-C₃-alkoxy moieties of C₁-C₃-alkoxy-C₁-C₃-alkyl, C₁-C₃-alkoxycarbonyl: for example methoxy, ethoxy, propoxy;
C₁-C₄-alkoxy: for example methoxy, ethoxy, propoxy, 1-methylethoxy butoxy, 1-methylpropoxy, 2-methylpropoxy and 1,1-dimethylethoxy;
C₁-C₆-alkoxy and also the C₁-C₆-alkoxy moieties of C₁-C₆-alkyoxy-C₁-C₆-alkyl, C₁-C₆-alkoxy-C₁-C₆-alkoxy-C₁-C₆-alkyl, di(C₁-C₆-alkoxy)C₁-C₆-alkyl, C₃-C₆-alkenyloxy-C₁-C₆-alkoxy-C₁-C₆-alkyl, C₁-C₆-alkoxycarbonyl-C₁-C₆-alkyl: C₁-C₄-alkoxy as mentioned above, and also, for example, pentoxy, 1-methylbutoxy, 2-methylbutoxy, 3-methoxylbutoxy, 1,1-dimethylpropoxy, 1,2-dimethylpropoxy, 2,2-dimethylpropoxy, 1-ethylpropoxy, hexoxy, 1-methylpentoxy, 2-methylpentoxy, 3-methylpentoxy, 4-methylpentoxy, 1,1-dimethylbutoxy, 1,2-dimethylbutoxy, 1,3-dimethylbutoxy, 2,2-dimethylbutoxy, 2,3-dimethylbutoxy, 3,3-dimethylbutoxy, 1-ethylbutoxy, 2-ethylbutoxy, 1,1,2-trimethylpropoxy, 1,2,2-trimethylpropoxy, 1-ethyl-1-methylpropoxy and 1-ethyl-2-methylpropoxy.
C₁-C₃-haloalkoxy: a C₁-C₃-alkoxy radical as mentioned above which is partially or fully substituted by fluorine, chlorine, bromine and/or iodine, i.e., for example, fluoromethoxy, difluoromethoxy, trifluoromethoxy, chlorodifluoromethoxy, bromodifluoromethoxy, 2-fluoroethoxy, 2-chloroethoxy, 2-bromomethoxy, 2-iodoethoxy, 2,2-difluoroethoxy, 2,2,2-trifluoroethoxy, 2-chloro-2-fluoroethoxy, 2-chloro-2,2-difluoroethoxy, 2,2-dichloro-2-fluoroethoxy, 2,2,2-trichloroethoxy, pentafluoroethoxy, 2-fluoropropoxy, 3-fluoropropoxy, 2-chloropropoxy, 3-chloropropoxy, 2-bromopropoxy, 3-bromopropoxy, 2,2-difluoropropoxy, 2,3-difluoropropoxy, 2,3-dichloropropoxy, 3,3,3-trifluoropropoxy, 3,3,3-trichloropropoxy, 2,2,3,3,3-pentafluoropropoxy, heptafluoropropoxy, 1-(fluoromethyl)-2-fluoroethoxy, 1-(chloromethyl)-2-chloroethoxy, 1-(bromo-methyl)-2-bromoethoxy;
C₁-C₄-haloalkoxy: a C₁-C₄-alkoxy radical as mentioned above which is partially or fully substituted by fluorine, chlorine, bromine and/or iodine, i.e., for example, fluoromethoxy, difluoromethoxy, trifluoromethoxy, chlorodifluoromethoxy, bromodifluoromethoxy, 2-fluoroethoxy, 2-chloroethoxy, 2-bromomethoxy, 2-iodoethoxy, 2,2-difluoroethoxy, 2,2,2-trifluoroethoxy, 2-chloro-2-fluoroethoxy, 2-chloro-2,2-difluoroethoxy, 2,2-dichloro-2-fluoroethoxy, 2,2,2-trichloroethoxy, pentafluoroethoxy, 2-fluoropropoxy, 3-fluoropropoxy, 2-chloropropoxy, 3-chloropropoxy, 2-bromopropoxy, 3-bromopropoxy, 2,2-difluoropropoxy, 2,3-difluoropropoxy, 2,3-dichloropropoxy, 3,3,3-trifluoropropoxy, 3,3,3-trichloropropoxy, 2,2,3,3,3-pentafluoropropoxy, heptafluoropropoxy, 1-(fluoromethyl)-2-fluoroethoxy, 1-(chloromethyl)-2-chloroethoxy, 1-(bromo-methyl)-2-bromoethoxy, 4-fluorobutoxy, 4-chlorobutoxy, 4-bromobutoxy and nonafluorobutoxy;
C₁-C₆-haloalkoxy and also the C₁-C₆-haloalkoxy moieties of C₁-C₆-haloalkoxy-C₁-C₆-alkyl, C₁-C₆-haloalkoxycarbonyl-C₁-C₆-alkyl: a C₁-C₄-haloalkoxy as mentioned above, and also, for example, 5-fluoropentoxy, 5-chloropentoxy, 5-bromopentoxy, 5-iodopentoxy, undecafluoropentoxy, 6-fluorohexoxy, 6-chlorohexoxy, 6-bromohexoxy, 6-iodohexoxy and dodecafluorohexoxy;
C₁-C₃-alkylthio: for example methylthio, ethylthio, propylthio, 1-methylethylthio;
C₁-C₄-alkylthio: for example methylthio, ethylthio, propylthio, 1-methylethylthio, butylthio, 1-methylpropylthio, 2-methylpropylthio and 1,1-dimethylethylthio;
C₁-C₆-alkylthio and also the C₁-C₆-alkylthio moieties of C₁-C₆-alkylthio-C₁-C₆-alkyl: C₁-C₄-alkylthio as mentioned above, and also, for example, pentylthio, 1-methylbutylthio, 2-methyl-butylthio, 3-methylbutylthio, 2,2-dimethylpropylthio, 1-ethylpropylthio, hexylthio, 1,1-di-methylpropylthio, 1,2-dimethylpropylthio, 1-methylpentylthio, 2-methylpentylthio, 3-methyl-pentylthio, 4-methylpentylthio, 1,1-dimethylbutylthio, 1,2-dimethylbutylthio, 1,3-dimethylbutylthio, 2,2-dimethylbutylthio, 2,3-dimethylbutylthio, 3,3-dimethylbutylthio, 1-ethylbutylthio, 2-ethylbutylthio, 1,1,2-trimethylpropylthio, 1,2,2-trimethylpropylthio, 1-ethyl-1-methylpropylthio and 1-ethyl-2-methylpropylthio;
C₁-C₆-alkylsulfinyl (C₁-C₆-alkyl-S(═O)—) and also the C₁-C₆-alkylsulfinyl moieties of C₁-C₆-alkylsulfinyl-C₁-C₆-alkyl: for example methylsulfinyl, ethylsulfinyl, propylsulfinyl, 1-me-thylethylsulfinyl, butylsulfinyl, 1-methylpropylsulfinyl, 2-methylpropylsulfinyl, 1,1-di-methylethylsulfinyl, pentylsulfinyl, 1-methylbutylsulfinyl, 2-methylbutylsulfinyl, 3-methylbutylsulfinyl, 2,2-dimethylpropylsulfinyl, 1-ethylpropylsulfinyl, 1,1-dimethylpropylsulfinyl, 1,2-dimethylpropylsulfinyl, hexylsulfinyl, 1-methylpentylsulfinyl, 2-methylpentylsulfinyl, 3-methylpentylsulfinyl, 4-methylpentyl-sulfinyl, 1,1-dimethylbutylsulfinyl, 1,2-dimethylbutylsulfinyl, 1,3-dimethylbutyl-sulfinyl, 2,2-dimethylbutylsulfinyl, 2,3-dimethylbutylsulfinyl, 3,3-dimethylbutyl-sulfinyl, 1-ethylbutylsulfinyl, 2-ethylbutylsulfinyl, 1,1,2-trimethylpropylsulfinyl, 1,2,2-trimethylpropylsulfinyl, 1-ethyl-1-methylpropylsulfinyl and 1-ethyl-2-methylpropylsulfinyl;
C₁-C₆-alkylsulfonyl (C₁-C₆-alkyl-S(O)₂—) and also the C₁-C₆-alkylsulfonyl moieties of C₁-C₆-alkylsulfonyl-C₁-C₆-alkyl: for example methylsulfonyl, ethylsulfonyl, propylsulfonyl, 1-methylethylsulfonyl, butylsulfonyl, 1-methylpropylsulfonyl, 2-methyl-propylsulfonyl, 1,1-dimethylethylsulfonyl, pentylsulfonyl, 1-methylbutylsulfonyl, 2-methylbutylsulfonyl, 3-methylbutylsulfonyl, 1,1-dimethylpropylsulfonyl, 1,2-dimethylpropylsulfonyl, 2,2-dimethylpropylsulfonyl, 1-ethylpropylsulfonyl, hexylsulfonyl, 1-methylpentylsulfonyl, 2-methylpentylsulfonyl, 3-methylpentylsulfonyl, 4-methylpentylsulfonyl, 1,1-dimethylbutylsulfonyl, 1,2-dimethylbutylsulfonyl, 1,3-dimethylbutylsulfonyl, 2,2-dimethylbutylsulfonyl, 2,3-dimethyl-butylsulfonyl, 3,3-dimethylbutylsulfonyl, 1-ethylbutylsulfonyl, 2-ethylbutylsulfonyl, 1,1,2-trimethyl-propylsulfonyl, 1,2,2-trimethylpropylsulfonyl, 1-ethyl-1-methylpropylsulfonyl and 1-ethyl-2-methylpropylsulfonyl;
(C₁-C₃-alkyl)amino: for example methylamino, ethylamino, propylamino, 1-methylethyl-amino.

The preferred embodiments of the invention mentioned herein below shall be understood as being preferred either independently from each other or in combination with one another.

According to a preferred embodiment of the invention preference is also given to those compounds of formula (I), wherein the variables, either independently of one another or in combination with one another, have the following meanings:

Particular groups of the embodiment relate to the diaminotriazine compound of formula (I), wherein:
R¹ is F.

Also preferred are diaminotriazine compounds of formula (I), wherein
R² is selected from the group consisting of H, halogen, CH₃, C₁-haloalkyl; in particular consisting of H, halogen, CH₃; more particularly consisting of H, F, Cl, CH₃.

Further particular groups of embodiments relate to the diaminotriazine compounds of formula (1), wherein
R³ is H or F; preferably H.

Further particular groups of embodiments relate to the diaminotriazine compounds of formula (1), wherein
R⁴ is selected from the group consisting of halogen, CH₃, C₁-haloalkyl; in particular consisting of halogen, CH₃; more particularly consisting of F, Br, Cl, CH₃.

Also preferred are diaminotriazine compounds of formula (I), wherein
R⁵ is selected from the group consisting of H, halogen, CN, C₁-C₆-alkyl, C₁-C₆-haloalkyl, C₁-C₆-alkoxy and C₁-C₆-haloalkoxy, in particular from the group consisting of hydrogen, fluorine, C₁-C₄-alkyl, such as methyl, ethyl, n-propyl, 2-propyl, n-butyl, 2-butyl, isobutyl or tert.-butyl, C₁-C₄-haloalkyl, such as difluoromethyl, trifluoromethyl, 2,2,2-trifluoroethyl, 1,1-difluoroethyl, 1,1,2,2-tetrafluoroethyl or pentafluoroethyl, C₁-C₄-alkoxy, such as methoxy or ethoxy and C₁-C₄-haloalkoxy, such as difluoromethoxy or trifluoromethoxy.

Further particular groups embodiments relate to the diaminotriazine compounds of formula (I), wherein
R⁶ is selected from the group consisting of H, halogen, CN, C₁-C₆-alkyl, C₁-C₆-haloalkyl, C₁-C₆-alkoxy and C₁-C₆-haloalkoxy, in particular from the group consisting of hydrogen, fluorine and C₁-C₄-alkyl, more particularly from hydrogen, fluorine and methyl, especially from fluorine and methyl.

In groups (1) of embodiments, R⁷ is as defined above. Preferably
R⁷ is selected from the group consisting of halogen, C₁-C₆-alkyl, C₁-C₆-haloalkyl, C₂-C₆-alkenyl, C₃-C₆-alkynyl, C₃-C₆-cycloalkyl, C₃-C₆-cycloalkyl-C₁-C₆-alkyl, C₃-C₆-cycloalkenyl, C₁-C₆-alkoxy-C₁-C₆-alkyl.

Further particular groups of embodiments relate to the diaminotriazine compounds of formula (I), wherein R⁶ and R⁷ together with the carbon atom to which they are attached form a moiety selected from the group consisting of carbonyl, C₃-C₆-cycloalkan, C₃-C₆-cycloalkenyl, three- to six-membered saturated or partially unsaturated heterocyclyl, where the carbocycle and the heterocycle are unsubstituted, partly or completely halogenated or carry from 1 to 6 C₁-C₆-alkyl groups, and the moiety >C=CR^{x}R^{y}, where R^{x} and R^{y} are hydrogen, C₁-C₄-alkyl, C₁-C₄-haloalkyl, C₃-C₆-cycloalkyl or CR^{x}R^{y} form a 3- to 6-membered cycloalkyl. Preferably, R⁶ and R⁷ together with the carbon atom to which they are attached form C₃-C₆-cycloalkan.

Especially preferred examples of CR⁵R⁶R⁷ are those radicals, where R², R³ and R⁴ are given in rows 1 to 65 of table 1a.

TABLE 1a

| no. | R⁵ | R⁶ | R⁷ |
|---|---|---|---|
| 1. | H | CH₃ | CH₃ |
| 2. | F | F | CH₃ |
| 3. | F | H | CH₃ |
| 4. | F | CH₃ | CH₃ |
| 5. | CH₃ | CH₃ | CH₃ |
| 6. | CH₃ | OCH₃ | CH₃ |
| 7. | F | H | C₂H₅ |
| 8. | H | CH₃ | C₂H₅ |
| 9. | F | CH₃ | C₂H₅ |
| 10. | H | OCH₃ | CH₃ |
| 11. | H | OCH₃ | C₂H₅ |
| 12. | F | C₂H₅ | C₂H₅ |
| 13. | H | OCH₃ | C₂H₅ |
| 14. | H | H | CH(CH₃)₂ |
| 15. | H | F | CH(CH₃)₂ |
| 16. | F | F | CH(CH₃)₂ |
| 17. | H | CH₃ | CH(CH₃)₂ |
| 18. | H | OCH₃ | CH(CH₃)₂ |
| 19. | F | CH₃ | CH(CH₃)₂ |
| 20. | H | H | CH₂CH₂CH₃ |
| 21. | H | F | CH₂CH₂CH₃ |
| 22. | F | F | CH₂CH₂CH₃ |
| 23. | H | CH₃ | CH₂CH₂CH₃ |
| 24. | H | OCH₃ | CH₂CH₂CH₃ |
| 25. | F | CH₃ | CH₂CH₂CH₃ |
| 26. | H | H | C(CH₃)₃ |
| 27. | H | F | C(CH₃)₃ |
| 28. | F | F | C(CH₃)₃ |
| 29. | H | CH₃ | C(CH₃)₃ |
| 30. | H | OCH₃ | C(CH₃)₃ |
| 31. | F | CH₃ | C(CH₃)₃ |
| 32. | H | H | Cyclopropyl |
| 33. | H | F | Cyclopropyl |
| 34. | F | F | Cyclopropyl |
| 35. | H | CH₃ | Cyclopropyl |
| 36. | H | OCH₃ | Cyclopropyl |
| 37. | F | CH₃ | Cyclopropyl |
| 38. | H | CH₃ | CF₃ |
| 39. | F | CH₃ | CF₃ |

| | | |
|---|---|---|
| 40. | H | CH₂—CH₂ |
| 41. | CH₃ | CH₂—CH₂ |
| 42. | OCH₃ | CH₂—CH₂ |
| 43. | F | CH₂—CH₂ |
| 44. | Cl | CH₂—CH₂ |
| 45. | H | CH₂—CH₂—CH₂ |
| 46. | CH₃ | CH₂—CH₂—CH₂ |
| 47. | OCH₃ | CH₂—CH₂—CH₂ |
| 48. | F | CH₂—CH₂—CH₂ |
| 49. | Cl | CH₂—CH₂—CH₂ |
| 50. | H | CH₂—CH₂—CH₂—CH₂ |
| 51. | CH₃ | CH₂—CH₂—CH₂—CH₂ |
| 52. | OCH₃ | CH₂—CH₂—CH₂—CH₂ |
| 53. | F | CH₂—CH₂—CH₂—CH₂ |
| 54. | Cl | CH₂—CH₂—CH₂—CH₂ |
| 55. | H | CH₂—CH₂—CH₂—CH₂—CH₂ |
| 56. | CH₃ | CH₂—CH₂—CH₂—CH₂—CH₂ |
| 57. | OCH₃ | CH₂—CH₂—CH₂—CH₂—CH₂ |
| 58. | F | CH₂—CH₂—CH₂—CH₂—CH₂ |
| 59. | Cl | CH₂—CH₂—CH₂—CH₂—CH₂ |
| 60. | H | O—CH₂—CH₂—CH₂ |
| 61. | CH₃ | O—CH₂—CH₂—CH₂ |
| 62. | OCH₃ | O—CH₂—CH₂—CH₂ |
| 63. | H | O—CH₂—CH₂—CH₂—CH₂ |
| 64. | CH₃ | O—CH₂—CH₂—CH₂—CH₂ |
| 65. | OCH₃ | O—CH₂—CH₂—CH₂—CH₂ |

R^{a} is selected from the group consisting of C₁-C₆-alkyl, C₂-C₆-alkenyl, C₂-C₆-alkynyl, (C₁-C₆-alkoxy)-C₁-C₆-alkyl, (C₁-C₆-alkoxy)-C₂-C₆-alkenyl, (C₁-C₆-alkoxy)-C₂-C₆-alkynyl, (C₁-C₆-cycloalkyl)-C₂-C₆-alkynyl, (C₃-C₆-cycloalkyl)-C₁-C₄-alkyl, (C₃-C₆-cycloalkoxy)-C₁-C₄-alkyl, where the the aforementioned radicals are unsubstituted, partly or completely halogenated and where the cycloaliphatic parts of the last 6 mentioned radicals may carry 1, 2, 3, 4, 5 or 6 methyl groups;
preferably, R⁸ is is selected from the group consisting of C₁-C₆-alkyl, C₂-C₆-alkenyl, C₂-C₆-alkynyl, (C₁-C₆-alkoxy)-C₁-C₆-alkyl.

In particular R⁸ is selected from the group consisting of of CH₃, CH₂CCH, CH₂C₀₀H₃, CH₂OCH₃, CH(CH₃)CCH, CH(CH₃)CCCH₃, especially CH₃, CH₂CCH, CH₂CCCH₃, CH₂OCH₃.

Particular embodiments of the compounds I are the following compounds: I-A, I-B, I-C, I-D, I-E, I-F:

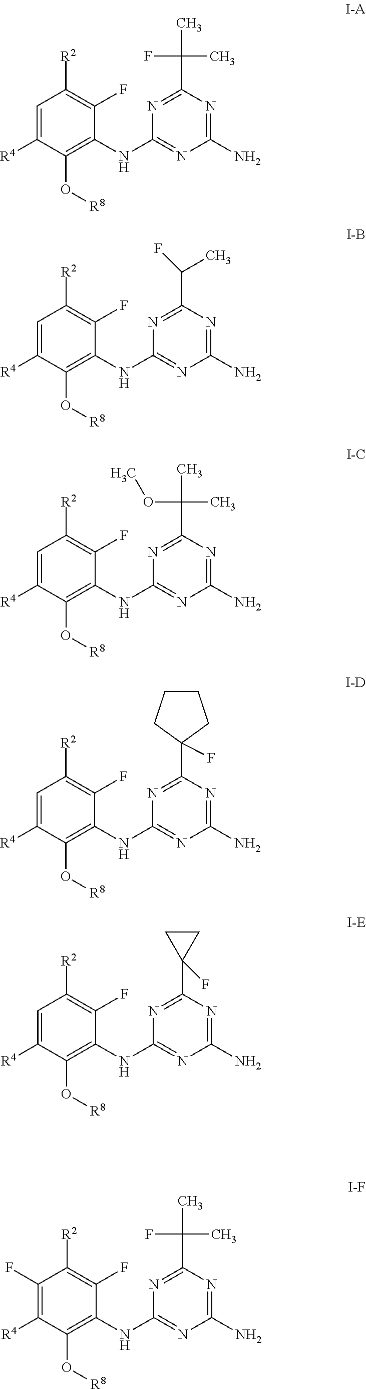

Table 1-1 Compounds of the formula I-A, I-B, I-C, I-D, I-E, I-F in which the meaning for the combination of R², R⁴ and R³ for each individual compound corresponds in each case to one line of Table A (compounds I-A.1-1.A-1 to I-A.1-1.A-48, I-B.1-1.A-1 to I-B.1-1.A-48, I-C.1-1.A-1 to I-C.1-1.A-48, I-D.1-1.A-1 to I-D.1-1.A-48, I-E.1-1.A-1 to I-E.1-1.A-48, I-F.1-1.A-1 to I-F.1-1.A-48).

TABLE A

| No. | R² | R⁴ | R⁸ |
|---|---|---|---|
| A-1 | H | Cl | CH₃ |
| A-2 | F | Cl | CH₃ |
| A-3 | Cl | Cl | CH₃ |
| A-4 | CH₃ | Cl | CH₃ |
| A-5 | H | Br | CH₃ |
| A-6 | F | Br | CH₃ |
| A-7 | Cl | Br | CH₃ |
| A-8 | CH₃ | Br | CH₃ |
| A-9 | H | F | CH₃ |
| A-10 | F | F | CH₃ |
| A-11 | Cl | F | CH₃ |
| A-12 | CH₃ | F | CH₃ |
| A-13 | H | Cl | CH₂—C≡C |
| A-14 | F | Cl | CH₂—C≡C |
| A-15 | Cl | Cl | CH₂—C≡C |
| A-16 | CH₃ | Cl | CH₂—C≡C |
| A-17 | H | Br | CH₂—C≡C |
| A-18 | F | Br | CH₂—C≡C |
| A-19 | Cl | Br | CH₂—C≡C |
| A-20 | CH₃ | Br | CH₂—C≡C |
| A-21 | H | F | CH₂—C≡C |
| A-22 | F | F | CH₂—C≡C |
| A-23 | Cl | F | CH₂—C≡C |
| A-24 | CH₃ | F | CH₂—C≡C |
| A-25 | H | Cl | CH₂—C≡C—CH₃ |
| A-26 | F | Cl | CH₂—C≡C—CH₃ |
| A-27 | Cl | Cl | CH₂—C≡C—CH₃ |
| A-28 | CH₃ | Cl | CH₂—C≡C—CH₃ |
| A-29 | H | Br | CH₂—C≡C—CH₃ |
| A-30 | F | Br | CH₂—C≡C—CH₃ |
| A-31 | Cl | Br | CH₂—C≡C—CH₃ |
| A-32 | CH₃ | Br | CH₂—C≡C—CH₃ |
| A-33 | H | F | CH₂—C≡C—CH₃ |
| A-34 | F | F | CH₂—C≡C—CH₃ |
| A-35 | Cl | F | CH₂—C≡C—CH₃ |
| A-36 | CH₃ | F | CH₂—C≡C—CH₃ |
| A-37 | H | Cl | CH₂—O—CH₃ |
| A-38 | F | Cl | CH₂—O—CH₃ |
| A-39 | Cl | Cl | CH₂—O—CH₃ |
| A-40 | CH₃ | Cl | CH₂—O—CH₃ |
| A-41 | H | Br | CH₂—O—CH₃ |
| A-42 | F | Br | CH₂—O—CH₃ |
| A-43 | Cl | Br | CH₂—O—CH₃ |
| A-44 | CH₃ | Br | CH₂—O—CH₃ |
| A-45 | H | F | CH₂—O—CH₃ |
| A-46 | F | F | CH₂—O—CH₃ |
| A-47 | Cl | F | CH₂—O—CH₃ |
| A-48 | CH₃ | F | CH₂—O—CH₃ |

According to another preferred embodiment of the invention the composition contains as component A at least one compound selected from I-A.1-1.A-1 to I-A.1-1.A-48.

According to another preferred embodiment of the invention the composition contains as 5 component A at least one compound selected from I-B.1-1.A-1 to I-B.1-1.A-48.

According to another preferred embodiment of the invention the composition contains as component A at least one compound selected from I-C.1-1.A-1 to I-C.1-1.A-48.

According to another preferred embodiment of the invention the composition contains as component A at least one compound selected from I-D.1-1.A-1 to I-D.1-1.A-48.

According to another preferred embodiment of the invention the composition contains as component A at least one compound selected from I-E.1-1.A-1 to I-E.1-1.A-48.

According to another preferred embodiment of the invention the composition contains as component A at least one compound selected from I-F.1-1.A-1 to I-F.1-1.A-48.

According to another preferred embodiment of the invention the composition contains as component A compound of the formula

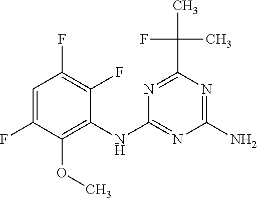 [SMILES: COc1c(F)cc(F)c(F)c1Nc1nc(N)nc(C(C)(C)F)n1]

According to another preferred embodiment of the invention the composition contains as component A compound of the formula

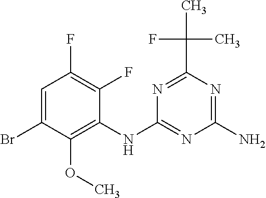 [SMILES: COc1c(Br)cc(F)c(F)c1Nc1nc(N)nc(C(C)(C)F)n1]

According to another preferred embodiment of the invention the composition contains as component A compound of the formula

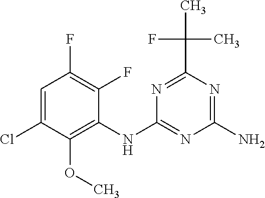 [SMILES: COc1c(Cl)cc(F)c(F)c1Nc1nc(N)nc(C(C)(C)F)n1]

According to another preferred embodiment of the invention the composition contains as component A compound of the formula

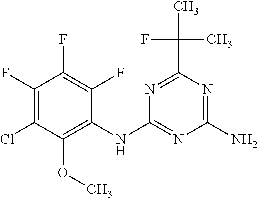 [SMILES: COc1c(Cl)c(F)c(F)c(F)c1Nc1nc(N)nc(C(C)(C)F)n1]

The diaminotriazine compounds of formula (I) according to the invention can be prepared by standard processes of organic chemistry, for example by the following process:

### Process A)

Diaminotriazines of formular (1) can be synthesized by addition of the corresponding 2-alcoxyanilines of formula (II) to halotriazines of formula (III) under basic or acidic conditions in an inert organic solvent as depicted in the following Scheme:

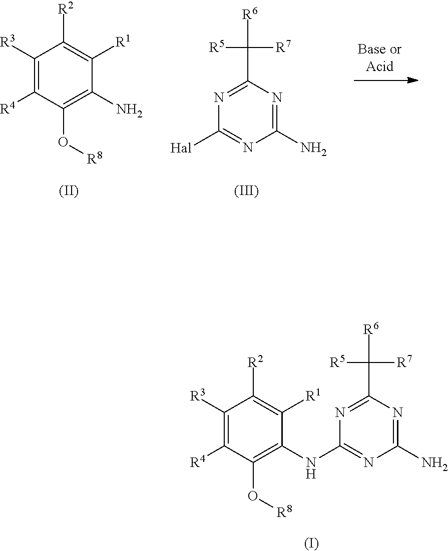

The variables R¹, R², R³ and R⁴, R⁶, R⁷ and R⁸ have the meanings, in particular the preferred meanings, as in formula (I) mentioned above and
Hal is halogen;
preferably Cl or Br;
particularly preferred Cl;

The reaction of the halotriazines of formula (III) with the amine compound of formula (II) is usually carried out from 50° C. to the boiling point of the reaction mixture in an inert organic solvent.

The halotriazines of formula (III) and the compounds of formula (II) are used in equimolar amounts or the compounds of formula (II) are used in excess with regard to the halotriazines of formula (III). Preferably the molar ratio of the compounds of formula (II) to the halotriazines of formula (III) is in the range from 2:1 to 1:1, preferably 1.5:1 to 1:1, especially preferred 1:1. The reaction of the halotriazines of formula (III) with the compounds of formula (II) is carried out in an organic solvent. Suitable solvents are those which can dissolve the halotriazines of formula (III) and the anilines of formula (II) at least partly and preferably fully under reaction conditions. Examples of suitable solvents are aliphatic hydrocarbons such as pentane, hexane, cyclohexane, nitromethane, aromatic hydrocarbons such as benzene, chlorobenzene, toluene, cresols, o-, m- and p-xylene, halogenated hydrocarbons such as dichloromethane, 1,2-dichloroethane, chloroform, carbon tetrachloride and chlorobenzene, ethers such as diethyl ether, diisopropyl ether, tert-butyl methylether (TBME), dioxane, anisole and tetrahydrofuran (THF), esters such as ethyl acetate and butyl acetate; nitriles such as acetonitrile and propionitrile, as well as dipolar aprotic solvents such as sulfolane, dimethylsulfoxide, N,N-dimethylformamide (DMF), N,N-dimethylacetamide (DMAC), 1,3-dimethyl-2-imidazolidinone (DMI), N,N′-dimethylpropylene urea (DMPU), dimethyl sulfoxide (DMSO) and 1-methyl-2 pyrrolidinone (NMP). Preferred solvents are ethers as defined above. The term solvent as used herein also includes mixtures of two or more of the above compounds.

The reaction of the halotriazines of formula (III) with the compounds of formula (II) is carried out in the presence of a base or an acid. Examples of suitable bases include metal-containing bases and nitrogen-containing bases.

Examples of suitable metal-containing bases are inorganic compounds such as alkali metal and alkaline earth metal hydroxides, and other metal hydroxides, such as lithium hydroxide, sodium hydroxide, potassium hydroxide, magnesium hydroxide, calcium hydroxide and aluminum hydroxide; alkali metal and alkaline earth metal oxide, and other metal oxides, such as lithium oxide, sodium oxide, potassium oxide, magnesium oxide, calcium oxide and magnesium oxide, iron oxide, silver oxide; alkali metal and alkaline earth metal hydrides such as lithium hydride, sodium hydride, potassium hydride and calcium hydride, alkali metal and alkaline earth metal formates, acetates and other metal salts of carboxylic acids, such as sodium formate, sodium benzoate, lithium acetate, sodium acetate, potassium acetate, magnesium acetate, and calcium acetate; alkali metal and alkaline earth metal carbonates such as lithium carbonate, sodium carbonate, potassium carbonate, magnesium carbonate, and calcium carbonate, as well as alkali metal hydrogen carbonates (bicarbonates) such as lithium hydrogen carbonate, sodium hydrogen carbonate, potassium hydrogen carbonate; alkali metal and alkaline earth metal phosphates such as sodium phosphate, potassium phosphate and calcium phosphate; alkali metal and alkaline earth metal alkoxides such as sodium methoxide, sodium ethoxide, potassium ethoxide, potassium tert-butoxide, potassium tert-pentoxide.

Preferred bases are alkali metal and alkaline earth metal alkoxides as defined above. The term base as used herein also includes mixtures of two or more, preferably two of the above compounds.

The bases can be used in equimolar concentration or in excess, preferably from 1 to 10, especially preferred from 2 to 4 equivalents based on the halotriazines of formula (III), and they may also be used as the solvent.

Example of suitable acids are inorganic acids like hydrofluoric acid, hydrochloric acid, hydrobromic acid, hydroiodic acid, phosphoric acid, sulfuric acid, p-toluenesulfonic acid; Lewis acids like boron trifluoride, aluminium chloride, ferric-Ill-chloride, tin-IV-chloride, titanium-IV-chloride and zinc-Il-chloride, as well as organic acids like formic acid, acetic acid, propionic acid, oxalic acid, methylbenzenesulfonic acid, benzenesulfonic acid, camphorsulfonic acid, citric acid, trifluoroacetic acid, can be used.

Preferred acids are inorganic acids.

The acids are generally employed in excess or, if appropriate, can be used as a solvent.

The end of the reaction can easily be determined by the skilled worker by means of routine methods.

The reaction mixtures are worked up in a customary manner, for example by mixing with water, separation of the phases and, if appropriate, purification of the crude product.

The anilines of formula (II) required for the preparation of compounds of formula (I), are commercially available or can be prepared by standard processes of organic chemistry, for example by nitration of commercially available phenols and subsequent reduction of the nitro group.

The halo-triazines of formula (III) required for the preparation of diaminotriazines of formula (I), are known from the literature, are commercially available and/or can be prepared by analogy (e.g. J. K. Chakrabarti et al., Tetrahedron 1975, 31, 1879-1882) by reacting thiotriazines of formula (IV) with a halogen source (e.g. Cl) or other suitable halogenating agents (e.g. SOCl2).

### Process B)

Diaminotriazines of formular (I) can be synthesized by alkylation of the corresponding phenoldiaminotriazines of formula (IV) under basic conditions in an inert organic solvent as depicted in the following Scheme:

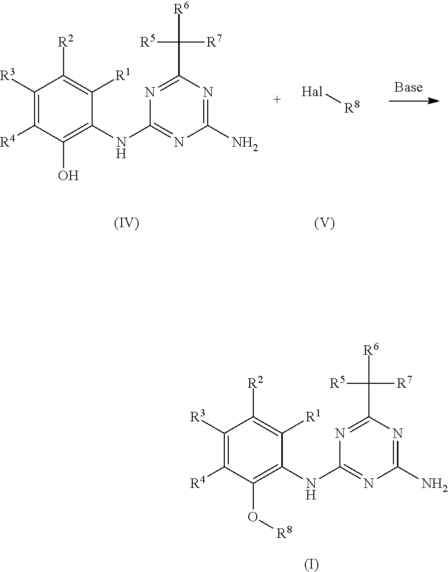

The variables R¹, R², R³ and R⁴, R⁶, R⁷ and R³ have the meanings, in particular the preferred meanings, as in formula (I) mentioned above and
Hal is halogen;
preferably I or Br or Cl;

The alkylation reaction of the phenoldiaminotriazines of formula (IV) can be carried out from room temperature to the boiling point of the reaction mixture in an organic solvent.

The alkylating reagent of formula (V) and the compounds of formula (IV) are used in equimolar amounts or the compounds of formula (V) are used in excess with regard to the phenoldiaminotriazines of formula (IV). Preferably the molar ratio of the compounds of formula (V) to phenoldiaminotriazines of formula (IV) is in the range from 1.5:1 to 1:1, preferred 1.2:1.

The reaction of the halotriazines of formula (III) with the compounds of formula (II) is carried out in the presence of a base or an acid. Examples of suitable bases include metal-containing bases and nitrogen-containing bases.

Examples of suitable metal-containing bases are alkali metal and alkaline earth metal hydrides such as lithium hydride, sodium hydride, potassium hydride and calcium hydride, alkali metal and alkaline earth metal carbonates such as lithium carbonate, sodium carbonate, potassium carbonate, magnesium carbonate, and calcium carbonate, as well as alkali metal hydrogen carbonates (bicarbonates) such as lithium hydrogen carbonate, sodium hydrogen carbonate, potassium hydrogen carbonate; alkali metal and alkaline earth metal phosphates such as sodium phosphate, potassium phosphate and calcium phosphate; alkali metal and alkaline earth metal alkoxides such as potassium tert-butoxide, potassium tert-pentoxide.

### Process C)

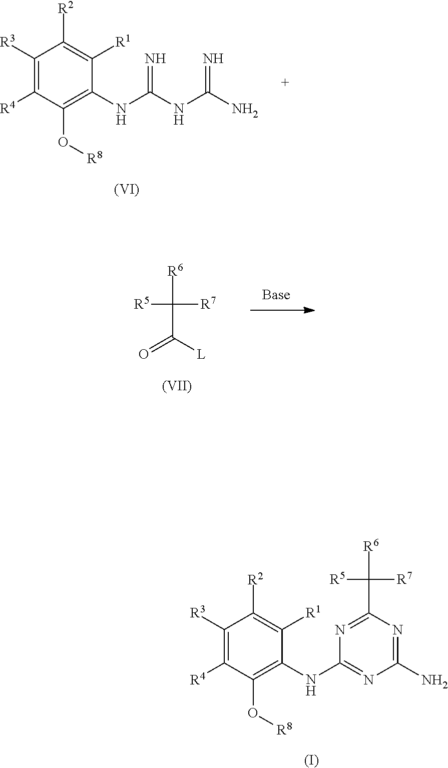

The variables R¹, R², R³ and R⁴, R⁶, R⁷ and R⁸ have the meanings, in particular the preferred meanings, as in formula (I) mentioned above and
L is a displaceable leaving group such as halogen, CN, C₁-C₆-alkoxy, C₁-C₆-alkoxycarbonyl, C₁-C₆-alkylcarbonyloxy or C₁-C₆-alkoxycarbonyloxy;
preferably halogen or C₁-C₆-alkoxy;
particularly preferred Cl or C₁-C₆-alkoxy,
especially preferred Cl.

The reaction of biguanidines of formula (VI) with carbonyl compounds of formula (VII) is usually carried out at temperatures from 50° C. to the boiling point of the reaction mixture, preferably from 50° C. to 200° C. (e.g. R. Sathunuru et al., J. Heterocycl. Chem. 2008, 45, 1673-1678).

The reaction can be carried out at atmospheric pressure or under elevated pressure, if appropriate under an inert gas, continuously or batchwise.

In one embodiment of the process according to the invention, the biguanidines of formula (VI) and the carbonyl compounds of formula (VII) are used in equimolar amounts.

In another embodiment of the process according to the invention, the carbonyl compounds of formula (VII) are used in excess with regard to the biguanidines of formula (VI).

Preferably the molar ratio of the carbonyl compounds of formula (VII) to the biguanidines of formula (VI) is in the range from 1.5:1 to 1:1, preferably 1.2:1 to 1:1, especially preferred 1.2:1, also especially preferred 1:1.

The reaction of the biguanidines of formula (VI) with the carbonyl compounds of formula (VII) is carried out in an organic solvent.

Suitable solvents are in principle all solvents capable of dissolving the biguanidines of formula (VI) and the carbonyl compounds of formula (VII) at least partly and preferably fully under reaction conditions.

Examples of suitable solvents are aliphatic hydrocarbons such as pentane, hexane, cyclohexane, nitromethane and mixtures of Cs-Cs-alkanes; aromatic hydrocarbons such as benzene, chlorobenzene, toluene, cresols, o-, m- and p-xylene; halogenated hydrocarbons such as dichloromethane, 1,2-dichloroethane, chloroform, carbon tetrachloride and chlorobenzene, ethers such as diethyl ether, diisopropyl ether, tert.-butyl methylether (TBME), dioxane, anisole and tetrahydrofuran (THF), nitriles such as acetonitrile and propionitrile, as well as dipolar aprotic solvents such as sulfolane, dimethylsulfoxide, N,N-dimethylformamide (DMF), N,N-dimethylacetamide (DMAC), 1,3-dimethyl-2-imidazolidinone (DMI), N,N′-dimethylpropylene urea (DMPU), dimethyl sulfoxide (DMSO) and 1-methyl-2 pyrrolidinone (NMP).

Preferred solvents are ethers and dipolar aprotic solvents as defined above. More preferred solvents are ethers as defined above.

The term solvent as used herein also includes mixtures of two or more of the above compounds.

The reaction of the biguanidines of formula (VI) with the carbonyl compounds of formula (VII) is carried out in the presence of a base.

Examples of suitable bases include metal-containing bases and nitrogen-containing bases. Examples of suitable metal-containing bases are inorganic compounds such as alkali metal and alkaline earth metal oxide, and other metal oxides, such as lithium oxide, sodium oxide, potassium oxide, magnesium oxide, calcium oxide and magnesium oxide, iron oxide, silver oxide; alkali metal and alkaline earth metal hydrides such as lithium hydride, sodium hydride, potassium hydride and calcium hydride, alkali metal amides such as lithium amide, sodium amide and potassium amide, alkali metal and alkaline earth metal carbonates such as lithium carbonate, sodium carbonate, potassium carbonate, magnesium carbonate, and calcium carbonate, as well as alkali metal hydrogen carbonates (bicarbonates) such as lithium hydrogen carbonate, sodium hydrogen carbonate, potassium hydrogen carbonate; alkali metal and alkaline earth metal phosphates such as sodium phosphate, potassium phosphate and calcium phosphate; and furthermore organic bases, such as tertiary amines such as tri-Ci-C6-alkylamines, for example triethylamine, trimethylamine, N-ethyldiisopropylamine, and N-methyl-piperidine, pyridine, substituted pyridines such as collidine, lutidine, N-methylmorpholine and 4-dimethylaminopyridine (DMAP), and also bicyclic amines such as 1,8-diazabicyclo[5.4.0]undec-7-ene (DBU) or 1,5-diazabicyclo[4.3.0]non-5-ene (DBN).

Preferred bases are tri-C1-C6-alkylamines as defined above. The term base as used herein also includes mixtures of two or more, preferably two of the above compounds. Particular preference is given to the use of one base. The bases are generally employed in excess; however, they can also be employed in equimolar amounts, or, if appropriate, can be used as solvent. Preferably from 1 to 5 base equivalents, particularly preferred 3 base equivalents of base are used, based on the biguanidines of formula (VII). The end of the reaction can easily be determined by the skilled worker by means of routine methods.

The reaction mixtures are worked up in a customary manner, for example by mixing with water, separation of the phases and, if appropriate, chromatographic purification of the crude product. Some of the intermediates and end products are obtained in the form of viscous oils, which can be purified or freed from volatile components under reduced pressure and at moderately elevated temperature.

If the intermediates and the end products are obtained as solid, purification can also be carried out by recrystallisation or digestion.

The carbonyl compounds of formula (VII) required for the preparation of azines of formula (I) are known in the literature and/or are commercially available.

The biguanidines of formula (VI) required for the preparation of azines of formula (I) can be prepared by reacting cyanoguanidines of formula (VIII) with amines of formula (II) in the presence of an acid:

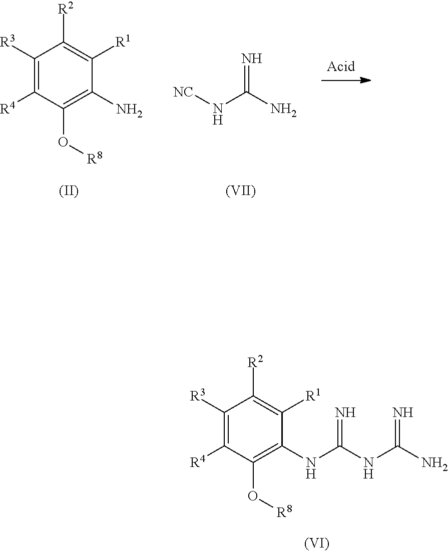

The reaction of guanidines of formula (VII) with amines of formula (II) is usually carried out from 50° C. to 150° C., preferably from 80° C. to 130° C. Microwave-Technology was used where applicable (e.g. C. O. Kappe, A. Stadler, Microwaves in Organic and Medicinal Chemistry, Weinheim 2012).

The reaction can be carried out at atmospheric pressure or under elevated pressure, if appropriate under an inert gas, in flow reactors or batchwise.

In one embodiment of the process according to the invention, the guanidines of formula (VII) and the amines of formula (II) are used in equimolar amounts.

In another embodiment of the process according to the invention, the amines of formula (II) are used in excess with regard to the guanidines of formula (VII).

Preferably the molar ratio of the amines of formula (II) to the guanidines of formula (VII) is in the range from 2:1 to 1:1, preferably 1.5:1 to 1:1, especially preferred 1:1.

The reaction of the guanidines of formula (VII) with the amines of formula (II) is carried out in an organic solvent. The term solvent as used herein also includes mixtures of two or more solvents.

Suitable in principle are all solvents which are capable of dissolving the guanidines of formula (VII) and the amines of formula (II) at least partly and preferably fully under reaction conditions.

Examples of suitable solvents are aliphatic hydrocarbons such as pentane, hexane, cyclohexane, nitromethane and mixtures of C5-C8-alkanes, aromatic hydrocarbons such as benzene, chlorobenzene, toluene, cresols, o-, m- and p-xylene, halogenated hydrocarbons such as dichloromethane, 1,2-dichloroethane, chloroform, carbon tetrachloride and chlorobenzene, ethers such as diethyl ether, diisopropyl ether, tert.-butyl methylether (TBME), dioxane, anisole and tetrahydrofuran (THF), esters such as ethyl acetate and butyl acetate; nitriles such as acetonitrile and propionitrile, as well as dipolar aprotic solvents such as sulfolane, dimethylsulfoxide, N,Ndimethylformamide (DMF), N,N-dimethylacetamide (DMAC), 1,3-dimethyl-2-imidazolidinone (DMI), N,N′-dimethylpropylene urea (DMPU), dimethyl sulfoxide (DMSO) and 1-methyl-2 pyrrolidinone (NMP).

Preferred solvents are ethers, nitriles and dipolar aprotic solvents as defined above.

More preferred solvents are nitriles as defined above.

The reaction of the guanidines of formula (VII) with the amines of formula (II) is carried out in the presence of an acid.

Example of suitable acids are inorganic acids like hydrofluoric acid, hydrochloric acid, hydrobromic acid, hydroiodic acid, phosphoric acid, sulfuric acid, p-toluenesulfonic acid; Lewis acids like boron trifluoride, aluminium chloride, ferric-Ill-chloride, tin-IV-chloride, titanium-IV-chloride and zinc-II-chloride, as well as organic acids like formic acid, acetic acid, propionic acid, oxalic acid, methylbenzenesulfonic acid, benzenesulfonic acid, camphorsulfonic acid, citric acid, trifluoroacetic acid, can be used. The acids are generally employed in excess or, if appropriate, can be used as solvent.

The guanidines of formula (VII) required for the preparation of biguanides of formula (VII) are commercially available or can be prepared in accordance with literature procedures (e.g. J. L. LaMattina et al., J. Med. Chem. 1990, 33, 543-552; A. Perez-Medrano et al., J. Med. Chem. 2009, 52, 3366-3376).

The anilines of formula (II) required for the preparation of biguanidines of formula (VII) are commercially available, predescribed in the literature or can be prepared in accordance with known literature procedures.

In one embodiment of the present invention the compositions according to the present invention comprise at least one compound of formula (I) and at least one further active compound B (herbicide B).

According to a first embodiment of the invention the compositions contain at least one inhibitor of the lipid biosynthesis (herbicide b1). These are compounds that inhibit lipid biosynthesis. Inhibition of the lipid biosynthesis can be affected either through inhibition of acetylCoA carboxylase (hereinafter termed ACC herbicides) or through a different mode of action (hereinafter termed non-ACC herbicides). The ACC herbicides belong to the group A (or group 1) of the HRAC classification system whereas the non-ACC herbicides belong to the group N (or now group 15) of the HRAC classification.

According to a second embodiment of the invention the compositions contain at least one ALS inhibitor (herbicide b2). The herbicidal activity of these compounds is based on the inhibition of acetolactate synthase and thus on the inhibition of the branched chain amino acid biosynthesis. These inhibitors belong to the group B (or 2) of the HRAC classification system.

According to a third embodiment of the invention the compositions contain at least one inhibitor of photosynthesis (herbicide b3). The herbicidal activity of these compounds is based either on the inhibition of the photosystem II in plants (so-called PSII inhibitors, groups C1 (or group 5), C2 (group 5) and C3 (group 6) of HRAC classification) or on diverting the electron transfer in photosystem I in plants (so-called PSI inhibitors, group D (or group 22) of HRAC classification) and thus on an inhibition of photosynthesis. Amongst these, PSII inhibitors are preferred.

According to a fourth embodiment of the invention the compositions contain at least one inhibitor of protoporphyrinogen-IX-oxidase (herbicide b4). The herbicidal activity of these compounds is based on the inhibition of the protoporphyrinogen-IX-oxidase. These inhibitors belong to the group E of the HRAC classification system.

According to a fifth embodiment of the invention the compositions contain at least one bleacher-herbicide (herbicide b5). The herbicidal activity of these compounds is based on the inhibition of the carotenoid biosynthesis. These include compounds which inhibit carotenoid biosynthesis by inhibition of phytoene desaturase (so-called PDS inhibitors, group F1 (group 12) of HRAC classification), compounds that inhibit the 4-hydroxyphenylpyruvate-dioxygenase (HPPD inhibitors, group F2 (group 27) of HRAC classification), compounds that inhibit DOXsynthase (group F4 (group 13) of HRAC class) and compounds which inhibit carotenoid biosynthesis by an unknown mode of action (bleacher—unknown target, group F3 (group 32+33) of HRAC classification).

According to a sixth embodiment of the invention the compositions contain at least one EPSP synthase inhibitor (herbicide b6). The herbicidal activity of these compounds is based on the inhibition of enolpyruvyl shikimate 3-phosphate synthase, and thus on the inhibition of the amino acid biosynthesis in plants. These inhibitors belong to the group G (9) of the HRAC classification system.

According to a seventh embodiment of the invention the compositions contain at least one glutamine synthetase inhibitor (herbicide b7). The herbicidal activity of these compounds is based on the inhibition of glutamine synthetase, and thus on the inhibition of the aminoacid biosynthesis in plants. These inhibitors belong to the group H (10) of the HRAC classification system.

According to an eighth embodiment of the invention the compositions contain at least one DHP synthase inhibitor (herbicide b8). The herbicidal activity of these compounds is based on the inhibition of 7,8-dihydropteroate synthase. These inhibitors belong to the group I (18) of the HRAC classification system.

According to a ninth embodiment of the invention the compositions contain at least one mitosis inhibitor (herbicide b9). The herbicidal activity of these compounds is based on the disturbance or inhibition of microtubule formation or organization, and thus on the inhibition of mitosis. These inhibitors belong to the groups K1 (3) and K2 (23) of the HRAC classification system. Among these, compounds of the group K1, in particular dinitroanilines andicafolin are preferred.

According to a tenth embodiment of the invention the compositions contain at least one VLCFA inhibitor (herbicide b10). The herbicidal activity of these compounds is based on the inhibition of the synthesis of very long chain fatty acids and thus on the disturbance or inhibition of cell division in plants. These inhibitors belong to the group K3 (15) of the HRAC classification system.

According to an eleventh embodiment of the invention the compositions contain at least one cellulose biosynthesis inhibitor (herbicide b11). The herbicidal activity of these compounds is based on the inhibition of the biosynthesis of cellulose and thus on the inhibition of the synthesis of cell walls in plants. These inhibitors belong to the group L (29) of the HRAC classification system.

According to a twelfth embodiment of the invention the compositions contain at least one decoupler herbicide (herbicide b12). The herbicidal activity of these compounds is based on the disruption of the cell membrane. These inhibitors belong to the group M (24) of the HRAC classification system.

According to a thirtheenth embodiment of the invention the compositions contain at least one auxinic herbicide (herbicide b13). These include compounds that mimic auxins, i.e. plant hormones, and affect the growth of the plants. These compounds belong to the group O (4) of the HRAC classification system.

According to a fourteenth embodiment of the invention the compositions contain at least one auxin transport inhibitor (herbicide b14). The herbicidal activity of these compounds is based on the inhibition of the auxin transport in plants. These compounds belong to the group P (19) of the HRAC classification system.

As to the given mechanisms of action and classification of the active substances, see e.g. “HRAC, Classification of Herbicides According to Mode of Action”, http://www.plantprotection.org/hrac/MOA.html).

Preference is given to those compositions according to the present invention comprising at least one herbicide B selected from herbicides of class b1, b2, b3, b4, b5, b6, b7, b9, b10, b13 and b14.

Specific preference is given to those compositions according to the present invention which comprise at least one herbicide B selected from the herbicides of class b1, b4, b5, b6, b7 and b10 and b13.

Particular preference is given to those compositions according to the present invention which comprise at least one herbicide B selected from the herbicides of class b4 and b10.

Examples of herbicides B which can be used in combination with the compounds of formula (I) according to the present invention are:
b1) selected from the group of the lipid biosynthesis inhibitors:
ACC-herbicides such as alloxydim, alloxydim-sodium, butroxydim, clethodim, clodinafop, clodinafop-propargyl, cycloxydim, cyhalofop, cyhalofop-butyl, diclofop, diclofop-methyl, fenoxaprop, fenoxaprop-ethyl, fenoxaprop-P, fenoxaprop-P-ethyl, fluazifop, fluazifop-butyl, fluazifop-P, fluazifop-P-butyl, haloxyfop, haloxyfop-methyl, haloxyfop-P, haloxyfop-P-methyl, metamifop, pinoxaden, profoxydim, propaquizafop, quizalofop, quizalofop-ethyl, quizalofop-tefuryl, quizalofop-P, quizalofop-P-ethyl, quizalofop-P-tefuryl, sethoxydim, tepraloxydim, tralkoxydim, 4-(4′-Chloro-4-cyclopropyl-2′-fluoro[1,1′-biphenyl]-3-yl)-5-hydroxy-2,2,6,6-tetramethyl-2H-pyran-3(6H)-one (CAS 1312337-72-6); 4-(2′,4′-Dichloro-4-cyclopropyl[1,1′-biphenyl]-3-yl)-5-hydroxy-2,2,6,6-tetramethyl-2H-pyran-3(6H)-one (CAS 1312337-45-3); 4-(4′-Chloro-4-ethyl-2′-fluoro[1,1′-biphenyl]-3-yl)-5-hydroxy-2,2,6,6-tetramethyl-2H-pyran-3(6H)-one (CAS 1033757-93-5); 4-(2′,4′-Dichloro-4-ethyl[1,1′-biphenyl]-3-yl)-2,2,6,6-tetramethyl-2H-pyran-3,5(4H,6H)-dione (CAS 1312340-84-3); 5-(Acetyloxy)-4-(4′-chloro-4-cyclopropyl-2′-fluoro[1,1-biphenyl]-3-yl)-3,6-dihydro-2,2,6,6-tetramethyl-2H-pyran-3-one (CAS 1312337-48-6); 5-(Acetyloxy)-4-(2′,4′-dichloro-4-cyclopropyl-[1,1′-biphenyl]-3-yl)-3,6-dihydro-2,2,6,6-tetramethyl-2H-pyran-3-one; 5-(Acetyloxy)-4-(4′-chloro-4-ethyl-2′-fluoro[1,1′-biphenyl]-3-yl)-3,6-dihydro-2,2,6,6-tetramethyl-2H-pyran-3-one (CAS 1312340-82-1); 5-(Acetyloxy)-4-(2′,4′-dichloro-4-ethyl[1,1′-biphenyl]-3-yl)-3,6-dihydro-2,2,6,6-tetramethyl-2H-pyran-3-one (CAS 1033760-55-2); 4-(4′-Chloro-4-cyclopropyl-2′-fluoro[1,1-biphenyl]-3-yl)-5,6-dihydro-2,2,6,6-tetramethyl-5-oxo-2H-pyran-3-yl carbonic acid methyl ester (CAS 1312337-51-1); 4-(2′,4′-Dichloro-4-cyclopropyl-[1,1′-biphenyl]-3-yl)-5,6-dihydro-2,2,6,6-tetramethyl-5-oxo-2H-pyran-3-yl carbonic acid methyl ester; 4-(4′-Chloro-4-ethyl-2′-fluoro[1,1′-biphenyl]-3-yl)-5,6-dihydro-2,2,6,6-tetramethyl-5-oxo-2H-pyran-3-yl carbonic acid methyl ester (CAS 1312340-83-2); 4-(2′,4′-Dichloro-4-ethyl[1,1′-biphenyl]-3-yl)-5,6-dihydro-2,2,6,6-tetramethyl-5-oxo-2H-pyran-3-yl carbonic acid methyl ester (CAS 1033760-58-5); and non ACC herbicides such as benfuresate, butylate, cycloate, dalapon, dimepiperate, EPTC, esprocarb, ethofumesate, flupropanate, molinate, orbencarb, pebulate, prosulfocarb, TCA, thiobencarb, tiocarbazil, triallate and vernolate;
b2) is selected from the group of the ALS inhibitors:
sulfonylureas such as amidosulfuron, azimsulfuron, bensulfuron, bensulfuron-methyl, chlorimuron, chlorimuron-ethyl, chlorsulfuron, cinosulfuron, cyclosulfamuron, ethametsulfuron, ethametsulfuron-methyl, ethoxysulfuron, flazasulfuron, flucetosulfuron, flupyrsulfuron, flupyrsulfuron-methyl-sodium, foramsulfuron, halosulfuron, halosulfuron-methyl, imazosulfuron, iodosulfuron, iodosulfuron-methyl-sodium, iofensulfuron, iofensulfuron-sodium, mesosulfuron, metazosulfuron, metsulfuron, metsulfuron-methyl, nicosulfuron, orthosulfamuron, oxasulfuron, primisulfuron, primisulfuron-methyl, propyrisulfuron, prosulfuron, pyrazosulfuron, pyrazosulfuron-ethyl, rimsulfuron, sulfometuron, sulfometuron-methyl, sulfosulfuron, thifensulfuron, thifensulfuron-methyl, triasulfuron, tribenuron, tribenuron-methyl, trifloxysulfuron, triflusulfuron, triflusulfuron-methyl and tritosulfuron,
imidazolinones such as imazamethabenz, imazamethabenz-methyl, imazamox, imazapic, imazapyr, imazaquin and imazethapyr, triazolopyrimidine herbicides and sulfonanilides such as cloransulam, cloransulam-methyl, diclosulam, flumetsulam, florasulam, metosulam, penoxsulam, pyrimisulfan and pyroxsulam,
pyrimidinylbenzoates such as bispyribac, bispyribac-sodium, pyribenzoxim, pyriftalid, pyriflubenzoxin, pyriminobac, pyriminobac-methyl, pyrithiobac, pyrithiobac-sodium, 4-[[[2-[(4,6-dimethoxy-2-pyrimidinyl)oxy]phenyl]methyl]amino]-benzoic acid-1-methylethyl ester (CAS 420138-41-6), 4-[[[2-[(4,6-dimethoxy-2-pyrimidinyl)oxy]phenyl]methyl]amino]-benzoic acid propyl ester (CAS 420138-40-5), N-(4-bromophenyl)-2-[(4,6-dimethoxy-2-pyrimidinyl)oxy]benzenemethanamine (CAS 420138-01-8),
sulfonylaminocarbonyl-triazolinone herbicides such as flucarbazone, flucarbazone-sodium, propoxycarbazone, propoxycarbazone-sodium, thiencarbazone and thiencarbazone-methyl; and triafamone;
among these, a preferred embodiment of the invention relates to those compositions comprising at least one imidazolinone herbicide:
b3) is selected from the group of the photosynthesis inhibitors:
amicarbazone, inhibitors of the photosystem II, e.g. 1-(6-tert-butylpyrimidin-4-yl)-2-hydroxy-4-methoxy-3-methyl-2H-pyrrol-5-one (CAS 1654744-66-7), 1-(5-tert-butylisoxazol-3-yl)-2-hydroxy-4-methoxy-3-methyl-2H-pyrrol-5-one (CAS 1637455-12-9), 1-(5-tert-butylisoxazol-3-yl)-4-chloro-2-hydroxy-3-methyl-2H-pyrrol-5-one (CAS 1637453-94-1), 1-(5-tert-butyl-1-methyl-pyrazol-3-yl)-4-chloro-2-hydroxy-3-methyl-2H-pyrrol-5-one (CAS 1654057-29-0), 1-(5-tert-butyl-1-methyl-pyrazol-3-yl)-3-chloro-2-hydroxy-4-methyl-2H-pyrrol-5-one (CAS 1654747-80-4), 4-hydroxy-1-methoxy-5-methyl-3-[4-(trifluoromethyl)-2-pyridyl]imidazolidin-2-one; (CAS 2023785-78-4), 4-hydroxy-1,5-dimethyl-3-[4-(trifluoromethyl)-2-pyridyl]imidazolidin-2-one (CAS 2023785-79-5), 5-ethoxy-4-hydroxy-1-methyl-3-[4-(trifluoromethyl)-2-pyridyl]imidazolidin-2-one (CAS 1701416-69-4), 4-hydroxy-1-methyl-3-[4-(trifluoromethyl)-2-pyridyl]imidazolidin-2-one (CAS 1708087-22-2), 4-hydroxy-1,5-dimethyl-3-[1-methyl-5-(trifluoromethyl)pyrazol-3-yl]imidazolidin-2-one (CAS 2023785-80-8), 1-(5-tert-butylisoxazol-3-yl)-4-ethoxy-5-hydroxy-3-methyl-imidazolidin-2-one (CAS 1844836-64-1), triazine herbicides, including of chlorotriazine, triazinones, triazindiones, methylthiotriazines and pyridazinones such as ametryn, atrazine, chloridazone, cyanazine, desmetryn, dimethametryn, hexazinone, metribuzin, prometon, prometryn, propazine, simazine, simetryn, terbumeton, terbuthylazin, terbutryn and trietazin, aryl urea such as chlorobromuron, chlorotoluron, chloroxuron, dimefuron, diuron, fluometuron, isoproturon, isouron, linuron, metamitron, methabenzthiazuron, metobenzuron, metoxuron, monolinuron, neburon, siduron, tebuthiuron and thiadiazuron, phenyl carbamates such as desmedipham, karbutilat, phenmedipham, phenmedipham-ethyl, nitrile herbicides such as bromofenoxim, bromoxynil and its salts and esters, ioxynil and its salts and esters, uraciles such as bromacil, lenacil and terbacil, and bentazon and bentazon-sodium, pyridate, pyridafol, pentanochlor and propanil and inhibitors of the photosystem I such as diquat, diquat-dibromide, paraquat, paraquat-dichloride and paraquat-dimetilsulfate. Among these, a preferred embodiment of the invention relates to those compositions comprising at least one aryl urea herbicide. Among these, likewise a preferred embodiment of the invention relates to those compositions comprising at least one triazine herbicide. Among these, likewise a preferred embodiment of the invention relates to those compositions comprising at least one nitrile herbicide;
b4) is selected from the group of the protoporphyrinogen-IX oxidase inhibitors:
acifluorfen, acifluorfen-sodium, azafenidin, bencarbazone, benzfendizone, bifenox, butafenacil, carfentrazone, carfentrazone-ethyl, chlomethoxyfen, chlorphthalim, cinidon-ethyl, cyclopyranil, fluazolate, flufenoximacil, flufenpyr, flufenpyr-ethyl, flumiclorac, flumiclorac-pentyl, flumioxazin, fluoroglycofen, fluoroglycofen-ethyl, fluthiacet, fluthiacet-methyl, fomesafen, halosafen, lactofen, oxadiargyl, oxadiazon, oxyfluorfen, pentoxazone, profluazol, pyraclonil, pyraflufen, pyraflufen-ethyl, saflufenacil, sulfentrazone, thidiazimin, tiafenacil, trifludimoxazin, epyrifenacil, N-ethyl-3-(2,6-dichloro-4-trifluoromethylphenoxy)-5-methyl-1H-pyrazole-1-carboxamide (CAS 452098-92-9), N-tetrahydrofurfuryl-3-(2,6-dichloro-4-trifluoromethylphenoxy)-5-methyl-1H-pyrazole-1-carboxamide (CAS 915396-43-9), N-ethyl-3-(2-chloro-6-fluoro-4-trifluoromethylphenoxy)-5-methyl-1H-pyrazole-1-carboxamide (CAS 452099-05-7), N-tetrahydrofurfuryl-3-(2-chloro-6-fluoro-4-trifluoromethylphenoxy)-5-methyl-1H-pyrazole-1-carboxamide (CAS 452100-03-7), 3-[7-fluoro-3-oxo-4-(prop-2-ynyl)-3,4-dihydro-2H-benzo[1,4]oxazin-6-yl]-1,5-dimethyl-6-thioxo-[1,3,5]triazinan-2,4-dione (CAS 451484-50-7) 2-(2,2,7-trifluoro-3-oxo-4-prop-2-ynyl-3,4-dihydro-2H-benzo[1,4]oxazin-6-yl)-4,5,6,7-tetrahydro-isoindole-1,3-dione (CAS 1300118-96-0), 1-methyl-6-trifluoromethyl-3-(2,2,7-trifluoro-3-oxo-4-prop-2-ynyl-3,4-dihydro-2H-benzo[1,4]oxazin-6-yl)-1H-pyrimidine-2,4-dione (CAS 1304113-05-0), methyl (E)-4-[2-chloro-5-[4-chloro-5-(difluoromethoxy)-1H-methyl-pyrazol-3-yl]-4-fluoro-phenoxy]-3-methoxy-but-2-enoate (CAS 948893-00-3), and 3-[7-chloro-5-fluoro-2-(trifluoromethyl)-1H-benzimidazol-4-yl]-1-methyl-6-(trifluoromethyl)-1H-pyrimidine-2,4-dione (CAS 212754-02-4),
2-[2-chloro-5-[3-chloro-5-(trifluoromethyl)-2-pyridinyl]-4-fluorophenoxy]-2-methoxy-acetic acid methyl ester (CAS 1970221-16-9), 2-[2-[[3-chloro-6-[3,6-dihydro-3-methyl-2,6-dioxo-4-(trifluoromethyl)-1(2H)-pyrimidinyl]-5-fluoro-2-pyridinyl]oxy]phenoxy]-acetic acid methyl ester (CAS 2158274-96-3), 2-[2-[[3-chloro-6-[3,6-dihydro-3-methyl-2,6-dioxo-4-(trifluoromethyl)-1(2H)-pyrimidinyl]-5-fluoro-2-pyridinyl]oxy]phenoxy]acetic acid ethyl ester (CAS 2158274-50-9), methyl 2-[[3-[2-chloro-5-[4-(difluoromethyl)-3-methyl-5-oxo-1,2,4-triazol-1-yl]-4-fluoro-phenoxy]-2-pyridyl]oxy]acetate (CAS 2271389-22-9), ethyl 2-[[3-[2-chloro-5-[4-(difluoromethyl)-3-methyl-5-oxo-1,2,4-triazol-1-yl]-4-fluoro-phenoxy]-2-pyridyl]oxy]acetate (CAS 2230679-62-4), 2-[[3-[[3-chloro-6-[3,6-dihydro-3-methyl-2,6-dioxo-4-(trifluoromethyl)-1(2H)-pyrimidinyl]-5-fluoro-2-pyridinyl]oxy]-2-pyridinyl]oxy]-acetic acid methyl ester (CAS 2158275-73-9), 2-[[3-[[3-chloro-6-[3,6-dihydro-3-methyl-2,6-dioxo-4-(trifluoromethyl)-1(2H)-pyrimidinyl]-5-fluoro-2-pyridinyl]oxy]-2-pyridinyl]oxy]acetic acid ethyl ester (CAS 2158274-56-5), 2-[2-[[3-chloro-6-[3,6-dihydro-3-methyl-2,6-dioxo-4-(trifluoromethyl)-1(2H)-pyrimidinyl]-5-fluoro-2-pyridinyl]oxy]phenoxy]-N-(methylsulfonyl)-acetamide (CAS 2158274-53-2), 2-[[3-[[3-chloro-6-[3,6-dihydro-3-methyl-2,6-dioxo-4-(trifluoromethyl)-1(2H)-pyrimidinyl]-5-fluoro-2-pyridinyl]oxy]-2-pyridinyl]oxy]-N-(methylsulfonyl)-acetamide (CAS 2158276-22-1),
3-[2-chloro-5-[3,6-dihydro-3-methyl-2,6-dioxo-4-(trifluoromethyl)-1(2H)-pyrimidinyl]-4-fluorophenyl]-4,5-dihydro-5-methyl-5-isoxazolecarboxylic acid ethyl ester (CAS 1949837-17-5);
b5) is selected from the group of the bleacher herbicides:
PDS inhibitors: beflubutamid, diflufenican, fluridone, flurochloridone, flurtamone, norflurazon, picolinafen, 4-(3-trifluoromethylphenoxy)-2-(4-trifluoromethylphenyl)pyrimidine (CAS 180608-33-7), rimisoxafen, HPPD inhibitors: benzobicyclon, benzofenap, bicyclopyrone, clomazone, fenquinotrione, isoxaflutole, mesotrione, oxotrione (CAS 1486617-21-3), pyrasulfotole, pyrazolynate, pyrazoxyfen, sulcotrione, tefuryltrione, tembotrione, tolpyralate, topramezone, bipyrazone, fenpyrazone, cypyrafluone, tripyrasulfone, benquitrione, dioxopyritrione; bleacher, unknown target: aclonifen, amitrole flumeturon,2-chloro-3-methylsulfanyl-N-(1-methyltetrazol-5-yl)-4-(trifluoromethyl)benzamide (CAS 1361139-71-0), bixlozone and 2-(2,5-dichlorophenyl)methyl-4,4-dimethyl-3-isoxazolidinone (CAS 81778-66-7), broclozone, flusulfinam, iptriazopyrid, pyraquinate
b6) from the group of the EPSP synthase inhibitors:
glyphosate, glyphosate-isopropylammonium, glyposate-potassium and glyphosate-trimesium (sulfosate);
b7) from the group of the glutamine synthase inhibitors:
bilanaphos (bialaphos), bilanaphos-sodium, glufosinate, glufosinate-P, glufosinate-ammonium and glufosinate-P-ammonium.
b8) from the group of the DHP synthase inhibitors:
asulam;
b9) is selected from the group of the mitosis inhibitors:
compounds of group K1: dinitroanilines such as benfluralin, butralin, dinitramine, ethalfluralin, fluchloralin, oryzalin, pendimethalin, prodiamine and trifluralin, phosphoramidates such as amiprophos, amiprophos-methyl, and butamiphos, benzoic acid herbicides such as chlorthal, chlorthal-dimethyl, pyridines such as dithiopyr and thiazopyr, benzamides such as propyzamide and tebutam; compounds of group K2: carbetamide, chlorpropham, flamprop, flamprop-isopropyl, flamprop-methyl, flamprop-M-isopropyl, flamprop-M-methyl and propham; among these, compounds of group K1, in particular dinitroanilines and icafolin are preferred;
b10) is selected from the group of the VLCFA inhibitors:
chloroacetamides such as acetochlor, alachlor, amidochlor, butachlor, dimethachlor, dimethenamid, dimethenamid-P, metazachlor, metolachlor, metolachlor-S, pethoxamid, pretilachlor, propachlor, propisochlor and thenylchlor, oxyacetanilides such as flufenacet and mefenacet, acetanilides such as diphenamid, naproanilide, napropamide and napropamide-M, tetrazolinones such fentrazamide, and other herbicides such as anilofos, cafenstrole, fenoxasulfone, ipfencarbazone, piperophos, pyroxasulfone, dimesulfazet and isoxazoline compounds of the formulae II.1, II.2, II.3, II.4, II.5, II.6, II.7, II.8 and II.9

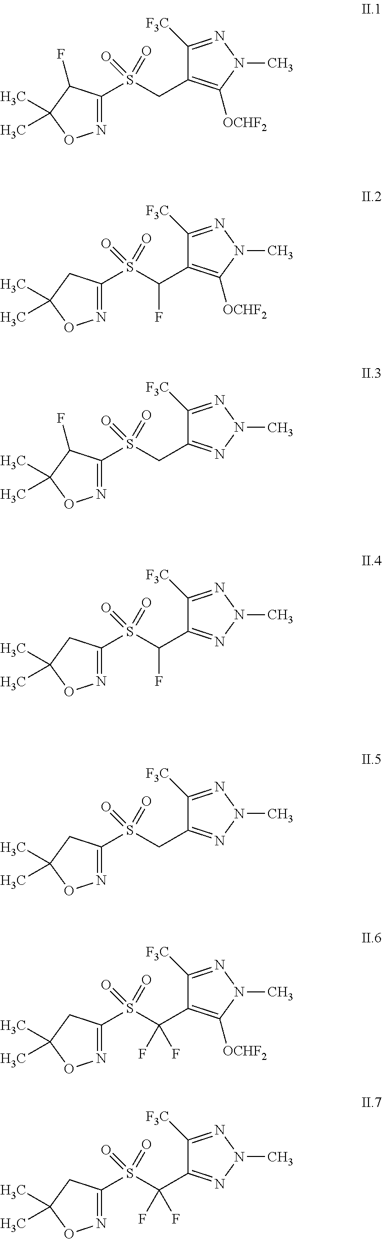

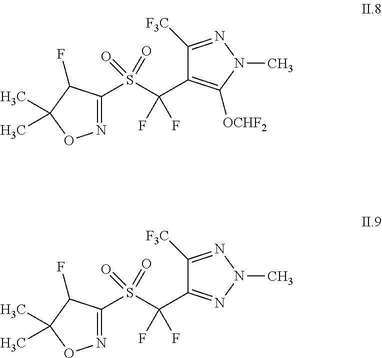

the isoxazoline compounds of the formula (II) are known in the art, e.g. from WO 2006/024820, WO 2006/037945, WO 2007/071900 and WO 2007/096576;
among the VLCFA inhibitors, preference is given to chloroacetamides, isoxazolines and oxyacetamides;
b11) is selected from the group of the cellulose biosynthesis inhibitors:
chlorthiamid, dichlobenil, flupoxam, indaziflam, isoxaben, triaziflam and 1-cyclohexyl-5-pentafluorphenyloxy-1⁴-[1,2,4,6]thiatriazin-3-ylamine (CAS 175899-01-1);
b12) from the group of the decoupler herbicides:
dinoseb, dinoterb and DNOC and its salts;
b13) is selected from the group of the auxinic herbicides:
2,4-D and its salts and esters such as clacyfos, 2,4-DB and its salts and esters, aminocyclopyrachlor and its salts and esters, aminopyralid and its salts such as aminopyralid-dimethylammonium, aminopyralid-tris(2-hydroxypropyl)ammonium and its esters, benazolin, benazolin-ethyl, chloramben and its salts and esters, clomeprop, clopyralid and its salts and esters, dicamba and its salts and esters, dichlorprop and its salts and esters, dichlorprop-P and its salts and esters, flopyrauxifen, fluroxypyr, fluroxypyr-butometyl, fluroxypyr-meptyl, halauxifen and its salts and esters (CAS 943832-60-8), MCPA and its salts and esters, MCPA-thioethyl, MCPB and its salts and esters, mecoprop and its salts and esters, mecoprop-P and its salts and esters, picloram and its salts and esters, quinclorac, quinmerac, TBA (2,3,6) and its salts and esters, triclopyr and its salts and esters, florpyrauxifen), and 4-amino-3-chloro-5-fluoro-6-(7-fluoro-1H-indol-6-yl)picolinic acid (CAS 1629965-65-6);
b14) from the group of the auxin transport inhibitors:
fluchloraminopyr, diflufenzopyr, diflufenzopyr-sodium, naptalam and naptalam-sodium;
b15) is selected from the group of the other herbicides: bromobutide, chlorflurenol,
chlorflurenol-methyl, cinmethylin, cumyluron, cyclopyrimorate and its salts and esters, dalapon, dazomet, difenzoquat, difenzoquat-metilsulfate, dimethipin, DSMA, dymron, endothal and its salts, etobenzanid, flurenol, flurenol-butyl, flurprimidol, fosamine, fosamine-ammonium, indanofan, maleic hydrazide, mefluidide, metam, methiozolin, methyl azide, methyl bromide, methyl-dymron, methyl iodide, MSMA, oleic acid, oxaziclomefone, pelargonic acid, pyributicarb, quinoclamine, tetflupyrolimet, tridiphane, 6-chloro-4-(2,7-dimethyl-1-naphthyl)-5-hydroxy-2-methyl-pyridazin-3-one (CAS 2414510-21-5).

Preffered herbicides B that can be used in combination with the compounds of the formula (I) according to the present invention are:
b1) from the group of the lipid biosynthesis inhibitors: clodinafop-propargyl, cycloxydim, cyhalofop-butyl, fenoxaprop-P-ethyl, pinoxaden, profoxydim, tepraloxydim, tralkoxydim, 4-(4′-Chloro-4-cyclopropyl-2′-fluoro[1,1′-biphenyl]-3-yl)-5-hydroxy-2,2,6,6-tetramethyl-2H-pyran-3(6H)-one (CAS 1312337-72-6); 4-(2′,4′-Dichloro-4-cyclopropyl[1,1′-biphenyl]-3-yl)-5-hydroxy-2,2,6,6-tetramethyl-2H-pyran-3(6H)-one (CAS 1312337-45-3); 4-(4′-Chloro-4-ethyl-2′-fluoro[1,1′-biphenyl]-3-yl)-5-hydroxy-2,2,6,6-tetramethyl-2H-pyran-3(6H)-one (CAS 1033757-93-5); 4-(2′,4′-Dichloro-4-ethyl[1,1′-biphenyl]-3-yl)-2,2,6,6-tetramethyl-2H-pyran-3,5(4H,6H)-dione (CAS 1312340-84-3); 5-(Acetyloxy)-4-(4′-chloro-4-cyclopropyl-2′-fluoro[1,1′-biphenyl]-3-yl)-3,6-dihydro-2,2,6,6-tetramethyl-2H-pyran-3-one (CAS 1312337-48-6); 5-(Acetyloxy)-4-(2′,4′-dichloro-4-cyclopropyl-[1,1′-biphenyl]-3-yl)-3,6-dihydro-2,2,6,6-tetramethyl-2H-pyran-3-one; 5-(Acetyloxy)-4-(4′-chloro-4-ethyl-2′-fluoro[1,1′-biphenyl]-3-yl)-3,6-dihydro-2,2,6,6-tetramethyl-2H-pyran-3-one (CAS 1312340-82-1); 5-(Acetyloxy)-4-(2′,4′-dichloro-4-ethyl[1,1′-biphenyl]-3-yl)-3,6-dihydro-2,2,6,6-tetramethyl-2H-pyran-3-one (CAS 1033760-55-2); 4-(4′-Chloro-4-cyclopropyl-2′-fluoro[1,1′-biphenyl]-3-yl)-5,6-dihydro-2,2,6,6-tetramethyl-5-oxo-2H-pyran-3-yl carbonic acid methyl ester (CAS 1312337-51-1); 4-(2′,4′-Dichloro-4-cyclopropyl-[1,1′-biphenyl]-3-yl)-5,6-dihydro-2,2,6,6-tetramethyl-5-oxo-2H-pyran-3-yl carbonic acid methyl ester; 4-(4′-Chloro-4-ethyl-2′-fluoro[1,1′-biphenyl]-3-yl)-5,6-dihydro-2,2,6,6-tetramethyl-5-oxo-2H-pyran-3-yl carbonic acid methyl ester (CAS 1312340-83-2); 4-(2′,4′-Dichloro-4-ethyl[1,1′-biphenyl]-3-yl)-5,6-dihydro-2,2,6,6-tetramethyl-5-oxo-2H-pyran-3-yl carbonic acid methyl ester (CAS 1033760-58-5); esprocarb, prosulfocarb, thiobencarb and triallate;
b2) from the group of the ALS inhibitors: bensulfuron-methyl, bispyribac-sodium, cyclosulfamuron, diclosulam, flumetsulam, flupyrsulfuron-methyl-sodium, foramsulfuron, imazamox, imazapic, imazapyr, imazaquin, imazethapyr, imazosulfuron, iodosulfuron, iodosulfuron-methyl-sodium, iofensulfuron, iofensulfuron-sodium, mesosulfuron, metazosulfuron, nicosulfuron, penoxsulam, propoxycarbazon-sodium, propyrisulfuron, pyrazosulfuron-ethyl, pyroxsulam, rimsulfuron, sulfosulfuron, thiencarbazon-methyl, tritosulfuron and triafamone;
b3) from the group of the photosynthesis inhibitors: ametryn, atrazine, diuron, fluometuron, hexazinone, isoproturon, linuron, metribuzin, paraquat, paraquat-dichloride, propanil, terbutryn, terbuthylazine, 1-(5-tert-butylisoxazol-3-yl)-2-hydroxy-4-methoxy-3-methyl-2H-pyrrol-5-one (CAS 1637455-12-9), 1-(5-tert-butylisoxazol-3-yl)-4-chloro-2-hydroxy-3-methyl-2H-pyrrol-5-one (CAS 1637453-94-1), 1-(5-tert-butylisoxazol-3-yl)-4-ethoxy-5-hydroxy-3-methyl-imidazolidin-2-one (CAS 1844836-64-1);
b4) from the group of the protoporphyrinogen-IX oxidase inhibitors: cyclopyranil, flumioxazin, oxyfluorfen, pyraflufen, pyraflufen-ethyl, saflufenacil, sulfentrazone, trifludimoxazin, epyrifenacil, 3-[7-fluoro-3-oxo-4-(prop-2-ynyl)-3,4-dihydro-2H-benzo[1,4]oxazin-6-yl]-1,5-dimethyl-6-thioxo-[1,3,5]triazinan-2,4-dione (CAS 451484-50-7), 2-(2,2,7-trifluoro-3-oxo-4-prop-2-ynyl-3,4-dihydro-2H-benzo[1,4]oxazin-6-yl)-4,5,6,7-tetrahydro-isoindole-1,3-dione (CAS 1300118-96-0), and 1-methyl-6-trifluoromethyl-3-(2,2,7-trifluoro-3-oxo-4-prop-2-ynyl-3,4-dihydro-2H-benzo[1,4]oxazin-6-yl)-1H-pyrimidine-2,4-dione (CAS 1304113-05-0); 2-[2-chloro-5-[3-chloro-5-(trifluoromethyl)-2-pyridinyl]-4-fluorophenoxy]-2-methoxy-acetic acid methyl ester (CAS 1970221-16-9), 2-[2-[[3-chloro-6-[3,6-dihydro-3-methyl-2,6-dioxo-4-(trifluoromethyl)-1(2H)-pyrimidinyl]-5-fluoro-2-pyridinyl]oxy]phenoxy]-acetic acid methyl ester (CAS 2158274-96-3), 2-[2-[[3-chloro-6-[3,6-dihydro-3-methyl-2,6-dioxo-4-(trifluoromethyl)-1(2H)-pyrimidinyl]-5-fluoro-2-pyridinyl]oxy]phenoxy]acetic acid ethyl ester (CAS 158274-50-9), methyl 2-[[3-[2-chloro-5-[4-(difluoromethyl)-3-methyl-5-oxo-1,2,4-triazol-1-yl]-4-fluoro-phenoxy]-2-pyridyl]oxy]acetate (CAS 2271389-22-9), ethyl 2-[[3-[2-chloro-5-[4-(difluoromethyl)-3-methyl-5-oxo-1,2,4-triazol-1-yl]-4-fluoro-phenoxy]-2-pyridyl]oxy]acetate (CAS 2230679-62-4), 2-[[3-[[3-chloro-6-[3,6-dihydro-3-methyl-2,6-dioxo-4-(trifluoromethyl)-1(2H)-pyrimidinyl]-5-fluoro-2-pyridinyl]oxy]-2-pyridinyl]oxy]-acetic acid methyl ester (CAS 2158275-73-9), 2-[[3-[[3-chloro-6-[3,6-dihydro-3-methyl-2,6-dioxo-4-(trifluoromethyl)-1(2H)-pyrimidinyl]-5-fluoro-2-pyridinyl]oxy]-2-pyridinyl]oxy]acetic acid ethyl ester (CAS 2158274-56-5), 2-[2-[[3-chloro-6-[3,6-dihydro-3-methyl-2,6-dioxo-4-(trifluoromethyl)-1(2H)-pyrimidinyl]-5-fluoro-2-pyridinyl]oxy]phenoxy]-N-(methylsulfonyl)-acetamide (CAS 2158274-53-2), 2-[[3-[[3-chloro-6-[3,6-dihydro-3-methyl-2,6-dioxo-4-(trifluoromethyl)-1(2H)-pyrimidinyl]-5-fluoro-2-pyridinyl]oxy]-2-pyridinyl]oxy]-N-(methylsulfonyl)-acetamide (CAS 2158276-22-1),
3-[2-chloro-5-[3,6-dihydro-3-methyl-2,6-dioxo-4-(trifluoromethyl)-1(2H)-pyrimidinyl]-4-fluorophenyl]-4,5-dihydro-5-methyl-5-isoxazolecarboxylic acid ethyl ester (CAS 1949837-17-5); b5) from the group of the bleacher herbicides: amitrole, bicyclopyrone, clomazone, diflufenican, fenquinotrione, flumeturon, flurochloridone, isoxaflutole, mesotrione, oxotrione (CAS 1486617-21-3), picolinafen, sulcotrione, tefuryltrione, tembotrione, tolpyralate, topramezone, 2-chloro-3-methylsulfanyl-N-(1-methyltetrazol-5-yl)-4-(trifluoromethyl)benzamide (CAS 1361139-71-0), bixlozone, 2-(2,5-dichlorophenyl)methyl-4,4-dimethyl-3-isoxazolidinone (CAS 81778-66-7), rimisoxafen, broclozone, flusulfinam, iptriazopyrid and pyraquinate;
b6) from the group of the EPSP synthase inhibitors: glyphosate, glyphosate-isopropylammonium and glyphosate-trimesium (sulfosate);
b7) from the group of the glutamine synthase inhibitors: glufosinate, glufosinate-P and glufosinate-ammonium;
b9) from the group of the mitosis inhibitors: pendimethalin, trifluralin and icafolin
b10) from the group of the VLCFA inhibitors: acetochlor, cafenstrole, dimethenamid-P, fentrazamide, flufenacet, mefenacet, metazachlor, metolachlor, S-metolachlor, fenoxasulfone, ipfencarbazone and pyroxasulfone; likewise, preference is given to isoxazoline compounds of the formulae 11.1, 11.2, 11.3, 11.4, 11.5, 11.6, 11.7, 11.8 and 11.9 as mentioned above;
b11) from the group of the cellulose biosynthesis inhibitors: indaziflam, isoxaben and triaziflam;
b13) from the group of the auxinic herbicides: 2,4-D and its salts and esters such as clacyfos, and aminocyclopyrachlor and its salts and esters, aminopyralid and its salts and its esters, clopyralid and its salts and esters, dicamba and its salts and esters, flopyrauxifen, fluroxypyr-meptyl, halauxifen, halauxifen-methyl, quinclorac, quinmerac, florpyrauxifen, florpyrauxifen-benzyl (CAS 1390661-72-9), 4-amino-3-chloro-5-fluoro-6-(7-fluoro-1H-indol-6-yl)picolinic acid (CAS 1629965-65-6) and fluchloraminopyr;
b14) from the group of the auxin transport inhibitors: fluchloraminopyr, diflufenzopyr and diflufenzopyr-sodium,
b15) from the group of the other herbicides: cinmethylin, dymon (=daimuron), indanofan, oxaziclomefone, tetflupyrolimet, 6-chloro-4-(2,7-dimethyl-1-naphthyl)-5-hydroxy-2-methyl-pyridazin-3-one (CAS 2414510-21-5).

According to another preferred embodiment of the invention, the composition comprises, in addition to a compound of formula (I), at least one and especially exactly one herbicidally active compound from group b1), in particular selected from the group consisting of clethodim, clodinafop-propargyl, cycloxydim, cyhalofop-butyl, fenoxaprop-ethyl, fenoxaprop-P-ethyl, metamifop, pinoxaden, profoxydim, sethoxydim, tepraloxydim, tralkoxydim, esprocarb, ethofumesate, molinate, prosulfocarb, thiobencarb and triallate.

According to another preferred embodiment of the invention, the composition comprises, in addition to a compound of formula (I) at least one and especially exactly one herbicidally active compound from group b2), in particular selected from the group consisting of bensulfuron-methyl, bispyribac-sodium, cloransulam-methyl, chlorsulfuron, clorimuron, cyclosulfamuron, diclosulam, florasulam, flumetsulam, flupyrsulfuron-methyl-sodium, foramsulfuron, imazamox, imazamox-ammonium, imazapic, imazapic-ammonium, imazapic-isopropylammonium, imazapyr, imazapyr-ammonium, imazethapyr-isopropylammonium, imazaquin, imazaquin-ammonium, imazethapyr, imazethapyr-ammonium, imazethapyr-isopropylammonium, imazosulfuron, iodosulfuron-methyl-sodium, iofensulfuron, iofensulfuron-sodium, mesosulfuron-methyl, metazosulfuron, metsulfuron-methyl, metosulam, nicosulfuron, penoxsulam, propoxycarbazon-sodium, pyrazosulfuron-ethyl, pyribenzoxim, pyriftalid, pyroxsulam, propyrisulfuron, rimsulfuron, sulfosulfuron, thiencarbazon-methyl, thifensulfuron-methyl, tribenuron-methyl, tritosulfuron and triafamone.

According to another preferred embodiment of the invention, the composition comprises, in addition to a compound of formula (I) at least one and especially exactly one herbicidally active compound from group b3), in particular selected from the group consisting of ametryn, atrazine, bentazon, bromoxynil, bromoxynil-octanoate, bromoxynil-heptanoate, bromoxynil-potassium, diuron, fluometuron, hexazinone, isoproturon, linuron, metamitron, metribuzin, paraquat-dichloride, propanil, simazin, terbutryn and terbuthylazine.

According to another preferred embodiment of the invention, the composition comprises, in addition to a compound of formula (I), especially an active compound from the group consisting of at least one and especially exactly one herbicidally active compound from group b4), in particular selected from the group consisting of acifluorfen, butafencil, carfenetrazone-ethyl, flumioxazin, fomesafen, oxadiargyl, oxyfluorfen, pyraflufen, pyraflufen-ethyl, saflufenacil, sulfentrazone, trifludimoxazin, epyrifenacil, 3-[2-chloro-5-[3,6-dihydro-3-methyl-2,6-dioxo-4-(trifluoromethyl)-1(2H)-pyrimidinyl]-4-fluorophenyl]-4,5-dihydro-5-methyl-5-isoxazolecarboxylic acid ethyl ester (CAS 1949837-17-5) and flufenoximacil.

According to another preferred embodiment of the invention, the composition comprises, in addition to a compound of formula (I) at least one and especially exactly one herbicidally active compound from group b5), in particular selected from the group consisting of amitrole, benzobicyclon, bicyclopyrone, clomazone, diflufenican, fenquintrone, fluometuron, flurochloridone, isoxaflutole, mesotrione, norflurazone, oxotrione (CAS 1486617-21-3), picolinafen, sulcotrione, tefuryltrione, tembotrione, tolpyralate, topramezone, topramezone-sodium, 2-chloro-3-methylsulfanyl-N-(1-methyltetrazol-5-yl)-4-(trifluoromethyl)benzamide (CAS 1361139-71-0), bixlozone, 2-(2,5-dichlorophenyl)-methyl-4,4-dimethyl-3-isoxazolidinone (CAS 81778-66-7)rimisoxafen and broclozone, flusulfinam, iptriazopyrid, pyraquinate

According to another preferred embodiment of the invention, the composition comprises, in addition to a compound of formula (I) at least one and especially exactly one herbicidally active compound from group b6), in particular selected from the group consisting of glyphosate, glyphosate-ammonium, glyphosate-dimethylammonium, glyphosate-isopropylammonium and glyphosate-trimesium (sulfosate) and glyphosate-potassium.

According to another preferred embodiment of the invention, the composition comprises, in addition to a compound of formula (I) at least one and especially exactly one herbicidally active compound from group b7), in particular selected from the group consisting of glufosinate, glufosinate-ammonium, glufosinate-P and glufosinate-P-ammonium.

According to another preferred embodiment of the invention, the composition comprises, in addition to a compound of formula (I) at least one and especially exactly one herbicidally active compound from group b9), in particular selected from the group consisting of pendimethalin and trifluralin.

According to another preferred embodiment of the invention, the composition comprises, in addition to a compound of formula (I) at least one and especially exactly one herbicidally active compound from group b10), in particular selected from the group consisting of acetochlor, butachlor, cafenstrole, dimethenamid-P, fentrazamide, flufenacet, mefenacet, metazachlor, metolachlor, S-metolachlor, fenoxasulfone, ipfencarbazone and pyroxasulfone.

According to another preferred embodiment of the invention, the composition comprises, in addition to a compound of formula (I), at least one and especially exactly one herbicidally active compound from group b11), in particular indaziflam, isoxaben and triaziflam.

According to another preferred embodiment of the invention, the composition comprises, in addition to a compound of formula (I) at least one and especially exactly one herbicidally active compound from group b13), in particular selected from the group consisting of 2,4-D, 2,4-D-isobutyl, 2,4-D-dimethylammonium, 2,4-D-N,N,N-trimethylethanolammonium, aminocyclopyrachlor, aminocyclopyrachlor-potassium, aminocyclopyrachlor-methyl, aminopyralid, aminopyralid-methyl, aminopyralid-dimethylammonium, aminopyralid-tris(2-hydroxypropyl)ammonium, clopyralid, clopyralid-methyl, clopyralid-olamine, dicamba, dicamba-butotyl, dicamba-diglycolamine, dicamba-dimethylammonium, dicamba-diolamine, dicamba-isopropylammonium, dicamba-potassium, dicamba-sodium, dicamba-trolamine, dicamba-N,N-bis-(3-aminopropyl)methylamine, dicamba-diethylenetriamine, flopyrauxifen, fluroxypyr, fluroxypyr-meptyl, halauxifen, halauxifen-methyl, MCPA, MCPA-2-ethylhexyl, MCPA-dimethylammonium, quinclorac, quinclorac-dimethylammonium, quinmerac, quinmerac-dimethylammonium, florpyrauxifen, florpyrauxifen-benzyl (CAS 1390661-72-9), 4-amino-3-chloro-5-fluoro-6-(7-fluoro-1H-indol-6-yl)picolinic acid (CAS 1629965-65-6) and fluchloraminopyr.

According to another preferred embodiment of the invention, the composition comprises, in addition to a compound of formula (I) at least one and especially exactly one herbicidally active compound from group b14), in particular selected from the group consisting of diflufenzopyr, diflufenzopyr-sodium, dymron, indanofan and diflufenzopyr-sodium.

According to another preferred embodiment of the invention, the composition comprises, in addition to a compound of formula (I) at least one and especially exactly one herbicidally active compound from group b15), in particular selected from the group consisting of cinmethylin, dymron (=daimuron), indanofan, oxaziclomefone, tetflupyrolimet, 6-chloro-4-(2,7-dimethyl-1-naphthyl)-5-hydroxy-2-methyl-pyridazin-3-one (CAS 2414510-21-5).

According to another preferred embodiment of the invention, the composition comprises, in addition to a compound of formula (I) at least one and especially exactly one safener C, in particular selected from the group consisting of benoxacor, cloquintocet, cyprosulfamide, dichlormid, fenchlorazole, fenclorim, furilazole, isoxadifen, mefenpyr, 4-(dichloroacetyl)-1-oxa-4-azaspiro[4.5]decane (MON4660, CAS 71526-07-3) and 2,2,5-trimethyl-3-(dichloroacetyl)-1,3-oxazolidine (R-29148, CAS 52836-31-4).

According to another preferred embodiment of the invention, the composition comprises, in addition to a compound of formula (I) at least one and especially exactly one herbicidally active compound selected from:
b1): clethodim, clodinafop-propargyl, cyhalofop-butyl, metamifop, profoxydim, quizalofop-ethyl, sethoxydim, prosulfocarb, triallate;
b2): mesosulfuron, pyrazosulfuron-ethyl, imazamox, imazethapyr, diclosulam, penoxsulam, pyroxsulam, bispyribac-sodium, thiencarbazone-methyl; and triafamone;
b3): atrazine, metribuzin, terbuthylazin, bromoxynil and its salts and esters bentazon and bentazon-sodium, propanil.
b4): flumioxazin, saflufenacil, trifludimoxazin, epyrifenacil, 2-[2-[[3-chloro-6-[3,6-dihydro-3-methyl-2,6-dioxo-4-(trifluoromethyl)-1(2H)-pyrimidinyl]-5-fluoro-2-pyridinyl]oxy]phenoxy]acetic acid ethyl ester (CAS 2158274-50-9) andflufenoximacil.
b5): diflufenican, picolinafen, clomazone, isoxaflutole, mesotrione, topramezone, aclonifen, bixlozone.
b6) and b7): glyphosate, glufosinate, glufosinate-P, glufosinate-ammonium and glufosinate-P-ammonium.
b9): trifluralin, propyzamide:
b10): butachlor, dimethenamid-P, metolachlor, pretilachlor, flufenacet pyroxasulfone.
b11): indaziflam, isoxaben.
b13): 2,4-D and its salts and esters, dicamba and its salts and esters.
b15): cinmethylin, cyclopyrimorate, tetflupyrolimet, 6-chloro-4-(2,7-dimethyl-1-naphthyl)-5-hydroxy-2-methyl-pyridazin-3-one (CAS 2414510-21-5).

Particularly preferred herbicides B are the herbicides B as defined above; in particular the herbicides B.1-B.215 listed below in table B:

TABLE B

| | Herbicide B |
|---|---|
| B.1 | clethodim |
| B.2 | clodinafop-propargyl |
| B.3 | cycloxydim |
| B.4 | cyhalofop-butyl |
| B.5 | fenoxaprop-ethyl |
| B.6 | fenoxaprop-P-ethyl |
| B.7 | metamifop |
| B.8 | pinoxaden |
| B.9 | profoxydim |
| B.10 | sethoxydim |
| B.11 | tepraloxydim |
| B.12 | tralkoxydim |
| B.13 | esprocarb |
| B.14 | ethofumesate |
| B.15 | molinate |
| B.16 | prosulfocarb |
| B.17 | thiobencarb |
| B.18 | triallate |
| B.19 | bensulfuron-methyl |
| B.20 | bispyribac-sodium |
| B.21 | cloransulam-methyl |
| B.22 | chlorsulfuron |
| B.23 | clorimuron |
| B.24 | cyclosulfamuron |
| B.25 | diclosulam |
| B.26 | florasulam |
| B.27 | flumetsulam |
| B.28 | flupyrsulfuron-methyl-sodium |
| B.29 | foramsulfuron |
| B.30 | imazamox |
| B.31 | imazamox-ammonium |
| B.32 | imazapic |
| B.33 | imazapic-ammonium |
| B.34 | imazapic-isopropylammonium |
| B.35 | imazapyr |
| B.36 | imazapyr-ammonium |
| B.37 | imazapyr-isopropylammonium |
| B.38 | imazaquin |
| B.39 | imazaquin-ammonium |
| B.40 | imazethapyr |
| B.41 | imazethapyr-ammonium |
| B.42 | imazethapyr-isopropylammonium |
| B.43 | imazosulfuron |
| B.44 | iodosulfuron-methyl-sodium |
| B.45 | iofensulfuron |
| B.46 | iofensulfuron-sodium |
| B.47 | mesosulfuron-methyl |
| B.48 | metazosulfuron |
| B.49 | metsulfuron-methyl |
| B.50 | metosulam |
| B.51 | nicosulfuron |
| B.52 | penoxsulam |
| B.53 | propoxycarbazon-sodium |
| B.54 | pyrazosulfuron-ethyl |
| B.55 | pyribenzoxim |
| B.56 | pyriftalid |
| B.57 | pyroxsulam |
| B.58 | propyrisulfuron |
| B.59 | rimsulfuron |
| B.60 | sulfosulfuron |
| B.61 | thiencarbazone-methyl |
| B.62 | thifensulfuron-methyl |
| B.63 | tribenuron-methyl |
| B.64 | tritosulfuron |
| B.65 | triafamone |
| B.66 | ametryne |
| B.67 | atrazine |
| B.68 | bentazon |
| B.69 | bromoxynil |
| B.70 | bromoxynil-octanoate |
| B.71 | bromoxynil-heptanoate |
| B.72 | bromoxynil-potassium |
| B.73 | diuron |
| B.74 | fluometuron |
| B.75 | hexazinone |
| B.76 | isoproturon |
| B.77 | linuron |
| B.78 | metamitron |
| B.79 | metribuzin |
| B.80 | propanil |
| B.81 | simazin |
| B.82 | terbuthylazine |
| B.83 | terbutryn |
| B.84 | paraquat-dichloride |
| B.85 | acifluorfen |
| B.86 | butafenacil |
| B.87 | carfentrazone-ethyl |
| B.88 | flumioxazin |
| B.89 | fomesafen |
| B.90 | oxadiargyl |
| B.91 | oxyfluorfen |
| B.92 | pyraflufen |
| B.93 | pyraflufen-ethyl |
| B.94 | saflufenacil |
| B.95 | sulfentrazone |
| B.96 | trifludimoxazin |
| B.97 | epyrifenacil |
| B.98 | benzobicyclon |
| B.99 | bicyclopyrone |
| B.100 | clomazone |
| B.101 | diflufenican |
| B.102 | flurochloridone |
| B.103 | isoxaflutole |
| B.104 | mesotrione |
| B.105 | norflurazone |
| B.106 | picolinafen |
| B.107 | sulcotrione |
| B.108 | tefuryltrione |
| B.109 | tembotrione |
| B.110 | tolpyralate |
| B.111 | topramezone |
| B.112 | topramezone-sodium |
| B.113 | amitrole |
| B.114 | fluometuron |
| B.115 | fenquinotrione |
| B.116 | glyphosate |
| B.117 | glyphosate-ammonium |
| B.118 | glyphosate-dimethylammonium |
| B.119 | glyphosate-isopropylammonium |
| B.120 | glyphosate-trimesium (sulfosate) |
| B.121 | glyphosate-potassium |
| B.122 | glufosinate |
| B.123 | glufosinate-ammonium |
| B.124 | glufosinate-P |
| B.125 | glufosinate-P-ammonium |
| B.126 | pendimethalin |
| B.127 | trifluralin |
| B.128 | acetochlor |
| B.129 | butachlor |
| B.130 | cafenstrole |
| B.131 | dimethenamid-P |
| B.132 | fentrazamide |
| B.133 | flufenacet |
| B.134 | mefenacet |
| B.135 | metazachlor |
| B.136 | metolachlor |
| B.137 | S-metolachlor |
| B.138 | pretilachlor |
| B.139 | fenoxasulfone |
| B.140 | indaziflam |
| B.141 | isoxaben |
| B.142 | triaziflam |
| B.143 | ipfencarbazone |
| B.144 | pyroxasulfone |
| B.145 | 2,4-D |
| B.146 | 2,4-D-isobutyl |
| B.147 | 2,4-D-dimethylammonium |
| B.148 | 2,4-D-N,N,N- |
| | trimethylethanolammonium |
| B.149 | aminopyralid |
| B.150 | aminopyralid-methyl |
| B.151 | aminopyralid-dimethyl-ammonium |
| B.152 | aminopyralid-tris(2- |
| | hydroxypropyl)ammonium |
| B.153 | clopyralid |
| B.154 | clopyralid-methyl |
| B.155 | clopyralid-olamine |
| B.156 | dicamba |
| B.157 | dicamba-butotyl |
| B.158 | dicamba-diglycolamine |
| B.159 | dicamba-dimethylammonium |
| B.160 | dicamba-diolamine |
| B.161 | dicamba-isopropylammonium |
| B.162 | dicamba-potassium |
| B.163 | dicamba-sodium |
| B.164 | dicamba-trolamine |
| B.165 | dicamba-N,N-bis- |
| | (3-aminopropyl)methylamine |
| B.166 | dicamba-diethylenetriamine |
| B.167 | fluroxypyr |
| B.168 | fluroxypyr-meptyl |
| B.169 | halauxifen |
| B.170 | halauxifen-methyl |
| B.171 | MCPA |
| B.172 | MCPA-2-ethylhexyl |
| B.173 | MCPA-dimethylammonium |
| B.174 | quinclorac |
| B.175 | quinclorac-dimethylammonium |
| B.176 | quinmerac |
| B.177 | quinmerac-dimethylammonium |
| B.178 | florpyrauxifen |
| B.179 | florpyrauxifen-benzyl |
| | (CAS 1390661-72-9) |
| B.180 | aminocyclopyrachlor |
| B.181 | aminocyclopyrachlor-potassium |
| B.182 | aminocyclopyrachlor-methyl |
| B.183 | diflufenzopyr |
| B.184 | diflufenzopyr-sodium |
| B.185 | dymron |
| B.186 | indanofan |
| B.187 | oxaziclomefone |
| B.188 | II.1 |
| B.189 | II.2 |
| B.190 | II.3 |
| B.191 | II.4 |
| B.192 | II.5 |
| B.193 | II.6 |
| B.194 | II.7 |
| B.195 | II.8 |
| B.196 | II.9 |
| B.197 | 4-amino-3-chloro-5-fluoro-6-(7- |
| | fluoro-1H-indol-6-yl)picolinic |
| | acid (CAS 1629965-65-6) |
| B.198 | flopyrauxifen |
| B.199 | oxotrione (CAS 1486617-21-3) |
| B.200 | cinmethylin |
| B.201 | 2-chloro-3-methylsulfanyl-N-(1- |
| | methyltetrazol-5-yl)-4- |
| | (trifluoromethyl)benzamide |
| | (CAS 1361139-71-0) |
| B.202 | bixlozone |
| B.203 | cyclopyranil |
| B.204 | 2-[2-chloro-5-[3-chloro-5- |
| | (trifluoromethyl)-2-pyridinyl]-4- |
| | fluorophenoxy]-2-methoxy- |
| | acetic acid methyl ester (CAS |
| | 1970221-16-9) |
| B.205 | 2-[2-[[3-chloro-6-[3,6-dihydro-3- |
| | methyl-2,6-dioxo-4- |
| | (trifluoromethyl)-1(2H)- |
| | pyrimidinyl]-5-fluoro-2- |
| | pyridinyl]oxy]phenoxy]-acetic |
| | acid methyl ester (CAS |
| | 2158274-96-3) |
| B.206 | 2-[2-[[3-chloro-6-[3,6-dihydro-3- |
| | methyl-2,6-dioxo-4- |
| | (trifluoromethyl)-1(2H)- |
| | pyrimidinyl]-5-fluoro-2- |
| | pyridinyl]oxy]phenoxy] acetic |
| | acid ethyl ester (CAS 2158274- |
| | 50-9) |
| B.207 | methyl 2-[[3-[2-chloro-5-[4- |
| | (difluoromethyl)-3-methyl-5- |
| | oxo-1,2,4-triazol-1-yl]-4-fluoro- |
| | phenoxy]-2-pyridyl]oxy]acetate |
| B.208 | ethyl 2-[[3-[2-chloro-5-[4- |
| | (difluoromethyl)-3-methyl-5- |
| | oxo-1,2,4-triazol-1-yl]-4-fluoro- |
| | phenoxy]-2-pyridyl]oxy]acetate |
| | (CAS 2230679-62-4) |
| B.209 | 2-[[3-[[3-chloro-6-[3,6-dihydro- |
| | 3-methyl-2,6-dioxo-4- |
| | (trifluoromethyl)-1(2H)- |
| | pyrimidinyl]-5-fluoro-2- |
| | pyridinyl]oxy]-2-pyridinyl]oxy]- |
| | acetic acid methyl ester (CAS |
| | 2158275-73-9) |
| B.210 | 2-[[3-[[3-chloro-6-[3,6-dihydro- |
| | 3-methyl-2,6-dioxo-4- |
| | (trifluoromethyl)-1(2H)- |
| | pyrimidinyl]-5-fluoro-2- |
| | pyridinyl]oxy]-2-pyridinyl]oxy] |
| | acetic acid ethyl ester (CAS |
| | 2158274-56-5) |
| B.211 | 2-[2-[[3-chloro-6-[3,6-dihydro-3- |
| | methyl-2,6-dioxo-4- |
| | (trifluoromethyl)-1(2H)- |
| | pyrimidinyl]-5-fluoro-2- |
| | pyridinyl]oxy]phenoxy]-N- |
| | (methylsulfonyl)-acetamide |
| | (CAS 2158274-53-2) |
| B.212 | 2-[[3-[[3-chloro-6-[3,6-dihydro- |
| | 3-methyl-2,6-dioxo-4- |
| | (trifluoromethyl)-1(2H)- |
| | pyrimidinyl]-5-fluoro-2- |
| | pyridinyl]oxy]-2-pyridinyl]oxy]- |
| | N-(methylsulfonyl)-acetamide |
| | (CAS 2158276-22-1) |
| B.213 | tetflupyrolimet |
| B.214 | rimisoxafen |
| B.215 | 3-[2-chloro-5-[3,6-dihydro-3- |
| | methyl-2,6-dioxo-4- |
| | (trifluoromethyl)-1(2H)- |
| | pyrimidinyl]-4-flurophenyl]-4,5- |
| | dihydro-5-methyl-5- |
| | isoxazolecarboxylic acid ethyl |
| | ester (CAS 1949837-17-5) |

In another embodiment of the present invention the compositions according to the present invention comprise at least one compound of formula (I) and at least one safener C.

Safeners are chemical compounds which prevent or reduce damage on useful plants without having a major impact on the herbicidal action of the herbicidal active components of the present compositions towards unwanted plants. They can be applied either before sowings (e.g. on seed treatments, shoots or seedlings) or in the pre-emergence application or post-emergence application of the useful plant. The safeners and the compounds of formula (I) and/or the herbicides B can be applied simultaneously or in succession.

Suitable safeners are e.g. (quinolin-8-oxy)acetic acids, 1-phenyl-5-haloalkyl-1H-1,2,4-triazol-3-carboxylic acids, 1-phenyl-4,5-dihydro-5-alkyl-1H-pyrazol-3,5-dicarboxylic acids, 4,5-dihydro-5,5-diaryl-3-isoxazol carboxylic acids, dichloroacetamides, alpha-oximinophenylacetonitriles, acetophenonoximes, 4,6-dihalo-2-phenylpyrimidines, N-[[4-(aminocarbonyl)phenyl]sulfonyl]-2-benzoic amides, 1,8-naphthalic anhydride, 2-halo-4-(haloalkyl)-5-thiazol carboxylic acids, phosphorthiolates and N-alkyl-O-phenylcarbamates and their agriculturally acceptable salts and their agriculturally acceptable derivatives such amides, esters, and thioesters, provided they have an acid group.

Examples of preferred safeners C are benoxacor, cloquintocet, cyometrinil, cyprosulfamide, dichlormid, dicyclonon, dietholate, fenchlorazole, fenclorim, flurazole, fluxofenim, furilazole, isoxadifen, mefenpyr, mephenate, naphthalic anhydride, oxabetrinil, 4-(dichloroacetyl)-1-oxa-4-azaspiro[4.5]decane (MON4660, CAS 71526-07-3), 2,2,5-trimethyl-3-(dichloroacetyl)-1,3-oxazolidine (R-29148, CAS 52836-31-4), metcamifen and BPCMS (CAS 54091-06-4).

Especially preferred safeners C are benoxacor, cloquintocet, cyprosulfamide, dichlormid, fenchlorazole, fenclorim, flurazole, fluxofenim, furilazole, isoxadifen, mefenpyr, naphthalic anhydride, oxabetrinil, 4-(dichloroacetyl)-1-oxa-4-azaspiro[4.5]decane (MON4660, CAS 71526-07-3), 2,2,5-trimethyl-3-(dichloroacetyl)-1,3-oxazolidine (R-29148, CAS 52836-31-4) and metcamifen.

Particularly preferred safeners C are cloquintocet, cyprosulfamide, fenclori, furilazole isoxadifen-ethyl, mefenpyr-diethyl.

Particularly preferred safeners C, which, as component C, are constituent of the composition according to the invention are the safeners C as defined above; in particular the safeners C.1-C.17 listed below in table C:

TABLE C

| | Safener C |
|---|---|
| C.1 | benoxacor |
| C.2 | cloquintocet |
| C.3 | cloquintocet-mexyl |
| C.4 | cyprosulfamide |
| C.5 | dichlormid |
| C.6 | fenchlorazole |
| C.7 | fenchlorazole-ethyl |
| C.8 | fenclorim |
| C.9 | furilazole |
| C.10 | isoxadifen |
| C.11 | isoxadifen-ethyl |
| C.12 | mefenpyr |
| C.13 | mefenpyr-diethyl |
| C.14 | naphtalic acid anhydride |
| C.15 | 4-(dichloroacetyl)-1-oxa-4- |
| | azaspiro[4.5]decane (MON4660, |
| | CAS 71526-07-3) |
| C.16 | 2,2,5-trimethyl-3-(dichloroacetyl)- |
| | 1,3-oxazolidine (R-29148, |
| | CAS 52836-31-4) |
| C.17 | metcamifen |

The active compounds B of groups b1) to b15) and the active compounds C are known herbicides and safeners, see, for example, The Compendium of Pesticide Common Names (http://www.alanwood.net/pesticides/); Farm Chemicals Handbook 2000 volume 86, Meister Publishing Company, 2000; B. Hock, C. Fedtke, R. R. Schmidt, Herbizide [Herbicides], Georg Thieme Verlag, Stuttgart 1995; W. H. Ahrens, Herbicide Handbook, 7th edition, Weed Science Society of America, 1994; and K. K. Hatzios, Herbicide Handbook, Supplement for the 7th edition, Weed Science Society of America, 1998. 2,2,5-Trimethyl-3-(dichloroacetyl)-1,3-oxazolidine [CAS No. 52836-31-4] is also referred to as R-29148. 4-(Dichloroacetyl)-1-oxa-4-azaspiro[4.5]decane [CAS No. 71526-07-3] is also referred to as AD-67 and MON 4660.

The assignment of the active compounds to the respective mechanisms of action is based on current knowledge. If several mechanisms of action apply to one active compound, this substance was only assigned to one mechanism of action.

Active compounds B and C having a carboxyl group can be employed in the form of the acid, in the form of an agriculturally suitable salt as mentioned above or else in the form of an agriculturally acceptable derivative in the compositions according to the invention.

In the case of dicamba, suitable salts include those, where the counterion is an agriculturally acceptable cation. For example, suitable salts of dicamba are dicamba-sodium, dicamba-potassium, dicamba-methylammonium, dicamba-dimethylammonium, dicamba-isopropylammonium, dicamba-diglycolamine, dicamba-olamine, dicamba-diolamine, dicamba-trolamine, dicamba-N,N-bis-(3-aminopropyl)methylamine and dicamba-diethylenetriamine. Examples of a suitable ester are dicamba-methyl and dicamba-butotyl.

Suitable salts of 2,4-D are 2,4-D-ammonium, 2,4-D-dimethylammonium, 2,4-D-diethylammonium, 2,4-D-diethanolammonium (2,4-D-diolamine), 2,4-D-triethanolammonium, 2,4-D-isopropylammonium, 2,4-D-triisopropanolammonium, 2,4-D-heptylammonium, 2,4-D-dodecylammonium, 2,4-D-tetradecylammonium, 2,4-D-triethylammonium, 2,4-D-tris(2-hydroxypropyl)ammonium, 2,4-D-tris(isopropyl)ammonium, 2,4-D-trolamine, 2,4-D-lithium, 2,4-D-sodium and 2,4-D-N,N,N-trimethylethanolammonium (2,4-D choline). Examples of suitable esters of 2,4-D are 2,4-D-butotyl, 2,4-D-2-butoxypropyl, 2,4-D-3-butoxypropyl, 2,4-D-butyl, 2,4-D-ethyl, 2,4-D-ethylhexyl, 2,4-D-isobutyl, 2,4-D-isooctyl, 2,4-D-isopropyl, 2,4-D-meptyl, 2,4-D-methyl, 2,4-D-octyl, 2,4-D-pentyl, 2,4-D-propyl, 2,4-D-tefuryl and clacyfos.

Suitable salts of 2,4-DB are for example 2,4-DB-sodium, 2,4-DB-potassium and 2,4-DB-dimethylammonium. Suitable esters of 2,4-DB are for example 2,4-DB-butyl and 2,4-DB-isoctyl.

Suitable salts of dichlorprop are for example dichlorprop-sodium, dichlorprop-potassium and dichlorprop-dimethylammonium. Examples of suitable esters of dichlorprop are dichlorprop-butotyl and dichlorprop-isoctyl.

Suitable salts and esters of MCPA include MCPA-butotyl, MCPA-butyl, MCPA-dimethyl-ammonium, MCPA-diolamine, MCPA-ethyl, MCPA-thioethyl, MCPA-2-ethylhexyl, MCPA-isobutyl, MCPA-isoctyl, MCPA-isopropyl, MCPA-isopropylammonium, MCPA-methyl, MCPA-olamine, MCPA-potassium, MCPA-sodium and MCPA-trolamine.

A suitable salt of MCPB is MCPB sodium. A suitable ester of MCPB is MCPB-ethyl.

Suitable salts of clopyralid are clopyralid-potassium, clopyralid-olamine and clopyralid-tris-(2-hydroxypropyl)ammonium. Example of suitable esters of clopyralid is clopyralid-methyl.

Examples of a suitable ester of fluroxypyr are fluroxypyr-meptyl and fluroxypyr-2-butoxy-1-methylethyl, wherein fluroxypyr-meptyl is preferred.

Suitable salts of picloram are picloram-dimethylammonium, picloram-potassium, picloram-triisopropanolammonium, picloram-triisopropylammonium and picloram-trolamine. A suitable ester of picloram is picloram-isoctyl.

A suitable salt of triclopyr is triclopyr-triethylammonium. Suitable esters of triclopyr are for example triclopyr-ethyl and triclopyr-butotyl.

Suitable salts and esters of chloramben include chloramben-ammonium, chloramben-diolamine, chloramben-methyl, chloramben-methylammonium and chloramben-sodium. Suitable salts and esters of 2,3,6-TBA include 2,3,6-TBA-dimethylammonium, 2,3,6-TBA-lithium, 2,3,6-TBA-potassium and 2,3,6-TBA-sodium.

Suitable salts and esters of aminopyralid include aminopyralid-potassium, aminopyralid-dimethylammonium, and aminopyralid-tris(2-hydroxypropyl)ammonium.

Suitable salts of glyphosate are for example glyphosate-ammonium, glyphosate-diammonium, glyphoste-dimethylammonium, glyphosate-isopropylammonium, glyphosate-potassium, glyphosate-sodium, glyphosate-trimesium as well as the ethanolamine and diethanolamine salts, preferably glyphosate-diammonium, glyphosate-isopropylammonium and glyphosate-trimesium (sulfosate).

A suitable salt of glufosinate is for example glufosinate-ammonium.

A suitable salt of glufosinate-P is for example glufosinate-P-ammonium.

Suitable salts and esters of bromoxynil are for example bromoxynil-butyrate, bromoxynil-heptanoate, bromoxynil-octanoate, bromoxynil-potassium and bromoxynil-sodium.

Suitable salts and esters of ioxonil are for example ioxonil-octanoate, ioxonil-potassium and ioxonil-sodium.

Suitable salts and esters of mecoprop include mecoprop-butotyl, mecoprop-dimethylammonium, mecoprop-diolamine, mecoprop-ethadyl, mecoprop-2-ethylhexyl, mecoprop-isoctyl, mecoprop-methyl, mecoprop-potassium, mecoprop-sodium and mecoprop-trolamine.

Suitable salts of mecoprop-P are for example mecoprop-P-butotyl, mecoprop-P-dimethylammonium, mecoprop-P-2-ethylhexyl, mecoprop-P-isobutyl, mecoprop-P-potassium and mecoprop-P-sodium.

A suitable salt of diflufenzopyr is for example diflufenzopyr-sodium.

A suitable salt of naptalam is for example naptalam-sodium.

Suitable salts and esters of aminocyclopyrachlor are for example aminocyclopyrachlor-dimethylammonium, aminocyclopyrachlor-methyl, aminocyclopyrachlor-triisopropanolammonium, aminocyclopyrachlor-sodium and aminocyclopyrachlor-potassium.

A suitable salt of quinclorac is for example quinclorac-dimethylammonium.

A suitable salt of quinmerac is for example quinmerac-dimethylammonium.

A suitable salt of imazamox is for example imazamox-ammonium.

Suitable salts of imazapic are for example imazapic-ammonium and imazapic-isopropylammonium.

Suitable salts of imazapyr are for example imazapyr-ammonium and imazapyr-isopropylammonium.

A suitable salt of imazaquin is for example imazaquin-ammonium.

Suitable salts of imazethapyr are for example imazethapyr-ammonium and imazethapyr-isopropylammonium.

A suitable salt of topramezone is for example topramezone-sodium.

According to a preferred embodiment of the invention, the composition comprises as herbicidal active compound B or component B at least one, preferably exactly one herbicide B.

According to another preferred embodiment of the invention, the composition comprises as herbicidal active compounds B or component B at least two, preferably exactly two herbicides B different from each other.

According to another preferred embodiment of the invention, the composition comprises as herbicidal active compounds B or component B at least three, preferably exactly three herbicides B different from each other.

According to another preferred embodiment of the invention, the composition comprises as safening component C or component C at least one, preferably exactly one safener C.

According to another preferred embodiment of the invention, the composition comprises as component B at least one, preferably exactly one herbicide B, and as component C at least one, preferably exactly one, safener C.

According to another preferred embodiment of the invention, the composition comprises at least two, preferably exactly two, herbicides B different from each other, and as component C at least one, preferably exactly one, safener C.

According to another preferred embodiment of the invention, the composition comprises at least three, preferably exactly three, herbicides B different from each other, and as component C at least one, preferably exactly one, safener C.

Here and below, the term “binary compositions” includes compositions comprising one or more, for example 1, 2 or 3, active compounds of the formula (I) and either one or more, for example 1, 2 or 3, herbicides B or one or more safeners C.

Correspondingly, the term “ternary compositions” includes compositions comprising one or more, for example 1, 2 or 3, active compounds of the formula (I), one or more, for example 1, 2 or 3, herbicides B and one or more, for example 1, 2 or 3, safeners C.

In binary compositions comprising at least one compound of the formula (I) as component A and at least one herbicide B, the weight ratio of the active compounds A:B is generally in the range of from 1:1000 to 1000:1, preferably in the range of from 1:500 to 500:1, in particular in the range of from 1:250 to 250:1 and particularly preferably in the range of from 1:75 to 75:1.

In binary compositions comprising at least one compound of the formula (I) as component A and at least one safener C, the weight ratio of the active compounds A:C is generally in the range of from 1:1000 to 1000:1, preferably in the range of from 1:500 to 500:1, in particular in the range of from 1:250 to 250:1 and particularly preferably in the range of from 1:75 to 75:1.

In ternary compositions comprising at least one compound of formula (I) as component A, at least one herbicide B and at least one safener C, the relative proportions by weight of the components A:B are generally in the range of from 1:1000 to 1000:1, preferably in the range of from 1:500 to 500:1, in particular in the range of from 1:250 to 250:1 and particularly preferably in the range of from 1:75 to 75:1, the weight ratio of the components A:C is generally in the range of from 1:1000 to 1000:1, preferably in the range of from 1:500 to 500:1, in particular in the range of from 1:250 to 250:1 and particularly preferably in the range of from 1:75 to 75:1, and the weight ratio of the components B:C is generally in the range of from 1:1000 to 1000:1, preferably in the range of from 1:500 to 500:1, in particular in the range of from 1:250 to 250:1 and particularly preferably in the range of from 1:75 to 75:1. The weight ratio of components A+B to component C is preferably in the range of from 1:500 to 500:1, in particular in the range of from 1:250 to 250:1 and particularly preferably in the range of from 1:75 to 75:1.

The weight ratios of the individual components in the preferred mixtures mentioned below are within the limits given above, in particular within the preferred limits.

Particularly preferred are the compositions mentioned below comprising the compounds of formula (I) as defined and the substance(s) as defined in the respective row of table 1;
especially preferred comprising as only herbicidal active compounds the compound of formula (1) as defined and the substance(s) as defined in the respective row of table 1;
most preferably comprising as only active compounds the compounds of formula (I) as defined and the substance(s) as defined in the respective row of table 1.

Particularly preferred are compositions 1.1 to 1.3887, comprising the compound of formula

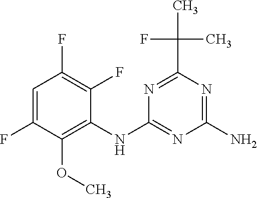 [SMILES: COc1c(F)cc(F)c(F)c1Nc1nc(N)nc(C(C)(C)F)n1]

and the substance(s) as defined in the respective row of table 1:

TABLE 1
(compositions 1.1 to 1.3887):

| comp. | | |
|---|---|---|
| no. | herbicide B | safener C |
| 1.1 | B.1 | — |
| 1.2 | B.2 | — |
| 1.3 | B.3 | — |
| 1.4 | B.4 | — |
| 1.5 | B.5 | — |
| 1.6 | B.6 | — |
| 1.7 | B.7 | — |
| 1.8 | B.8 | — |
| 1.9 | B.9 | — |
| 1.10 | B.10 | — |
| 1.11 | B.11 | — |
| 1.12 | B.12 | — |
| 1.13 | B.13 | — |
| 1.14 | B.14 | — |
| 1.15 | B.15 | — |
| 1.16 | B.16 | — |
| 1.17 | B.17 | — |
| 1.18 | B.18 | — |
| 1.19 | B.19 | — |
| 1.20 | B.20 | — |
| 1.21 | B.21 | — |
| 1.22 | B.22 | — |
| 1.23 | B.23 | — |
| 1.24 | B.24 | — |
| 1.25 | B.25 | — |
| 1.26 | B.26 | — |
| 1.27 | B.27 | — |
| 1.28 | B.28 | — |
| 1.29 | B.29 | — |
| 1.30 | B.30 | — |
| 1.31 | B.31 | — |
| 1.32 | B.32 | — |
| 1.33 | B.33 | — |
| 1.34 | B.34 | — |
| 1.35 | B.35 | — |
| 1.36 | B.36 | — |
| 1.37 | B.37 | — |
| 1.38 | B.38 | — |
| 1.39 | B.39 | — |
| 1.40 | B.40 | — |
| 1.41 | B.41 | — |
| 1.42 | B.42 | — |
| 1.43 | B.43 | — |
| 1.44 | B.44 | — |
| 1.45 | B.45 | — |
| 1.46 | B.46 | — |
| 1.47 | B.47 | — |
| 1.48 | B.48 | — |
| 1.49 | B.49 | — |
| 1.50 | B.50 | — |
| 1.51 | B.51 | — |
| 1.52 | B.52 | — |
| 1.53 | B.53 | — |
| 1.54 | B.54 | — |
| 1.55 | B.55 | — |
| 1.56 | B.56 | — |
| 1.57 | B.57 | — |
| 1.58 | B.58. | — |
| 1.59 | B.59 | — |
| 1.60 | B.60 | — |
| 1.61 | B.61 | — |
| 1.62 | B.62 | — |
| 1.63 | B.63 | — |
| 1.64 | B.64 | — |
| 1.65 | B.65 | — |
| 1.66 | B.66 | — |
| 1.67 | B.67 | — |
| 1.68 | B.68 | — |
| 1.69 | B.69 | — |
| 1.70 | B.70 | — |
| 1.71 | B.71 | — |
| 1.72 | B.72 | — |
| 1.73 | B.73 | — |
| 1.74 | B.74 | — |
| 1.75 | B.75 | — |
| 1.76 | B.76 | — |
| 1.77 | B.77 | — |
| 1.78 | B.78 | — |
| 1.79 | B.79 | — |
| 1.80 | B.80 | — |
| 1.81 | B.81 | — |
| 1.82 | B.82 | — |
| 1.83 | B.83 | — |
| 1.84 | B.84 | — |
| 1.85 | B.85 | — |
| 1.86 | B.86 | — |
| 1.87 | B.87 | — |
| 1.88 | B.88 | — |
| 1.89 | B.89 | — |
| 1.90 | B.90 | — |
| 1.91 | B.91 | — |
| 1.92 | B.92 | — |
| 1.93 | B.93 | — |
| 1.94 | B.94 | — |
| 1.95 | B.95 | — |
| 1.96 | B.96 | — |
| 1.97 | B.97 | — |
| 1.98 | B.98 | — |
| 1.99 | B.99 | — |
| 1.100 | B.100 | — |
| 1.101 | B.101 | — |
| 1.102 | B.102 | — |
| 1.103 | B.103 | — |
| 1.104 | B.104 | — |
| 1.105 | B.105 | — |
| 1.106 | B.106 | — |
| 1.107 | B.107 | — |
| 1.108 | B.108 | — |
| 1.109 | B.109 | — |
| 1.110 | B.110 | — |
| 1.111 | B.111 | — |
| 1.112 | B.112 | — |
| 1.113 | B.113 | — |
| 1.114 | B.114 | — |
| 1.115 | B.115 | — |
| 1.116 | B.116 | — |
| 1.117 | B.117 | — |
| 1.118 | B.118 | — |
| 1.119 | B.119 | — |
| 1.120 | B.120 | — |
| 1.121 | B.121 | — |
| 1.122 | B.122 | — |
| 1.123 | B.123 | — |
| 1.124 | B.124 | — |
| 1.125 | B.125 | — |
| 1.126 | B.126 | — |
| 1.127 | B.127 | — |
| 1.128 | B.128 | — |
| 1.129 | B.129 | — |
| 1.130 | B.130 | — |
| 1.131 | B.131 | — |
| 1.132 | B.132 | — |
| 1.133 | B.133 | — |
| 1.134 | B.134 | — |
| 1.135 | B.135 | — |
| 1.136 | B.136 | — |
| 1.137 | B.137 | — |
| 1.138 | B.138 | — |
| 1.139 | B.139 | — |
| 1.140 | B.140 | — |
| 1.141 | B.141 | — |
| 1.142 | B.142 | — |
| 1.143 | B.143 | — |
| 1.144 | B.144 | — |
| 1.145 | B.145 | — |
| 1.146 | B.146 | — |
| 1.147 | B.147 | — |
| 1.148 | B.148 | — |
| 1.149 | B.149 | — |
| 1.150 | B.150 | — |
| 1.151 | B.151 | — |
| 1.152 | B.152 | — |
| 1.153 | B.153 | — |
| 1.154 | B.154 | — |
| 1.155 | B.155 | — |
| 1.156 | B.156 | — |
| 1.157 | B.157 | — |
| 1.158 | B.158 | — |
| 1.159 | B.159 | — |
| 1.160 | B.160 | — |
| 1.161 | B.161 | — |
| 1.162 | B.162 | — |
| 1.163 | B.163 | — |
| 1.164 | B.164 | — |
| 1.165 | B.165 | — |
| 1.166 | B.166 | — |
| 1.167 | B.167 | — |
| 1.168 | B.168 | — |
| 1.169 | B.169 | — |
| 1.170 | B.170 | — |
| 1.171 | B.171 | — |
| 1.172 | B.172 | — |
| 1.173 | B.173 | — |
| 1.174 | B.174 | — |
| 1.175 | B.175 | — |
| 1.176 | B.176 | — |
| 1.177 | B.177 | — |
| 1.178 | B.178 | — |
| 1.179 | B.179 | — |
| 1.180 | B.180 | — |
| 1.181 | B.181 | — |
| 1.182 | B.182 | — |
| 1.183 | B.183 | — |
| 1.184 | B.184 | — |
| 1.185 | B.185 | — |
| 1.186 | B.186 | — |
| 1.187 | B.187 | — |
| 1.188 | B.188 | — |
| 1.189 | B.189 | — |
| 1.190 | B.190 | — |
| 1.191 | B.191 | — |
| 1.192 | B.192 | — |
| 1.193 | B.193 | — |
| 1.194 | B.194 | — |
| 1.195 | B.195 | — |
| 1.196 | B.196 | — |
| 1.197 | B.197 | — |
| 1.198 | B.198 | — |
| 1.199 | B.199 | — |
| 1.200 | B.200 | — |
| 1.201 | B.201 | — |
| 1.202 | B.202 | — |
| 1.203 | B.203 | — |
| 1.204 | B.204 | — |
| 1.205 | B.205 | — |
| 1.206 | B.206 | — |
| 1.207 | B.207 | — |
| 1.208 | B.208 | — |
| 1.209 | B.209 | — |
| 1.210 | B.210 | — |
| 1.211 | B.211 | — |
| 1.212 | B.212 | — |
| 1.213 | B.213 | — |
| 1.214 | B.214 | — |
| 1.215 | B.215 | — |
| 1.216 | B.1 | C.1 |
| 1.217 | B.2 | C.1 |
| 1.218 | B.3 | C.1 |
| 1.219 | B.4 | C.1 |
| 1.220 | B.5 | C.1 |
| 1.221 | B.6 | C.1 |
| 1.222 | B.7 | C.1 |
| 1.223 | B.8 | C.1 |
| 1.224 | B.9 | C.1 |
| 1.225 | B.10 | C.1 |
| 1.226 | B.11 | C.1 |
| 1.227 | B.12 | C.1 |
| 1.228 | B.13 | C.1 |
| 1.229 | B.14 | C.1 |
| 1.230 | B.15 | C.1 |
| 1.231 | B.16 | C.1 |
| 1.232 | B.17 | C.1 |
| 1.233 | B.18 | C.1 |
| 1.234 | B.19 | C.1 |
| 1.235 | B.20 | C.1 |
| 1.236 | B.21 | C.1 |
| 1.237 | B.22 | C.1 |
| 1.238 | B.23 | C.1 |
| 1.239 | B.24 | C.1 |
| 1.240 | B.25 | C.1 |
| 1.241 | B.26 | C.1 |
| 1.242 | B.27 | C.1 |
| 1.243 | B.28 | C.1 |
| 1.244 | B.29 | C.1 |
| 1.245 | B.30 | C.1 |
| 1.246 | B.31 | C.1 |
| 1.247 | B.32 | C.1 |
| 1.248 | B.33 | C.1 |
| 1.249 | B.34 | C.1 |
| 1.250 | B.35 | C.1 |
| 1.251 | B.36 | C.1 |
| 1.252 | B.37 | C.1 |
| 1.253 | B.38 | C.1 |
| 1.254 | B.39 | C.1 |
| 1.255 | B.40 | C.1 |
| 1.256 | B.41 | C.1 |
| 1.257 | B.42 | C.1 |
| 1.258 | B.43 | C.1 |
| 1.259 | B.44 | C.1 |
| 1.260 | B.45 | C.1 |
| 1.261 | B.46 | C.1 |
| 1.262 | B.47 | C.1 |
| 1.263 | B.48 | C.1 |
| 1.264 | B.49 | C.1 |
| 1.265 | B.50 | C.1 |
| 1.266 | B.51 | C.1 |
| 1.267 | B.52 | C.1 |
| 1.268 | B.53 | C.1 |
| 1.269 | B.54 | C.1 |
| 1.270 | B.55 | C.1 |
| 1.271 | B.56 | C.1 |
| 1.272 | B.57 | C.1 |
| 1.273 | B.58. | C.1 |
| 1.274 | B.59 | C.1 |
| 1.275 | B.60 | C.1 |
| 1.276 | B.61 | C.1 |
| 1.277 | B.62 | C.1 |
| 1.278 | B.63 | C.1 |
| 1.279 | B.64 | C.1 |
| 1.280 | B.65 | C.1 |
| 1.281 | B.66 | C.1 |
| 1.282 | B.67 | C.1 |
| 1.283 | B.68 | C.1 |
| 1.284 | B.69 | C.1 |
| 1.285 | B.70 | C.1 |
| 1.286 | B.71 | C.1 |
| 1.287 | B.72 | C.1 |
| 1.288 | B.73 | C.1 |
| 1.289 | B.74 | C.1 |
| 1.290 | B.75 | C.1 |
| 1.291 | B.76 | C.1 |
| 1.292 | B.77 | C.1 |
| 1.293 | B.78 | C.1 |
| 1.294 | B.79 | C.1 |
| 1.295 | B.80 | C.1 |
| 1.296 | B.81 | C.1 |
| 1.297 | B.82 | C.1 |
| 1.298 | B.83 | C.1 |
| 1.299 | B.84 | C.1 |
| 1.300 | B.85 | C.1 |
| 1.301 | B.86 | C.1 |
| 1.302 | B.87 | C.1 |
| 1.303 | B.88 | C.1 |
| 1.304 | B.89 | C.1 |
| 1.305 | B.90 | C.1 |
| 1.306 | B.91 | C.1 |
| 1.307 | B.92 | C.1 |
| 1.308 | B.93 | C.1 |
| 1.309 | B.94 | C.1 |
| 1.310 | B.95 | C.1 |
| 1.311 | B.96 | C.1 |
| 1.312 | B.97 | C.1 |
| 1.313 | B.98 | C.1 |
| 1.314 | B.99 | C.1 |
| 1.315 | B.100 | C.1 |
| 1.316 | B.101 | C.1 |
| 1.317 | B.102 | C.1 |
| 1.318 | B.103 | C.1 |
| 1.319 | B.104 | C.1 |
| 1.320 | B.105 | C.1 |
| 1.321 | B.106 | C.1 |
| 1.322 | B.107 | C.1 |
| 1.323 | B.108 | C.1 |
| 1.324 | B.109 | C.1 |
| 1.325 | B.110 | C.1 |
| 1.326 | B.111 | C.1 |
| 1.327 | B.112 | C.1 |
| 1.328 | B.113 | C.1 |
| 1.329 | B.114 | C.1 |
| 1.330 | B.115 | C.1 |
| 1.331 | B.116 | C.1 |
| 1.332 | B.117 | C.1 |
| 1.333 | B.118 | C.1 |
| 1.334 | B.119 | C.1 |
| 1.335 | B.120 | C.1 |
| 1.336 | B.121 | C.1 |
| 1.337 | B.122 | C.1 |
| 1.338 | B.123 | C.1 |
| 1.339 | B.124 | C.1 |
| 1.340 | B.125 | C.1 |
| 1.341 | B.126 | C.1 |
| 1.342 | B.127 | C.1 |
| 1.343 | B.128 | C.1 |
| 1.344 | B.129 | C.1 |
| 1.345 | B.130 | C.1 |
| 1.346 | B.131 | C.1 |
| 1.347 | B.132 | C.1 |
| 1.348 | B.133 | C.1 |
| 1.349 | B.134 | C.1 |
| 1.350 | B.135 | C.1 |
| 1.351 | B.136 | C.1 |
| 1.352 | B.137 | C.1 |
| 1.353 | B.138 | C.1 |
| 1.354 | B.139 | C.1 |
| 1.355 | B.140 | C.1 |
| 1.356 | B.141 | C.1 |
| 1.357 | B.142 | C.1 |
| 1.358 | B.143 | C.1 |
| 1.359 | B.144 | C.1 |
| 1.360 | B.145 | C.1 |
| 1.361 | B.146 | C.1 |
| 1.362 | B.147 | C.1 |
| 1.363 | B.148 | C.1 |
| 1.364 | B.149 | C.1 |
| 1.365 | B.150 | C.1 |
| 1.366 | B.151 | C.1 |
| 1.367 | B.152 | C.1 |
| 1.368 | B.153 | C.1 |
| 1.369 | B.154 | C.1 |
| 1.370 | B.155 | C.1 |
| 1.371 | B.156 | C.1 |
| 1.372 | B.157 | C.1 |
| 1.373 | B.158 | C.1 |
| 1.374 | B.159 | C.1 |
| 1.375 | B.160 | C.1 |
| 1.376 | B.161 | C.1 |
| 1.377 | B.162 | C.1 |
| 1.378 | B.163 | C.1 |
| 1.379 | B.164 | C.1 |
| 1.380 | B.165 | C.1 |
| 1.381 | B.166 | C.1 |
| 1.382 | B.167 | C.1 |
| 1.383 | B.168 | C.1 |
| 1.384 | B.169 | C.1 |
| 1.385 | B.170 | C.1 |
| 1.386 | B.171 | C.1 |
| 1.387 | B.172 | C.1 |
| 1.388 | B.173 | C.1 |
| 1.389 | B.174 | C.1 |
| 1.390 | B.175 | C.1 |
| 1.391 | B.176 | C.1 |
| 1.392 | B.177 | C.1 |
| 1.393 | B.178 | C.1 |
| 1.394 | B.179 | C.1 |
| 1.395 | B.180 | C.1 |
| 1.396 | B.181 | C.1 |
| 1.397 | B.182 | C.1 |
| 1.398 | B.183 | C.1 |
| 1.399 | B.184 | C.1 |
| 1.400 | B.185 | C.1 |
| 1.401 | B.186 | C.1 |
| 1.402 | B.187 | C.1 |
| 1.403 | B.188 | C.1 |
| 1.404 | B.189 | C.1 |
| 1.405 | B.190 | C.1 |
| 1.406 | B.191 | C.1 |
| 1.407 | B.192 | C.1 |
| 1.408 | B.193 | C.1 |
| 1.409 | B.194 | C.1 |
| 1.410 | B.195 | C.1 |
| 1.411 | B.196 | C.1 |
| 1.412 | B.197 | C.1 |
| 1.413 | B.198 | C.1 |
| 1.414 | B.199 | C.1 |
| 1.415 | B.200 | C.1 |
| 1.416 | B.201 | C.1 |
| 1.417 | B.202 | C.1 |
| 1.418 | B.203 | C.1 |
| 1.419 | B.204 | C.1 |
| 1.420 | B.205 | C.1 |
| 1.421 | B.206 | C.1 |
| 1.422 | B.207 | C.1 |
| 1.423 | B.208 | C.1 |
| 1.424 | B.209 | C.1 |
| 1.425 | B.210 | C.1 |
| 1.426 | B.211 | C.1 |
| 1.427 | B.212 | C.1 |
| 1.428 | B.213 | C.1 |
| 1.429 | B.214 | C.1 |
| 1.430 | B.215 | C.1 |
| 1.431 | B.1 | C.2 |
| 1.432 | B.2 | C.2 |
| 1.433 | B.3 | C.2 |
| 1.434 | B.4 | C.2 |
| 1.435 | B.5 | C.2 |
| 1.436 | B.6 | C.2 |
| 1.437 | B.7 | C.2 |
| 1.438 | B.8 | C.2 |
| 1.439 | B.9 | C.2 |
| 1.440 | B.10 | C.2 |
| 1.441 | B.11 | C.2 |
| 1.442 | B.12 | C.2 |
| 1.443 | B.13 | C.2 |
| 1.444 | B.14 | C.2 |
| 1.445 | B.15 | C.2 |
| 1.446 | B.16 | C.2 |
| 1.447 | B.17 | C.2 |
| 1.448 | B.18 | C.2 |
| 1.449 | B.19 | C.2 |
| 1.450 | B.20 | C.2 |
| 1.451 | B.21 | C.2 |
| 1.452 | B.22 | C.2 |
| 1.453 | B.23 | C.2 |
| 1.454 | B.24 | C.2 |
| 1.455 | B.25 | C.2 |
| 1.456 | B.26 | C.2 |
| 1.457 | B.27 | C.2 |
| 1.458 | B.28 | C.2 |
| 1.459 | B.29 | C.2 |
| 1.460 | B.30 | C.2 |
| 1.461 | B.31 | C.2 |
| 1.462 | B.32 | C.2 |
| 1.463 | B.33 | C.2 |
| 1.464 | B.34 | C.2 |
| 1.465 | B.35 | C.2 |
| 1.466 | B.36 | C.2 |
| 1.467 | B.37 | C.2 |
| 1.468 | B.38 | C.2 |
| 1.469 | B.39 | C.2 |
| 1.470 | B.40 | C.2 |
| 1.471 | B.41 | C.2 |
| 1.472 | B.42 | C.2 |
| 1.473 | B.43 | C.2 |
| 1.474 | B.44 | C.2 |
| 1.475 | B.45 | C.2 |
| 1.476 | B.46 | C.2 |
| 1.477 | B.47 | C.2 |
| 1.478 | B.48 | C.2 |
| 1.479 | B.49 | C.2 |
| 1.480 | B.50 | C.2 |
| 1.481 | B.51 | C.2 |
| 1.482 | B.52 | C.2 |
| 1.483 | B.53 | C.2 |
| 1.484 | B.54 | C.2 |
| 1.485 | B.55 | C.2 |
| 1.486 | B.56 | C.2 |
| 1.487 | B.57 | C.2 |
| 1.488 | B.58. | C.2 |
| 1.489 | B.59 | C.2 |
| 1.490 | B.60 | C.2 |
| 1.491 | B.61 | C.2 |
| 1.492 | B.62 | C.2 |
| 1.493 | B.63 | C.2 |
| 1.494 | B.64 | C.2 |
| 1.495 | B.65 | C.2 |
| 1.496 | B.66 | C.2 |
| 1.497 | B.67 | C.2 |
| 1.498 | B.68 | C.2 |
| 1.499 | B.69 | C.2 |
| 1.500 | B.70 | C.2 |
| 1.501 | B.71 | C.2 |
| 1.502 | B.72 | C.2 |
| 1.503 | B.73 | C.2 |
| 1.504 | B.74 | C.2 |
| 1.505 | B.75 | C.2 |
| 1.506 | B.76 | C.2 |
| 1.507 | B.77 | C.2 |
| 1.508 | B.78 | C.2 |
| 1.509 | B.79 | C.2 |
| 1.510 | B.80 | C.2 |
| 1.511 | B.81 | C.2 |
| 1.512 | B.82 | C.2 |
| 1.513 | B.83 | C.2 |
| 1.514 | B.84 | C.2 |
| 1.515 | B.85 | C.2 |
| 1.516 | B.86 | C.2 |
| 1.517 | B.87 | C.2 |
| 1.518 | B.88 | C.2 |
| 1.519 | B.89 | C.2 |
| 1.520 | B.90 | C.2 |
| 1.521 | B.91 | C.2 |
| 1.522 | B.92 | C.2 |
| 1.523 | B.93 | C.2 |
| 1.524 | B.94 | C.2 |
| 1.525 | B.95 | C.2 |
| 1.526 | B.96 | C.2 |
| 1.527 | B.97 | C.2 |
| 1.528 | B.98 | C.2 |
| 1.529 | B.99 | C.2 |
| 1.530 | B.100 | C.2 |
| 1.531 | B.101 | C.2 |
| 1.532 | B.102 | C.2 |
| 1.533 | B.103 | C.2 |
| 1.534 | B.104 | C.2 |
| 1.535 | B.105 | C.2 |
| 1.536 | B.106 | C.2 |
| 1.537 | B.107 | C.2 |
| 1.538 | B.108 | C.2 |
| 1.539 | B.109 | C.2 |
| 1.540 | B.110 | C.2 |
| 1.541 | B.111 | C.2 |
| 1.542 | B.112 | C.2 |
| 1.543 | B.113 | C.2 |
| 1.544 | B.114 | C.2 |
| 1.545 | B.115 | C.2 |
| 1.546 | B.116 | C.2 |
| 1.547 | B.117 | C.2 |
| 1.548 | B.118 | C.2 |
| 1.549 | B.119 | C.2 |
| 1.550 | B.120 | C.2 |
| 1.551 | B.121 | C.2 |
| 1.552 | B.122 | C.2 |
| 1.553 | B.123 | C.2 |
| 1.554 | B.124 | C.2 |
| 1.555 | B.125 | C.2 |
| 1.556 | B.126 | C.2 |
| 1.557 | B.127 | C.2 |
| 1.558 | B.128 | C.2 |
| 1.559 | B.129 | C.2 |
| 1.560 | B.130 | C.2 |
| 1.561 | B.131 | C.2 |
| 1.562 | B.132 | C.2 |
| 1.563 | B.133 | C.2 |
| 1.564 | B.134 | C.2 |
| 1.565 | B.135 | C.2 |
| 1.566 | B.136 | C.2 |
| 1.567 | B.137 | C.2 |
| 1.568 | B.138 | C.2 |
| 1.569 | B.139 | C.2 |
| 1.570 | B.140 | C.2 |
| 1.571 | B.141 | C.2 |
| 1.572 | B.142 | C.2 |
| 1.573 | B.143 | C.2 |
| 1.574 | B.144 | C.2 |
| 1.575 | B.145 | C.2 |
| 1.576 | B.146 | C.2 |
| 1.577 | B.147 | C.2 |
| 1.578 | B.148 | C.2 |
| 1.579 | B.149 | C.2 |
| 1.580 | B.150 | C.2 |
| 1.581 | B.151 | C.2 |
| 1.582 | B.152 | C.2 |
| 1.583 | B.153 | C.2 |
| 1.584 | B.154 | C.2 |
| 1.585 | B.155 | C.2 |
| 1.586 | B.156 | C.2 |
| 1.587 | B.157 | C.2 |
| 1.588 | B.158 | C.2 |
| 1.589 | B.159 | C.2 |
| 1.590 | B.160 | C.2 |
| 1.591 | B.161 | C.2 |
| 1.592 | B.162 | C.2 |
| 1.593 | B.163 | C.2 |
| 1.594 | B.164 | C.2 |
| 1.595 | B.165 | C.2 |
| 1.596 | B.166 | C.2 |
| 1.597 | B.167 | C.2 |
| 1.598 | B.168 | C.2 |
| 1.599 | B.169 | C.2 |
| 1.600 | B.170 | C.2 |
| 1.601 | B.171 | C.2 |
| 1.602 | B.172 | C.2 |
| 1.603 | B.173 | C.2 |
| 1.604 | B.174 | C.2 |
| 1.605 | B.175 | C.2 |
| 1.606 | B.176 | C.2 |
| 1.607 | B.177 | C.2 |
| 1.608 | B.178 | C.2 |
| 1.609 | B.179 | C.2 |
| 1.610 | B.180 | C.2 |
| 1.611 | B.181 | C.2 |
| 1.612 | B.182 | C.2 |
| 1.613 | B.183 | C.2 |
| 1.614 | B.184 | C.2 |
| 1.615 | B.185 | C.2 |
| 1.616 | B.186 | C.2 |
| 1.617 | B.187 | C.2 |
| 1.618 | B.188 | C.2 |
| 1.619 | B.189 | C.2 |
| 1.620 | B.190 | C.2 |
| 1.621 | B.191 | C.2 |
| 1.622 | B.192 | C.2 |
| 1.623 | B.193 | C.2 |
| 1.624 | B.194 | C.2 |
| 1.625 | B.195 | C.2 |
| 1.626 | B.196 | C.2 |
| 1.627 | B.197 | C.2 |
| 1.628 | B.198 | C.2 |
| 1.629 | B.199 | C.2 |
| 1.630 | B.200 | C.2 |
| 1.631 | B.201 | C.2 |
| 1.632 | B.202 | C.2 |
| 1.633 | B.203 | C.2 |
| 1.634 | B.204 | C.2 |
| 1.635 | B.205 | C.2 |
| 1.636 | B.206 | C.2 |
| 1.637 | B.207 | C.2 |
| 1.638 | B.208 | C.2 |
| 1.639 | B.209 | C.2 |
| 1.640 | B.210 | C.2 |
| 1.641 | B.211 | C.2 |
| 1.642 | B.212 | C.2 |
| 1.643 | B.213 | C.2 |
| 1.644 | B.214 | C.2 |
| 1.645 | B.214 | C.2 |
| 1.646 | B.1 | C.3 |
| 1.647 | B.2 | C.3 |
| 1.648 | B.3 | C.3 |
| 1.649 | B.4 | C.3 |
| 1.650 | B.5 | C.3 |
| 1.651 | B.6 | C.3 |
| 1.652 | B.7 | C.3 |
| 1.653 | B.8 | C.3 |
| 1.654 | B.9 | C.3 |
| 1.655 | B.10 | C.3 |
| 1.656 | B.11 | C.3 |
| 1.657 | B.12 | C.3 |
| 1.658 | B.13 | C.3 |
| 1.659 | B.14 | C.3 |
| 1.660 | B.15 | C.3 |
| 1.661 | B.16 | C.3 |
| 1.662 | B.17 | C.3 |
| 1.663 | B.18 | C.3 |
| 1.664 | B.19 | C.3 |
| 1.665 | B.20 | C.3 |
| 1.666 | B.21 | C.3 |
| 1.667 | B.22 | C.3 |
| 1.668 | B.23 | C.3 |
| 1.669 | B.24 | C.3 |
| 1.670 | B.25 | C.3 |
| 1.671 | B.26 | C.3 |
| 1.672 | B.27 | C.3 |
| 1.673 | B.28 | C.3 |
| 1.674 | B.29 | C.3 |
| 1.675 | B.30 | C.3 |
| 1.676 | B.31 | C.3 |
| 1.677 | B.32 | C.3 |
| 1.678 | B.33 | C.3 |
| 1.679 | B.34 | C.3 |
| 1.680 | B.35 | C.3 |
| 1.681 | B.36 | C.3 |
| 1.682 | B.37 | C.3 |
| 1.683 | B.38 | C.3 |
| 1.684 | B.39 | C.3 |
| 1.685 | B.40 | C.3 |
| 1.686 | B.41 | C.3 |
| 1.687 | B.42 | C.3 |
| 1.688 | B.43 | C.3 |
| 1.689 | B.44 | C.3 |
| 1.690 | B.45 | C.3 |
| 1.691 | B.46 | C.3 |
| 1.692 | B.47 | C.3 |
| 1.693 | B.48 | C.3 |
| 1.694 | B.49 | C.3 |
| 1.695 | B.50 | C.3 |
| 1.696 | B.51 | C.3 |
| 1.697 | B.52 | C.3 |
| 1.698 | B.53 | C.3 |
| 1.699 | B.54 | C.3 |
| 1.700 | B.55 | C.3 |
| 1.701 | B.56 | C.3 |
| 1.702 | B.57 | C.3 |
| 1.703 | B.58. | C.3 |
| 1.704 | B.59 | C.3 |
| 1.705 | B.60 | C.3 |
| 1.706 | B.61 | C.3 |
| 1.707 | B.62 | C.3 |
| 1.708 | B.63 | C.3 |
| 1.709 | B.64 | C.3 |
| 1.710 | B.65 | C.3 |
| 1.711 | B.66 | C.3 |
| 1.712 | B.67 | C.3 |
| 1.713 | B.68 | C.3 |
| 1.714 | B.69 | C.3 |
| 1.715 | B.70 | C.3 |
| 1.716 | B.71 | C.3 |
| 1.717 | B.72 | C.3 |
| 1.718 | B.73 | C.3 |
| 1.719 | B.74 | C.3 |
| 1.720 | B.75 | C.3 |
| 1.721 | B.76 | C.3 |
| 1.722 | B.77 | C.3 |
| 1.723 | B.78 | C.3 |
| 1.724 | B.79 | C.3 |
| 1.725 | B.80 | C.3 |
| 1.726 | B.81 | C.3 |
| 1.727 | B.82 | C.3 |
| 1.728 | B.83 | C.3 |
| 1.729 | B.84 | C.3 |
| 1.730 | B.85 | C.3 |
| 1.731 | B.86 | C.3 |
| 1.732 | B.87 | C.3 |
| 1.733 | B.88 | C.3 |
| 1.734 | B.89 | C.3 |
| 1.735 | B.90 | C.3 |
| 1.736 | B.91 | C.3 |
| 1.737 | B.92 | C.3 |
| 1.738 | B.93 | C.3 |
| 1.739 | B.94 | C.3 |
| 1.740 | B.95 | C.3 |
| 1.741 | B.96 | C.3 |
| 1.742 | B.97 | C.3 |
| 1.743 | B.98 | C.3 |
| 1.744 | B.99 | C.3 |
| 1.745 | B.100 | C.3 |
| 1.746 | B.101 | C.3 |
| 1.747 | B.102 | C.3 |
| 1.748 | B.103 | C.3 |
| 1.749 | B.104 | C.3 |
| 1.750 | B.105 | C.3 |
| 1.751 | B.106 | C.3 |
| 1.752 | B.107 | C.3 |
| 1.753 | B.108 | C.3 |
| 1.754 | B.109 | C.3 |
| 1.755 | B.110 | C.3 |
| 1.756 | B.111 | C.3 |
| 1.757 | B.112 | C.3 |
| 1.758 | B.113 | C.3 |
| 1.759 | B.114 | C.3 |
| 1.760 | B.115 | C.3 |
| 1.761 | B.116 | C.3 |
| 1.762 | B.117 | C.3 |
| 1.763 | B.118 | C.3 |
| 1.764 | B.119 | C.3 |
| 1.765 | B.120 | C.3 |
| 1.766 | B.121 | C.3 |
| 1.767 | B.122 | C.3 |
| 1.768 | B.123 | C.3 |
| 1.769 | B.124 | C.3 |
| 1.770 | B.125 | C.3 |
| 1.771 | B.126 | C.3 |
| 1.772 | B.127 | C.3 |
| 1.773 | B.128 | C.3 |
| 1.774 | B.129 | C.3 |
| 1.775 | B.130 | C.3 |
| 1.776 | B.131 | C.3 |
| 1.777 | B.132 | C.3 |
| 1.778 | B.133 | C.3 |
| 1.779 | B.134 | C.3 |
| 1.780 | B.135 | C.3 |
| 1.781 | B.136 | C.3 |
| 1.782 | B.137 | C.3 |
| 1.783 | B.138 | C.3 |
| 1.784 | B.139 | C.3 |
| 1.785 | B.140 | C.3 |
| 1.786 | B.141 | C.3 |
| 1.787 | B.142 | C.3 |
| 1.788 | B.143 | C.3 |
| 1.789 | B.144 | C.3 |
| 1.790 | B.145 | C.3 |
| 1.791 | B.146 | C.3 |
| 1.792 | B.147 | C.3 |
| 1.793 | B.148 | C.3 |
| 1.794 | B.149 | C.3 |
| 1.795 | B.150 | C.3 |
| 1.796 | B.151 | C.3 |
| 1.797 | B.152 | C.3 |
| 1.798 | B.153 | C.3 |
| 1.799 | B.154 | C.3 |
| 1.800 | B.155 | C.3 |
| 1.801 | B.156 | C.3 |
| 1.802 | B.157 | C.3 |
| 1.803 | B.158 | C.3 |
| 1.804 | B.159 | C.3 |
| 1.805 | B.160 | C.3 |
| 1.806 | B.161 | C.3 |
| 1.807 | B.162 | C.3 |
| 1.808 | B.163 | C.3 |
| 1.809 | B.164 | C.3 |
| 1.810 | B.165 | C.3 |
| 1.811 | B.166 | C.3 |
| 1.812 | B.167 | C.3 |
| 1.813 | B.168 | C.3 |
| 1.814 | B.169 | C.3 |
| 1.815 | B.170 | C.3 |
| 1.816 | B.171 | C.3 |
| 1.817 | B.172 | C.3 |
| 1.818 | B.173 | C.3 |
| 1.819 | B.174 | C.3 |
| 1.820 | B.175 | C.3 |
| 1.821 | B.176 | C.3 |
| 1.822 | B.177 | C.3 |
| 1.823 | B.178 | C.3 |
| 1.824 | B.179 | C.3 |
| 1.825 | B.180 | C.3 |
| 1.826 | B.181 | C.3 |
| 1.827 | B.182 | C.3 |
| 1.828 | B.183 | C.3 |
| 1.829 | B.184 | C.3 |
| 1.830 | B.185 | C.3 |
| 1.831 | B.186 | C.3 |
| 1.832 | B.187 | C.3 |
| 1.833 | B.188 | C.3 |
| 1.834 | B.189 | C.3 |
| 1.835 | B.190 | C.3 |
| 1.836 | B.191 | C.3 |
| 1.837 | B.192 | C.3 |
| 1.838 | B.193 | C.3 |
| 1.839 | B.194 | C.3 |
| 1.840 | B.195 | C.3 |
| 1.841 | B.196 | C.3 |
| 1.842 | B.197 | C.3 |
| 1.843 | B.198 | C.3 |
| 1.844 | B.199 | C.3 |
| 1.845 | B.200 | C.3 |
| 1.846 | B.201 | C.3 |
| 1.847 | B.202 | C.3 |
| 1.848 | B.203 | C.3 |
| 1.849 | B.204 | C.3 |
| 1.850 | B.205 | C.3 |
| 1.851 | B.206 | C.3 |
| 1.852 | B.207 | C.3 |
| 1.853 | B.208 | C.3 |
| 1.854 | B.209 | C.3 |
| 1.855 | B.210 | C.3 |
| 1.856 | B.211 | C.3 |
| 1.857 | B.212 | C.3 |
| 1.858 | B.213 | C.3 |
| 1.859 | B.214 | C.3 |
| 1.860 | B.215 | C.3 |
| 1.861 | B.1 | C.4 |
| 1.862 | B.2 | C.4 |
| 1.863 | B.3 | C.4 |
| 1.864 | B.4 | C.4 |
| 1.865 | B.5 | C.4 |
| 1.866 | B.6 | C.4 |
| 1.867 | B.7 | C.4 |
| 1.868 | B.8 | C.4 |
| 1.869 | B.9 | C.4 |
| 1.870 | B.10 | C.4 |
| 1.871 | B.11 | C.4 |
| 1.872 | B.12 | C.4 |
| 1.873 | B.13 | C.4 |
| 1.874 | B.14 | C.4 |
| 1.875 | B.15 | C.4 |
| 1.876 | B.16 | C.4 |
| 1.877 | B.17 | C.4 |
| 1.878 | B.18 | C.4 |
| 1.879 | B.19 | C.4 |
| 1.880 | B.20 | C.4 |
| 1.881 | B.21 | C.4 |
| 1.882 | B.22 | C.4 |
| 1.883 | B.23 | C.4 |
| 1.884 | B.24 | C.4 |
| 1.885 | B.25 | C.4 |
| 1.886 | B.26 | C.4 |
| 1.887 | B.27 | C.4 |
| 1.888 | B.28 | C.4 |
| 1.889 | B.29 | C.4 |
| 1.890 | B.30 | C.4 |
| 1.891 | B.31 | C.4 |
| 1.892 | B.32 | C.4 |
| 1.893 | B.33 | C.4 |
| 1.894 | B.34 | C.4 |
| 1.895 | B.35 | C.4 |
| 1.896 | B.36 | C.4 |
| 1.897 | B.37 | C.4 |
| 1.898 | B.38 | C.4 |
| 1.899 | B.39 | C.4 |
| 1.900 | B.40 | C.4 |
| 1.901 | B.41 | C.4 |
| 1.902 | B.42 | C.4 |
| 1.903 | B.43 | C.4 |
| 1.904 | B.44 | C.4 |
| 1.905 | B.45 | C.4 |
| 1.906 | B.46 | C.4 |
| 1.907 | B.47 | C.4 |
| 1.908 | B.48 | C.4 |
| 1.909 | B.49 | C.4 |
| 1.910 | B.50 | C.4 |
| 1.911 | B.51 | C.4 |
| 1.912 | B.52 | C.4 |
| 1.913 | B.53 | C.4 |
| 1.914 | B.54 | C.4 |
| 1.915 | B.55 | C.4 |
| 1.916 | B.56 | C.4 |
| 1.917 | B.57 | C.4 |
| 1.918 | B.58. | C.4 |
| 1.919 | B.59 | C.4 |
| 1.920 | B.60 | C.4 |
| 1.921 | B.61 | C.4 |
| 1.922 | B.62 | C.4 |
| 1.923 | B.63 | C.4 |
| 1.924 | B.64 | C.4 |
| 1.925 | B.65 | C.4 |
| 1.926 | B.66 | C.4 |
| 1.927 | B.67 | C.4 |
| 1.928 | B.68 | C.4 |
| 1.929 | B.69 | C.4 |
| 1.930 | B.70 | C.4 |
| 1.931 | B.71 | C.4 |
| 1.932 | B.72 | C.4 |
| 1.933 | B.73 | C.4 |
| 1.934 | B.74 | C.4 |
| 1.935 | B.75 | C.4 |
| 1.936 | B.76 | C.4 |
| 1.937 | B.77 | C.4 |
| 1.938 | B.78 | C.4 |
| 1.939 | B.79 | C.4 |
| 1.940 | B.80 | C.4 |
| 1.941 | B.81 | C.4 |
| 1.942 | B.82 | C.4 |
| 1.943 | B.83 | C.4 |
| 1.944 | B.84 | C.4 |
| 1.945 | B.85 | C.4 |
| 1.946 | B.86 | C.4 |
| 1.947 | B.87 | C.4 |
| 1.948 | B.88 | C.4 |
| 1.949 | B.89 | C.4 |
| 1.950 | B.90 | C.4 |
| 1.951 | B.91 | C.4 |
| 1.952 | B.92 | C.4 |
| 1.953 | B.93 | C.4 |
| 1.954 | B.94 | C.4 |
| 1.955 | B.95 | C.4 |
| 1.956 | B.96 | C.4 |
| 1.957 | B.97 | C.4 |
| 1.958 | B.98 | C.4 |
| 1.959 | B.99 | C.4 |
| 1.960 | B.100 | C.4 |
| 1.961 | B.101 | C.4 |
| 1.962 | B.102 | C.4 |
| 1.963 | B.103 | C.4 |
| 1.964 | B.104 | C.4 |
| 1.965 | B.105 | C.4 |
| 1.966 | B.106 | C.4 |
| 1.967 | B.107 | C.4 |
| 1.968 | B.108 | C.4 |
| 1.969 | B.109 | C.4 |
| 1.970 | B.110 | C.4 |
| 1.971 | B.111 | C.4 |
| 1.972 | B.112 | C.4 |
| 1.973 | B.113 | C.4 |
| 1.974 | B.114 | C.4 |
| 1.975 | B.115 | C.4 |
| 1.976 | B.116 | C.4 |
| 1.977 | B.117 | C.4 |
| 1.978 | B.118 | C.4 |
| 1.979 | B.119 | C.4 |
| 1.980 | B.120 | C.4 |
| 1.981 | B.121 | C.4 |
| 1.982 | B.122 | C.4 |
| 1.983 | B.123 | C.4 |
| 1.984 | B.124 | C.4 |
| 1.985 | B.125 | C.4 |
| 1.986 | B.126 | C.4 |
| 1.987 | B.127 | C.4 |
| 1.988 | B.128 | C.4 |
| 1.989 | B.129 | C.4 |
| 1.990 | B.130 | C.4 |
| 1.991 | B.131 | C.4 |
| 1.992 | B.132 | C.4 |
| 1.993 | B.133 | C.4 |
| 1.994 | B.134 | C.4 |
| 1.995 | B.135 | C.4 |
| 1.996 | B.136 | C.4 |
| 1.997 | B.137 | C.4 |
| 1.998 | B.138 | C.4 |
| 1.999 | B.139 | C.4 |
| 1.1000 | B.140 | C.4 |
| 1.1001 | B.141 | C.4 |
| 1.1002 | B.142 | C.4 |
| 1.1003 | B.143 | C.4 |
| 1.1004 | B.144 | C.4 |
| 1.1005 | B.145 | C.4 |
| 1.1006 | B.146 | C.4 |
| 1.1007 | B.147 | C.4 |
| 1.1008 | B.148 | C.4 |
| 1.1009 | B.149 | C.4 |
| 1.1010 | B.150 | C.4 |
| 1.1011 | B.151 | C.4 |
| 1.1012 | B.152 | C.4 |
| 1.1013 | B.153 | C.4 |
| 1.1014 | B.154 | C.4 |
| 1.1015 | B.155 | C.4 |
| 1.1016 | B.156 | C.4 |
| 1.1017 | B.157 | C.4 |
| 1.1018 | B.158 | C.4 |
| 1.1019 | B.159 | C.4 |
| 1.1020 | B.160 | C.4 |
| 1.1021 | B.161 | C.4 |
| 1.1022 | B.162 | C.4 |
| 1.1023 | B.163 | C.4 |
| 1.1024 | B.164 | C.4 |
| 1.1025 | B.165 | C.4 |
| 1.1026 | B.166 | C.4 |
| 1.1027 | B.167 | C.4 |
| 1.1028 | B.168 | C.4 |
| 1.1029 | B.169 | C.4 |
| 1.1030 | B.170 | C.4 |
| 1.1031 | B.171 | C.4 |
| 1.1032 | B.172 | C.4 |
| 1.1033 | B.173 | C.4 |
| 1.1034 | B.174 | C.4 |
| 1.1035 | B.175 | C.4 |
| 1.1036 | B.176 | C.4 |
| 1.1037 | B.177 | C.4 |
| 1.1038 | B.178 | C.4 |
| 1.1039 | B.179 | C.4 |
| 1.1040 | B.180 | C.4 |
| 1.1041 | B.181 | C.4 |
| 1.1042 | B.182 | C.4 |
| 1.1043 | B.183 | C.4 |
| 1.1044 | B.184 | C.4 |
| 1.1045 | B.185 | C.4 |
| 1.1046 | B.186 | C.4 |
| 1.1047 | B.187 | C.4 |
| 1.1048 | B.188 | C.4 |
| 1.1049 | B.189 | C.4 |
| 1.1050 | B.190 | C.4 |
| 1.1051 | B.191 | C.4 |
| 1.1052 | B.192 | C.4 |
| 1.1053 | B.193 | C.4 |
| 1.1054 | B.194 | C.4 |
| 1.1055 | B.195 | C.4 |
| 1.1056 | B.196 | C.4 |
| 1.1057 | B.197 | C.4 |
| 1.1058 | B.198 | C.4 |
| 1.1059 | B.199 | C.4 |
| 1.1060 | B.200 | C.4 |
| 1.1061 | B.201 | C.4 |
| 1.1062 | B.202 | C.4 |
| 1.1063 | B.203 | C.4 |
| 1.1064 | B.204 | C.4 |
| 1.1065 | B.205 | C.4 |
| 1.1066 | B.206 | C.4 |
| 1.1067 | B.207 | C.4 |
| 1.1068 | B.208 | C.4 |
| 1.1069 | B.209 | C.4 |
| 1.1070 | B.210 | C.4 |
| 1.1071 | B.211 | C.4 |
| 1.1072 | B.212 | C.4 |
| 1.1073 | B.213 | C.4 |
| 1.1074 | B.214 | C.4 |
| 1.1075 | B.215 | C.4 |
| 1.1076 | B.1 | C.5 |
| 1.1077 | B.2 | C.5 |
| 1.1078 | B.3 | C.5 |
| 1.1079 | B.4 | C.5 |
| 1.1080 | B.5 | C.5 |
| 1.1081 | B.6 | C.5 |
| 1.1082 | B.7 | C.5 |
| 1.1083 | B.8 | C.5 |
| 1.1084 | B.9 | C.5 |
| 1.1085 | B.10 | C.5 |
| 1.1086 | B.11 | C.5 |
| 1.1087 | B.12 | C.5 |
| 1.1088 | B.13 | C.5 |
| 1.1089 | B.14 | C.5 |
| 1.1090 | B.15 | C.5 |
| 1.1091 | B.16 | C.5 |
| 1.1092 | B.17 | C.5 |
| 1.1093 | B.18 | C.5 |
| 1.1094 | B.19 | C.5 |
| 1.1095 | B.20 | C.5 |
| 1.1096 | B.21 | C.5 |
| 1.1097 | B.22 | C.5 |
| 1.1098 | B.23 | C.5 |
| 1.1099 | B.24 | C.5 |
| 1.1100 | B.25 | C.5 |
| 1.1101 | B.26 | C.5 |
| 1.1102 | B.27 | C.5 |
| 1.1103 | B.28 | C.5 |
| 1.1104 | B.29 | C.5 |
| 1.1105 | B.30 | C.5 |
| 1.1106 | B.31 | C.5 |
| 1.1107 | B.32 | C.5 |
| 1.1108 | B.33 | C.5 |
| 1.1109 | B.34 | C.5 |
| 1.1110 | B.35 | C.5 |
| 1.1111 | B.36 | C.5 |
| 1.1112 | B.37 | C.5 |
| 1.1113 | B.38 | C.5 |
| 1.1114 | B.39 | C.5 |
| 1.1115 | B.40 | C.5 |
| 1.1116 | B.41 | C.5 |
| 1.1117 | B.42 | C.5 |
| 1.1118 | B.43 | C.5 |
| 1.1119 | B.44 | C.5 |
| 1.1120 | B.45 | C.5 |
| 1.1121 | B.46 | C.5 |
| 1.1122 | B.47 | C.5 |
| 1.1123 | B.48 | C.5 |
| 1.1124 | B.49 | C.5 |
| 1.1125 | B.50 | C.5 |
| 1.1126 | B.51 | C.5 |
| 1.1127 | B.52 | C.5 |
| 1.1128 | B.53 | C.5 |
| 1.1129 | B.54 | C.5 |
| 1.1130 | B.55 | C.5 |
| 1.1131 | B.56 | C.5 |
| 1.1132 | B.57 | C.5 |
| 1.1133 | B.58. | C.5 |
| 1.1134 | B.59 | C.5 |
| 1.1135 | B.60 | C.5 |
| 1.1136 | B.61 | C.5 |
| 1.1137 | B.62 | C.5 |
| 1.1138 | B.63 | C.5 |
| 1.1139 | B.64 | C.5 |
| 1.1140 | B.65 | C.5 |
| 1.1141 | B.66 | C.5 |
| 1.1142 | B.67 | C.5 |
| 1.1143 | B.68 | C.5 |
| 1.1144 | B.69 | C.5 |
| 1.1145 | B.70 | C.5 |
| 1.1146 | B.71 | C.5 |
| 1.1147 | B.72 | C.5 |
| 1.1148 | B.73 | C.5 |
| 1.1149 | B.74 | C.5 |
| 1.1150 | B.75 | C.5 |
| 1.1151 | B.76 | C.5 |
| 1.1152 | B.77 | C.5 |
| 1.1153 | B.78 | C.5 |
| 1.1154 | B.79 | C.5 |
| 1.1155 | B.80 | C.5 |
| 1.1156 | B.81 | C.5 |
| 1.1157 | B.82 | C.5 |
| 1.1158 | B.83 | C.5 |
| 1.1159 | B.84 | C.5 |
| 1.1160 | B.85 | C.5 |
| 1.1161 | B.86 | C.5 |
| 1.1162 | B.87 | C.5 |
| 1.1163 | B.88 | C.5 |
| 1.1164 | B.89 | C.5 |
| 1.1165 | B.90 | C.5 |
| 1.1166 | B.91 | C.5 |
| 1.1167 | B.92 | C.5 |
| 1.1168 | B.93 | C.5 |
| 1.1169 | B.94 | C.5 |
| 1.1170 | B.95 | C.5 |
| 1.1171 | B.96 | C.5 |
| 1.1172 | B.97 | C.5 |
| 1.1173 | B.98 | C.5 |
| 1.1174 | B.99 | C.5 |
| 1.1175 | B.100 | C.5 |
| 1.1176 | B.101 | C.5 |
| 1.1177 | B.102 | C.5 |
| 1.1178 | B.103 | C.5 |
| 1.1179 | B.104 | C.5 |
| 1.1180 | B.105 | C.5 |
| 1.1181 | B.106 | C.5 |
| 1.1182 | B.107 | C.5 |
| 1.1183 | B.108 | C.5 |
| 1.1184 | B.109 | C.5 |
| 1.1185 | B.110 | C.5 |
| 1.1186 | B.111 | C.5 |
| 1.1187 | B.112 | C.5 |
| 1.1188 | B.113 | C.5 |
| 1.1189 | B.114 | C.5 |
| 1.1190 | B.115 | C.5 |
| 1.1191 | B.116 | C.5 |
| 1.1192 | B.117 | C.5 |
| 1.1193 | B.118 | C.5 |
| 1.1194 | B.119 | C.5 |
| 1.1195 | B.120 | C.5 |
| 1.1196 | B.121 | C.5 |
| 1.1197 | B.122 | C.5 |
| 1.1198 | B.123 | C.5 |
| 1.1199 | B.124 | C.5 |
| 1.1200 | B.125 | C.5 |
| 1.1201 | B.126 | C.5 |
| 1.1202 | B.127 | C.5 |
| 1.1203 | B.128 | C.5 |
| 1.1204 | B.129 | C.5 |
| 1.1205 | B.130 | C.5 |
| 1.1206 | B.131 | C.5 |
| 1.1207 | B.132 | C.5 |
| 1.1208 | B.133 | C.5 |
| 1.1209 | B.134 | C.5 |
| 1.1210 | B.135 | C.5 |
| 1.1211 | B.136 | C.5 |
| 1.1212 | B.137 | C.5 |
| 1.1213 | B.138 | C.5 |
| 1.1214 | B.139 | C.5 |
| 1.1215 | B.140 | C.5 |
| 1.1216 | B.141 | C.5 |
| 1.1217 | B.142 | C.5 |
| 1.1218 | B.143 | C.5 |
| 1.1219 | B.144 | C.5 |
| 1.1220 | B.145 | C.5 |
| 1.1221 | B.146 | C.5 |
| 1.1222 | B.147 | C.5 |
| 1.1223 | B.148 | C.5 |
| 1.1224 | B.149 | C.5 |
| 1.1225 | B.150 | C.5 |
| 1.1226 | B.151 | C.5 |
| 1.1227 | B.152 | C.5 |
| 1.1228 | B.153 | C.5 |
| 1.1229 | B.154 | C.5 |
| 1.1230 | B.155 | C.5 |
| 1.1231 | B.156 | C.5 |
| 1.1232 | B.157 | C.5 |
| 1.1233 | B.158 | C.5 |
| 1.1234 | B.159 | C.5 |
| 1.1235 | B.160 | C.5 |
| 1.1236 | B.161 | C.5 |
| 1.1237 | B.162 | C.5 |
| 1.1238 | B.163 | C.5 |
| 1.1239 | B.164 | C.5 |
| 1.1240 | B.165 | C.5 |
| 1.1241 | B.166 | C.5 |
| 1.1242 | B.167 | C.5 |
| 1.1243 | B.168 | C.5 |
| 1.1244 | B.169 | C.5 |
| 1.1245 | B.170 | C.5 |
| 1.1246 | B.171 | C.5 |
| 1.1247 | B.172 | C.5 |
| 1.1248 | B.173 | C.5 |
| 1.1249 | B.174 | C.5 |
| 1.1250 | B.175 | C.5 |
| 1.1251 | B.176 | C.5 |
| 1.1252 | B.177 | C.5 |
| 1.1253 | B.178 | C.5 |
| 1.1254 | B.179 | C.5 |
| 1.1255 | B.180 | C.5 |
| 1.1256 | B.181 | C.5 |
| 1.1257 | B.182 | C.5 |
| 1.1258 | B.183 | C.5 |
| 1.1259 | B.184 | C.5 |
| 1.1260 | B.185 | C.5 |
| 1.1261 | B.186 | C.5 |
| 1.1262 | B.187 | C.5 |
| 1.1263 | B.188 | C.5 |
| 1.1264 | B.189 | C.5 |
| 1.1265 | B.190 | C.5 |
| 1.1266 | B.191 | C.5 |
| 1.1267 | B.192 | C.5 |
| 1.1268 | B.193 | C.5 |
| 1.1269 | B.194 | C.5 |
| 1.1270 | B.195 | C.5 |
| 1.1271 | B.196 | C.5 |
| 1.1272 | B.197 | C.5 |
| 1.1273 | B.198 | C.5 |
| 1.1274 | B.199 | C.5 |
| 1.1275 | B.200 | C.5 |
| 1.1276 | B.201 | C.5 |
| 1.1277 | B.202 | C.5 |
| 1.1278 | B.203 | C.5 |
| 1.1279 | B.204 | C.5 |
| 1.1280 | B.205 | C.5 |
| 1.1281 | B.206 | C.5 |
| 1.1282 | B.207 | C.5 |
| 1.1283 | B.208 | C.5 |
| 1.1284 | B.209 | C.5 |
| 1.1285 | B.210 | C.5 |
| 1.1286 | B.211 | C.5 |
| 1.1287 | B.212 | C.5 |
| 1.1288 | B.213 | C.5 |
| 1.1289 | B.214 | C.5 |
| 1.1290 | B.215 | C.5 |
| 1.1291 | B.1 | C.6 |
| 1.1292 | B.2 | C.6 |
| 1.1293 | B.3 | C.6 |
| 1.1294 | B.4 | C.6 |
| 1.1295 | B.5 | C.6 |
| 1.1296 | B.6 | C.6 |
| 1.1297 | B.7 | C.6 |
| 1.1298 | B.8 | C.6 |
| 1.1299 | B.9 | C.6 |
| 1.1300 | B.10 | C.6 |
| 1.1301 | B.11 | C.6 |
| 1.1302 | B.12 | C.6 |
| 1.1303 | B.13 | C.6 |
| 1.1304 | B.14 | C.6 |
| 1.1305 | B.15 | C.6 |
| 1.1306 | B.16 | C.6 |
| 1.1307 | B.17 | C.6 |
| 1.1308 | B.18 | C.6 |
| 1.1309 | B.19 | C.6 |
| 1.1310 | B.20 | C.6 |
| 1.1311 | B.21 | C.6 |
| 1.1312 | B.22 | C.6 |
| 1.1313 | B.23 | C.6 |
| 1.1314 | B.24 | C.6 |
| 1.1315 | B.25 | C.6 |
| 1.1316 | B.26 | C.6 |
| 1.1317 | B.27 | C.6 |
| 1.1318 | B.28 | C.6 |
| 1.1319 | B.29 | C.6 |
| 1.1320 | B.30 | C.6 |
| 1.1321 | B.31 | C.6 |
| 1.1322 | B.32 | C.6 |
| 1.1323 | B.33 | C.6 |
| 1.1324 | B.34 | C.6 |
| 1.1325 | B.35 | C.6 |
| 1.1326 | B.36 | C.6 |
| 1.1327 | B.37 | C.6 |
| 1.1328 | B.38 | C.6 |
| 1.1329 | B.39 | C.6 |
| 1.1330 | B.40 | C.6 |
| 1.1331 | B.41 | C.6 |
| 1.1332 | B.42 | C.6 |
| 1.1333 | B.43 | C.6 |
| 1.1334 | B.44 | C.6 |
| 1.1335 | B.45 | C.6 |
| 1.1336 | B.46 | C.6 |
| 1.1337 | B.47 | C.6 |
| 1.1338 | B.48 | C.6 |
| 1.1339 | B.49 | C.6 |
| 1.1340 | B.50 | C.6 |
| 1.1341 | B.51 | C.6 |
| 1.1342 | B.52 | C.6 |
| 1.1343 | B.53 | C.6 |
| 1.1344 | B.54 | C.6 |
| 1.1345 | B.55 | C.6 |
| 1.1346 | B.56 | C.6 |
| 1.1347 | B.57 | C.6 |
| 1.1348 | B.58. | C.6 |
| 1.1349 | B.59 | C.6 |
| 1.1350 | B.60 | C.6 |
| 1.1351 | B.61 | C.6 |
| 1.1352 | B.62 | C.6 |
| 1.1353 | B.63 | C.6 |
| 1.1354 | B.64 | C.6 |
| 1.1355 | B.65 | C.6 |
| 1.1356 | B.66 | C.6 |
| 1.1357 | B.67 | C.6 |
| 1.1358 | B.68 | C.6 |
| 1.1359 | B.69 | C.6 |
| 1.1360 | B.70 | C.6 |
| 1.1361 | B.71 | C.6 |
| 1.1362 | B.72 | C.6 |
| 1.1363 | B.73 | C.6 |
| 1.1364 | B.74 | C.6 |
| 1.1365 | B.75 | C.6 |
| 1.1366 | B.76 | C.6 |
| 1.1367 | B.77 | C.6 |
| 1.1368 | B.78 | C.6 |
| 1.1369 | B.79 | C.6 |
| 1.1370 | B.80 | C.6 |
| 1.1371 | B.81 | C.6 |
| 1.1372 | B.82 | C.6 |
| 1.1373 | B.83 | C.6 |
| 1.1374 | B.84 | C.6 |
| 1.1375 | B.85 | C.6 |
| 1.1376 | B.86 | C.6 |
| 1.1377 | B.87 | C.6 |
| 1.1378 | B.88 | C.6 |
| 1.1379 | B.89 | C.6 |
| 1.1380 | B.90 | C.6 |
| 1.1381 | B.91 | C.6 |
| 1.1382 | B.92 | C.6 |
| 1.1383 | B.93 | C.6 |
| 1.1384 | B.94 | C.6 |
| 1.1385 | B.95 | C.6 |
| 1.1386 | B.96 | C.6 |
| 1.1387 | B.97 | C.6 |
| 1.1388 | B.98 | C.6 |
| 1.1389 | B.99 | C.6 |
| 1.1390 | B.100 | C.6 |
| 1.1391 | B.101 | C.6 |
| 1.1392 | B.102 | C.6 |
| 1.1393 | B.103 | C.6 |
| 1.1394 | B.104 | C.6 |
| 1.1395 | B.105 | C.6 |
| 1.1396 | B.106 | C.6 |
| 1.1397 | B.107 | C.6 |
| 1.1398 | B.108 | C.6 |
| 1.1399 | B.109 | C.6 |
| 1.1400 | B.110 | C.6 |
| 1.1401 | B.111 | C.6 |
| 1.1402 | B.112 | C.6 |
| 1.1403 | B.113 | C.6 |
| 1.1404 | B.114 | C.6 |
| 1.1405 | B.115 | C.6 |
| 1.1406 | B.116 | C.6 |
| 1.1407 | B.117 | C.6 |
| 1.1408 | B.118 | C.6 |
| 1.1409 | B.119 | C.6 |
| 1.1410 | B.120 | C.6 |
| 1.1411 | B.121 | C.6 |
| 1.1412 | B.122 | C.6 |
| 1.1413 | B.123 | C.6 |
| 1.1414 | B.124 | C.6 |
| 1.1415 | B.125 | C.6 |
| 1.1416 | B.126 | C.6 |
| 1.1417 | B.127 | C.6 |
| 1.1418 | B.128 | C.6 |
| 1.1419 | B.129 | C.6 |
| 1.1420 | B.130 | C.6 |
| 1.1421 | B.131 | C.6 |
| 1.1422 | B.132 | C.6 |
| 1.1423 | B.133 | C.6 |
| 1.1424 | B.134 | C.6 |
| 1.1425 | B.135 | C.6 |
| 1.1426 | B.136 | C.6 |
| 1.1427 | B.137 | C.6 |
| 1.1428 | B.138 | C.6 |
| 1.1429 | B.139 | C.6 |
| 1.1430 | B.140 | C.6 |
| 1.1431 | B.141 | C.6 |
| 1.1432 | B.142 | C.6 |
| 1.1433 | B.143 | C.6 |
| 1.1434 | B.144 | C.6 |
| 1.1435 | B.145 | C.6 |
| 1.1436 | B.146 | C.6 |
| 1.1437 | B.147 | C.6 |
| 1.1438 | B.148 | C.6 |
| 1.1439 | B.149 | C.6 |
| 1.1440 | B.150 | C.6 |
| 1.1441 | B.151 | C.6 |
| 1.1442 | B.152 | C.6 |
| 1.1443 | B.153 | C.6 |
| 1.1444 | B.154 | C.6 |
| 1.1445 | B.155 | C.6 |
| 1.1446 | B.156 | C.6 |
| 1.1447 | B.157 | C.6 |
| 1.1448 | B.158 | C.6 |
| 1.1449 | B.159 | C.6 |
| 1.1450 | B.160 | C.6 |
| 1.1451 | B.161 | C.6 |
| 1.1452 | B.162 | C.6 |
| 1.1453 | B.163 | C.6 |
| 1.1454 | B.164 | C.6 |
| 1.1455 | B.165 | C.6 |
| 1.1456 | B.166 | C.6 |
| 1.1457 | B.167 | C.6 |
| 1.1458 | B.168 | C.6 |
| 1.1459 | B.169 | C.6 |
| 1.1460 | B.170 | C.6 |
| 1.1461 | B.171 | C.6 |
| 1.1462 | B.172 | C.6 |
| 1.1463 | B.173 | C.6 |
| 1.1464 | B.174 | C.6 |
| 1.1465 | B.175 | C.6 |
| 1.1466 | B.176 | C.6 |
| 1.1467 | B.177 | C.6 |
| 1.1468 | B.178 | C.6 |
| 1.1469 | B.179 | C.6 |
| 1.1470 | B.180 | C.6 |
| 1.1471 | B.181 | C.6 |
| 1.1472 | B.182 | C.6 |
| 1.1473 | B.183 | C.6 |
| 1.1474 | B.184 | C.6 |
| 1.1475 | B.185 | C.6 |
| 1.1476 | B.186 | C.6 |
| 1.1477 | B.187 | C.6 |
| 1.1478 | B.188 | C.6 |
| 1.1479 | B.189 | C.6 |
| 1.1480 | B.190 | C.6 |
| 1.1481 | B.191 | C.6 |
| 1.1482 | B.192 | C.6 |
| 1.1483 | B.193 | C.6 |
| 1.1484 | B.194 | C.6 |
| 1.1485 | B.195 | C.6 |
| 1.1486 | B.196 | C.6 |
| 1.1487 | B.197 | C.6 |
| 1.1488 | B.198 | C.6 |
| 1.1489 | B.199 | C.6 |
| 1.1490 | B.200 | C.6 |
| 1.1491 | B.201 | C.6 |
| 1.1492 | B.202 | C.6 |
| 1.1493 | B.203 | C.6 |
| 1.1494 | B.204 | C.6 |
| 1.1495 | B.205 | C.6 |
| 1.1496 | B.206 | C.6 |
| 1.1497 | B.207 | C.6 |
| 1.1498 | B.208 | C.6 |
| 1.1499 | B.209 | C.6 |
| 1.1500 | B.210 | C.6 |
| 1.1501 | B.211 | C.6 |
| 1.1502 | B.212 | C.6 |
| 1.1503 | B.213 | C.6 |
| 1.1504 | B.214 | C.6 |
| 1.1505 | B.215 | C.6 |
| 1.1506 | B.1 | C.7 |
| 1.1507 | B.2 | C.7 |
| 1.1508 | B.3 | C.7 |
| 1.1509 | B.4 | C.7 |
| 1.1510 | B.5 | C.7 |
| 1.1511 | B.6 | C.7 |
| 1.1512 | B.7 | C.7 |
| 1.1513 | B.8 | C.7 |
| 1.1514 | B.9 | C.7 |
| 1.1515 | B.10 | C.7 |
| 1.1516 | B.11 | C.7 |
| 1.1517 | B.12 | C.7 |
| 1.1518 | B.13 | C.7 |
| 1.1519 | B.14 | C.7 |
| 1.1520 | B.15 | C.7 |
| 1.1521 | B.16 | C.7 |
| 1.1522 | B.17 | C.7 |
| 1.1523 | B.18 | C.7 |
| 1.1524 | B.19 | C.7 |
| 1.1525 | B.20 | C.7 |
| 1.1526 | B.21 | C.7 |
| 1.1527 | B.22 | C.7 |
| 1.1528 | B.23 | C.7 |
| 1.1529 | B.24 | C.7 |
| 1.1530 | B.25 | C.7 |
| 1.1531 | B.26 | C.7 |
| 1.1532 | B.27 | C.7 |
| 1.1533 | B.28 | C.7 |
| 1.1534 | B.29 | C.7 |
| 1.1535 | B.30 | C.7 |
| 1.1536 | B.31 | C.7 |
| 1.1537 | B.32 | C.7 |
| 1.1538 | B.33 | C.7 |
| 1.1539 | B.34 | C.7 |
| 1.1540 | B.35 | C.7 |
| 1.1541 | B.36 | C.7 |
| 1.1542 | B.37 | C.7 |
| 1.1543 | B.38 | C.7 |
| 1.1544 | B.39 | C.7 |
| 1.1545 | B.40 | C.7 |
| 1.1546 | B.41 | C.7 |
| 1.1547 | B.42 | C.7 |
| 1.1548 | B.43 | C.7 |
| 1.1549 | B.44 | C.7 |
| 1.1550 | B.45 | C.7 |
| 1.1551 | B.46 | C.7 |
| 1.1552 | B.47 | C.7 |
| 1.1553 | B.48 | C.7 |
| 1.1554 | B.49 | C.7 |
| 1.1555 | B.50 | C.7 |
| 1.1556 | B.51 | C.7 |
| 1.1557 | B.52 | C.7 |
| 1.1558 | B.53 | C.7 |
| 1.1559 | B.54 | C.7 |
| 1.1560 | B.55 | C.7 |
| 1.1561 | B.56 | C.7 |
| 1.1562 | B.57 | C.7 |
| 1.1563 | B.58. | C.7 |
| 1.1564 | B.59 | C.7 |
| 1.1565 | B.60 | C.7 |
| 1.1566 | B.61 | C.7 |
| 1.1567 | B.62 | C.7 |
| 1.1568 | B.63 | C.7 |
| 1.1569 | B.64 | C.7 |
| 1.1570 | B.65 | C.7 |
| 1.1571 | B.66 | C.7 |
| 1.1572 | B.67 | C.7 |
| 1.1573 | B.68 | C.7 |
| 1.1574 | B.69 | C.7 |
| 1.1575 | B.70 | C.7 |
| 1.1576 | B.71 | C.7 |
| 1.1577 | B.72 | C.7 |
| 1.1578 | B.73 | C.7 |
| 1.1579 | B.74 | C.7 |
| 1.1580 | B.75 | C.7 |
| 1.1581 | B.76 | C.7 |
| 1.1582 | B.77 | C.7 |
| 1.1583 | B.78 | C.7 |
| 1.1584 | B.79 | C.7 |
| 1.1585 | B.80 | C.7 |
| 1.1586 | B.81 | C.7 |
| 1.1587 | B.82 | C.7 |
| 1.1588 | B.83 | C.7 |
| 1.1589 | B.84 | C.7 |
| 1.1590 | B.85 | C.7 |
| 1.1591 | B.86 | C.7 |
| 1.1592 | B.87 | C.7 |
| 1.1593 | B.88 | C.7 |
| 1.1594 | B.89 | C.7 |
| 1.1595 | B.90 | C.7 |
| 1.1596 | B.91 | C.7 |
| 1.1597 | B.92 | C.7 |
| 1.1598 | B.93 | C.7 |
| 1.1599 | B.94 | C.7 |
| 1.1600 | B.95 | C.7 |
| 1.1601 | B.96 | C.7 |
| 1.1602 | B.97 | C.7 |
| 1.1603 | B.98 | C.7 |
| 1.1604 | B.99 | C.7 |
| 1.1605 | B.100 | C.7 |
| 1.1606 | B.101 | C.7 |
| 1.1607 | B.102 | C.7 |
| 1.1608 | B.103 | C.7 |
| 1.1609 | B.104 | C.7 |
| 1.1610 | B.105 | C.7 |
| 1.1611 | B.106 | C.7 |
| 1.1612 | B.107 | C.7 |
| 1.1613 | B.108 | C.7 |
| 1.1614 | B.109 | C.7 |
| 1.1615 | B.110 | C.7 |
| 1.1616 | B.111 | C.7 |
| 1.1617 | B.112 | C.7 |
| 1.1618 | B.113 | C.7 |
| 1.1619 | B.114 | C.7 |
| 1.1620 | B.115 | C.7 |
| 1.1621 | B.116 | C.7 |
| 1.1622 | B.117 | C.7 |
| 1.1623 | B.118 | C.7 |
| 1.1624 | B.119 | C.7 |
| 1.1625 | B.120 | C.7 |
| 1.1626 | B.121 | C.7 |
| 1.1627 | B.122 | C.7 |
| 1.1628 | B.123 | C.7 |
| 1.1629 | B.124 | C.7 |
| 1.1630 | B.125 | C.7 |
| 1.1631 | B.126 | C.7 |
| 1.1632 | B.127 | C.7 |
| 1.1633 | B.128 | C.7 |
| 1.1634 | B.129 | C.7 |
| 1.1635 | B.130 | C.7 |
| 1.1636 | B.131 | C.7 |
| 1.1637 | B.132 | C.7 |
| 1.1638 | B.133 | C.7 |
| 1.1639 | B.134 | C.7 |
| 1.1640 | B.135 | C.7 |
| 1.1641 | B.136 | C.7 |
| 1.1642 | B.137 | C.7 |
| 1.1643 | B.138 | C.7 |
| 1.1644 | B.139 | C.7 |
| 1.1645 | B.140 | C.7 |
| 1.1646 | B.141 | C.7 |
| 1.1647 | B.142 | C.7 |
| 1.1648 | B.143 | C.7 |
| 1.1649 | B.144 | C.7 |
| 1.1650 | B.145 | C.7 |
| 1.1651 | B.146 | C.7 |
| 1.1652 | B.147 | C.7 |
| 1.1653 | B.148 | C.7 |
| 1.1654 | B.149 | C.7 |
| 1.1655 | B.150 | C.7 |
| 1.1656 | B.151 | C.7 |
| 1.1657 | B.152 | C.7 |
| 1.1658 | B.153 | C.7 |
| 1.1659 | B.154 | C.7 |
| 1.1660 | B.155 | C.7 |
| 1.1661 | B.156 | C.7 |
| 1.1662 | B.157 | C.7 |
| 1.1663 | B.158 | C.7 |
| 1.1664 | B.159 | C.7 |
| 1.1665 | B.160 | C.7 |
| 1.1666 | B.161 | C.7 |
| 1.1667 | B.162 | C.7 |
| 1.1668 | B.163 | C.7 |
| 1.1669 | B.164 | C.7 |
| 1.1670 | B.165 | C.7 |
| 1.1671 | B.166 | C.7 |
| 1.1672 | B.167 | C.7 |
| 1.1673 | B.168 | C.7 |
| 1.1674 | B.169 | C.7 |
| 1.1675 | B.170 | C.7 |
| 1.1676 | B.171 | C.7 |
| 1.1677 | B.172 | C.7 |
| 1.1678 | B.173 | C.7 |
| 1.1679 | B.174 | C.7 |
| 1.1680 | B.175 | C.7 |
| 1.1681 | B.176 | C.7 |
| 1.1682 | B.177 | C.7 |
| 1.1683 | B.178 | C.7 |
| 1.1684 | B.179 | C.7 |
| 1.1685 | B.180 | C.7 |
| 1.1686 | B.181 | C.7 |
| 1.1687 | B.182 | C.7 |
| 1.1688 | B.183 | C.7 |
| 1.1689 | B.184 | C.7 |
| 1.1690 | B.185 | C.7 |
| 1.1691 | B.186 | C.7 |
| 1.1692 | B.187 | C.7 |
| 1.1693 | B.188 | C.7 |
| 1.1694 | B.189 | C.7 |
| 1.1695 | B.190 | C.7 |
| 1.1696 | B.191 | C.7 |
| 1.1697 | B.192 | C.7 |
| 1.1698 | B.193 | C.7 |
| 1.1699 | B.194 | C.7 |
| 1.1700 | B.195 | C.7 |
| 1.1701 | B.196 | C.7 |
| 1.1702 | B.197 | C.7 |
| 1.1703 | B.198 | C.7 |
| 1.1704 | B.199 | C.7 |
| 1.1705 | B.200 | C.7 |
| 1.1706 | B.201 | C.7 |
| 1.1707 | B.202 | C.7 |
| 1.1708 | B.203 | C.7 |
| 1.1709 | B.204 | C.7 |
| 1.1710 | B.205 | C.7 |
| 1.1711 | B.206 | C.7 |
| 1.1712 | B.207 | C.7 |
| 1.1713 | B.208 | C.7 |
| 1.1714 | B.209 | C.7 |
| 1.1715 | B.210 | C.7 |
| 1.1716 | B.211 | C.7 |
| 1.1717 | B.212 | C.7 |
| 1.1718 | B.213 | C.7 |
| 1.1719 | B.214 | C.7 |
| 1.1720 | B.215 | C.7 |
| 1.1721 | B.1 | C.8 |
| 1.1722 | B.2 | C.8 |
| 1.1723 | B.3 | C.8 |
| 1.1724 | B.4 | C.8 |
| 1.1725 | B.5 | C.8 |
| 1.1726 | B.6 | C.8 |
| 1.1727 | B.7 | C.8 |
| 1.1728 | B.8 | C.8 |
| 1.1729 | B.9 | C.8 |
| 1.1730 | B.10 | C.8 |
| 1.1731 | B.11 | C.8 |
| 1.1732 | B.12 | C.8 |
| 1.1733 | B.13 | C.8 |
| 1.1734 | B.14 | C.8 |
| 1.1735 | B.15 | C.8 |
| 1.1736 | B.16 | C.8 |
| 1.1737 | B.17 | C.8 |
| 1.1738 | B.18 | C.8 |
| 1.1739 | B.19 | C.8 |
| 1.1740 | B.20 | C.8 |
| 1.1741 | B.21 | C.8 |
| 1.1742 | B.22 | C.8 |
| 1.1743 | B.23 | C.8 |
| 1.1744 | B.24 | C.8 |
| 1.1745 | B.25 | C.8 |
| 1.1746 | B.26 | C.8 |
| 1.1747 | B.27 | C.8 |
| 1.1748 | B.28 | C.8 |
| 1.1749 | B.29 | C.8 |
| 1.1750 | B.30 | C.8 |
| 1.1751 | B.31 | C.8 |
| 1.1752 | B.32 | C.8 |
| 1.1753 | B.33 | C.8 |
| 1.1754 | B.34 | C.8 |
| 1.1755 | B.35 | C.8 |
| 1.1756 | B.36 | C.8 |
| 1.1757 | B.37 | C.8 |
| 1.1758 | B.38 | C.8 |
| 1.1759 | B.39 | C.8 |
| 1.1760 | B.40 | C.8 |
| 1.1761 | B.41 | C.8 |
| 1.1762 | B.42 | C.8 |
| 1.1763 | B.43 | C.8 |
| 1.1764 | B.44 | C.8 |
| 1.1765 | B.45 | C.8 |
| 1.1766 | B.46 | C.8 |
| 1.1767 | B.47 | C.8 |
| 1.1768 | B.48 | C.8 |
| 1.1769 | B.49 | C.8 |
| 1.1770 | B.50 | C.8 |
| 1.1771 | B.51 | C.8 |
| 1.1772 | B.52 | C.8 |
| 1.1773 | B.53 | C.8 |
| 1.1774 | B.54 | C.8 |
| 1.1775 | B.55 | C.8 |
| 1.1776 | B.56 | C.8 |
| 1.1777 | B.57 | C.8 |
| 1.1778 | B.58. | C.8 |
| 1.1779 | B.59 | C.8 |
| 1.1780 | B.60 | C.8 |
| 1.1781 | B.61 | C.8 |
| 1.1782 | B.62 | C.8 |
| 1.1783 | B.63 | C.8 |
| 1.1784 | B.64 | C.8 |
| 1.1785 | B.65 | C.8 |
| 1.1786 | B.66 | C.8 |
| 1.1787 | B.67 | C.8 |
| 1.1788 | B.68 | C.8 |
| 1.1789 | B.69 | C.8 |
| 1.1790 | B.70 | C.8 |
| 1.1791 | B.71 | C.8 |
| 1.1792 | B.72 | C.8 |
| 1.1793 | B.73 | C.8 |
| 1.1794 | B.74 | C.8 |
| 1.1795 | B.75 | C.8 |
| 1.1796 | B.76 | C.8 |
| 1.1797 | B.77 | C.8 |
| 1.1798 | B.78 | C.8 |
| 1.1799 | B.79 | C.8 |
| 1.1800 | B.80 | C.8 |
| 1.1801 | B.81 | C.8 |
| 1.1802 | B.82 | C.8 |
| 1.1803 | B.83 | C.8 |
| 1.1804 | B.84 | C.8 |
| 1.1805 | B.85 | C.8 |
| 1.1806 | B.86 | C.8 |
| 1.1807 | B.87 | C.8 |
| 1.1808 | B.88 | C.8 |
| 1.1809 | B.89 | C.8 |
| 1.1810 | B.90 | C.8 |
| 1.1811 | B.91 | C.8 |
| 1.1812 | B.92 | C.8 |
| 1.1813 | B.93 | C.8 |
| 1.1814 | B.94 | C.8 |
| 1.1815 | B.95 | C.8 |
| 1.1816 | B.96 | C.8 |
| 1.1817 | B.97 | C.8 |
| 1.1818 | B.98 | C.8 |
| 1.1819 | B.99 | C.8 |
| 1.1820 | B.100 | C.8 |
| 1.1821 | B.101 | C.8 |
| 1.1822 | B.102 | C.8 |
| 1.1823 | B.103 | C.8 |
| 1.1824 | B.104 | C.8 |
| 1.1825 | B.105 | C.8 |
| 1.1826 | B.106 | C.8 |
| 1.1827 | B.107 | C.8 |
| 1.1828 | B.108 | C.8 |
| 1.1829 | B.109 | C.8 |
| 1.1830 | B.110 | C.8 |
| 1.1831 | B.111 | C.8 |
| 1.1832 | B.112 | C.8 |
| 1.1833 | B.113 | C.8 |
| 1.1834 | B.114 | C.8 |
| 1.1835 | B.115 | C.8 |
| 1.1836 | B.116 | C.8 |
| 1.1837 | B.117 | C.8 |
| 1.1838 | B.118 | C.8 |
| 1.1839 | B.119 | C.8 |
| 1.1840 | B.120 | C.8 |
| 1.1841 | B.121 | C.8 |
| 1.1842 | B.122 | C.8 |
| 1.1843 | B.123 | C.8 |
| 1.1844 | B.124 | C.8 |
| 1.1845 | B.125 | C.8 |
| 1.1846 | B.126 | C.8 |
| 1.1847 | B.127 | C.8 |
| 1.1848 | B.128 | C.8 |
| 1.1849 | B.129 | C.8 |
| 1.1850 | B.130 | C.8 |
| 1.1851 | B.131 | C.8 |
| 1.1852 | B.132 | C.8 |
| 1.1853 | B.133 | C.8 |
| 1.1854 | B.134 | C.8 |
| 1.1855 | B.135 | C.8 |
| 1.1856 | B.136 | C.8 |
| 1.1857 | B.137 | C.8 |
| 1.1858 | B.138 | C.8 |
| 1.1859 | B.139 | C.8 |
| 1.1860 | B.140 | C.8 |
| 1.1861 | B.141 | C.8 |
| 1.1862 | B.142 | C.8 |
| 1.1863 | B.143 | C.8 |
| 1.1864 | B.144 | C.8 |
| 1.1865 | B.145 | C.8 |
| 1.1866 | B.146 | C.8 |
| 1.1867 | B.147 | C.8 |
| 1.1868 | B.148 | C.8 |
| 1.1869 | B.149 | C.8 |
| 1.1870 | B.150 | C.8 |
| 1.1871 | B.151 | C.8 |
| 1.1872 | B.152 | C.8 |
| 1.1873 | B.153 | C.8 |
| 1.1874 | B.154 | C.8 |
| 1.1875 | B.155 | C.8 |
| 1.1876 | B.156 | C.8 |
| 1.1877 | B.157 | C.8 |
| 1.1878 | B.158 | C.8 |
| 1.1879 | B.159 | C.8 |
| 1.1880 | B.160 | C.8 |
| 1.1881 | B.161 | C.8 |
| 1.1882 | B.162 | C.8 |
| 1.1883 | B.163 | C.8 |
| 1.1884 | B.164 | C.8 |
| 1.1885 | B.165 | C.8 |
| 1.1886 | B.166 | C.8 |
| 1.1887 | B.167 | C.8 |
| 1.1888 | B.168 | C.8 |
| 1.1889 | B.169 | C.8 |
| 1.1890 | B.170 | C.8 |
| 1.1891 | B.171 | C.8 |
| 1.1892 | B.172 | C.8 |
| 1.1893 | B.173 | C.8 |
| 1.1894 | B.174 | C.8 |
| 1.1895 | B.175 | C.8 |
| 1.1896 | B.176 | C.8 |
| 1.1897 | B.177 | C.8 |
| 1.1898 | B.178 | C.8 |
| 1.1899 | B.179 | C.8 |
| 1.1900 | B.180 | C.8 |
| 1.1901 | B.181 | C.8 |
| 1.1902 | B.182 | C.8 |
| 1.1903 | B.183 | C.8 |
| 1.1904 | B.184 | C.8 |
| 1.1905 | B.185 | C.8 |
| 1.1906 | B.186 | C.8 |
| 1.1907 | B.187 | C.8 |
| 1.1908 | B.188 | C.8 |
| 1.1909 | B.189 | C.8 |
| 1.1910 | B.190 | C.8 |
| 1.1911 | B.191 | C.8 |
| 1.1912 | B.192 | C.8 |
| 1.1913 | B.193 | C.8 |
| 1.1914 | B.194 | C.8 |
| 1.1915 | B.195 | C.8 |
| 1.1916 | B.196 | C.8 |
| 1.1917 | B.197 | C.8 |
| 1.1918 | B.198 | C.8 |
| 1.1919 | B.199 | C.8 |
| 1.1920 | B.200 | C.8 |
| 1.1921 | B.201 | C.8 |
| 1.1922 | B.202 | C.8 |
| 1.1923 | B.203 | C.8 |
| 1.1924 | B.204 | C.8 |
| 1.1925 | B.205 | C.8 |
| 1.1926 | B.206 | C.8 |
| 1.1927 | B.207 | C.8 |
| 1.1928 | B.208 | C.8 |
| 1.1929 | B.209 | C.8 |
| 1.1930 | B.210 | C.8 |
| 1.1931 | B.211 | C.8 |
| 1.1932 | B.212 | C.8 |
| 1.1933 | B.213 | C.8 |
| 1.1934 | B.214 | C.8 |
| 1.1935 | B.215 | C.8 |
| 1.1936 | B.1 | C.9 |
| 1.1937 | B.2 | C.9 |
| 1.1938 | B.3 | C.9 |
| 1.1939 | B.4 | C.9 |
| 1.1940 | B.5 | C.9 |
| 1.1941 | B.6 | C.9 |
| 1.1942 | B.7 | C.9 |
| 1.1943 | B.8 | C.9 |
| 1.1944 | B.9 | C.9 |
| 1.1945 | B.10 | C.9 |
| 1.1946 | B.11 | C.9 |
| 1.1947 | B.12 | C.9 |
| 1.1948 | B.13 | C.9 |
| 1.1949 | B.14 | C.9 |
| 1.1950 | B.15 | C.9 |
| 1.1951 | B.16 | C.9 |
| 1.1952 | B.17 | C.9 |
| 1.1953 | B.18 | C.9 |
| 1.1954 | B.19 | C.9 |
| 1.1955 | B.20 | C.9 |
| 1.1956 | B.21 | C.9 |
| 1.1957 | B.22 | C.9 |
| 1.1958 | B.23 | C.9 |
| 1.1959 | B.24 | C.9 |
| 1.1960 | B.25 | C.9 |
| 1.1961 | B.26 | C.9 |
| 1.1962 | B.27 | C.9 |
| 1.1963 | B.28 | C.9 |
| 1.1964 | B.29 | C.9 |
| 1.1965 | B.30 | C.9 |
| 1.1966 | B.31 | C.9 |
| 1.1967 | B.32 | C.9 |
| 1.1968 | B.33 | C.9 |
| 1.1969 | B.34 | C.9 |
| 1.1970 | B.35 | C.9 |
| 1.1971 | B.36 | C.9 |
| 1.1972 | B.37 | C.9 |
| 1.1973 | B.38 | C.9 |
| 1.1974 | B.39 | C.9 |
| 1.1975 | B.40 | C.9 |
| 1.1976 | B.41 | C.9 |
| 1.1977 | B.42 | C.9 |
| 1.1978 | B.43 | C.9 |
| 1.1979 | B.44 | C.9 |
| 1.1980 | B.45 | C.9 |
| 1.1981 | B.46 | C.9 |
| 1.1982 | B.47 | C.9 |
| 1.1983 | B.48 | C.9 |
| 1.1984 | B.49 | C.9 |
| 1.1985 | B.50 | C.9 |
| 1.1986 | B.51 | C.9 |
| 1.1987 | B.52 | C.9 |
| 1.1988 | B.53 | C.9 |
| 1.1989 | B.54 | C.9 |
| 1.1990 | B.55 | C.9 |
| 1.1991 | B.56 | C.9 |
| 1.1992 | B.57 | C.9 |
| 1.1993 | B.58. | C.9 |
| 1.1994 | B.59 | C.9 |
| 1.1995 | B.60 | C.9 |
| 1.1996 | B.61 | C.9 |
| 1.1997 | B.62 | C.9 |
| 1.1998 | B.63 | C.9 |
| 1.1999 | B.64 | C.9 |
| 1.2000 | B.65 | C.9 |
| 1.2001 | B.66 | C.9 |
| 1.2002 | B.67 | C.9 |
| 1.2003 | B.68 | C.9 |
| 1.2004 | B.69 | C.9 |
| 1.2005 | B.70 | C.9 |
| 1.2006 | B.71 | C.9 |
| 1.2007 | B.72 | C.9 |
| 1.2008 | B.73 | C.9 |
| 1.2009 | B.74 | C.9 |
| 1.2010 | B.75 | C.9 |
| 1.2011 | B.76 | C.9 |
| 1.2012 | B.77 | C.9 |
| 1.2013 | B.78 | C.9 |
| 1.2014 | B.79 | C.9 |
| 1.2015 | B.80 | C.9 |
| 1.2016 | B.81 | C.9 |
| 1.2017 | B.82 | C.9 |
| 1.2018 | B.83 | C.9 |
| 1.2019 | B.84 | C.9 |
| 1.2020 | B.85 | C.9 |
| 1.2021 | B.86 | C.9 |
| 1.2022 | B.87 | C.9 |
| 1.2023 | B.88 | C.9 |
| 1.2024 | B.89 | C.9 |
| 1.2025 | B.90 | C.9 |
| 1.2026 | B.91 | C.9 |
| 1.2027 | B.92 | C.9 |
| 1.2028 | B.93 | C.9 |
| 1.2029 | B.94 | C.9 |
| 1.2030 | B.95 | C.9 |
| 1.2031 | B.96 | C.9 |
| 1.2032 | B.97 | C.9 |
| 1.2033 | B.98 | C.9 |
| 1.2034 | B.99 | C.9 |
| 1.2035 | B.100 | C.9 |
| 1.2036 | B.101 | C.9 |
| 1.2037 | B.102 | C.9 |
| 1.2038 | B.103 | C.9 |
| 1.2039 | B.104 | C.9 |
| 1.2040 | B.105 | C.9 |
| 1.2041 | B.106 | C.9 |
| 1.2042 | B.107 | C.9 |
| 1.2043 | B.108 | C.9 |
| 1.2044 | B.109 | C.9 |
| 1.2045 | B.110 | C.9 |
| 1.2046 | B.111 | C.9 |
| 1.2047 | B.112 | C.9 |
| 1.2048 | B.113 | C.9 |
| 1.2049 | B.114 | C.9 |
| 1.2050 | B.115 | C.9 |
| 1.2051 | B.116 | C.9 |
| 1.2052 | B.117 | C.9 |
| 1.2053 | B.118 | C.9 |
| 1.2054 | B.119 | C.9 |
| 1.2055 | B.120 | C.9 |
| 1.2056 | B.121 | C.9 |
| 1.2057 | B.122 | C.9 |
| 1.2058 | B.123 | C.9 |
| 1.2059 | B.124 | C.9 |
| 1.2060 | B.125 | C.9 |
| 1.2061 | B.126 | C.9 |
| 1.2062 | B.127 | C.9 |
| 1.2063 | B.128 | C.9 |
| 1.2064 | B.129 | C.9 |
| 1.2065 | B.130 | C.9 |
| 1.2066 | B.131 | C.9 |
| 1.2067 | B.132 | C.9 |
| 1.2068 | B.133 | C.9 |
| 1.2069 | B.134 | C.9 |
| 1.2070 | B.135 | C.9 |
| 1.2071 | B.136 | C.9 |
| 1.2072 | B.137 | C.9 |
| 1.2073 | B.138 | C.9 |
| 1.2074 | B.139 | C.9 |
| 1.2075 | B.140 | C.9 |
| 1.2076 | B.141 | C.9 |
| 1.2077 | B.142 | C.9 |
| 1.2078 | B.143 | C.9 |
| 1.2079 | B.144 | C.9 |
| 1.2080 | B.145 | C.9 |
| 1.2081 | B.146 | C.9 |
| 1.2082 | B.147 | C.9 |
| 1.2083 | B.148 | C.9 |
| 1.2084 | B.149 | C.9 |
| 1.2085 | B.150 | C.9 |
| 1.2086 | B.151 | C.9 |
| 1.2087 | B.152 | C.9 |
| 1.2088 | B.153 | C.9 |
| 1.2089 | B.154 | C.9 |
| 1.2090 | B.155 | C.9 |
| 1.2091 | B.156 | C.9 |
| 1.2092 | B.157 | C.9 |
| 1.2093 | B.158 | C.9 |
| 1.2094 | B.159 | C.9 |
| 1.2095 | B.160 | C.9 |
| 1.2096 | B.161 | C.9 |
| 1.2097 | B.162 | C.9 |
| 1.2098 | B.163 | C.9 |
| 1.2099 | B.164 | C.9 |
| 1.2100 | B.165 | C.9 |
| 1.2101 | B.166 | C.9 |
| 1.2102 | B.167 | C.9 |
| 1.2103 | B.168 | C.9 |
| 1.2104 | B.169 | C.9 |
| 1.2105 | B.170 | C.9 |
| 1.2106 | B.171 | C.9 |
| 1.2107 | B.172 | C.9 |
| 1.2108 | B.173 | C.9 |
| 1.2109 | B.174 | C.9 |
| 1.2110 | B.175 | C.9 |
| 1.2111 | B.176 | C.9 |
| 1.2112 | B.177 | C.9 |
| 1.2113 | B.178 | C.9 |
| 1.2114 | B.179 | C.9 |
| 1.2115 | B.180 | C.9 |
| 1.2116 | B.181 | C.9 |
| 1.2117 | B.182 | C.9 |
| 1.2118 | B.183 | C.9 |
| 1.2119 | B.184 | C.9 |
| 1.2120 | B.185 | C.9 |
| 1.2121 | B.186 | C.9 |
| 1.2122 | B.187 | C.9 |
| 1.2123 | B.188 | C.9 |
| 1.2124 | B.189 | C.9 |
| 1.2125 | B.190 | C.9 |
| 1.2126 | B.191 | C.9 |
| 1.2127 | B.192 | C.9 |
| 1.2128 | B.193 | C.9 |
| 1.2129 | B.194 | C.9 |
| 1.2130 | B.195 | C.9 |
| 1.2131 | B.196 | C.9 |
| 1.2132 | B.197 | C.9 |
| 1.2133 | B.198 | C.9 |
| 1.2134 | B.199 | C.9 |
| 1.2135 | B.200 | C.9 |
| 1.2136 | B.201 | C.9 |
| 1.2137 | B.202 | C.9 |
| 1.2138 | B.203 | C.9 |
| 1.2139 | B.204 | C.9 |
| 1.2140 | B.205 | C.9 |
| 1.2141 | B.206 | C.9 |
| 1.2142 | B.207 | C.9 |
| 1.2143 | B.208 | C.9 |
| 1.2144 | B.209 | C.9 |
| 1.2145 | B.210 | C.9 |
| 1.2146 | B.211 | C.9 |
| 1.2147 | B.212 | C.9 |
| 1.2148 | B.213 | C.9 |
| 1.2149 | B.214 | C.9 |
| 1.2150 | B.215 | C.9 |
| 1.2151 | B.1 | C.10 |
| 1.2152 | B.2 | C.10 |
| 1.2153 | B.3 | C.10 |
| 1.2154 | B.4 | C.10 |
| 1.2155 | B.5 | C.10 |
| 1.2156 | B.6 | C.10 |
| 1.2157 | B.7 | C.10 |
| 1.2158 | B.8 | C.10 |
| 1.2159 | B.9 | C.10 |
| 1.2160 | B.10 | C.10 |
| 1.2161 | B.11 | C.10 |
| 1.2162 | B.12 | C.10 |
| 1.2163 | B.13 | C.10 |
| 1.2164 | B.14 | C.10 |
| 1.2165 | B.15 | C.10 |
| 1.2166 | B.16 | C.10 |
| 1.2167 | B.17 | C.10 |
| 1.2168 | B.18 | C.10 |
| 1.2169 | B.19 | C.10 |
| 1.2170 | B.20 | C.10 |
| 1.2171 | B.21 | C.10 |
| 1.2172 | B.22 | C.10 |
| 1.2173 | B.23 | C.10 |
| 1.2174 | B.24 | C.10 |
| 1.2175 | B.25 | C.10 |
| 1.2176 | B.26 | C.10 |
| 1.2177 | B.27 | C.10 |
| 1.2178 | B.28 | C.10 |
| 1.2179 | B.29 | C.10 |
| 1.2180 | B.30 | C.10 |
| 1.2181 | B.31 | C.10 |
| 1.2182 | B.32 | C.10 |
| 1.2183 | B.33 | C.10 |
| 1.2184 | B.34 | C.10 |
| 1.2185 | B.35 | C.10 |
| 1.2186 | B.36 | C.10 |
| 1.2187 | B.37 | C.10 |
| 1.2188 | B.38 | C.10 |
| 1.2189 | B.39 | C.10 |
| 1.2190 | B.40 | C.10 |
| 1.2191 | B.41 | C.10 |
| 1.2192 | B.42 | C.10 |
| 1.2193 | B.43 | C.10 |
| 1.2194 | B.44 | C.10 |
| 1.2195 | B.45 | C.10 |
| 1.2196 | B.46 | C.10 |
| 1.2197 | B.47 | C.10 |
| 1.2198 | B.48 | C.10 |
| 1.2199 | B.49 | C.10 |
| 1.2200 | B.50 | C.10 |
| 1.2201 | B.51 | C.10 |
| 1.2202 | B.52 | C.10 |
| 1.2203 | B.53 | C.10 |
| 1.2204 | B.54 | C.10 |
| 1.2205 | B.55 | C.10 |
| 1.2206 | B.56 | C.10 |
| 1.2207 | B.57 | C.10 |
| 1.2208 | B.58. | C.10 |
| 1.2209 | B.59 | C.10 |
| 1.2210 | B.60 | C.10 |
| 1.2211 | B.61 | C.10 |
| 1.2212 | B.62 | C.10 |
| 1.2213 | B.63 | C.10 |
| 1.2214 | B.64 | C.10 |
| 1.2215 | B.65 | C.10 |
| 1.2216 | B.66 | C.10 |
| 1.2217 | B.67 | C.10 |
| 1.2218 | B.68 | C.10 |
| 1.2219 | B.69 | C.10 |
| 1.2220 | B.70 | C.10 |
| 1.2221 | B.71 | C.10 |
| 1.2222 | B.72 | C.10 |
| 1.2223 | B.73 | C.10 |
| 1.2224 | B.74 | C.10 |
| 1.2225 | B.75 | C.10 |
| 1.2226 | B.76 | C.10 |
| 1.2227 | B.77 | C.10 |
| 1.2228 | B.78 | C.10 |
| 1.2229 | B.79 | C.10 |
| 1.2230 | B.80 | C.10 |
| 1.2231 | B.81 | C.10 |
| 1.2232 | B.82 | C.10 |
| 1.2233 | B.83 | C.10 |
| 1.2234 | B.84 | C.10 |
| 1.2235 | B.85 | C.10 |
| 1.2236 | B.86 | C.10 |
| 1.2237 | B.87 | C.10 |
| 1.2238 | B.88 | C.10 |
| 1.2239 | B.89 | C.10 |
| 1.2240 | B.90 | C.10 |
| 1.2241 | B.91 | C.10 |
| 1.2242 | B.92 | C.10 |
| 1.2243 | B.93 | C.10 |
| 1.2244 | B.94 | C.10 |
| 1.2245 | B.95 | C.10 |
| 1.2246 | B.96 | C.10 |
| 1.2247 | B.97 | C.10 |
| 1.2248 | B.98 | C.10 |
| 1.2249 | B.99 | C.10 |
| 1.2250 | B.100 | C.10 |
| 1.2251 | B.101 | C.10 |
| 1.2252 | B.102 | C.10 |
| 1.2253 | B.103 | C.10 |
| 1.2254 | B.104 | C.10 |
| 1.2255 | B.105 | C.10 |
| 1.2256 | B.106 | C.10 |
| 1.2257 | B.107 | C.10 |
| 1.2258 | B.108 | C.10 |
| 1.2259 | B.109 | C.10 |
| 1.2260 | B.110 | C.10 |
| 1.2261 | B.111 | C.10 |
| 1.2262 | B.112 | C.10 |
| 1.2263 | B.113 | C.10 |
| 1.2264 | B.114 | C.10 |
| 1.2265 | B.115 | C.10 |
| 1.2266 | B.116 | C.10 |
| 1.2267 | B.117 | C.10 |
| 1.2268 | B.118 | C.10 |
| 1.2269 | B.119 | C.10 |
| 1.2270 | B.120 | C.10 |
| 1.2271 | B.121 | C.10 |
| 1.2272 | B.122 | C.10 |
| 1.2273 | B.123 | C.10 |
| 1.2274 | B.124 | C.10 |
| 1.2275 | B.125 | C.10 |
| 1.2276 | B.126 | C.10 |
| 1.2277 | B.127 | C.10 |
| 1.2278 | B.128 | C.10 |
| 1.2279 | B.129 | C.10 |
| 1.2280 | B.130 | C.10 |
| 1.2281 | B.131 | C.10 |
| 1.2282 | B.132 | C.10 |
| 1.2283 | B.133 | C.10 |
| 1.2284 | B.134 | C.10 |
| 1.2285 | B.135 | C.10 |
| 1.2286 | B.136 | C.10 |
| 1.2287 | B.137 | C.10 |
| 1.2288 | B.138 | C.10 |
| 1.2289 | B.139 | C.10 |
| 1.2290 | B.140 | C.10 |
| 1.2291 | B.141 | C.10 |
| 1.2292 | B.142 | C.10 |
| 1.2293 | B.143 | C.10 |
| 1.2294 | B.144 | C.10 |
| 1.2295 | B.145 | C.10 |
| 1.2296 | B.146 | C.10 |
| 1.2297 | B.147 | C.10 |
| 1.2298 | B.148 | C.10 |
| 1.2299 | B.149 | C.10 |
| 1.2300 | B.150 | C.10 |
| 1.2301 | B.151 | C.10 |
| 1.2302 | B.152 | C.10 |
| 1.2303 | B.153 | C.10 |
| 1.2304 | B.154 | C.10 |
| 1.2305 | B.155 | C.10 |
| 1.2306 | B.156 | C.10 |
| 1.2307 | B.157 | C.10 |
| 1.2308 | B.158 | C.10 |
| 1.2309 | B.159 | C.10 |
| 1.2310 | B.160 | C.10 |
| 1.2311 | B.161 | C.10 |
| 1.2312 | B.162 | C.10 |
| 1.2313 | B.163 | C.10 |
| 1.2314 | B.164 | C.10 |
| 1.2315 | B.165 | C.10 |
| 1.2316 | B.166 | C.10 |
| 1.2317 | B.167 | C.10 |
| 1.2318 | B.168 | C.10 |
| 1.2319 | B.169 | C.10 |
| 1.2320 | B.170 | C.10 |
| 1.2321 | B.171 | C.10 |
| 1.2322 | B.172 | C.10 |
| 1.2323 | B.173 | C.10 |
| 1.2324 | B.174 | C.10 |
| 1.2325 | B.175 | C.10 |
| 1.2326 | B.176 | C.10 |
| 1.2327 | B.177 | C.10 |
| 1.2328 | B.178 | C.10 |
| 1.2329 | B.179 | C.10 |
| 1.2330 | B.180 | C.10 |
| 1.2331 | B.181 | C.10 |
| 1.2332 | B.182 | C.10 |
| 1.2333 | B.183 | C.10 |
| 1.2334 | B.184 | C.10 |
| 1.2335 | B.185 | C.10 |
| 1.2336 | B.186 | C.10 |
| 1.2337 | B.187 | C.10 |
| 1.2338 | B.188 | C.10 |
| 1.2339 | B.189 | C.10 |
| 1.2340 | B.190 | C.10 |
| 1.2341 | B.191 | C.10 |
| 1.2342 | B.192 | C.10 |
| 1.2343 | B.193 | C.10 |
| 1.2344 | B.194 | C.10 |
| 1.2345 | B.195 | C.10 |
| 1.2346 | B.196 | C.10 |
| 1.2347 | B.197 | C.10 |
| 1.2348 | B.198 | C.10 |
| 1.2349 | B.199 | C.10 |
| 1.2350 | B.200 | C.10 |
| 1.2351 | B.201 | C.10 |
| 1.2352 | B.202 | C.10 |
| 1.2353 | B.203 | C.10 |
| 1.2354 | B.204 | C.10 |
| 1.2355 | B.205 | C.10 |
| 1.2356 | B.206 | C.10 |
| 1.2357 | B.207 | C.10 |
| 1.2358 | B.208 | C.10 |
| 1.2359 | B.209 | C.10 |
| 1.2360 | B.210 | C.10 |
| 1.2361 | B.211 | C.10 |
| 1.2362 | B.212 | C.10 |
| 1.2363 | B.213 | C.10 |
| 1.2364 | B.214 | C.10 |
| 1.2365 | B.215 | C.10 |
| 1.2366 | B.1 | C.11 |
| 1.2367 | B.2 | C.11 |
| 1.2368 | B.3 | C.11 |
| 1.2369 | B.4 | C.11 |
| 1.2370 | B.5 | C.11 |
| 1.2371 | B.6 | C.11 |
| 1.2372 | B.7 | C.11 |
| 1.2373 | B.8 | C.11 |
| 1.2374 | B.9 | C.11 |
| 1.2375 | B.10 | C.11 |
| 1.2376 | B.11 | C.11 |
| 1.2377 | B.12 | C.11 |
| 1.2378 | B.13 | C.11 |
| 1.2379 | B.14 | C.11 |
| 1.2380 | B.15 | C.11 |
| 1.2381 | B.16 | C.11 |
| 1.2382 | B.17 | C.11 |
| 1.2383 | B.18 | C.11 |
| 1.2384 | B.19 | C.11 |
| 1.2385 | B.20 | C.11 |
| 1.2386 | B.21 | C.11 |
| 1.2387 | B.22 | C.11 |
| 1.2388 | B.23 | C.11 |
| 1.2389 | B.24 | C.11 |
| 1.2390 | B.25 | C.11 |
| 1.2391 | B.26 | C.11 |
| 1.2392 | B.27 | C.11 |
| 1.2393 | B.28 | C.11 |
| 1.2394 | B.29 | C.11 |
| 1.2395 | B.30 | C.11 |
| 1.2396 | B.31 | C.11 |
| 1.2397 | B.32 | C.11 |
| 1.2398 | B.33 | C.11 |
| 1.2399 | B.34 | C.11 |
| 1.2400 | B.35 | C.11 |
| 1.2401 | B.36 | C.11 |
| 1.2402 | B.37 | C.11 |
| 1.2403 | B.38 | C.11 |
| 1.2404 | B.39 | C.11 |
| 1.2405 | B.40 | C.11 |
| 1.2406 | B.41 | C.11 |
| 1.2407 | B.42 | C.11 |
| 1.2408 | B.43 | C.11 |
| 1.2409 | B.44 | C.11 |
| 1.2410 | B.45 | C.11 |
| 1.2411 | B.46 | C.11 |
| 1.2412 | B.47 | C.11 |
| 1.2413 | B.48 | C.11 |
| 1.2414 | B.49 | C.11 |
| 1.2415 | B.50 | C.11 |
| 1.2416 | B.51 | C.11 |
| 1.2417 | B.52 | C.11 |
| 1.2418 | B.53 | C.11 |
| 1.2419 | B.54 | C.11 |
| 1.2420 | B.55 | C.11 |
| 1.2421 | B.56 | C.11 |
| 1.2422 | B.57 | C.11 |
| 1.2423 | B.58. | C.11 |
| 1.2424 | B.59 | C.11 |
| 1.2425 | B.60 | C.11 |
| 1.2426 | B.61 | C.11 |
| 1.2427 | B.62 | C.11 |
| 1.2428 | B.63 | C.11 |
| 1.2429 | B.64 | C.11 |
| 1.2430 | B.65 | C.11 |
| 1.2431 | B.66 | C.11 |
| 1.2432 | B.67 | C.11 |
| 1.2433 | B.68 | C.11 |
| 1.2434 | B.69 | C.11 |
| 1.2435 | B.70 | C.11 |
| 1.2436 | B.71 | C.11 |
| 1.2437 | B.72 | C.11 |
| 1.2438 | B.73 | C.11 |
| 1.2439 | B.74 | C.11 |
| 1.2440 | B.75 | C.11 |
| 1.2441 | B.76 | C.11 |
| 1.2442 | B.77 | C.11 |
| 1.2443 | B.78 | C.11 |
| 1.2444 | B.79 | C.11 |
| 1.2445 | B.80 | C.11 |
| 1.2446 | B.81 | C.11 |
| 1.2447 | B.82 | C.11 |
| 1.2448 | B.83 | C.11 |
| 1.2449 | B.84 | C.11 |
| 1.2450 | B.85 | C.11 |
| 1.2451 | B.86 | C.11 |
| 1.2452 | B.87 | C.11 |
| 1.2453 | B.88 | C.11 |
| 1.2454 | B.89 | C.11 |
| 1.2455 | B.90 | C.11 |
| 1.2456 | B.91 | C.11 |
| 1.2457 | B.92 | C.11 |
| 1.2458 | B.93 | C.11 |
| 1.2459 | B.94 | C.11 |
| 1.2460 | B.95 | C.11 |
| 1.2461 | B.96 | C.11 |
| 1.2462 | B.97 | C.11 |
| 1.2463 | B.98 | C.11 |
| 1.2464 | B.99 | C.11 |
| 1.2465 | B.100 | C.11 |
| 1.2466 | B.101 | C.11 |
| 1.2467 | B.102 | C.11 |
| 1.2468 | B.103 | C.11 |
| 1.2469 | B.104 | C.11 |
| 1.2470 | B.105 | C.11 |
| 1.2471 | B.106 | C.11 |
| 1.2472 | B.107 | C.11 |
| 1.2473 | B.108 | C.11 |
| 1.2474 | B.109 | C.11 |
| 1.2475 | B.110 | C.11 |
| 1.2476 | B.111 | C.11 |
| 1.2477 | B.112 | C.11 |
| 1.2478 | B.113 | C.11 |
| 1.2479 | B.114 | C.11 |
| 1.2480 | B.115 | C.11 |
| 1.2481 | B.116 | C.11 |
| 1.2482 | B.117 | C.11 |
| 1.2483 | B.118 | C.11 |
| 1.2484 | B.119 | C.11 |
| 1.2485 | B.120 | C.11 |
| 1.2486 | B.121 | C.11 |
| 1.2487 | B.122 | C.11 |
| 1.2488 | B.123 | C.11 |
| 1.2489 | B.124 | C.11 |
| 1.2490 | B.125 | C.11 |
| 1.2491 | B.126 | C.11 |
| 1.2492 | B.127 | C.11 |
| 1.2493 | B.128 | C.11 |
| 1.2494 | B.129 | C.11 |
| 1.2495 | B.130 | C.11 |
| 1.2496 | B.131 | C.11 |
| 1.2497 | B.132 | C.11 |
| 1.2498 | B.133 | C.11 |
| 1.2499 | B.134 | C.11 |
| 1.2500 | B.135 | C.11 |
| 1.2501 | B.136 | C.11 |
| 1.2502 | B.137 | C.11 |
| 1.2503 | B.138 | C.11 |
| 1.2504 | B.139 | C.11 |
| 1.2505 | B.140 | C.11 |
| 1.2506 | B.141 | C.11 |
| 1.2507 | B.142 | C.11 |
| 1.2508 | B.143 | C.11 |
| 1.2509 | B.144 | C.11 |
| 1.2510 | B.145 | C.11 |
| 1.2511 | B.146 | C.11 |
| 1.2512 | B.147 | C.11 |
| 1.2513 | B.148 | C.11 |
| 1.2514 | B.149 | C.11 |
| 1.2515 | B.150 | C.11 |
| 1.2516 | B.151 | C.11 |
| 1.2517 | B.152 | C.11 |
| 1.2518 | B.153 | C.11 |
| 1.2519 | B.154 | C.11 |
| 1.2520 | B.155 | C.11 |
| 1.2521 | B.156 | C.11 |
| 1.2522 | B.157 | C.11 |
| 1.2523 | B.158 | C.11 |
| 1.2524 | B.159 | C.11 |
| 1.2525 | B.160 | C.11 |
| 1.2526 | B.161 | C.11 |
| 1.2527 | B.162 | C.11 |
| 1.2528 | B.163 | C.11 |
| 1.2529 | B.164 | C.11 |
| 1.2530 | B.165 | C.11 |
| 1.2531 | B.166 | C.11 |
| 1.2532 | B.167 | C.11 |
| 1.2533 | B.168 | C.11 |
| 1.2534 | B.169 | C.11 |
| 1.2535 | B.170 | C.11 |
| 1.2536 | B.171 | C.11 |
| 1.2537 | B.172 | C.11 |
| 1.2538 | B.173 | C.11 |
| 1.2539 | B.174 | C.11 |
| 1.2540 | B.175 | C.11 |
| 1.2541 | B.176 | C.11 |
| 1.2542 | B.177 | C.11 |
| 1.2543 | B.178 | C.11 |
| 1.2544 | B.179 | C.11 |
| 1.2545 | B.180 | C.11 |
| 1.2546 | B.181 | C.11 |
| 1.2547 | B.182 | C.11 |
| 1.2548 | B.183 | C.11 |
| 1.2549 | B.184 | C.11 |
| 1.2550 | B.185 | C.11 |
| 1.2551 | B.186 | C.11 |
| 1.2552 | B.187 | C.11 |
| 1.2553 | B.188 | C.11 |
| 1.2554 | B.189 | C.11 |
| 1.2555 | B.190 | C.11 |
| 1.2556 | B.191 | C.11 |
| 1.2557 | B.192 | C.11 |
| 1.2558 | B.193 | C.11 |
| 1.2559 | B.194 | C.11 |
| 1.2560 | B.195 | C.11 |
| 1.2561 | B.196 | C.11 |
| 1.2562 | B.197 | C.11 |
| 1.2563 | B.198 | C.11 |
| 1.2564 | B.199 | C.11 |
| 1.2565 | B.200 | C.11 |
| 1.2566 | B.201 | C.11 |
| 1.2567 | B.202 | C.11 |
| 1.2568 | B.203 | C.11 |
| 1.2569 | B.204 | C.11 |
| 1.2570 | B.205 | C.11 |
| 1.2571 | B.206 | C.11 |
| 1.2572 | B.207 | C.11 |
| 1.2573 | B.208 | C.11 |
| 1.2574 | B.209 | C.11 |
| 1.2575 | B.210 | C.11 |
| 1.2576 | B.211 | C.11 |
| 1.2577 | B.212 | C.11 |
| 1.2578 | B.213 | C.11 |
| 1.2579 | B.214 | C.11 |
| 1.2580 | B.215 | C.11 |
| 1.2581 | B.1 | C.12 |
| 1.2582 | B.2 | C.12 |
| 1.2583 | B.3 | C.12 |
| 1.2584 | B.4 | C.12 |
| 1.2585 | B.5 | C.12 |
| 1.2586 | B.6 | C.12 |
| 1.2587 | B.7 | C.12 |
| 1.2588 | B.8 | C.12 |
| 1.2589 | B.9 | C.12 |
| 1.2590 | B.10 | C.12 |
| 1.2591 | B.11 | C.12 |
| 1.2592 | B.12 | C.12 |
| 1.2593 | B.13 | C.12 |
| 1.2594 | B.14 | C.12 |
| 1.2595 | B.15 | C.12 |
| 1.2596 | B.16 | C.12 |
| 1.2597 | B.17 | C.12 |
| 1.2598 | B.18 | C.12 |
| 1.2599 | B.19 | C.12 |
| 1.2600 | B.20 | C.12 |
| 1.2601 | B.21 | C.12 |
| 1.2602 | B.22 | C.12 |
| 1.2603 | B.23 | C.12 |
| 1.2604 | B.24 | C.12 |
| 1.2605 | B.25 | C.12 |
| 1.2606 | B.26 | C.12 |
| 1.2607 | B.27 | C.12 |
| 1.2608 | B.28 | C.12 |
| 1.2609 | B.29 | C.12 |
| 1.2610 | B.30 | C.12 |
| 1.2611 | B.31 | C.12 |
| 1.2612 | B.32 | C.12 |
| 1.2613 | B.33 | C.12 |
| 1.2614 | B.34 | C.12 |
| 1.2615 | B.35 | C.12 |
| 1.2616 | B.36 | C.12 |
| 1.2617 | B.37 | C.12 |
| 1.2618 | B.38 | C.12 |
| 1.2619 | B.39 | C.12 |
| 1.2620 | B.40 | C.12 |
| 1.2621 | B.41 | C.12 |
| 1.2622 | B.42 | C.12 |
| 1.2623 | B.43 | C.12 |
| 1.2624 | B.44 | C.12 |
| 1.2625 | B.45 | C.12 |
| 1.2626 | B.46 | C.12 |
| 1.2627 | B.47 | C.12 |
| 1.2628 | B.48 | C.12 |
| 1.2629 | B.49 | C.12 |
| 1.2630 | B.50 | C.12 |
| 1.2631 | B.51 | C.12 |
| 1.2632 | B.52 | C.12 |
| 1.2633 | B.53 | C.12 |
| 1.2634 | B.54 | C.12 |
| 1.2635 | B.55 | C.12 |
| 1.2636 | B.56 | C.12 |
| 1.2637 | B.57 | C.12 |
| 1.2638 | B.58. | C.12 |
| 1.2639 | B.59 | C.12 |
| 1.2640 | B.60 | C.12 |
| 1.2641 | B.61 | C.12 |
| 1.2642 | B.62 | C.12 |
| 1.2643 | B.63 | C.12 |
| 1.2644 | B.64 | C.12 |
| 1.2645 | B.65 | C.12 |
| 1.2646 | B.66 | C.12 |
| 1.2647 | B.67 | C.12 |
| 1.2648 | B.68 | C.12 |
| 1.2649 | B.69 | C.12 |
| 1.2650 | B.70 | C.12 |
| 1.2651 | B.71 | C.12 |
| 1.2652 | B.72 | C.12 |
| 1.2653 | B.73 | C.12 |
| 1.2654 | B.74 | C.12 |
| 1.2655 | B.75 | C.12 |
| 1.2656 | B.76 | C.12 |
| 1.2657 | B.77 | C.12 |
| 1.2658 | B.78 | C.12 |
| 1.2659 | B.79 | C.12 |
| 1.2660 | B.80 | C.12 |
| 1.2661 | B.81 | C.12 |
| 1.2662 | B.82 | C.12 |
| 1.2663 | B.83 | C.12 |
| 1.2664 | B.84 | C.12 |
| 1.2665 | B.85 | C.12 |
| 1.2666 | B.86 | C.12 |
| 1.2667 | B.87 | C.12 |
| 1.2668 | B.88 | C.12 |
| 1.2669 | B.89 | C.12 |
| 1.2670 | B.90 | C.12 |
| 1.2671 | B.91 | C.12 |
| 1.2672 | B.92 | C.12 |
| 1.2673 | B.93 | C.12 |
| 1.2674 | B.94 | C.12 |
| 1.2675 | B.95 | C.12 |
| 1.2676 | B.96 | C.12 |
| 1.2677 | B.97 | C.12 |
| 1.2678 | B.98 | C.12 |
| 1.2679 | B.99 | C.12 |
| 1.2680 | B.100 | C.12 |
| 1.2681 | B.101 | C.12 |
| 1.2682 | B.102 | C.12 |
| 1.2683 | B.103 | C.12 |
| 1.2684 | B.104 | C.12 |
| 1.2685 | B.105 | C.12 |
| 1.2686 | B.106 | C.12 |
| 1.2687 | B.107 | C.12 |
| 1.2688 | B.108 | C.12 |
| 1.2689 | B.109 | C.12 |
| 1.2690 | B.110 | C.12 |
| 1.2691 | B.111 | C.12 |
| 1.2692 | B.112 | C.12 |
| 1.2693 | B.113 | C.12 |
| 1.2694 | B.114 | C.12 |
| 1.2695 | B.115 | C.12 |
| 1.2696 | B.116 | C.12 |
| 1.2697 | B.117 | C.12 |
| 1.2698 | B.118 | C.12 |
| 1.2699 | B.119 | C.12 |
| 1.2700 | B.120 | C.12 |
| 1.2701 | B.121 | C.12 |
| 1.2702 | B.122 | C.12 |
| 1.2703 | B.123 | C.12 |
| 1.2704 | B.124 | C.12 |
| 1.2705 | B.125 | C.12 |
| 1.2706 | B.126 | C.12 |
| 1.2707 | B.127 | C.12 |
| 1.2708 | B.128 | C.12 |
| 1.2709 | B.129 | C.12 |
| 1.2710 | B.130 | C.12 |
| 1.2711 | B.131 | C.12 |
| 1.2712 | B.132 | C.12 |
| 1.2713 | B.133 | C.12 |
| 1.2714 | B.134 | C.12 |
| 1.2715 | B.135 | C.12 |
| 1.2716 | B.136 | C.12 |
| 1.2717 | B.137 | C.12 |
| 1.2718 | B.138 | C.12 |
| 1.2719 | B.139 | C.12 |
| 1.2720 | B.140 | C.12 |
| 1.2721 | B.141 | C.12 |
| 1.2722 | B.142 | C.12 |
| 1.2723 | B.143 | C.12 |
| 1.2724 | B.144 | C.12 |
| 1.2725 | B.145 | C.12 |
| 1.2726 | B.146 | C.12 |
| 1.2727 | B.147 | C.12 |
| 1.2728 | B.148 | C.12 |
| 1.2729 | B.149 | C.12 |
| 1.2730 | B.150 | C.12 |
| 1.2731 | B.151 | C.12 |
| 1.2732 | B.152 | C.12 |
| 1.2733 | B.153 | C.12 |
| 1.2734 | B.154 | C.12 |
| 1.2735 | B.155 | C.12 |
| 1.2736 | B.156 | C.12 |
| 1.2737 | B.157 | C.12 |
| 1.2738 | B.158 | C.12 |
| 1.2739 | B.159 | C.12 |
| 1.2740 | B.160 | C.12 |
| 1.2741 | B.161 | C.12 |
| 1.2742 | B.162 | C.12 |
| 1.2743 | B.163 | C.12 |
| 1.2744 | B.164 | C.12 |
| 1.2745 | B.165 | C.12 |
| 1.2746 | B.166 | C.12 |
| 1.2747 | B.167 | C.12 |
| 1.2748 | B.168 | C.12 |
| 1.2749 | B.169 | C.12 |
| 1.2750 | B.170 | C.12 |
| 1.2751 | B.171 | C.12 |
| 1.2752 | B.172 | C.12 |
| 1.2753 | B.173 | C.12 |
| 1.2754 | B.174 | C.12 |
| 1.2755 | B.175 | C.12 |
| 1.2756 | B.176 | C.12 |
| 1.2757 | B.177 | C.12 |
| 1.2758 | B.178 | C.12 |
| 1.2759 | B.179 | C.12 |
| 1.2760 | B.180 | C.12 |
| 1.2761 | B.181 | C.12 |
| 1.2762 | B.182 | C.12 |
| 1.2763 | B.183 | C.12 |
| 1.2764 | B.184 | C.12 |
| 1.2765 | B.185 | C.12 |
| 1.2766 | B.186 | C.12 |
| 1.2767 | B.187 | C.12 |
| 1.2768 | B.188 | C.12 |
| 1.2769 | B.189 | C.12 |
| 1.2770 | B.190 | C.12 |
| 1.2771 | B.191 | C.12 |
| 1.2772 | B.192 | C.12 |
| 1.2773 | B.193 | C.12 |
| 1.2774 | B.194 | C.12 |
| 1.2775 | B.195 | C.12 |
| 1.2776 | B.196 | C.12 |
| 1.2777 | B.197 | C.12 |
| 1.2778 | B.198 | C.12 |
| 1.2779 | B.199 | C.12 |
| 1.2780 | B.200 | C.12 |
| 1.2781 | B.201 | C.12 |
| 1.2782 | B.202 | C.12 |
| 1.2783 | B.203 | C.12 |
| 1.2784 | B.204 | C.12 |
| 1.2785 | B.205 | C.12 |
| 1.2786 | B.206 | C.12 |
| 1.2787 | B.207 | C.12 |
| 1.2788 | B.208 | C.12 |
| 1.2789 | B.209 | C.12 |
| 1.2790 | B.210 | C.12 |
| 1.2791 | B.211 | C.12 |
| 1.2792 | B.212 | C.12 |
| 1.2793 | B.213 | C.12 |
| 1.2794 | B.214 | C.12 |
| 1.2795 | B.215 | C.12 |
| 1.2796 | B.1 | C.13 |
| 1.2797 | B.2 | C.13 |
| 1.2798 | B.3 | C.13 |
| 1.2799 | B.4 | C.13 |
| 1.2800 | B.5 | C.13 |
| 1.2801 | B.6 | C.13 |
| 1.2802 | B.7 | C.13 |
| 1.2803 | B.8 | C.13 |
| 1.2804 | B.9 | C.13 |
| 1.2805 | B.10 | C.13 |
| 1.2806 | B.11 | C.13 |
| 1.2807 | B.12 | C.13 |
| 1.2808 | B.13 | C.13 |
| 1.2809 | B.14 | C.13 |
| 1.2810 | B.15 | C.13 |
| 1.2811 | B.16 | C.13 |
| 1.2812 | B.17 | C.13 |
| 1.2813 | B.18 | C.13 |
| 1.2814 | B.19 | C.13 |
| 1.2815 | B.20 | C.13 |
| 1.2816 | B.21 | C.13 |
| 1.2817 | B.22 | C.13 |
| 1.2818 | B.23 | C.13 |
| 1.2819 | B.24 | C.13 |
| 1.2820 | B.25 | C.13 |
| 1.2821 | B.26 | C.13 |
| 1.2822 | B.27 | C.13 |
| 1.2823 | B.28 | C.13 |
| 1.2824 | B.29 | C.13 |
| 1.2825 | B.30 | C.13 |
| 1.2826 | B.31 | C.13 |
| 1.2827 | B.32 | C.13 |
| 1.2828 | B.33 | C.13 |
| 1.2829 | B.34 | C.13 |
| 1.2830 | B.35 | C.13 |
| 1.2831 | B.36 | C.13 |
| 1.2832 | B.37 | C.13 |
| 1.2833 | B.38 | C.13 |
| 1.2834 | B.39 | C.13 |
| 1.2835 | B.40 | C.13 |
| 1.2836 | B.41 | C.13 |
| 1.2837 | B.42 | C.13 |
| 1.2838 | B.43 | C.13 |
| 1.2839 | B.44 | C.13 |
| 1.2840 | B.45 | C.13 |
| 1.2841 | B.46 | C.13 |
| 1.2842 | B.47 | C.13 |
| 1.2843 | B.48 | C.13 |
| 1.2844 | B.49 | C.13 |
| 1.2845 | B.50 | C.13 |
| 1.2846 | B.51 | C.13 |
| 1.2847 | B.52 | C.13 |
| 1.2848 | B.53 | C.13 |
| 1.2849 | B.54 | C.13 |
| 1.2850 | B.55 | C.13 |
| 1.2851 | B.56 | C.13 |
| 1.2852 | B.57 | C.13 |
| 1.2853 | B.58. | C.13 |
| 1.2854 | B.59 | C.13 |
| 1.2855 | B.60 | C.13 |
| 1.2856 | B.61 | C.13 |
| 1.2857 | B.62 | C.13 |
| 1.2858 | B.63 | C.13 |
| 1.2859 | B.64 | C.13 |
| 1.2860 | B.65 | C.13 |
| 1.2861 | B.66 | C.13 |
| 1.2862 | B.67 | C.13 |
| 1.2863 | B.68 | C.13 |
| 1.2864 | B.69 | C.13 |
| 1.2865 | B.70 | C.13 |
| 1.2866 | B.71 | C.13 |
| 1.2867 | B.72 | C.13 |
| 1.2868 | B.73 | C.13 |
| 1.2869 | B.74 | C.13 |
| 1.2870 | B.75 | C.13 |
| 1.2871 | B.76 | C.13 |
| 1.2872 | B.77 | C.13 |
| 1.2873 | B.78 | C.13 |
| 1.2874 | B.79 | C.13 |
| 1.2875 | B.80 | C.13 |
| 1.2876 | B.81 | C.13 |
| 1.2877 | B.82 | C.13 |
| 1.2878 | B.83 | C.13 |
| 1.2879 | B.84 | C.13 |
| 1.2880 | B.85 | C.13 |
| 1.2881 | B.86 | C.13 |
| 1.2882 | B.87 | C.13 |
| 1.2883 | B.88 | C.13 |
| 1.2884 | B.89 | C.13 |
| 1.2885 | B.90 | C.13 |
| 1.2886 | B.91 | C.13 |
| 1.2887 | B.92 | C.13 |
| 1.2888 | B.93 | C.13 |
| 1.2889 | B.94 | C.13 |
| 1.2890 | B.95 | C.13 |
| 1.2891 | B.96 | C.13 |
| 1.2892 | B.97 | C.13 |
| 1.2893 | B.98 | C.13 |
| 1.2894 | B.99 | C.13 |
| 1.2895 | B.100 | C.13 |
| 1.2896 | B.101 | C.13 |
| 1.2897 | B.102 | C.13 |
| 1.2898 | B.103 | C.13 |
| 1.2899 | B.104 | C.13 |
| 1.2900 | B.105 | C.13 |
| 1.2901 | B.106 | C.13 |
| 1.2902 | B.107 | C.13 |
| 1.2903 | B.108 | C.13 |
| 1.2904 | B.109 | C.13 |
| 1.2905 | B.110 | C.13 |
| 1.2906 | B.111 | C.13 |
| 1.2907 | B.112 | C.13 |
| 1.2908 | B.113 | C.13 |
| 1.2909 | B.114 | C.13 |
| 1.2910 | B.115 | C.13 |
| 1.2911 | B.116 | C.13 |
| 1.2912 | B.117 | C.13 |
| 1.2913 | B.118 | C.13 |
| 1.2914 | B.119 | C.13 |
| 1.2915 | B.120 | C.13 |
| 1.2916 | B.121 | C.13 |
| 1.2917 | B.122 | C.13 |
| 1.2918 | B.123 | C.13 |
| 1.2919 | B.124 | C.13 |
| 1.2920 | B.125 | C.13 |
| 1.2921 | B.126 | C.13 |
| 1.2922 | B.127 | C.13 |
| 1.2923 | B.128 | C.13 |
| 1.2924 | B.129 | C.13 |
| 1.2925 | B.130 | C.13 |
| 1.2926 | B.131 | C.13 |
| 1.2927 | B.132 | C.13 |
| 1.2928 | B.133 | C.13 |
| 1.2929 | B.134 | C.13 |
| 1.2930 | B.135 | C.13 |
| 1.2931 | B.136 | C.13 |
| 1.2932 | B.137 | C.13 |
| 1.2933 | B.138 | C.13 |
| 1.2934 | B.139 | C.13 |
| 1.2935 | B.140 | C.13 |
| 1.2936 | B.141 | C.13 |
| 1.2937 | B.142 | C.13 |
| 1.2938 | B.143 | C.13 |
| 1.2939 | B.144 | C.13 |
| 1.2940 | B.145 | C.13 |
| 1.2941 | B.146 | C.13 |
| 1.2942 | B.147 | C.13 |
| 1.2943 | B.148 | C.13 |
| 1.2944 | B.149 | C.13 |
| 1.2945 | B.150 | C.13 |
| 1.2946 | B.151 | C.13 |
| 1.2947 | B.152 | C.13 |
| 1.2948 | B.153 | C.13 |
| 1.2949 | B.154 | C.13 |
| 1.2950 | B.155 | C.13 |
| 1.2951 | B.156 | C.13 |
| 1.2952 | B.157 | C.13 |
| 1.2953 | B.158 | C.13 |
| 1.2954 | B.159 | C.13 |
| 1.2955 | B.160 | C.13 |
| 1.2956 | B.161 | C.13 |
| 1.2957 | B.162 | C.13 |
| 1.2958 | B.163 | C.13 |
| 1.2959 | B.164 | C.13 |
| 1.2960 | B.165 | C.13 |
| 1.2961 | B.166 | C.13 |
| 1.2962 | B.167 | C.13 |
| 1.2963 | B.168 | C.13 |
| 1.2964 | B.169 | C.13 |
| 1.2965 | B.170 | C.13 |
| 1.2966 | B.171 | C.13 |
| 1.2967 | B.172 | C.13 |
| 1.2968 | B.173 | C.13 |
| 1.2969 | B.174 | C.13 |
| 1.2970 | B.175 | C.13 |
| 1.2971 | B.176 | C.13 |
| 1.2972 | B.177 | C.13 |
| 1.2973 | B.178 | C.13 |
| 1.2974 | B.179 | C.13 |
| 1.2975 | B.180 | C.13 |
| 1.2976 | B.181 | C.13 |
| 1.2977 | B.182 | C.13 |
| 1.2978 | B.183 | C.13 |
| 1.2979 | B.184 | C.13 |
| 1.2980 | B.185 | C.13 |
| 1.2981 | B.186 | C.13 |
| 1.2982 | B.187 | C.13 |
| 1.2983 | B.188 | C.13 |
| 1.2984 | B.189 | C.13 |
| 1.2985 | B.190 | C.13 |
| 1.2986 | B.191 | C.13 |
| 1.2987 | B.192 | C.13 |
| 1.2988 | B.193 | C.13 |
| 1.2989 | B.194 | C.13 |
| 1.2990 | B.195 | C.13 |
| 1.2991 | B.196 | C.13 |
| 1.2992 | B.197 | C.13 |
| 1.2993 | B.198 | C.13 |
| 1.2994 | B.199 | C.13 |
| 1.2995 | B.200 | C.13 |
| 1.2996 | B.201 | C.13 |
| 1.2997 | B.202 | C.13 |
| 1.2998 | B.203 | C.13 |
| 1.2999 | B.204 | C.13 |
| 1.3000 | B.205 | C.13 |
| 1.3001 | B.206 | C.13 |
| 1.3002 | B.207 | C.13 |
| 1.3003 | B.208 | C.13 |
| 1.3004 | B.209 | C.13 |
| 1.3005 | B.210 | C.13 |
| 1.3006 | B.211 | C.13 |
| 1.3007 | B.212 | C.13 |
| 1.3008 | B.213 | C.13 |
| 1.3009 | B.214 | C.13 |
| 1.3010 | B.215 | C.13 |
| 1.3011 | B.1 | C.14 |
| 1.3012 | B.2 | C.14 |
| 1.3013 | B.3 | C.14 |
| 1.3014 | B.4 | C.14 |
| 1.3015 | B.5 | C.14 |
| 1.3016 | B.6 | C.14 |
| 1.3017 | B.7 | C.14 |
| 1.3018 | B.8 | C.14 |
| 1.3019 | B.9 | C.14 |
| 1.3020 | B.10 | C.14 |
| 1.3021 | B.11 | C.14 |
| 1.3022 | B.12 | C.14 |
| 1.3023 | B.13 | C.14 |
| 1.3024 | B.14 | C.14 |
| 1.3025 | B.15 | C.14 |
| 1.3026 | B.16 | C.14 |
| 1.3027 | B.17 | C.14 |
| 1.3028 | B.18 | C.14 |
| 1.3029 | B.19 | C.14 |
| 1.3030 | B.20 | C.14 |
| 1.3031 | B.21 | C.14 |
| 1.3032 | B.22 | C.14 |
| 1.3033 | B.23 | C.14 |
| 1.3034 | B.24 | C.14 |
| 1.3035 | B.25 | C.14 |
| 1.3036 | B.26 | C.14 |
| 1.3037 | B.27 | C.14 |
| 1.3038 | B.28 | C.14 |
| 1.3039 | B.29 | C.14 |
| 1.3040 | B.30 | C.14 |
| 1.3041 | B.31 | C.14 |
| 1.3042 | B.32 | C.14 |
| 1.3043 | B.33 | C.14 |
| 1.3044 | B.34 | C.14 |
| 1.3045 | B.35 | C.14 |
| 1.3046 | B.36 | C.14 |
| 1.3047 | B.37 | C.14 |
| 1.3048 | B.38 | C.14 |
| 1.3049 | B.39 | C.14 |
| 1.3050 | B.40 | C.14 |
| 1.3051 | B.41 | C.14 |
| 1.3052 | B.42 | C.14 |
| 1.3053 | B.43 | C.14 |
| 1.3054 | B.44 | C.14 |
| 1.3055 | B.45 | C.14 |
| 1.3056 | B.46 | C.14 |
| 1.3057 | B.47 | C.14 |
| 1.3058 | B.48 | C.14 |
| 1.3059 | B.49 | C.14 |
| 1.3060 | B.50 | C.14 |
| 1.3061 | B.51 | C.14 |
| 1.3062 | B.52 | C.14 |
| 1.3063 | B.53 | C.14 |
| 1.3064 | B.54 | C.14 |
| 1.3065 | B.55 | C.14 |
| 1.3066 | B.56 | C.14 |
| 1.3067 | B.57 | C.14 |
| 1.3068 | B.58. | C.14 |
| 1.3069 | B.59 | C.14 |
| 1.3070 | B.60 | C.14 |
| 1.3071 | B.61 | C.14 |
| 1.3072 | B.62 | C.14 |
| 1.3073 | B.63 | C.14 |
| 1.3074 | B.64 | C.14 |
| 1.3075 | B.65 | C.14 |
| 1.3076 | B.66 | C.14 |
| 1.3077 | B.67 | C.14 |
| 1.3078 | B.68 | C.14 |
| 1.3079 | B.69 | C.14 |
| 1.3080 | B.70 | C.14 |
| 1.3081 | B.71 | C.14 |
| 1.3082 | B.72 | C.14 |
| 1.3083 | B.73 | C.14 |
| 1.3084 | B.74 | C.14 |
| 1.3085 | B.75 | C.14 |
| 1.3086 | B.76 | C.14 |
| 1.3087 | B.77 | C.14 |
| 1.3088 | B.78 | C.14 |
| 1.3089 | B.79 | C.14 |
| 1.3090 | B.80 | C.14 |
| 1.3091 | B.81 | C.14 |
| 1.3092 | B.82 | C.14 |
| 1.3093 | B.83 | C.14 |
| 1.3094 | B.84 | C.14 |
| 1.3095 | B.85 | C.14 |
| 1.3096 | B.86 | C.14 |
| 1.3097 | B.87 | C.14 |
| 1.3098 | B.88 | C.14 |
| 1.3099 | B.89 | C.14 |
| 1.3100 | B.90 | C.14 |
| 1.3101 | B.91 | C.14 |
| 1.3102 | B.92 | C.14 |
| 1.3103 | B.93 | C.14 |
| 1.3104 | B.94 | C.14 |
| 1.3105 | B.95 | C.14 |
| 1.3106 | B.96 | C.14 |
| 1.3107 | B.97 | C.14 |
| 1.3108 | B.98 | C.14 |
| 1.3109 | B.99 | C.14 |
| 1.3110 | B.100 | C.14 |
| 1.3111 | B.101 | C.14 |
| 1.3112 | B.102 | C.14 |
| 1.3113 | B.103 | C.14 |
| 1.3114 | B.104 | C.14 |
| 1.3115 | B.105 | C.14 |
| 1.3116 | B.106 | C.14 |
| 1.3117 | B.107 | C.14 |
| 1.3118 | B.108 | C.14 |
| 1.3119 | B.109 | C.14 |
| 1.3120 | B.110 | C.14 |
| 1.3121 | B.111 | C.14 |
| 1.3122 | B.112 | C.14 |
| 1.3123 | B.113 | C.14 |
| 1.3124 | B.114 | C.14 |
| 1.3125 | B.115 | C.14 |
| 1.3126 | B.116 | C.14 |
| 1.3127 | B.117 | C.14 |
| 1.3128 | B.118 | C.14 |
| 1.3129 | B.119 | C.14 |
| 1.3130 | B.120 | C.14 |
| 1.3131 | B.121 | C.14 |
| 1.3132 | B.122 | C.14 |
| 1.3133 | B.123 | C.14 |
| 1.3134 | B.124 | C.14 |
| 1.3135 | B.125 | C.14 |
| 1.3136 | B.126 | C.14 |
| 1.3137 | B.127 | C.14 |
| 1.3138 | B.128 | C.14 |
| 1.3139 | B.129 | C.14 |
| 1.3140 | B.130 | C.14 |
| 1.3141 | B.131 | C.14 |
| 1.3142 | B.132 | C.14 |
| 1.3143 | B.133 | C.14 |
| 1.3144 | B.134 | C.14 |
| 1.3145 | B.135 | C.14 |
| 1.3146 | B.136 | C.14 |
| 1.3147 | B.137 | C.14 |
| 1.3148 | B.138 | C.14 |
| 1.3149 | B.139 | C.14 |
| 1.3150 | B.140 | C.14 |
| 1.3151 | B.141 | C.14 |
| 1.3152 | B.142 | C.14 |
| 1.3153 | B.143 | C.14 |
| 1.3154 | B.144 | C.14 |
| 1.3155 | B.145 | C.14 |
| 1.3156 | B.146 | C.14 |
| 1.3157 | B.147 | C.14 |
| 1.3158 | B.148 | C.14 |
| 1.3159 | B.149 | C.14 |
| 1.3160 | B.150 | C.14 |
| 1.3161 | B.151 | C.14 |
| 1.3162 | B.152 | C.14 |
| 1.3163 | B.153 | C.14 |
| 1.3164 | B.154 | C.14 |
| 1.3165 | B.155 | C.14 |
| 1.3166 | B.156 | C.14 |
| 1.3167 | B.157 | C.14 |
| 1.3168 | B.158 | C.14 |
| 1.3169 | B.159 | C.14 |
| 1.3170 | B.160 | C.14 |
| 1.3171 | B.161 | C.14 |
| 1.3172 | B.162 | C.14 |
| 1.3173 | B.163 | C.14 |
| 1.3174 | B.164 | C.14 |
| 1.3175 | B.165 | C.14 |
| 1.3176 | B.166 | C.14 |
| 1.3177 | B.167 | C.14 |
| 1.3178 | B.168 | C.14 |
| 1.3179 | B.169 | C.14 |
| 1.3180 | B.170 | C.14 |
| 1.3181 | B.171 | C.14 |
| 1.3182 | B.172 | C.14 |
| 1.3183 | B.173 | C.14 |
| 1.3184 | B.174 | C.14 |
| 1.3185 | B.175 | C.14 |
| 1.3186 | B.176 | C.14 |
| 1.3187 | B.177 | C.14 |
| 1.3188 | B.178 | C.14 |
| 1.3189 | B.179 | C.14 |
| 1.3190 | B.180 | C.14 |
| 1.3191 | B.181 | C.14 |
| 1.3192 | B.182 | C.14 |
| 1.3193 | B.183 | C.14 |
| 1.3194 | B.184 | C.14 |
| 1.3195 | B.185 | C.14 |
| 1.3196 | B.186 | C.14 |
| 1.3197 | B.187 | C.14 |
| 1.3198 | B.188 | C.14 |
| 1.3199 | B.189 | C.14 |
| 1.3200 | B.190 | C.14 |
| 1.3201 | B.191 | C.14 |
| 1.3202 | B.192 | C.14 |
| 1.3203 | B.193 | C.14 |
| 1.3204 | B.194 | C.14 |
| 1.3205 | B.195 | C.14 |
| 1.3206 | B.196 | C.14 |
| 1.3207 | B.197 | C.14 |
| 1.3208 | B.198 | C.14 |
| 1.3209 | B.199 | C.14 |
| 1.3210 | B.200 | C.14 |
| 1.3211 | B.201 | C.14 |
| 1.3212 | B.202 | C.14 |
| 1.3213 | B.203 | C.14 |
| 1.3214 | B.204 | C.14 |
| 1.3215 | B.205 | C.14 |
| 1.3216 | B.206 | C.14 |
| 1.3217 | B.207 | C.14 |
| 1.3218 | B.208 | C.14 |
| 1.3219 | B.209 | C.14 |
| 1.3220 | B.210 | C.14 |
| 1.3221 | B.211 | C.14 |
| 1.3222 | B.212 | C.14 |
| 1.3223 | B.213 | C.14 |
| 1.3224 | B.214 | C.14 |
| 1.3225 | B.215 | C.14 |
| 1.3226 | B.1 | C.15 |
| 1.3227 | B.2 | C.15 |
| 1.3228 | B.3 | C.15 |
| 1.3229 | B.4 | C.15 |
| 1.3230 | B.5 | C.15 |
| 1.3231 | B.6 | C.15 |
| 1.3232 | B.7 | C.15 |
| 1.3233 | B.8 | C.15 |
| 1.3234 | B.9 | C.15 |
| 1.3235 | B.10 | C.15 |
| 1.3236 | B.11 | C.15 |
| 1.3237 | B.12 | C.15 |
| 1.3238 | B.13 | C.15 |
| 1.3239 | B.14 | C.15 |
| 1.3240 | B.15 | C.15 |
| 1.3241 | B.16 | C.15 |
| 1.3242 | B.17 | C.15 |
| 1.3243 | B.18 | C.15 |
| 1.3244 | B.19 | C.15 |
| 1.3245 | B.20 | C.15 |
| 1.3246 | B.21 | C.15 |
| 1.3247 | B.22 | C.15 |
| 1.3248 | B.23 | C.15 |
| 1.3249 | B.24 | C.15 |
| 1.3250 | B.25 | C.15 |
| 1.3251 | B.26 | C.15 |
| 1.3252 | B.27 | C.15 |
| 1.3253 | B.28 | C.15 |
| 1.3254 | B.29 | C.15 |
| 1.3255 | B.30 | C.15 |
| 1.3256 | B.31 | C.15 |
| 1.3257 | B.32 | C.15 |
| 1.3258 | B.33 | C.15 |
| 1.3259 | B.34 | C.15 |
| 1.3260 | B.35 | C.15 |
| 1.3261 | B.36 | C.15 |
| 1.3262 | B.37 | C.15 |
| 1.3263 | B.38 | C.15 |
| 1.3264 | B.39 | C.15 |
| 1.3265 | B.40 | C.15 |
| 1.3266 | B.41 | C.15 |
| 1.3267 | B.42 | C.15 |
| 1.3268 | B.43 | C.15 |
| 1.3269 | B.44 | C.15 |
| 1.3270 | B.45 | C.15 |
| 1.3271 | B.46 | C.15 |
| 1.3272 | B.47 | C.15 |
| 1.3273 | B.48 | C.15 |
| 1.3274 | B.49 | C.15 |
| 1.3275 | B.50 | C.15 |
| 1.3276 | B.51 | C.15 |
| 1.3277 | B.52 | C.15 |
| 1.3278 | B.53 | C.15 |
| 1.3279 | B.54 | C.15 |
| 1.3280 | B.55 | C.15 |
| 1.3281 | B.56 | C.15 |
| 1.3282 | B.57 | C.15 |
| 1.3283 | B.58. | C.15 |
| 1.3284 | B.59 | C.15 |
| 1.3285 | B.60 | C.15 |
| 1.3286 | B.61 | C.15 |
| 1.3287 | B.62 | C.15 |
| 1.3288 | B.63 | C.15 |
| 1.3289 | B.64 | C.15 |
| 1.3290 | B.65 | C.15 |
| 1.3291 | B.66 | C.15 |
| 1.3292 | B.67 | C.15 |
| 1.3293 | B.68 | C.15 |
| 1.3294 | B.69 | C.15 |
| 1.3295 | B.70 | C.15 |
| 1.3296 | B.71 | C.15 |
| 1.3297 | B.72 | C.15 |
| 1.3298 | B.73 | C.15 |
| 1.3299 | B.74 | C.15 |
| 1.3300 | B.75 | C.15 |
| 1.3301 | B.76 | C.15 |
| 1.3302 | B.77 | C.15 |
| 1.3303 | B.78 | C.15 |
| 1.3304 | B.79 | C.15 |
| 1.3305 | B.80 | C.15 |
| 1.3306 | B.81 | C.15 |
| 1.3307 | B.82 | C.15 |
| 1.3308 | B.83 | C.15 |
| 1.3309 | B.84 | C.15 |
| 1.3310 | B.85 | C.15 |
| 1.3311 | B.86 | C.15 |
| 1.3312 | B.87 | C.15 |
| 1.3313 | B.88 | C.15 |
| 1.3314 | B.89 | C.15 |
| 1.3315 | B.90 | C.15 |
| 1.3316 | B.91 | C.15 |
| 1.3317 | B.92 | C.15 |
| 1.3318 | B.93 | C.15 |
| 1.3319 | B.94 | C.15 |
| 1.3320 | B.95 | C.15 |
| 1.3321 | B.96 | C.15 |
| 1.3322 | B.97 | C.15 |
| 1.3323 | B.98 | C.15 |
| 1.3324 | B.99 | C.15 |
| 1.3325 | B.100 | C.15 |
| 1.3326 | B.101 | C.15 |
| 1.3327 | B.102 | C.15 |
| 1.3328 | B.103 | C.15 |
| 1.3329 | B.104 | C.15 |
| 1.3330 | B.105 | C.15 |
| 1.3331 | B.106 | C.15 |
| 1.3332 | B.107 | C.15 |
| 1.3333 | B.108 | C.15 |
| 1.3334 | B.109 | C.15 |
| 1.3335 | B.110 | C.15 |
| 1.3336 | B.111 | C.15 |
| 1.3337 | B.112 | C.15 |
| 1.3338 | B.113 | C.15 |
| 1.3339 | B.114 | C.15 |
| 1.3340 | B.115 | C.15 |
| 1.3341 | B.116 | C.15 |
| 1.3342 | B.117 | C.15 |
| 1.3343 | B.118 | C.15 |
| 1.3344 | B.119 | C.15 |
| 1.3345 | B.120 | C.15 |
| 1.3346 | B.121 | C.15 |
| 1.3347 | B.122 | C.15 |
| 1.3348 | B.123 | C.15 |
| 1.3349 | B.124 | C.15 |
| 1.3350 | B.125 | C.15 |
| 1.3351 | B.126 | C.15 |
| 1.3352 | B.127 | C.15 |
| 1.3353 | B.128 | C.15 |
| 1.3354 | B.129 | C.15 |
| 1.3355 | B.130 | C.15 |
| 1.3356 | B.131 | C.15 |
| 1.3357 | B.132 | C.15 |
| 1.3358 | B.133 | C.15 |
| 1.3359 | B.134 | C.15 |
| 1.3360 | B.135 | C.15 |
| 1.3361 | B.136 | C.15 |
| 1.3362 | B.137 | C.15 |
| 1.3363 | B.138 | C.15 |
| 1.3364 | B.139 | C.15 |
| 1.3365 | B.140 | C.15 |
| 1.3366 | B.141 | C.15 |
| 1.3367 | B.142 | C.15 |
| 1.3368 | B.143 | C.15 |
| 1.3369 | B.144 | C.15 |
| 1.3370 | B.145 | C.15 |
| 1.3371 | B.146 | C.15 |
| 1.3372 | B.147 | C.15 |
| 1.3373 | B.148 | C.15 |
| 1.3374 | B.149 | C.15 |
| 1.3375 | B.150 | C.15 |
| 1.3376 | B.151 | C.15 |
| 1.3377 | B.152 | C.15 |
| 1.3378 | B.153 | C.15 |
| 1.3379 | B.154 | C.15 |
| 1.3380 | B.155 | C.15 |
| 1.3381 | B.156 | C.15 |
| 1.3382 | B.157 | C.15 |
| 1.3383 | B.158 | C.15 |
| 1.3384 | B.159 | C.15 |
| 1.3385 | B.160 | C.15 |
| 1.3386 | B.161 | C.15 |
| 1.3387 | B.162 | C.15 |
| 1.3388 | B.163 | C.15 |
| 1.3389 | B.164 | C.15 |
| 1.3390 | B.165 | C.15 |
| 1.3391 | B.166 | C.15 |
| 1.3392 | B.167 | C.15 |
| 1.3393 | B.168 | C.15 |
| 1.3394 | B.169 | C.15 |
| 1.3395 | B.170 | C.15 |
| 1.3396 | B.171 | C.15 |
| 1.3397 | B.172 | C.15 |
| 1.3398 | B.173 | C.15 |
| 1.3399 | B.174 | C.15 |
| 1.3400 | B.175 | C.15 |
| 1.3401 | B.176 | C.15 |
| 1.3402 | B.177 | C.15 |
| 1.3403 | B.178 | C.15 |
| 1.3404 | B.179 | C.15 |
| 1.3405 | B.180 | C.15 |
| 1.3406 | B.181 | C.15 |
| 1.3407 | B.182 | C.15 |
| 1.3408 | B.183 | C.15 |
| 1.3409 | B.184 | C.15 |
| 1.3410 | B.185 | C.15 |
| 1.3411 | B.186 | C.15 |
| 1.3412 | B.187 | C.15 |
| 1.3413 | B.188 | C.15 |
| 1.3414 | B.189 | C.15 |
| 1.3415 | B.190 | C.15 |
| 1.3416 | B.191 | C.15 |
| 1.3417 | B.192 | C.15 |
| 1.3418 | B.193 | C.15 |
| 1.3419 | B.194 | C.15 |
| 1.3420 | B.195 | C.15 |
| 1.3421 | B.196 | C.15 |
| 1.3422 | B.197 | C.15 |
| 1.3423 | B.198 | C.15 |
| 1.3424 | B.199 | C.15 |
| 1.3425 | B.200 | C.15 |
| 1.3426 | B.201 | C.15 |
| 1.3427 | B.202 | C.15 |
| 1.3428 | B.203 | C.15 |
| 1.3429 | B.204 | C.15 |
| 1.3430 | B.205 | C.15 |
| 1.3431 | B.206 | C.15 |
| 1.3432 | B.207 | C.15 |
| 1.3433 | B.208 | C.15 |
| 1.3434 | B.209 | C.15 |
| 1.3435 | B.210 | C.15 |
| 1.3436 | B.211 | C.15 |
| 1.3437 | B.212 | C.15 |
| 1.3438 | B.213 | C.15 |
| 1.3439 | B.214 | C.15 |
| 1.3440 | B.215 | C.15 |
| 1.3441 | B.1 | C.16 |
| 1.3442 | B.2 | C.16 |
| 1.3443 | B.3 | C.16 |
| 1.3444 | B.4 | C.16 |
| 1.3445 | B.5 | C.16 |
| 1.3446 | B.6 | C.16 |
| 1.3447 | B.7 | C.16 |
| 1.3448 | B.8 | C.16 |
| 1.3449 | B.9 | C.16 |
| 1.3450 | B.10 | C.16 |
| 1.3451 | B.11 | C.16 |
| 1.3452 | B.12 | C.16 |
| 1.3453 | B.13 | C.16 |
| 1.3454 | B.14 | C.16 |
| 1.3455 | B.15 | C.16 |
| 1.3456 | B.16 | C.16 |
| 1.3457 | B.17 | C.16 |
| 1.3458 | B.18 | C.16 |
| 1.3459 | B.19 | C.16 |
| 1.3460 | B.20 | C.16 |
| 1.3461 | B.21 | C.16 |
| 1.3462 | B.22 | C.16 |
| 1.3463 | B.23 | C.16 |
| 1.3464 | B.24 | C.16 |
| 1.3465 | B.25 | C.16 |
| 1.3466 | B.26 | C.16 |
| 1.3467 | B.27 | C.16 |
| 1.3468 | B.28 | C.16 |
| 1.3469 | B.29 | C.16 |
| 1.3470 | B.30 | C.16 |
| 1.3471 | B.31 | C.16 |
| 1.3472 | B.32 | C.16 |
| 1.3473 | B.33 | C.16 |
| 1.3474 | B.34 | C.16 |
| 1.3475 | B.35 | C.16 |
| 1.3476 | B.36 | C.16 |
| 1.3477 | B.37 | C.16 |
| 1.3478 | B.38 | C.16 |
| 1.3479 | B.39 | C.16 |
| 1.3480 | B.40 | C.16 |
| 1.3481 | B.41 | C.16 |
| 1.3482 | B.42 | C.16 |
| 1.3483 | B.43 | C.16 |
| 1.3484 | B.44 | C.16 |
| 1.3485 | B.45 | C.16 |
| 1.3486 | B.46 | C.16 |
| 1.3487 | B.47 | C.16 |
| 1.3488 | B.48 | C.16 |
| 1.3489 | B.49 | C.16 |
| 1.3490 | B.50 | C.16 |
| 1.3491 | B.51 | C.16 |
| 1.3492 | B.52 | C.16 |
| 1.3493 | B.53 | C.16 |
| 1.3494 | B.54 | C.16 |
| 1.3495 | B.55 | C.16 |
| 1.3496 | B.56 | C.16 |
| 1.3497 | B.57 | C.16 |
| 1.3498 | B.58. | C.16 |
| 1.3499 | B.59 | C.16 |
| 1.3500 | B.60 | C.16 |
| 1.3501 | B.61 | C.16 |
| 1.3502 | B.62 | C.16 |
| 1.3503 | B.63 | C.16 |
| 1.3504 | B.64 | C.16 |
| 1.3505 | B.65 | C.16 |
| 1.3506 | B.66 | C.16 |
| 1.3507 | B.67 | C.16 |
| 1.3508 | B.68 | C.16 |
| 1.3509 | B.69 | C.16 |
| 1.3510 | B.70 | C.16 |
| 1.3511 | B.71 | C.16 |
| 1.3512 | B.72 | C.16 |
| 1.3513 | B.73 | C.16 |
| 1.3514 | B.74 | C.16 |
| 1.3515 | B.75 | C.16 |
| 1.3516 | B.76 | C.16 |
| 1.3517 | B.77 | C.16 |
| 1.3518 | B.78 | C.16 |
| 1.3519 | B.79 | C.16 |
| 1.3520 | B.80 | C.16 |
| 1.3521 | B.81 | C.16 |
| 1.3522 | B.82 | C.16 |
| 1.3523 | B.83 | C.16 |
| 1.3524 | B.84 | C.16 |
| 1.3525 | B.85 | C.16 |
| 1.3526 | B.86 | C.16 |
| 1.3527 | B.87 | C.16 |
| 1.3528 | B.88 | C.16 |
| 1.3529 | B.89 | C.16 |
| 1.3530 | B.90 | C.16 |
| 1.3531 | B.91 | C.16 |
| 1.3532 | B.92 | C.16 |
| 1.3533 | B.93 | C.16 |
| 1.3534 | B.94 | C.16 |
| 1.3535 | B.95 | C.16 |
| 1.3536 | B.96 | C.16 |
| 1.3537 | B.97 | C.16 |
| 1.3538 | B.98 | C.16 |
| 1.3539 | B.99 | C.16 |
| 1.3540 | B.100 | C.16 |
| 1.3541 | B.101 | C.16 |
| 1.3542 | B.102 | C.16 |
| 1.3543 | B.103 | C.16 |
| 1.3544 | B.104 | C.16 |
| 1.3545 | B.105 | C.16 |
| 1.3546 | B.106 | C.16 |
| 1.3547 | B.107 | C.16 |
| 1.3548 | B.108 | C.16 |
| 1.3549 | B.109 | C.16 |
| 1.3550 | B.110 | C.16 |
| 1.3551 | B.111 | C.16 |
| 1.3552 | B.112 | C.16 |
| 1.3553 | B.113 | C.16 |
| 1.3554 | B.114 | C.16 |
| 1.3555 | B.115 | C.16 |
| 1.3556 | B.116 | C.16 |
| 1.3557 | B.117 | C.16 |
| 1.3558 | B.118 | C.16 |
| 1.3559 | B.119 | C.16 |
| 1.3560 | B.120 | C.16 |
| 1.3561 | B.121 | C.16 |
| 1.3562 | B.122 | C.16 |
| 1.3563 | B.123 | C.16 |
| 1.3564 | B.124 | C.16 |
| 1.3565 | B.125 | C.16 |
| 1.3566 | B.126 | C.16 |
| 1.3567 | B.127 | C.16 |
| 1.3568 | B.128 | C.16 |
| 1.3569 | B.129 | C.16 |
| 1.3570 | B.130 | C.16 |
| 1.3571 | B.131 | C.16 |
| 1.3572 | B.132 | C.16 |
| 1.3573 | B.133 | C.16 |
| 1.3574 | B.134 | C.16 |
| 1.3575 | B.135 | C.16 |
| 1.3576 | B.136 | C.16 |
| 1.3577 | B.137 | C.16 |
| 1.3578 | B.138 | C.16 |
| 1.3579 | B.139 | C.16 |
| 1.3580 | B.140 | C.16 |
| 1.3581 | B.141 | C.16 |
| 1.3582 | B.142 | C.16 |
| 1.3583 | B.143 | C.16 |
| 1.3584 | B.144 | C.16 |
| 1.3585 | B.145 | C.16 |
| 1.3586 | B.146 | C.16 |
| 1.3587 | B.147 | C.16 |
| 1.3588 | B.148 | C.16 |
| 1.3589 | B.149 | C.16 |
| 1.3590 | B.150 | C.16 |
| 1.3591 | B.151 | C.16 |
| 1.3592 | B.152 | C.16 |
| 1.3593 | B.153 | C.16 |
| 1.3594 | B.154 | C.16 |
| 1.3595 | B.155 | C.16 |
| 1.3596 | B.156 | C.16 |
| 1.3597 | B.157 | C.16 |
| 1.3598 | B.158 | C.16 |
| 1.3599 | B.159 | C.16 |
| 1.3600 | B.160 | C.16 |
| 1.3601 | B.161 | C.16 |
| 1.3602 | B.162 | C.16 |
| 1.3603 | B.163 | C.16 |
| 1.3604 | B.164 | C.16 |
| 1.3605 | B.165 | C.16 |
| 1.3606 | B.166 | C.16 |
| 1.3607 | B.167 | C.16 |
| 1.3608 | B.168 | C.16 |
| 1.3609 | B.169 | C.16 |
| 1.3610 | B.170 | C.16 |
| 1.3611 | B.171 | C.16 |
| 1.3612 | B.172 | C.16 |
| 1.3613 | B.173 | C.16 |
| 1.3614 | B.174 | C.16 |
| 1.3615 | B.175 | C.16 |
| 1.3616 | B.176 | C.16 |
| 1.3617 | B.177 | C.16 |
| 1.3618 | B.178 | C.16 |
| 1.3619 | B.179 | C.16 |
| 1.3620 | B.180 | C.16 |
| 1.3621 | B.181 | C.16 |
| 1.3622 | B.182 | C.16 |
| 1.3623 | B.183 | C.16 |
| 1.3624 | B.184 | C.16 |
| 1.3625 | B.185 | C.16 |
| 1.3626 | B.186 | C.16 |
| 1.3627 | B.187 | C.16 |
| 1.3628 | B.188 | C.16 |
| 1.3629 | B.189 | C.16 |
| 1.3630 | B.190 | C.16 |
| 1.3631 | B.191 | C.16 |
| 1.3632 | B.192 | C.16 |
| 1.3633 | B.193 | C.16 |
| 1.3634 | B.194 | C.16 |
| 1.3635 | B.195 | C.16 |
| 1.3636 | B.196 | C.16 |
| 1.3637 | B.197 | C.16 |
| 1.3638 | B.198 | C.16 |
| 1.3639 | B.199 | C.16 |
| 1.3640 | B.200 | C.16 |
| 1.3641 | B.201 | C.16 |
| 1.3642 | B.202 | C.16 |
| 1.3643 | B.203 | C.16 |
| 1.3644 | B.204 | C.16 |
| 1.3645 | B.205 | C.16 |
| 1.3646 | B.206 | C.16 |
| 1.3647 | B.207 | C.16 |
| 1.3648 | B.208 | C.16 |
| 1.3649 | B.209 | C.16 |
| 1.3650 | B.210 | C.16 |
| 1.3651 | B.211 | C.16 |
| 1.3652 | B.212 | C.16 |
| 1.3653 | B.213 | C.16 |
| 1.3654 | B.214 | C.16 |
| 1.3655 | B.215 | C.16 |
| 1.3656 | B.1 | C.17 |
| 1.3657 | B.2 | C.17 |
| 1.3658 | B.3 | C.17 |
| 1.3659 | B.4 | C.17 |
| 1.3660 | B.5 | C.17 |
| 1.3661 | B.6 | C.17 |
| 1.3662 | B.7 | C.17 |
| 1.3663 | B.8 | C.17 |
| 1.3664 | B.9 | C.17 |
| 1.3665 | B.10 | C.17 |
| 1.3666 | B.11 | C.17 |
| 1.3667 | B.12 | C.17 |
| 1.3668 | B.13 | C.17 |
| 1.3669 | B.14 | C.17 |
| 1.3670 | B.15 | C.17 |
| 1.3671 | B.16 | C.17 |
| 1.3672 | B.17 | C.17 |
| 1.3673 | B.18 | C.17 |
| 1.3674 | B.19 | C.17 |
| 1.3675 | B.20 | C.17 |
| 1.3676 | B.21 | C.17 |
| 1.3677 | B.22 | C.17 |
| 1.3678 | B.23 | C.17 |
| 1.3679 | B.24 | C.17 |
| 1.3680 | B.25 | C.17 |
| 1.3681 | B.26 | C.17 |
| 1.3682 | B.27 | C.17 |
| 1.3683 | B.28 | C.17 |
| 1.3684 | B.29 | C.17 |
| 1.3685 | B.30 | C.17 |
| 1.3686 | B.31 | C.17 |
| 1.3687 | B.32 | C.17 |
| 1.3688 | B.33 | C.17 |
| 1.3689 | B.34 | C.17 |
| 1.3690 | B.35 | C.17 |
| 1.3691 | B.36 | C.17 |
| 1.3692 | B.37 | C.17 |
| 1.3693 | B.38 | C.17 |
| 1.3694 | B.39 | C.17 |
| 1.3695 | B.40 | C.17 |
| 1.3696 | B.41 | C.17 |
| 1.3697 | B.42 | C.17 |
| 1.3698 | B.43 | C.17 |
| 1.3699 | B.44 | C.17 |
| 1.3700 | B.45 | C.17 |
| 1.3701 | B.46 | C.17 |
| 1.3702 | B.47 | C.17 |
| 1.3703 | B.48 | C.17 |
| 1.3704 | B.49 | C.17 |
| 1.3705 | B.50 | C.17 |
| 1.3706 | B.51 | C.17 |
| 1.3707 | B.52 | C.17 |
| 1.3708 | B.53 | C.17 |
| 1.3709 | B.54 | C.17 |
| 1.3710 | B.55 | C.17 |
| 1.3711 | B.56 | C.17 |
| 1.3712 | B.57 | C.17 |
| 1.3713 | B.58. | C.17 |
| 1.3714 | B.59 | C.17 |
| 1.3715 | B.60 | C.17 |
| 1.3716 | B.61 | C.17 |
| 1.3717 | B.62 | C.17 |
| 1.3718 | B.63 | C.17 |
| 1.3719 | B.64 | C.17 |
| 1.3720 | B.65 | C.17 |
| 1.3721 | B.66 | C.17 |
| 1.3722 | B.67 | C.17 |
| 1.3723 | B.68 | C.17 |
| 1.3724 | B.69 | C.17 |
| 1.3725 | B.70 | C.17 |
| 1.3726 | B.71 | C.17 |
| 1.3727 | B.72 | C.17 |
| 1.3728 | B.73 | C.17 |
| 1.3729 | B.74 | C.17 |
| 1.3730 | B.75 | C.17 |
| 1.3731 | B.76 | C.17 |
| 1.3732 | B.77 | C.17 |
| 1.3733 | B.78 | C.17 |
| 1.3734 | B.79 | C.17 |
| 1.3735 | B.80 | C.17 |
| 1.3736 | B.81 | C.17 |
| 1.3737 | B.82 | C.17 |
| 1.3738 | B.83 | C.17 |
| 1.3739 | B.84 | C.17 |
| 1.3740 | B.85 | C.17 |
| 1.3741 | B.86 | C.17 |
| 1.3742 | B.87 | C.17 |
| 1.3743 | B.88 | C.17 |
| 1.3744 | B.89 | C.17 |
| 1.3745 | B.90 | C.17 |
| 1.3746 | B.91 | C.17 |
| 1.3747 | B.92 | C.17 |
| 1.3748 | B.93 | C.17 |
| 1.3749 | B.94 | C.17 |
| 1.3750 | B.95 | C.17 |
| 1.3751 | B.96 | C.17 |
| 1.3752 | B.97 | C.17 |
| 1.3753 | B.98 | C.17 |
| 1.3754 | B.99 | C.17 |
| 1.3755 | B.100 | C.17 |
| 1.3756 | B.101 | C.17 |
| 1.3757 | B.102 | C.17 |
| 1.3758 | B.103 | C.17 |
| 1.3759 | B.104 | C.17 |
| 1.3760 | B.105 | C.17 |
| 1.3761 | B.106 | C.17 |
| 1.3762 | B.107 | C.17 |
| 1.3763 | B.108 | C.17 |
| 1.3764 | B.109 | C.17 |
| 1.3765 | B.110 | C.17 |
| 1.3766 | B.111 | C.17 |
| 1.3767 | B.112 | C.17 |
| 1.3768 | B.113 | C.17 |
| 1.3769 | B.114 | C.17 |
| 1.3770 | B.115 | C.17 |
| 1.3771 | B.116 | C.17 |
| 1.3772 | B.117 | C.17 |
| 1.3773 | B.118 | C.17 |
| 1.3774 | B.119 | C.17 |
| 1.3775 | B.120 | C.17 |
| 1.3776 | B.121 | C.17 |
| 1.3777 | B.122 | C.17 |
| 1.3778 | B.123 | C.17 |
| 1.3779 | B.124 | C.17 |
| 1.3780 | B.125 | C.17 |
| 1.3781 | B.126 | C.17 |
| 1.3782 | B.127 | C.17 |
| 1.3783 | B.128 | C.17 |
| 1.3784 | B.129 | C.17 |
| 1.3785 | B.130 | C.17 |
| 1.3786 | B.131 | C.17 |
| 1.3787 | B.132 | C.17 |
| 1.3788 | B.133 | C.17 |
| 1.3789 | B.134 | C.17 |
| 1.3790 | B.135 | C.17 |
| 1.3791 | B.136 | C.17 |
| 1.3792 | B.137 | C.17 |
| 1.3793 | B.138 | C.17 |
| 1.3794 | B.139 | C.17 |
| 1.3795 | B.140 | C.17 |
| 1.3796 | B.141 | C.17 |
| 1.3797 | B.142 | C.17 |
| 1.3798 | B.143 | C.17 |
| 1.3799 | B.144 | C.17 |
| 1.3800 | B.145 | C.17 |
| 1.3801 | B.146 | C.17 |
| 1.3802 | B.147 | C.17 |
| 1.3803 | B.148 | C.17 |
| 1.3804 | B.149 | C.17 |
| 1.3805 | B.150 | C.17 |
| 1.3806 | B.151 | C.17 |
| 1.3807 | B.152 | C.17 |
| 1.3808 | B.153 | C.17 |
| 1.3809 | B.154 | C.17 |
| 1.3810 | B.155 | C.17 |
| 1.3811 | B.156 | C.17 |
| 1.3812 | B.157 | C.17 |
| 1.3813 | B.158 | C.17 |
| 1.3814 | B.159 | C.17 |
| 1.3815 | B.160 | C.17 |
| 1.3816 | B.161 | C.17 |
| 1.3817 | B.162 | C.17 |
| 1.3818 | B.163 | C.17 |
| 1.3819 | B.164 | C.17 |
| 1.3820 | B.165 | C.17 |
| 1.3821 | B.166 | C.17 |
| 1.3822 | B.167 | C.17 |
| 1.3823 | B.168 | C.17 |
| 1.3824 | B.169 | C.17 |
| 1.3825 | B.170 | C.17 |
| 1.3826 | B.171 | C.17 |
| 1.3827 | B.172 | C.17 |
| 1.3828 | B.173 | C.17 |
| 1.3829 | B.174 | C.17 |
| 1.3830 | B.175 | C.17 |
| 1.3831 | B.176 | C.17 |
| 1.3832 | B.177 | C.17 |
| 1.3833 | B.178 | C.17 |
| 1.3834 | B.179 | C.17 |
| 1.3835 | B.180 | C.17 |
| 1.3836 | B.181 | C.17 |
| 1.3837 | B.182 | C.17 |
| 1.3838 | B.183 | C.17 |
| 1.3839 | B.184 | C.17 |
| 1.3840 | B.185 | C.17 |
| 1.3841 | B.186 | C.17 |
| 1.3842 | B.187 | C.17 |
| 1.3843 | B.188 | C.17 |
| 1.3844 | B.189 | C.17 |
| 1.3845 | B.190 | C.17 |
| 1.3846 | B.191 | C.17 |
| 1.3847 | B.192 | C.17 |
| 1.3848 | B.193 | C.17 |
| 1.3849 | B.194 | C.17 |
| 1.3850 | B.195 | C.17 |
| 1.3851 | B.196 | C.17 |
| 1.3852 | B.197 | C.17 |
| 1.3853 | B.198 | C.17 |
| 1.3854 | B.199 | C.17 |
| 1.3855 | B.200 | C.17 |
| 1.3856 | B.201 | C.17 |
| 1.3857 | B.202 | C.17 |
| 1.3858 | B.203 | C.17 |
| 1.3859 | B.204 | C.17 |
| 1.3860 | B.205 | C.17 |
| 1.3861 | B.206 | C.17 |
| 1.3862 | B.207 | C.17 |
| 1.3863 | B.208 | C.17 |
| 1.3864 | B.209 | C.17 |
| 1.3865 | B.210 | C.17 |
| 1.3866 | B.211 | C.17 |
| 1.3867 | B.212 | C.17 |
| 1.3868 | B.213 | C.17 |
| 1.3869 | B.214 | C.17 |
| 1.3870 | B.215 | C.17 |
| 1.3871 | — | C.1 |
| 1.3872 | — | C.2 |
| 1.3873 | — | C.3 |
| 1.3874 | — | C.4 |
| 1.3875 | — | C.5 |
| 1.3876 | — | C.6 |
| 1.3877 | — | C.7 |
| 1.3878 | — | C.8 |
| 1.3879 | — | C.9 |
| 1.3880 | — | C.10 |
| 1.3881 | — | C.11 |
| 1.3882 | — | C.12 |
| 1.3883 | — | C.13 |
| 1.3884 | — | C.14 |
| 1.3885 | — | C.15 |
| 1.3886 | — | C.16 |
| 1.3887 | — | C.17 |

The specific number for each single composition is deductible as follows:

Composition 1.200 for example comprises the compound (I.a.20) and cinmethylin (B.200) (see table 1, entry 1.200; as well as table B, entry B.200).

Composition 2.200 for example comprises the compound (L.a. 19) (see the definition for compositions 2.1 to 2.3887 below) and cinmethylin (B.200) (see table 1, entry 1.200; as well as table B, entry B.200).

Composition 7.200 for example comprises imazapyr (B.35) (see the definition for compositions 7.1 to 7.3887 below), the compound (I.a.20) and cinmethylin (B.200) (see table 1, entry 1.200; as well as table B, entry B.200).

Also particularly preferred are compositions 2.1 to 2.3887, comprising the compound of formula

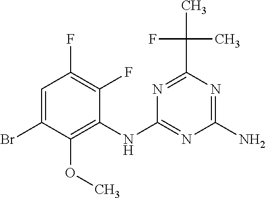 [SMILES: COc1c(Br)cc(F)c(F)c1Nc1nc(N)nc(C(C)(C)F)n1]

and the substance(s) as defined in the respective row of table 1.

Also particularly preferred are compositions 3.1 to 3.3887, comprising the compound of formula

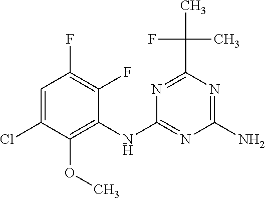 [SMILES: COc1c(Cl)cc(F)c(F)c1Nc1nc(N)nc(C(C)(C)F)n1]

and the substance(s) as defined in the respective row of table 1.

Also particularly preferred are compositions 4.1 to 4.3887, comprising the compound of formula

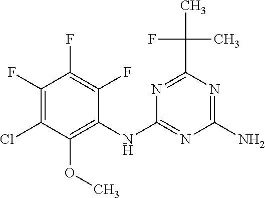 [SMILES: COc1c(Cl)c(F)c(F)c(F)c1Nc1nc(N)nc(C(C)(C)F)n1]

and the substance(s) as defined in the respective row of table 1.

The invention also relates to agrochemical compositions comprising an auxiliary and at least one composition according to the invention.

An agrochemical composition comprises a pesticidally effective amount of at least one composition according to the invention. The term “effective amount” denotes an amount of the active ingredients, which is sufficient for controlling unwanted plants, especially for controlling unwanted plants in crops (i.e. cultivated plants) and which does not result in a substantial damage to the treated plants. Such an amount can vary in a broad range and is dependent on various factors, such as the plants to be controlled, the treated crop or material, the climatic conditions and the specific composition according to the invention used.

The compounds A and optionally B and/or C, their N-oxides, salts or derivatives can be converted into customary types of agrochemical compositions, e. g. solutions, emulsions, suspensions, dusts, powders, pastes, granules, pressings, capsules, and mixtures thereof.

Examples for agrochemical composition types are suspensions (e.g. SC, OD, FS), emulsifiable concentrates (e.g. EC), emulsions (e.g. EW, EO, ES, ME), capsules (e.g. CS, ZC), pastes, pastilles, wettable powders or dusts (e.g. WP, SP, WS, DP, DS), pressings (e.g. BR, TB, DT), granules (e.g. WG, SG, GR, FG, GG, MG), insecticidal articles (e.g. LN), as well as gel formulations for the treatment of plant propagation materials such as seeds (e.g. GF). These and further agrochemical compositions types are defined in the “Catalogue of pesticide formulation types and international coding system”, Technical Monograph No. 2, 6^{th} Ed. May 2008, CropLife International.

The agrochemical compositions are prepared in a known manner, such as described by Mollet and Grubemann, Formulation technology, Wiley VCH, Weinheim, 2001; or Knowles, New developments in crop protection product formulation, Agrow Reports DS243, T&F Informa, London, 2005.

Suitable auxiliaries are solvents, liquid carriers, solid carriers or fillers, surfactants, dispersants, emulsifiers, wetters, adjuvants, solubilizers, penetration enhancers, protective colloids, adhesion agents, thickeners, humectants, repellents, attractants, feeding stimulants, compatibilizers, bactericides, anti-freezing agents, anti-foaming agents, colorants, tackifiers and binders.

Suitable solvents and liquid carriers are water and organic solvents, such as mineral oil fractions of medium to high boiling point, e.g. kerosene, diesel oil; oils of vegetable or animal origin; aliphatic, cyclic and aromatic hydrocarbons, e. g. toluene, paraffin, tetrahydronaphthalene, alkylated naphthalenes; alcohols, e.g. ethanol, propanol, butanol, benzylalcohol, cyclohexanol; glycols; DMSO; ketones, e.g. cyclohexanone; esters, e.g. lactates, carbonates, fatty acid esters, gamma-butyrolactone; fatty acids; phosphonates; amines; amides, e.g. N-methylpyrrolidone, fatty acid dimethylamides; and mixtures thereof.

Suitable solid carriers or fillers are mineral earths, e.g. silicates, silica gels, talc, kaolins, limestone, lime, chalk, clays, dolomite, diatomaceous earth, bentonite, calcium sulfate, magnesium sulfate, magnesium oxide; polysaccharides, e.g. cellulose, starch; fertilizers, e.g. ammonium sulfate, ammonium phosphate, ammonium nitrate, ureas; products of vegetable origin, e.g. cereal meal, tree bark meal, wood meal, nutshell meal, and mixtures thereof.

Suitable surfactants are surface-active compounds, such as anionic, cationic, nonionic and amphoteric surfactants, block polymers, polyelectrolytes, and mixtures thereof. Such surfactants can be used as emulsifier, dispersant, solubilizer, wetter, penetration enhancer, protective colloid, or adjuvant. Examples of surfactants are listed in McCutcheon's, Vol. 1: Emulsifiers & Detergents, McCutcheon's Directories, Glen Rock, USA, 2008 (International Ed. or North American Ed.).

Suitable anionic surfactants are alkali, alkaline earth or ammonium salts of sulfonates, sulfates, phosphates, carboxylates, and mixtures thereof. Examples of sulfonates are alkylarylsulfonates, diphenylsulfonates, alpha-olefin sulfonates, lignine sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkylnaphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates, and carboxylated alcohol or alkylphenol ethoxylates.

Suitable nonionic surfactants are alkoxylates, N-substituted fatty acid amides, amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation, preferably ethylene oxide. Examples of N-substituted fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides. Examples of polymeric surfactants are home- or copolymers of vinylpyrrolidone, vinylalcohols, or vinylacetate.

Suitable cationic surfactants are quaternary surfactants, for example quaternary ammonium compounds with one or two hydrophobic groups, or salts of long-chain primary amines. Suitable amphoteric surfactants are alkylbetains and imidazolines. Suitable block polymers are block polymers of the A-B or A-B-A type comprising blocks of polyethylene oxide and polypropylene oxide, or of the A-B-C type comprising alkanol, polyethylene oxide and polypropylene oxide. Suitable polyelectrolytes are polyacids or polybases. Examples of polyacids are alkali salts of polyacrylic acid or polyacid comb polymers. Examples of polybases are polyvinylamines or polyethyleneamines.

Suitable adjuvants are compounds, which have a neglectable or even no pesticidal activity themselves, and which improve the biological performance of the compound I on the target.

Examples are surfactants, mineral or vegetable oils, and other auxiliaries. Further examples are listed by Knowles, Adjuvants and additives, Agrow Reports DS256, T&F Informa UK, 2006, chapter 5.

Suitable thickeners are polysaccharides (e.g. xanthan gum, carboxymethylcellulose), inorganic clays (organically modified or unmodified), polycarboxylates, and silicates.

Suitable bactericides are bronopol and isothiazolinone derivatives such as alkylisothiazolinones and benzisothiazolinones.

Suitable anti-freezing agents are ethylene glycol, propylene glycol, urea and glycerin.

Suitable anti-foaming agents are silicones, long chain alcohols, and salts of fatty acids.

Suitable colorants (e.g. in red, blue, or green) are pigments of low water solubility and water-soluble dyes. Examples are inorganic colorants (e.g. iron oxide, titan oxide, iron hexacyanoferrate) and organic colorants (e.g. alizarin-, azo- and phthalocyanine colorants).

Suitable tackifiers or binders are polyvinylpyrrolidons, polyvinylacetates, polyvinyl alcohols, polyacrylates, biological or synthetic waxes, and cellulose ethers.

Examples for agrochemical composition types and their preparation are:
i) Water-soluble concentrates (SL, LS)
10-60 wt % of a compostion according to the invention and 5-15 wt % wetting agent (e.g. alcohol alkoxylates) are dissolved in water and/or in a water-soluble solvent (e.g. alcohols) ad 100 wt %. The active substance dissolves upon dilution with water.
ii) Dispersible concentrates (DC)
5-25 wt % of a composition according to the invention and 1-10 wt % dispersant (e. g. polyvinylpyrrolidone) are dissolved in organic solvent (e.g. cyclohexanone) ad 100 wt %. Dilution with water gives a dispersion.
iii) Emulsifiable concentrates (EC)
15-70 wt % of a composition according to the invention and 5-10 wt % emulsifiers (e.g. calcium dodecylbenzenesulfonate and castor oil ethoxylate) are dissolved in water-insoluble organic solvent (e.g. aromatic hydrocarbon) ad 100 wt %. Dilution with water gives an emulsion.
iv) Emulsions (EW, EO, ES)
5-40 wt % of a composition according to the invention and 1-10 wt % emulsifiers (e.g. calcium dodecylbenzenesulfonate and castor oil ethoxylate) are dissolved in 20-40 wt % water-insoluble organic solvent (e.g. aromatic hydrocarbon). This mixture is introduced into water ad 100 wt % by means of an emulsifying machine and made into a homogeneous emulsion. Dilution with water gives an emulsion.
v) Suspensions (SC, OD, FS)

In an agitated ball mill, 20-60 wt % of a composition according to the invention are comminuted with addition of 2-10 wt % dispersants and wetting agents (e.g. sodium lignosulfonate and alcohol ethoxylate), 0.1-2 wt % thickener (e.g. xanthan gum) and water ad 100 wt % to give a fine active substance suspension. Dilution with water gives a stable suspension of the active substance. For FS type composition up to 40 wt % binder (e.g. polyvinylalcohol) is added.
vi) Water-dispersible granules and water-soluble granules (WG, SG)
50-80 wt % of a composition according to the invention are ground finely with addition of dispersants and wetting agents (e.g. sodium lignosulfonate and alcohol ethoxylate) ad 100 wt % and prepared as water-dispersible or water-soluble granules by means of technical appliances (e. g. extrusion, spray tower, fluidized bed). Dilution with water gives a stable dispersion or solution of the active substance.
vii) Water-dispersible powders and water-soluble powders (WP, SP, WS)
50-80 wt % of a composition according to the invention are ground in a rotor-stator mill with addition of 1-5 wt % dispersants (e.g. sodium lignosulfonate), 1-3 wt % wetting agents (e.g. alcohol ethoxylate) and solid carrier (e.g. silica gel) ad 100 wt %. Dilution with water gives a stable dispersion or solution of the active substance.
viii) Gel (GW, GF)

In an agitated ball mill, 5-25 wt % of a a composition according to the invention are comminuted with addition of 3-10 wt % dispersants (e.g. sodium lignosulfonate), 1-5 wt % thickener (e.g. carboxymethylcellulose) and water ad 100 wt % to give a fine suspension of the active substance. Dilution with water gives a stable suspension of the active substance.
iv) Microemulsion (ME)
5-20 wt % of a composition according to the invention are added to 5-30 wt % organic solvent blend (e.g. fatty acid dimethylamide and cyclohexanone), 10-25 wt % surfactant blend (e.g. alcohol ethoxylate and arylphenol ethoxylate), and water ad 100%. This mixture is stirred for 1 h to produce spontaneously a thermodynamically stable microemulsion.
iv) Microcapsules (CS)

An oil phase comprising 5-50 wt % of a composition according to the invention, 0-40 wt % water insoluble organic solvent (e.g. aromatic hydrocarbon), 2-15 wt % acrylic monomers (e.g. methylmethacrylate, methacrylic acid and a di- or triacrylate) are dispersed into an aqueous solution of a protective colloid (e.g. polyvinyl alcohol). Radical polymerization initiated by a radical initiator results in the formation of poly(meth)acrylate microcapsules. Alternatively, an oil phase comprising 5-50 wt % of a compound I according to the invention, 0-40 wt % water insoluble organic solvent (e.g. aromatic hydrocarbon), and an isocyanate monomer (e.g. diphenylmethene-4,4′-diisocyanate) are dispersed into an aqueous solution of a protective colloid (e.g. polyvinyl alcohol). The addition of a polyamine (e.g. hexamethylenediamine) results in the formation of polyurea microcapsules. The monomers amount to 1-10 wt %. The wt % relate to the total CS composition.
ix) Dustable powders (DP, DS)
1-10 wt % of a composition according to the invention are ground finely and mixed intimately with solid carrier (e.g. finely divided kaolin) ad 100 wt %.
x) Granules (GR, FG)
0.5-30 wt % of a composition according to the invention is ground finely and associated with solid carrier (e.g. silicate) ad 100 wt %. Granulation is achieved by extrusion, spray-drying or the fluidized bed.
xi) Ultra-low volume liquids (UL)
1-50 wt % of a composition according to the invention are dissolved in organic solvent (e.g. aromatic hydrocarbon) ad 100 wt %.

The agrochemical compositions types i) to xi) may optionally comprise further auxiliaries, such as 0.1-1 wt % bactericides, 5-15 wt % anti-freezing agents, 0.1-1 wt % anti-foaming agents, and 0.1-1 wt % colorants.

The agrochemical compositions generally comprise between 0.01 and 95%, preferably between 0.1 and 90%, and in particular between 0.5 and 75%, by weight of active substance. The active substances are employed in a purity of from 90% to 100%, preferably from 95% to 100% (according to NMR spectrum).

Solutions for seed treatment (LS), suspoemulsions (SE), flowable concentrates (FS), powders for dry treatment (DS), water-dispersible powders for slurry treatment (WS), water-soluble powders (SS), emulsions (ES), emulsifiable concentrates (EC) and gels (GF) are usually employed for the purposes of treatment of plant propagation materials, particularly seeds. The compositions in question give, after two-to-tenfold dilution, active substance concentrations of from 0.01 to 60% by weight, preferably from 0.1 to 40% by weight, in the ready-to-use preparations. Application can be carried out before or during sowing.

Methods for applying compounds of formula (I) and compositions thereof, respectively, on to plant propagation material, especially seeds include dressing, coating, pelleting, dusting, soaking and in-furrow application methods of the propagation material. Preferably, compound I or the compositions thereof, respectively, are applied on to the plant propagation material by a method such that germination is not induced, e. g. by seed dressing, pelleting, coating and dusting.

Various types of oils, wetters, adjuvants, fertilizer, or micronutrients, and further pesticides (e.g. herbicides, insecticides, fungicides, growth regulators, safeners) may be added to the active substances or the compositions comprising them as premix or, if appropriate not until immediately prior to use (tank mix). These agents can be admixed with the compositions according to the invention in a weight ratio of 1:100 to 100:1, preferably 1:10 to 10:1.

The user applies the agrochemical composition according to the invention usually from a predosage device, a knapsack sprayer, a spray tank, a spray plane, or an irrigation system. Usually, the agrochemical composition is made up with water, buffer, and/or further auxiliaries to the desired application concentration and the ready-to-use spray liquor or the agrochemical composition according to the invention is thus obtained. Usually, 20 to 2000 liters, preferably 50 to 400 liters, of the ready-to-use spray liquor are applied per hectare of agricultural useful area.

According to one embodiment, either individual components of the agrochemical composition according to the invention or partially premixed components, e. g. agrochemical components comprising compounds of formula (I) and/or active substances from the groups B and/or C may be mixed by the user in a spray tank and further auxiliaries and additives may be added, if appropriate.

In a further embodiment, individual components of the agrochemical composition according to the invention such as parts of a kit or parts of a binary or ternary mixture may be mixed by the user himself in a spray tank and further auxiliaries may be added, if appropriate.

In a further embodiment, either individual components of the agrochemical composition according to the invention or partially premixed components, e. g. components comprising compounds of formula (I) and active substances from the groups B and/or C, can be applied jointly (e.g. after tank mix) or consecutively.

Accordingly, a first embodiment of the invention relates to compositions in the form of a agrochemical composition formulated as a 1-component composition comprising the at least one active compound of formula (I) or the at least one active compound of formula (I) (active compound A) and at least one further active compound selected from the herbicides B and the safeners C and also a solid or liquid carrier and, if appropriate, one or more surfactants.

Accordingly, a second embodiment of the invention relates to compositions in the form of a agrochemical composition formulated as a 2-component composition comprising a first formulation (component) comprising the at least one active compound A, a solid or liquid carrier and, if appropriate, one or more surfactants, and a second component comprising at least one further active compound selected from the herbicides B and safeners C, a solid or liquid carrier and, if appropriate, one or more surfactants.

The active compound A and the at least one further active compound B and/or C can be formulated and applied jointly or separately, simultaneously or in succession, before, during or after the emergence of the plants. In case of separate application, the order of the application of the active compounds A, B and/or C is of minor importance. The only thing that is important is that the at least one active compound A and the at least one further active compound B and/or C are present simultaneously at the site of action, i.e. are at the same time in contact with or taken up by the plant to be controlled/safened.

The compositions according to the invention are suitable as herbicides. They are suitable as such or as an appropriately formulated composition (agrochemical composition).

The compositions according to the invention control vegetation on non-crop areas very efficiently, especially at high rates of application. They act against broad-leafed weeds and grass weeds in crops such as wheat, rice, corn, soybeans, sugarcane, sunflower and cotton without causing any significant damage to the crop plants. This effect is mainly observed at low rates of application.

The compositions according to the invention have an outstanding herbicidal activity against undesired vegetation, i.e. against a broad spectrum of economically important harmful monocotyledonous and dicotyledonous weeds. Further, the compositions according to the invention have an outstanding herbicidal activity against undesired vegetation which are resistant to compounds of the mode of actions included but not restricted to the compounds of the class b1) to b15) as defined above.

As mentioned below are some representatives of monocotyledonous and dicotyledonous weeds, which can be controlled by the compositions according to the invention without the enumeration being a restriction to certain species.

Preferably the compositions according to the invention are used to control monocotyledonous weeds.

Examples of monocotyledonous weeds on which the compositions according to the invention act efficiently are selected from the genera Hordeum spp., Echinochloa spp., Poa spp., Bromus spp., Digitaria spp., Eriochloa spp., Setaria spp., Pennisetum spp., Eleusine spp., Eragrostis spp., Panicum spp., Lolium spp., Brachiaria spp., Leptochloa spp., Avena spp., Cyperus spp., Axonopris spp., Sorghum spp., and Melinus spp.

Preferred examples of monocotyledonous weeds on which the compositions according to the invention act efficiently are selected from the species Hordeum murinum, Echinochloa crus-galli, Poa annua, Bromus rubens L., Bromus rigidus, Bromus secalinus L., Digitaria sanguinalis, Digitaria insularis, Eriochloa gracilis, Setaria faberi, Setaria viridis, Pennisetum glaucum, Eleusine indica, Eragrostis pectinacea, Panicum miliaceum, Lolium multiflorum, Brachiaria platyphylla, Leptochloa fusca, Avena fatua, Cyperus compressus, Cyperus esculentes, Axonopris offinis, Sorghum halapense, and Melinus repens.

Especially preferred examples of monocotyledonous weeds on which the compositions according to the invention act efficiently are selected from the species Echinochloa spp., Digitaria spp., Setaria spp., Eleusine spp. and Brachiarium spp.

Also preferably the compositions according to the invention are used to control dicotyledonous weeds.

Examples of dicotyledonous weeds on which the compositions according to the invention act efficiently are selected from the genera Amaranthus spp., Erigeron spp., Conyza spp., Polygonum spp., Medicago spp., Mollugo spp., Cyclospermum spp., Stellaria spp., Gnaphalium spp., Taraxacum spp., Oenothera spp., Amsinckia spp., Erodium spp., Erigeron spp., Senecio spp., Lamium spp., Kochia spp., Chenopodium spp., Lactuca spp., Malva spp., Ipomoea spp., Brassica spp., Sinapis spp., Urtica spp., Sida spp, Portulaca spp., Richardia spp., Ambrosia spp., Calandrinia spp., Sisymbrium spp., Sesbania spp., Capsella spp., Sonchus spp., Euphorbia spp., Helianthus spp., Coronopus spp., Salsola spp., Abutilon spp., Vicia spp., Epilobium spp., Cardamine spp., Picris spp., Trifolium spp., Galinsoga spp., Epimedium spp., Marchantia spp., Solanum spp., Oxalis spp., Metricaria spp., Plantago spp., Tribulus spp., Cenchrus spp., Bidens spp., Veronica spp., and Hypochaeris spp.

Preferred examples of dicotyledonous weeds on which the compositions according to the invention act efficiently are selected from the species Amaranthus spinosus, Polygonum convolvulus, Medicago polymorpha, Mollugo verticillata, Cyclospermum leptophyllum, Stellaria media, Gnaphalium purpureum, Taraxacum officinale, Oenothera laciniata, Amsinckia intermedia, Erodium cicutarium, Erodium moschatum, Erigeron bonariensis (Conyza bonariensis), Senecio vulgaris, Lamium amplexicaule, Erigeron canadensis, Polygonum aviculare, Kochia scoparia, Chenopodium album, Lactuca serriola, Malva parviflora, Malva neglecta, Ipomoea hederacea, Ipomoea lacunose, Brassica nigra, Sinapis arvensis, Urtica dioica, Amaranthus blitoides, Amaranthus retroflexus, Amaranthus hybridus, Amaranthus lividus, Amaranthus palmeri, Amaranthus tuberculatus, Sida spinosa, Portulaca oleracea, Richardia scabra, Ambrosia artemisiifolia, Calandrinia caulescens, Sisymbrium irio, Sesbania exaltata, Capsella bursa-pastoris, Sonchus oleraceus, Euphorbia maculate, Euphorbia heterophylla, Helianthus annuus, Coronopus didymus, Salsola tragus, Abutilon theophrasti, Vicia benghalensis L., Epilobium paniculatum, Cardamine spp, Picris echioides, Trifolium spp., Galinsoga spp., Epimedium spp., Marchantia spp., Solanum spp., Oxalis spp., Metricaria matriccarioides, Plantago spp., Tribulus terrestris, Salsola kali, Cenchrus spp., Bidens bipinnata, Veronica spp., and Hypochaeris radicata.

Especially preferred examples of dicotyledonous weeds on which the compositions according to the invention act efficiently are selected from the species Amaranthus spp., Erigeron spp., Conyza spp., Kochia spp. and Abutilon spp.

The compositions according to the invention are applied to the plants mainly by spraying the leaves. Here, the application can be carried out using, for example, water as carrier by customary spraying techniques using spray liquor amounts of from about 100 to 1000 I/ha (for example from 300 to 400 I/ha). The herbicidal compositions may also be applied by the low-volume or the ultra-low-volume method, or in the form of microgranules.

Application of the herbicidal compositions according to the present invention can be done before, during and/or after, preferably during and/or after, the emergence of the undesirable plants.

The herbicidal compositions according to the present invention can be applied pre- or post-emergence or together with the seed of a crop plant. It is also possible to apply the compounds and compositions by applying seed, pretreated with a composition of the invention, of a crop plant. If the active compounds A and B and, if appropriate C, are less well tolerated by certain crop plants, application techniques may be used in which the herbicidal compositions are sprayed, with the aid of the spraying equipment, in such a way that as far as possible they do not come into contact with the leaves of the sensitive crop plants, while the active compounds reach the leaves of undesirable plants growing underneath, or the bare soil surface (post-directed, lay-by).

In a further embodiment, the composition according to the invention can be applied by treating seed. The treatment of seed comprises essentially all procedures familiar to the person skilled in the art (seed dressing, seed coating, seed dusting, seed soaking, seed film coating, seed multilayer coating, seed encrusting, seed dripping and seed pelleting) based on the compounds of the formula (I) according to the invention or the compositions prepared therefrom. Here, the herbicidal compositions can be applied diluted or undiluted.

The term “seed” comprises seed of all types, such as, for example, corns, seeds, fruits, tubers, seedlings and similar forms. Here, preferably, the term seed describes corns and seeds. The seed used can be seed of the useful plants mentioned above, but also the seed of transgenic plants or plants obtained by customary breeding methods.

Moreover, it may be advantageous to apply the compositions of the present invention on their own or jointly in combination with other crop protection agents, for example with agents for controlling pests or phytopathogenic fungi or bacteria or with groups of active compounds which regulate growth. Also of interest is the miscibility with mineral salt solutions which are employed for treating nutritional and trace element deficiencies. Non-phytotoxic oils and oil concentrates can also be added.

When employed in plant protection, the amounts of active substances applied, i.e. A and B and, if appropriate, C without formulation auxiliaries, are, depending on the kind of effect desired, from 0.001 to 3 kg per ha, preferably from 0.005 to 2.5 kg per ha, more preferably from 0.01 to 2 kg per ha and in particular from 0.025 to 1.5 kg per ha.

In another preferred embodiment of the invention, the rates of application of the compound of formula (I) according to the present invention (total amount of compound of formula (I)) are from 0.1 g/ha to 3000 g/ha, preferably 1 g/ha to 1000 g/ha, more preferably 5 g/ha to 1000 g/ha depending on the control target, the season, the target plants and the growth stage.

In another preferred embodiment of the invention, the application rates of the compound of formula (I) are in the range from 0.1 g/ha to 5000 g/ha and preferably in the range from 1 g/ha to 2500 g/ha or from 5 g/ha to 2000 g/ha.

In another preferred embodiment of the invention, the application rate of the compound of formula (I) is 0.1 to 1000 g/ha, preferably 1 to 750 g/ha, more preferably 5 to 500 g/ha.

The required application rates of herbicidal compounds B are generally in the range of from 0.0005 kg/ha to 2.5 kg/ha and preferably in the range of from 0.005 kg/ha to 2 kg/ha or 0.01 kg/ha to 1.5 kg/h of a.s.

The required application rates of safeners C are generally in the range of from 0.0005 kg/ha to 2.5 kg/ha and preferably in the range of from 0.005 kg/ha to 2 kg/ha or 0.01 kg/ha to 1.5 kg/h of a.s.

In treatment of plant propagation materials such as seeds, e. g. by dusting, coating or drenching seed, amounts of active substance of from 0.1 to 1000 g, preferably from 1 to 1000 g, more preferably from 1 to 100 g and most preferably from 5 to 100 g, per 100 kilogram of plant propagation material (preferably seeds) are generally required.

In another embodiment of the invention, to treat the seed, the amounts of active substances applied, i.e. A and B and, if appropriate, C are generally employed in amounts of from 0.001 to 10 kg per 100 kg of seed.

When used in the protection of materials or stored products, the amount of active substance applied depends on the kind of application area and on the desired effect. Amounts customarily applied in the protection of materials are 0.001 g to 2 kg, preferably 0.005 g to 1 kg, of active substance per cubic meter of treated material.

In the methods of the present invention it is immaterial whether the herbicide compound of formula (I), and the further herbicide component B and/or the herbicide safener compound C are formulated and applied jointly or separately.

In the case of separate application it is of minor importance, in which order the application takes place. It is only necessary, that the herbicide compound A and the herbicide compound B and/or the herbicide safener compound C are applied in a time frame that allows simultaneous action of the active ingredients on the plants, preferably within a time-frame of at most 35 days, in particular at most 14 days.

Depending on the application method in question, the compositions according to the invention can additionally be employed in a further number of crop plants for eliminating undesirable plants.

According to the invention all the crop plants (cultivated plants) mentioned herein are understood to comprise all species, subspecies, variants and/or hybrids which belong to the respective cultivated plants, including but not limited to winter and spring varieties, in particular in cereals such as wheat and barley, as well as oilseed rape, e.g. winter wheat, spring wheat, winter barley etc.

For example, corn is also known as Indian corn or maize (Zea mays) which comprises all kinds of corn such as field corn and sweet corn. According to the invention all maize or corn subspecies and/or varieties are comprised, in particular flour corn (Zea mays var. amylacea), popcorn (Zea mays var. everta), dent corn (Zea mays var. indentata), flint corn (Zea mays var. indurata), sweet corn (Zea mays var. saccharata and var. rugosa), waxy corn (Zea mays var. ceratina), amylomaize (high amylose Zea mays varieties), pod corn or wild maize (Zea mays var. tunicata) and striped maize (Zea mays var. japonica).

Further, most soybean cultivars are classifiable into indeterminate and determinate growth habit, whereas Glycine soja, the wild progenitor of soybean, is indeterminate (PNAS 2010, 107 (19) 8563-856). The indeterminate growth habit (Maturity Group, MG 00 to MG 4.9) is characterized by a continuation of vegetative growth after flowering begins whereas determinate soybean varieties (Maturity Group, (MG) 5 to MG 8) characteristically have finished most of their vegetative growth when flowering begins. According to the invention all soybean cultivars or varieties are comprised, in particular indeterminate and determinate cultivars or varieties.

Examples of suitable crops are the following: Allium cepa, Ananas comosus, Arachis hypogaea, Asparagus officinalis, Avena sativa, Beta vulgaris spec. altissima, Beta vulgaris spec. rapa, Brassica napus var. napus, Brassica napus var. napobrassica, Brassica rapa var. silvestris, Brassica oleracea, Brassica nigra, Camellia sinensis, Carthamus tinctorius, Carya illinoinensis, Citrus limon, Citrus sinensis, Coffea arabica (Coffea canephora, Coffea liberica), Cucumis sativus, Cynodon dactylon, Daucus carota, Elaeis guineensis, Fragaria vesca, Glycine max, Gossypium hirsutum, (Gossypium arboreum, Gossypium herbaceum, Gossypium vitifolium), Helianthus annuus, Hevea brasiliensis, Hordeum vulgare, Humulus lupulus, Ipomoea batatas, Juglans regia, Lens culinaris, Linum usitatissimum, Lycopersicon lycopersicum, Malus spec., Manihot esculenta, Medicago sativa, Musa spec., Nicotiana tabacum (N. rustica), Olea europaea, Oryza sativa, Phaseolus lunatus, Phaseolus vulgaris, Picea abies, Pinus spec., Pistacia vera, Pisum sativum, Prunus avium, Prunus persica, Pyrus communis, Prunus armeniaca, Prunus cerasus, Prunus dulcis and prunus domestica, Ribes sylvestre, Ricinus communis, Saccharum officinarum, Secale cereale, Sinapis alba, Solanum tuberosum, Sorghum bicolor (s. vulgare), Theobroma cacao, Trifolium pratense, Triticum aestivum, Triticale, Triticum durum, Vicia faba, Vitis vinifera, Zea mays.

Preferred crops are Arachis hypogaea, Beta vulgaris spec. altissima, Brassica napus var. napus, Brassica oleracea, Citrus limon, Citrus sinensis, Coffea arabica (Coffea canephora, Coffea liberica), Cynodon dactylon, Glycine max, Gossypium hirsutum, (Gossypium arboreum, Gossypium herbaceum, Gossypium vitifolium), Helianthus annuus, Hordeum vulgare, Juglans regia, Lens culinaris, Linum usitatissimum, Lycopersicon lycopersicum, Malus spec., Medicago sativa, Nicotiana tabacum (N. rustica), Olea europaea, Oryza sativa, Phaseolus lunatus, Phaseolus vulgaris, Pistacia vera, Pisum sativum, Prunus dulcis, Saccharum officinarum, Secale cereale, Solanum tuberosum, Sorghum bicolor (s. vulgare), Triticale, Triticum aestivum, Triticum durum, Vicia faba, Vitis vinifera and Zea mays

Especially preferred crops are crops of cereals, corn, soybeans, rice, oilseed rape, sugar cane, sunflower, cotton, peas, lentils, peanuts or permanent crops.

The compositions according to the invention can also be used in crops which have been modified by mutagenesis or genetic engineering in order to provide a new trait to a plant or to modify an already present trait.

The term “crops” as used herein includes also (crop) plants which have been modified by mutagenesis or genetic engineering in order to provide a new trait to a plant or to modify an already present trait.

Mutagenesis includes techniques of random mutagenesis using X-rays or mutagenic chemicals, but also techniques of targeted mutagenesis, in order to create mutations at a specific locus of a plant genome. Targeted mutagenesis techniques frequently use oligonucleotides or proteins like CRISPR/Cas, zinc-finger nucleases, TALENs or meganucleases to achieve the targeting effect.

Genetic engineering usually uses recombinant DNA techniques to create modifications in a plant genome which under natural circumstances cannot readily be obtained by cross breeding, mutagenesis or natural recombination. Typically, one or more genes are integrated into the genome of a plant in order to add a trait or improve a trait. These integrated genes are also referred to as transgenes in the art, while plant comprising such transgenes are referred to as transgenic plants. The process of plant transformation usually produces several transformation events, wich differ in the genomic locus in which a transgene has been integrated. Plants comprising a specific transgene on a specific genomic locus are usually described as comprising a specific “event”, which is referred to by a specific event name. Traits which have been introduced in plants or hae been modified include in particular herbicide tolerance, insect resistance, increased yield and tolerance to abiotic conditions, like drought.

Herbicide tolerance has been created by using mutagenesis as well as using genetic engineering. Plants which have been rendered tolerant to acetolactate synthase (ALS) inhibitor herbicides by conventional methods of mutagenesis and breeding comprise plant varieties commercially available under the name Clearfield®. However, most of the herbicide tolerance traits have been created via the use of transgenes.

Herbicide tolerance has been created to glyphosate, glufosinate, 2,4-D, dicamba, oxynil herbicides, like bromoxynil and ioxynil, sulfonylurea herbicides, ALS inhibitor herbicides and 4-hydroxyphenylpyruvate dioxygenase (HPPD) inhibitors, like isoxaflutole and mesotrione to microtubule assembly inhibitors like icafolin and to PPO herbicides like saflufenacil, tiafenacil, trifludimoxazin, epyrifenacil, CAS 2158274-56-5, CAS 1970221-16-9, CAS 2158274-50-9Transgenes wich have been used to provide herbicide tolerance traits comprise: for tolerance to glyphosate: cp4 epsps, epsps grg23ace5, mepsps, 2mepsps, gat4601, gat4621 and goxv247, for tolerance to glufosinate: pat and bar, for tolerance to 2,4-D: aad-1 and aad-12, for tolerance to dicamba: dmo, for tolerance to oxynil herbicies: bxn, for tolerance to sulfonylurea herbicides: zm-hra, csr1-2, gm-hra, S4-HrA, for tolerance to ALS inhibitor herbicides: csr1-2, for tolerance to HPPD inhibitor herbicides: hppdPF, W336 and avhppd-03, for tolerance to PPO herbicides as described in e.g. WO2019106568, WO2023031161, WO2018022777, WO2017039969.

Transgenic corn events comprising herbicide tolerance genes are for example, but not excluding others, DAS40278, MON801, MON802, MON809, MON810, MON832, MON87411, MON87419, MON87427, MON88017, MON89034, NK603, GA21, MZHGOJG, HCEM485, VCO-Ø1981-5, 676, 678, 680, 33121, 4114, 59122, 98140, Bt10, Bt176, CBH-351, DBT418, DLL25, MS3, MS6, MZIR098, T25, TC1507 and TC6275.

Transgenic soybean events comprising herbicide tolerance genes are for example, but not excluding others, GTS 40-3-2, MON87705, MON87708, MON87712, MON87769, MON89788, A2704-12, A2704-21, A5547-127, A5547-35, DP356043, DAS44406-6, DAS68416-4, DAS-81419-2, GU262, SYHTOH2, W62, W98, FG72 and CV127.

Transgenic cotton events comprising herbicide tolerance genes are for example, but not excluding others, 19-51a, 31707, 42317, 81910, 281-24-236, 3006-210-23, BXN10211, BXN10215, BXN10222, BXN10224, MON1445, MON1698, MON88701, MON88913, GH1B119, GHB614, LLCotton25, T303-3 and T304-40.

Transgenic canola events comprising herbicide tolerance genes are for example, but not excluding others, MON88302, HCR-1, HCN10, HCN28, HCN92, MS1, MS8, PHY14, PHY23, PHY35, PHY36, RF1, RF2 and RF3.

Insect resistance has mainly been created by transferring bacterial genes for insecticidal proteins to plants. Transgenes which have most frequently been used are toxin genes of Bacillus spec. and synthetic variants thereof, like cry1A, cry1Ab, cry1Ab-Ac, cry1Ac, cry1A.105, cry1F, cry1Fa2, cry2Ab2, cry2Ae, mcry3A, ecry3.1Ab, cry3Bb1, cry34Ab1, cry35Ab1, cry9C, vip3A(a), vip3Aa20. However, also genes of plant origin have been transferred to other plants.

In particular genes coding for protease inhibitors, like CpTI and pinll. A further approach uses transgenes in order to produce double stranded RNA in plants to target and downregulate insect genes. An example for such a transgene is dvsnf7.

Transgenic corn events comprising genes for insecticidal proteins or double stranded RNA are for example, but not excluding others, Bt10, Bt11, Bt176, MON801, MON802, MON809, MON810, MON863, MON87411, MON88017, MON89034, 33121, 4114, 5307, 59122, TC1507, TC6275, CBH-351, MIR162, DBT418 and MZIR098.

Transgenic soybean events comprising genes for insecticidal proteins are for example, but not excluding others, MON87701, MON87751 and DAS-81419.

Transgenic cotton events comprising genes for insecticidal proteins are for example, but not excluding others, SGK321, MON531, MON757, MON1076, MON15985, 31707, 31803, 31807, 31808, 42317, BNLA-601, Event1, COT67B, COT102, T303-3, T304-40, GFM Cry1A, GK12, MLS 9124, 281-24-236, 3006-210-23, GHB119 and SGK321.

Increased yield has been created by increasing ear biomass using the transgene athb17, being present in corn event MON87403, or by enhancing photosynthesis using the transgene bbx32, being present in the soybean event MON87712.

Crops comprising a modified oil content have been created by using the transgenes: gm-fad2-1, Pj.D6D, Nc.Fad3, fad2-1A and fatb1-A. Soybean events comprising at least one of these genes are: 260-05, MON87705 and MON87769.

Tolerance to abiotic conditions, in particular to tolerance to drought, has been created by using the transgene cspB, comprised by the corn event MON87460 and by using the transgene Hahb-4, comprised by soybean event IND-00410-5.

Traits are frequently combined by combining genes in a transformation event or by combining different events during the breeding process. Preferred combination of traits are herbicide tolerance to different groups of herbicides, insect tolerance to different kind of insects, in particular tolerance to lepidopteran and coleopteran insects, herbicide tolerance with one or several types of insect resistance, herbicide tolerance with increased yield as well as a combination of herbicide tolerance and tolerance to abiotic conditions.

Plants comprising singular or stacked traits as well as the genes and events providing these traits are well known in the art. For example, detailed information as to the mutagenized or integrated genes and the respective events are available from websites of the organizations “International Service for the Acquisition of Agri-biotech Applications (ISAAA)” (http://www.isaaa.org/gmapprovaldatabase) and the “Center for Environmental Risk Assessment (CERA)” (http://cera-qmc.orq/GMCropDatabase), as well as in patent applications, like EP3028573 and WO2017/011288.

The use of compositions according to the invention on crops may result in effects which are specific to a crop comprising a certain gene or event. These effects might involve changes in growth behavior or changed resistance to biotic or abiotic stress factors. Such effects may in particular comprise enhanced yield, enhanced resistance or tolerance to insects, nematodes, fungal, bacterial, mycoplasma, viral or viroid pathogens as well as early vigour, early or delayed ripening, cold or heat tolerance as well as changed amino acid or fatty acid spectrum or content.

Furthermore, plants are also covered that contain by the use of recombinant DNA techniques a modified amount of ingredients or new ingredients, specifically to improve raw material production, e.g., potatoes that produce increased amounts of amylopectin (e.g. Amflora® potato, BASF SE, Germany).

Furthermore, it has been found that the the compositions according to the invention are also suitable for the defoliation and/or desiccation of plant parts, for which crop plants such as cotton, potato, oilseed rape, sunflower, soybean or field beans, in particular cotton, are suitable.

In this regard compositions have been found for the desiccation and/or defoliation of plants, processes for preparing these compositions, and methods for desiccating and/or defoliating plants using the compositions according to the invention.

As desiccants, the compositions according to the invention are suitable in particular for desiccating the above-ground parts of crop plants such as potato, oilseed rape, sunflower and soybean, but also cereals. This makes possible the fully mechanical harvesting of these important crop plants.

Also of economic interest is the facilitation of harvesting, which is made possible by concentrating within a certain period of time the dehiscence, or reduction of adhesion to the tree, in citrus fruit, olives and other species and varieties of pomaceous fruit, stone fruit and nuts. The same mechanism, i.e. the promotion of the development of abscission tissue between fruit part or leaf part and shoot part of the plants is also essential for the controlled defoliation of useful plants, in particular cotton.

Moreover, a shortening of the time interval in which the individual cotton plants mature leads to an increased fiber quality after harvesting.

The following examples serve to illustrate the invention.

### A PREPARATION EXAMPLES

### Example 1: N4-(5-chloro-2,3,4-trifluoro-6-methoxy-phenyl)-6-(1-fluoro-1-methyl-ethyl)-1,3,5-triazine-2,4-diamine

### Step 1. 2-chloro-3,4,5-trifluoro-phenol

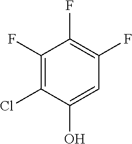 [SMILES: Oc1cc(F)c(F)c(F)c1Cl]

3,4,5-Trifluorophenol (50 g, 337.66 mmol, 1 eq) was dissolved in 500 mL of DCM and 14 mL of acetonitrile. To the solution was SO2Cl2 (47.85 g, 354.54 mmol, 1.05 eq) was added dropwise at rt. The reaction mixture was stirred and then was quenched with water. After extractive work-up (DCM/water) and removal of the solvents, 59.16 g of desired chlorinated compound were obtained (84% yield).

¹H NMR (400 MHz, Chloroform-d) δ 6.71 (ddt, J=10.5, 6.8, 1.9 Hz, 1H), 5.61 (s, 1H).

### Step 2. 6-chloro-3,4,5-trifluoro-2-nitro-phenol

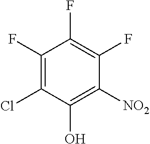 [SMILES: O=[N+]([O-])c1c(O)c(Cl)c(F)c(F)c1F]

Nitric acid (24.23 mL, 580.56 mmol) was dropwise added over a solution of 2-chloro-3,4,5-trifluoro-phenol (124.9 g, 721.1 mmol) in DCM (1000 mL) at −20° C. The reaction mixture was stirred at 0° C. for 2.5 h. After extractive work up H2O/DCM, the crude was purified via automated column chromatography (silica, cyclohexane/EtOAc) to give 107.41 g of desired nitrophenol (90% yield).

¹H NMR (400 MHz, Chloroform-d) δ 10.89 (s, 1H)

### Step 3. 1-chloro-4,5,6-trifluoro-2-methoxy-3-nitro-benzene

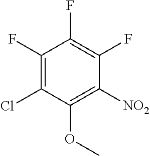

K₂CO₃ (488.36 mg, 3.53 mmol) was slowly added over a solution of 6-chloro-3,4,5-trifluoro-2-nitro-phenol (670 mg, 2.95 mmol) in 10 mL of acetone at room temperature. Iodomethane (1.1 equiv.) was added. The reaction mixture was stirred until full consumption of the starting material was observed. After extractive work up with water and EtOAc the crude was purified via automated column chromatography (Silica, Cyclohexane/EtOAc) to give 507.26 mg of desired product (72% yield).

¹H NMR (400 MHz, Chloroform-d) δ 4.04 (s, 3H).

### Step 4. 5-Chloro-2,3,4-trifluoro-6-methoxy-aniline

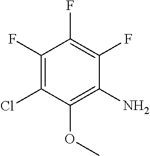

A solution of 1-chloro-4,5,6-trifluoro-2-methoxy-3-nitro-benzene (10.2 g, 42.23 mmol) in 20 mL of EtOAc was gradually added over a suspension of zinc (11.05 g, 168.91 mmol) in 100 mL of acetic acid at room temperature The reaction mixture was stirred at rt for 20 h. After extractive work up H2O/EtOAc, the desired aniline was obtained after evaporation of the solvent (77.23 g, 78% yield).

¹H NMR (400 MHz, Chloroform-d) δ 3.85 (s, 3H).

### Step 5. N4-(5-Chloro-2,3,4-trifluoro-6-methoxy-phenyl)-6-(1-fluoro-1-methyl-ethyl)-1,3,5-triazine-2,4-diamine

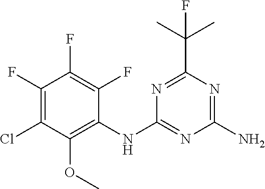 [SMILES: COc1c(Cl)c(F)c(F)c(F)c1Nc1nc(N)nc(C(C)(C)F)n1]

5-Chloro-2,3,4-trifluoro-6-methoxy-aniline (12 g, 56.72 mmol) and 4-chloro-6-(1-fluoro-1-methyl-ethyl)-1,3,5-triazin-2-amine (10.82 g, 56.72 mmol) were dissolved in 100 mL dioxane. After the addition of 3 equivalents of 4M HCl in dioxane, the reaction mixture was stirred at 90° C. for 4 h. Extractive work-up H2O/EtOAc and the crude was purified via automated column chromatography to give 4.35 g of compound I-4 (31% yield).

¹H NMR (400 MHz, DMSO-d6) δ 9.29 (s, 1H), 7.15 (d, J=57.2 Hz, 2H), 3.78 (s, 3H), 1.56 (d, J=21.6 Hz, 6H).

The compounds I-1 to I-4 can be synthesized accordingly.

### B Use Examples

The herbicidal action of the compounds and compositions according to the invention was demonstrated by the following greenhouse experiments:

The culture containers used were plastic pots containing loamy sand with approximately 3.0% of humus as substrate. The seeds of the test plants were sown separately for each species.

For the pre-emergence treatment, the active compounds, suspended or emulsified in water, were applied directly after sowing by means of finely distributing nozzles. The containers were irrigated gently to promote germination and growth and subsequently covered with transparent plastic hoods until the plants had rooted. This cover caused uniform germination of the test plants unless this was adversely affected by the active compounds.

For the post-emergence treatment, the test plants were grown to a plant height of from 3 to 15 cm, depending on the plant habit, and only then treated with the active compounds which had been suspended or emulsified in water. To this end, the test plants were either sown directly, and grown in the same containers, or they were first grown separately as seedlings and transplanted into the test containers a few days prior to treatment.

Depending on the species, the plants were kept at 10-25° C. and 20-35° C., respectively.

The test period extended over 2 to 4 weeks. During this time, the plants were tended and their response to the individual treatments was evaluated.

Evaluation was carried out using a scale from 0 to 100. 100 means no emergence of the plants, or complete destruction of at least the above-ground parts, and 0 means no damage or normal course of growth. A good herbicidal activity is given at values of at least 70, and very good herbicidal activity is given at values of at least 85.

If not stated differently, the respective components A and B, and if appropriate, C were formulated as a 5% by weight strength emulsion concentrate and, with addition of the amount of solvent system, introduced into the spray liquor used for applying the active compound.

In the examples below, using the method of S. R. Colby (1967) “Calculating synergistic and antagonistic responses of herbicide combinations”, Weeds 15, p. 22ff., the value E, which is expected if the activity of the individual active compounds is only additive, was calculated.

$$E = X + Y - ( X \cdot Y / 100 )$$

where
X=percent activity using active compound A at an application rate a;
Y=percent activity using active compound B at an application rate b;
E=expected activity (in %) by A+B at application rates a+b.

If the value found experimentally is higher than the value E calculated according to Colby, a synergistic effect is present.

The following active compounds have been tested:

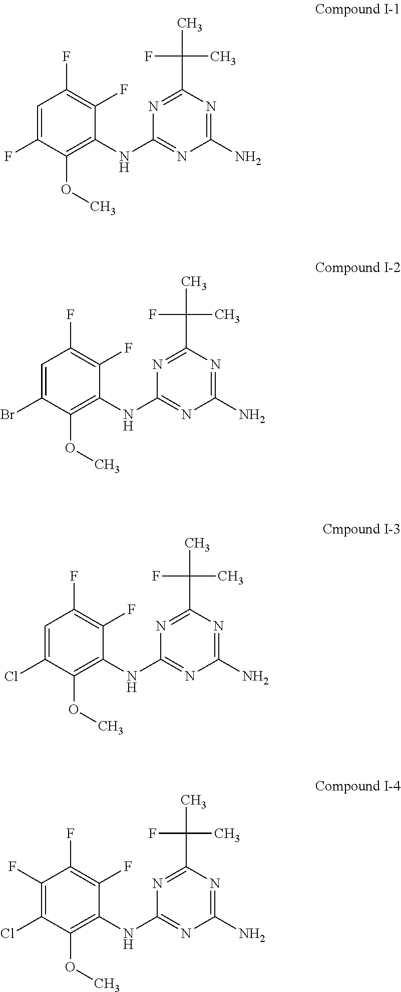 [SMILES: COc1c(F)cc(F)c(F)c1Nc1nc(N)nc(C(C)(C)F)n1 ; COc1c(Br)cc(F)c(F)c1Nc1nc(N)nc(C(C)(C)F)n1 ; COc1c(Cl)cc(F)c(F)c1Nc1nc(N)nc(C(C)(C)F)n1 ; COc1c(Cl)c(F)c(F)c(F)c1Nc1nc(N)nc(C(C)(C)F)n1]

The compounds 1-1 to 1-4 were used as an 5% EC formulation.

The compounds B were used as disclosed below in each example. The plants used in the greenhouse experiments were of the following species:

| Bayer Code | Scientific name |
|---|---|
| ABUTH | Abutilon theophrasti |
| ALOMY | Alopecurus myosuroides |
| AMARE | Amaranthus retroflexus |
| AMBEL | Ambrosia artemisiifolia |
| AVEFA | Avena fatua |
| BRADC | Brachiaria decumbens |
| COMBE | Commelina benghalensis |
| DIGSA | Digitaria sanguinalis |
| ECHCG | Echinochloa crus-galli |
| EPHHL | Euphorbia heterophylla |
| GALAP | Galium aparine |
| GERPU | Geranium pusillum |
| IPOHE | Ipomoea hederacea |
| LOLMU | Lolium multiflorum |
| POLCO | Polygonum convolvulus |
| SETVI | Setaria viridis |

The results of these tests are given below in the use examples and demonstrate the synergistic effect of the mixtures comprising at least one phenyluracil of the formula (I) and at least one herbicide B.

In this context, a.i. means active ingredient, based on 100% active ingredient.

As indicated application was either post emergent (POST) at the respective growth stage (GS) of the weed (BBCH code), or pre-emergent (PRE).

Assessment was 20 days after treatment (DAT).

### Example 1: Synergistic Herbicidal Action of the Composition of the Compound I-1 and Pyroxasulfone (PRE)

Pyroxasulfone was used as an SC formulation, having an active ingredient concentration of 500 g/l.

| | | | | | combination | |
|---|---|---|---|---|---|---|
| | solo application | | | | Compound I-1 + | |
| | Compound I-1 | | Pyroxasulfone | | Pyroxasulfone | |
| | use rate | % | use rate | % | use rate | % |
| weed | (gai/ha) | activity | (gai/ha) | activity | (gai/ha) | activity |
| ECHCG | 2 | 35 | 8 | 80 | 2 + 8 | 100 |
| ECHCG | 2 | 35 | 4 | 80 | 2 + 4 | 98 |
| EPHHL | 8 | 0 | 16 | 25 | 8 + 16 | 100 |
| EPHHL | 4 | 0 | 16 | 25 | 4 + 16 | 90 |
| EPHHL | 8 | 0 | 8 | 20 | 8 + 8 | 85 |
| EPHHL | 8 | 0 | 4 | 25 | 8 + 4 | 90 |
| EPHHL | 4 | 0 | 4 | 25 | 4 + 4 | 85 |
| IPOHE | 16 | 75 | 16 | 0 | 16 + 16 | 98 |
| IPOHE | 8 | 70 | 16 | 0 | 8 + 16 | 98 |
| ABUTH | 4 | 75 | 16 | 10 | 4 + 16 | 100 |
| ABUTH | 2 | 65 | 16 | 10 | 2 + 16 | 100 |
| ABUTH | 4 | 75 | 8 | 0 | 4 + 8 | 100 |
| ABUTH | 2 | 65 | 8 | 0 | 2 + 8 | 100 |
| ABUTH | 4 | 75 | 4 | 0 | 4 + 4 | 100 |
| ABUTH | 2 | 65 | 4 | 0 | 2 + 4 | 98 |

### Example 2: Synergistic Herbicidal Action of the Composition of the Compound I-2 and Pyroxasulfone (POST)

Pyroxasulfone was used as an SC formulation, having an active ingredient concentration of 500 g/l.

| | | | | | combination | |
|---|---|---|---|---|---|---|
| | solo application | | | | Compound I-2 + | |
| | Compound I-2 | | Pyroxasulfone | | Pyroxasulfone | |
| | use rate | % | use rate | % | use rate | % |
| weed | (gai/ha) | activity | (gai/ha) | activity | (gai/ha) | activity |
| SETVI | 8 | 25 | 16 | 80 | 8 + 16 | 95 |
| SETVI | 4 | 20 | 8 | 40 | 4 + 8 | 75 |
| SETVI | 8 | 25 | 4 | 30 | 8 + 4 | 70 |
| COMBE | 8 | 40 | 16 | 45 | 8 + 16 | 80 |
| COMBE | 4 | 0 | 16 | 45 | 4 + 16 | 95 |
| EPHHL | 8 | 60 | 16 | 25 | 8 + 16 | 85 |
| EPHHL | 4 | 50 | 16 | 25 | 4 + 16 | 75 |
| EPHHL | 4 | 50 | 8 | 10 | 4 + 8 | 65 |

### Example 3: Synergistic Herbicidal Action of the Composition of the Compound I-1 and Saflufenacil (POST)

Saflufenacil was used as an SC formulation, having an active ingredient concentration of 342 g/l.

| | | | | | combination | |
|---|---|---|---|---|---|---|
| | solo application | | | | Compound I-1 + | |
| | Compound I-1 | | Saflufenacil | | Saflufenacil | |
| | use rate | % | use rate | % | use rate | % |
| weed | (gai/ha) | activity | (gai/ha) | activity | (gai/ha) | activity |
| SETVI | 4 | 70 | 5 | 60 | 4 + 5 | 98 |
| SETVI | 2 | 5 | 5 | 60 | 2 + 5 | 95 |
| COMBE | 16 | 75 | 1.25 | 60 | 16 + 1.25 | 100 |
| GERPU | 8 | 50 | 5 | 80 | 8 + 5 | 100 |
| GERPU | 16 | 70 | 2.5 | 60 | 16 + 2.5 | 100 |

### Example 4: Synergistic Herbicidal Action of the Composition of the Compound I-3 and Saflufenacil (PRE)

Saflufenacil was used as an SC formulation, having an active ingredient concentration of 342 g/l.

| | | | | | combination | |
|---|---|---|---|---|---|---|
| | solo application | | | | LS Compound I-3 + | |
| | LS Compound I-3 | | Saflufenacil | | Saflufenacil | |
| | use rate | % | use rate | % | use rate | % |
| weed | (gai/ha) | activity | (gai/ha) | activity | (gai/ha) | activity |
| LOLMU | 4 | 80 | 5 | 45 | 4 + 5 | 100 |
| IPOHE | 32 | 40 | 5 | 25 | 32 + 5 | 100 |
| IPOHE | 16 | 40 | 5 | 25 | 16 + 5 | 65 |
| IPOHE | 8 | 30 | 5 | 25 | 8 + 5 | 70 |
| IPOHE | 4 | 5 | 5 | 25 | 4 + 5 | 50 |
| IPOHE | 32 | 40 | 2.5 | 5 | 32 + 2.5 | 85 |

### Example 5: Synergistic Herbicidal Action of the Composition of the Compound I-1 and Cinmethylin (PRE)

Cinmethylin was used as an EC formulation, having an active ingredient concentration of 750 g/l.

| | | | | | combination | |
|---|---|---|---|---|---|---|
| | solo application | | | | Compound I-1 + | |
| | Compound I-1 | | Cinmethylin | | Cinmethylin | |
| | use rate | % | use rate | % | use rate | % |
| weed | (gai/ha) | activity | (gai/ha) | activity | (gai/ha) | activity |
| EPHHL | 16 | 60 | 50 | 0 | 16 + 50 | 90 |
| EPHHL | 8 | 45 | 50 | 0 | 8 + 50 | 90 |
| EPHHL | 16 | 60 | 25 | 0 | 16 + 25 | 90 |
| EPHHL | 4 | 15 | 25 | 0 | 4 + 25 | 25 |
| IPOHE | 16 | 60 | 50 | 0 | 16 + 50 | 90 |
| IPOHE | 16 | 60 | 25 | 0 | 16 + 25 | 90 |

### Example 6: Synergistic Herbicidal Action of the Composition of the Compound I-3 and Cinmethylin (POST)

Cinmethylin was used as an EC formulation, having an active ingredient concentration of 750 g/l.

| | | | | | combination | |
|---|---|---|---|---|---|---|
| | solo application | | | | Compound I-3 + | |
| | Compound I-3 | | Cinmethylin | | Cinmethylin | |
| | use rate | % | use rate | % | use rate | % |
| weed | (gai/ha) | activity | (gai/ha) | activity | (gai/ha) | activity |
| ABUTH | 16 | 50 | 100 | 0 | 16 + 100 | 98 |
| ABUTH | 4 | 10 | 100 | 0 | 4 + 100 | 60 |
| ABUTH | 16 | 50 | 50 | 0 | 16 + 50 | 98 |
| ABUTH | 4 | 10 | 50 | 0 | 4 + 50 | 65 |
| AMARE | 4 | 50 | 100 | 30 | 4 + 100 | 98 |
| AMARE | 4 | 50 | 25 | 0 | 4 + 25 | 100 |
| GERPU | 16 | 10 | 25 | 10 | 16 + 25 | 100 |
| GERPU | 8 | 0 | 25 | 10 | 8 + 25 | 50 |
| GERPU | 4 | 0 | 25 | 10 | 4 + 25 | 50 |

### Example 7: Synergistic Herbicidal Action of the Composition of the Compound I-1 and Picolinafen (PRE)

Picolinafen was used as an 75% WG formulation.

| | | | | | combination | |
|---|---|---|---|---|---|---|
| | solo application | | | | Compound I-1 + | |
| | Compound I-1 | | Picolinafen | | Picolinafen | |
| | use rate | % | use rate | % | use rate | % |
| weed | (gai/ha) | activity | (gai/ha) | activity | (gai/ha) | activity |
| GERPU | 4 | 50 | 50 | 15 | 4 + 50 | 85 |

### Example 8: Synergistic Herbicidal Action of the Composition of the Compound I-2 and Picolinafen (PRE)

Picolinafen was used as an 75% WG formulation.

| | | | | | combination | |
|---|---|---|---|---|---|---|
| | solo application | | | | Compound I-2 + | |
| | Compound I-2 | | Picolinafen | | Picolinafen | |
| | use rate | % | use rate | % | use rate | % |
| weed | (gai/ha) | activity | (gai/ha) | activity | (gai/ha) | activity |
| ALOMY | 16 | 95 | 50 | 25 | 16 + 50 | 98 |
| GERPU | 8 | 80 | 100 | 40 | 8 + 100 | 98 |

### Example 9: Synergistic Herbicidal Action of the Composition of the Compound I-1 and Atrazine (POST)

Atrazine was used as an SC formulation, having an active ingredient concentration of 480 g/l.

| | | | | | combination | |
|---|---|---|---|---|---|---|
| | solo application | | | | Compound I-1 + | |
| | Compound I-1 | | Atrazine | | Atrazine | |
| | use rate | % | use rate | % | use rate | % |
| weed | (gai/ha) | activity | (gai/ha) | activity | (gai/ha) | activity |
| GERPU | 4 | 0 | 100 | 75 | 4 + 100 | 98 |
| GERPU | 2 | 0 | 100 | 75 | 2 + 100 | 80 |
| GERPU | 4 | 0 | 50 | 30 | 4 + 50 | 75 |
| GERPU | 2 | 0 | 50 | 30 | 2 + 50 | 75 |

Example 10: Synergistic Herbicidal Action of the Composition of the Compound I-3 and Atrazine (PRE)

Atrazine was used as an SC formulation, having an active ingredient concentration of 480 g/l.

| | | | | | combination | |
|---|---|---|---|---|---|---|
| | solo application | | | | Compound I-3 + | |
| | Compound I-3 | | Atrazine | | Atrazine | |
| | use rate | % | use rate | % | use rate | % |
| weed | (gai/ha) | activity | (gai/ha) | activity | (gai/ha) | activity |
| COMBE | 8 | 70 | 100 | 25 | 8 + 100 | 90 |
| COMBE | 4 | 35 | 100 | 25 | 4 + 100 | 85 |
| ABUTH | 8 | 70 | 50 | 0 | 8 + 50 | 90 |

### Example 11: Synergistic Herbicidal Action of the Composition of the Compound I-1 and Diflufenican (POST)

Diflufenican was used as an SC formulation, having an active ingredient concentration of 500 g/l.

| | | | | | combination | |
|---|---|---|---|---|---|---|
| | solo application | | | | Compound I-1 + | |
| | Compound I-1 | | Diflufenican | | Diflufenican | |
| | use rate | % | use rate | % | use rate | % |
| weed | (gai/ha) | activity | (gai/ha) | activity | (gai/ha) | activity |
| DIGSA | 4 | 30 | 100 | 35 | 4 + 100 | 60 |
| DIGSA | 2 | 0 | 100 | 35 | 2 + 100 | 45 |
| GERPU | 4 | 0 | 50 | 25 | 4 + 50 | 35 |
| GERPU | 2 | 0 | 50 | 25 | 2 + 50 | 30 |

### Example 12: Synergistic Herbicidal Action of the Composition of the Compound I-2 and Diflufenican (POST)

Diflufenican was used as an SC formulation, having an active ingredient concentration of 500 g/l.

| | | | | | combination | |
|---|---|---|---|---|---|---|
| | solo application | | | | Compound I-2 + | |
| | Compound I-2 | | Diflufenican | | Diflufenican | |
| | use rate | % | use rate | % | use rate | % |
| weed | (gai/ha) | activity | (gai/ha) | activity | (gai/ha) | activity |
| ECHCG | 4 | 0 | 100 | 40 | 4 + 100 | 50 |
| COMBE | 8 | 10 | 100 | 20 | 8 + 100 | 60 |
| COMBE | 4 | 0 | 100 | 20 | 4 + 100 | 65 |
| COMBE | 8 | 10 | 50 | 25 | 8 + 50 | 70 |

### Example 13: Synergistic Herbicidal Action of the Composition of the Compound I-1 and Glufosinate-Ammonium (POST)

Glufosinate-Ammonium was used as an SL formulation, having an active ingredient concentration of 281.8 g/l.

| | | | | | combination | |
|---|---|---|---|---|---|---|
| | solo application | | | | Compound I-1 + | |
| | | | Glufosinate- | | Glufosinate- | |
| | Compound I-1 | | Ammonium | | Ammonium | |
| | use rate | % | use rate | % | use rate | % |
| weed | (gai/ha) | activity | (gai/ha) | activity | (gai/ha) | activity |
| ECHCG | 4 | 0 | 150 | 30 | 4 + 150 | 60 |
| DIGSA | 2 | 0 | 150 | 95 | 2 + 150 | 98 |
| ABUTH | 4 | 50 | 75 | 30 | 4 + 75 | 90 |
| ABUTH | 2 | 30 | 75 | 30 | 2 + 75 | 60 |
| EPHHL | 4 | 60 | 150 | 45 | 4 + 150 | 95 |
| EPHHL | 2 | 50 | 150 | 45 | 2 + 150 | 80 |

### Example 14: Synergistic Herbicidal Action of the Composition of the Compound I-3 and Glufosinate-Ammonium (POST)

Glufosinate-Ammonium was used as an SL formulation, having an active ingredient concentration of 281.8 g/l.

| | | | | | combination | |
|---|---|---|---|---|---|---|
| | solo application | | | | Compound I-3 + | |
| | | | Glufosinate- | | Glufosinate- | |
| | Compound I-3 | | Ammonium | | Ammonium | |
| | use rate | % | use rate | % | use rate | % |
| weed | (gai/ha) | activity | (gai/ha) | activity | (gai/ha) | activity |
| ECHCG | 8 | 50 | 150 | 30 | 8 + 150 | 75 |
| ECHCG | 4 | 35 | 150 | 30 | 4 + 150 | 75 |
| ECHCG | 8 | 50 | 75 | 0 | 8 + 75 | 65 |
| EPHHL | 4 | 65 | 150 | 45 | 4 + 150 | 95 |
| GERPU | 4 | 0 | 75 | 35 | 4 + 75 | 60 |

### Example 15: Synergistic Herbicidal Action of the Composition of the Compound I-3 and L-Glufosinate-P-Ammonium (POST)

L-Glufosinate-P-Ammonium was used as an 5% EC formulation.

| | | | | | combination | |
|---|---|---|---|---|---|---|
| | solo application | | | | Compound I-3 + | |
| | | | L-Glufosinate- | | L-Glufosinate- | |
| | Compound I-3 | | P-Ammonium | | P-Ammonium | |
| | use rate | % | use rate | % | use rate | % |
| weed | (gai/ha) | activity | (gai/ha) | activity | (gai/ha) | activity |
| ECHCG | 8 | 50 | 75 | 30 | 8 + 75 | 95 |
| ECHCG | 4 | 35 | 75 | 30 | 4 + 75 | 75 |
| GERPU | 8 | 25 | 75 | 65 | 8 + 75 | 95 |
| GERPU | 4 | 0 | 75 | 65 | 4 + 75 | 90 |

### Example 16: Synergistic Herbicidal Action of the Composition of the Compound I-1 and Topramezone (PRE)

Topramezone was used as an SC formulation, having an active ingredient concentration of 336 g/l.

| | | | | | combination | |
|---|---|---|---|---|---|---|
| | solo application | | | | Compound I-1 + | |
| | Compound I-1 | | Topramezone | | Topramezone | |
| | use rate | % | use rate | % | use rate | % |
| weed | (gai/ha) | activity | (gai/ha) | activity | (gai/ha) | activity |
| LOLMU | 2 | 50 | 3.125 | 0 | 2 + 3.125 | 80 |
| ECHCG | 2 | 65 | 6.25 | 10 | 2 + 6.25 | 85 |
| SETVI | 2 | 20 | 3.125 | 0 | 2 + 3.125 | 60 |
| AMBEL | 1 | 10 | 6.25 | 0 | 1 + 6.25 | 70 |

### Example 17: Synergistic Herbicidal Action of the Composition of the Compound I-2 and Topramezone (POST)

Topramezone was used as an SC formulation, having an active ingredient concentration of 336 g/l.

| | | | | | combination | |
|---|---|---|---|---|---|---|
| | solo application | | | | Compound I-2 + | |
| | Compound I-2 | | Topramezone | | Topramezone | |
| | use rate | % | use rate | % | use rate | % |
| weed | (gai/ha) | activity | (gai/ha) | activity | (gai/ha) | activity |
| IPOHE | 4 | 35 | 6.25 | 35 | 4 + 6.25 | 75 |
| IPOHE | 4 | 35 | 3.125 | 15 | 4 + 3.125 | 60 |
| IPOHE | 2 | 10 | 3.125 | 15 | 2 + 3.125 | 30 |

### Example 18: Synergistic Herbicidal Action of the Composition of the Compound I-1 and Sethoxydim (PRE)

Sethoxydim was used as an EC formulation, having an active ingredient concentration of 460 g/l.

| | | | | | combination | |
|---|---|---|---|---|---|---|
| | solo application | | | | Compound I-1 + | |
| | Compound I-1 | | Sethoxydim | | Sethoxydim | |
| | use rate | % | use rate | % | use rate | % |
| weed | (gai/ha) | activity | (gai/ha) | activity | (gai/ha) | activity |
| ALOMY | 1 | 10 | 6.25 | 20 | 1 + 6.25 | 70 |
| LOLMU | 1 | 40 | 6.25 | 15 | 1 + 6.25 | 60 |
| ECHCG | 2 | 65 | 12.5 | 40 | 2 + 12.5 | 90 |
| ECHCG | 2 | 65 | 6.25 | 10 | 2 + 6.25 | 80 |
| SETVI | 2 | 20 | 12.5 | 60 | 2 + 12.5 | 95 |
| SETVI | 2 | 20 | 6.25 | 5 | 2 + 6.25 | 80 |

### Example 19: Synergistic Herbicidal Action of the Composition of the Compound I-2 and Sethoxydim (PRE)

Sethoxydim was used as an EC formulation, having an active ingredient concentration of 460 g/l.

| | | | | | combination | |
|---|---|---|---|---|---|---|
| | solo application | | | | Compound I-2 + | |
| | Compound I-2 | | Sethoxydim | | Sethoxydim | |
| | use rate | % | use rate | % | use rate | % |
| weed | (gai/ha) | activity | (gai/ha) | activity | (gai/ha) | activity |
| ALOMY | 2 | 20 | 6.25 | 20 | 2 + 6.25 | 60 |
| SETVI | 4 | 30 | 12.5 | 60 | 4 + 12.5 | 80 |
| SETVI | 2 | 10 | 12.5 | 60 | 2 + 12.5 | 70 |
| SETVI | 4 | 30 | 6.25 | 5 | 4 + 6.25 | 50 |
| SETVI | 2 | 10 | 6.25 | 5 | 2 + 6.25 | 30 |
| COMBE | 4 | 10 | 6.25 | 0 | 4 + 6.25 | 70 |

### Example 20: Synergistic Herbicidal Action of the Composition of the Compound I-1 and Dicamba (POST)

Dicamba was used as an SL formulation, having an active ingredient concentration of 480 g/l.

| | | | | | combination | |
|---|---|---|---|---|---|---|
| | solo application | | | | Compound I-1 + | |
| | Compound I-1 | | Dicamba | | Dicamba | |
| | use rate | % | use rate | % | use rate | % |
| weed | (gai/ha) | activity | (gai/ha) | activity | (gai/ha) | activity |
| ABUTH | 2 | 10 | 62.5 | 65 | 2 + 62.5 | 80 |
| EPHHL | 2 | 40 | 62.5 | 35 | 2 + 62.5 | 75 |
| EPHHL | 2 | 40 | 31.25 | 10 | 2 + 31.25 | 70 |

### Example 21: Synergistic Herbicidal Action of the Composition of the Compound I-3 and Dicamba (POST)

Dicamba was used as an SL formulation, having an active ingredient concentration of 480 g/l.

| | | | | | combination | |
|---|---|---|---|---|---|---|
| | solo application | | | | Compound I-3 + | |
| | Compound I-3 | | Dicamba | | Dicamba | |
| | use rate | % | use rate | % | use rate | % |
| weed | (gai/ha) | activity | (gai/ha) | activity | (gai/ha) | activity |
| ABUTH | 2 | 30 | 31.25 | 60 | 2 + 31.25 | 80 |
| EPHHL | 4 | 60 | 62.5 | 35 | 4 + 62.5 | 98 |
| EPHHL | 4 | 60 | 31.25 | 10 | 4 + 31.25 | 70 |

### Example 22: Synergistic Herbicidal Action of the Composition of the Compound I-2 and Imazethapyr (PRE)

Imazethapyr was used as an SL formulation, having an active ingredient concentration of 240 g/l.

| | | | | | combination | |
|---|---|---|---|---|---|---|
| | solo application | | | | Compound I-2 + | |
| | Compound I-2 | | Imazethapyr | | Imazethapyr | |
| | use rate | % | use rate | % | use rate | % |
| weed | (gai/ha) | activity | (gai/ha) | activity | (gai/ha) | activity |
| LOLMU | 2 | 40 | 15 | 40 | 2 + 15 | 85 |
| COMBE | 4 | 15 | 7.5 | 30 | 4 + 7.5 | 50 |
| ABUTH | 2 | 20 | 7.5 | 60 | 2 + 7.5 | 80 |
| AMBEL | 4 | 20 | 15 | 10 | 4 + 15 | 45 |

### Example 23: Synergistic Herbicidal Action of the Composition of the Compound I-3 and Imazethapyr (PRE)

Imazethapyr was used as an SL formulation, having an active ingredient concentration of 240 g/l.

| | | | | | combination | |
|---|---|---|---|---|---|---|
| | solo application | | | | Compound I-3 + | |
| | Compound I-3 | | Imazethapyr | | Imazethapyr | |
| | use rate | % | use rate | % | use rate | % |
| weed | (gai/ha) | activity | (gai/ha) | activity | (gai/ha) | activity |
| COMBE | 4 | 25 | 15 | 70 | 4 + 15 | 85 |
| COMBE | 4 | 25 | 7.5 | 30 | 4 + 7.5 | 70 |
| AMBEL | 4 | 25 | 15 | 10 | 4 + 15 | 75 |
| AMBEL | 4 | 25 | 7.5 | 0 | 4 + 7.5 | 75 |

### Example 24: Synergistic Herbicidal Action of the Composition of the Compound I-1 and Trifludimoxazin (POST)

Trifludimoxazin was used as an SC formulation, having an active ingredient concentration of 500 g/l.

| | | | | | combination | |
|---|---|---|---|---|---|---|
| | solo application | | | | Compound I-1 + | |
| | Compound I-1 | | Trifludimoxazin | | Trifludimoxazin | |
| | use rate | % | use rate | % | use rate | % |
| weed | (gai/ha) | activity | (gai/ha) | activity | (gai/ha) | activity |
| DIGSA | 2 | 10 | 1 | 30 | 2 + 1 | 55 |
| DIGSA | 1 | 0 | 1 | 30 | 1 + 1 | 75 |
| ABUTH | 1 | 10 | 0.5 | 80 | 1 + 0.5 | 95 |

### Example 25: Synergistic Herbicidal Action of the Composition of the Compound I-3 and Trifludimoxazin (PRE)

| | | | | | combination | |
|---|---|---|---|---|---|---|
| | solo application | | | | Compound I-3 + | |
| | Compound I-3 | | Trifludimoxazin | | Trifludimoxazin | |
| | use rate | % | use rate | % | use rate | % |
| weed | (gai/ha) | activity | (gai/ha) | activity | (gai/ha) | activity |
| ALOMY | 4 | 90 | 0.5 | 10 | 4 + 0.5 | 98 |
| ABUTH | 4 | 65 | 0.5 | 0 | 4 + 0.5 | 98 |
| AMBEL | 4 | 25 | 0.5 | 0 | 4 + 0.5 | 80 |

### Example 26: Synergistic Herbicidal Action of the Composition of the Compound I-1 and Glyphosate (POST)

Glyphosate was used as an SL formulation, having an active ingredient concentration of 575 g/l.

| | | | | | combination | |
|---|---|---|---|---|---|---|
| | solo application | | | | Compound I-1 + | |
| | Compound I-1 | | Glyphosate | | Glyphosate | |
| | use rate | % | use rate | % | use rate | % |
| weed | (gai/ha) | activity | (gai/ha) | activity | (gai/ha) | activity |
| ECHCG | 2 | 10 | 200 | 35 | 2 + 200 | 80 |
| ECHCG | 1 | 10 | 100 | 30 | 1 + 100 | 50 |
| ABUTH | 1 | 10 | 200 | 25 | 1 + 200 | 90 |
| AMARE | 1 | 50 | 200 | 80 | 1 + 200 | 100 |
| GERPU | 1 | 30 | 100 | 45 | 1 + 100 | 85 |

### Example 27: Synergistic Herbicidal Action of the Composition of the Compound I-2 and Glyphosate (POST)

Glyphosate was used as an SL formulation, having an active ingredient concentration of 575 g/l.

| | | | | | combination | |
|---|---|---|---|---|---|---|
| | solo application | | | | Compound I-2 + | |
| | Compound I-2 | | Glyphosate | | Glyphosate | |
| | use rate | % | use rate | % | use rate | % |
| weed | (gai/ha) | activity | (gai/ha) | activity | (gai/ha) | activity |
| ECHCG | 4 | 25 | 200 | 35 | 4 + 200 | 65 |
| IPOHE | 2 | 30 | 200 | 15 | 2 + 200 | 60 |
| GERPU | 2 | 30 | 100 | 45 | 2 + 100 | 90 |

### Example 28: Synergistic Herbicidal Action of the Composition of the Compound I-3 and Glyphosate (POST)

Glyphosate was used as an SL formulation, having an active ingredient concentration of 575 g/l.

| | | | | | combination | |
|---|---|---|---|---|---|---|
| | solo application | | | | Compound I-3 + | |
| | Compound I-3 | | Glyphosate | | Glyphosate | |
| | use rate | % | use rate | % | use rate | % |
| weed | (gai/ha) | activity | (gai/ha) | activity | (gai/ha) | activity |
| ECHCG | 2 | 30 | 200 | 35 | 2 + 200 | 75 |
| ABUTH | 2 | 30 | 200 | 25 | 2 + 200 | 70 |
| AMARE | 2 | 70 | 100 | 10 | 2 + 100 | 100 |
| GERPU | 4 | 40 | 100 | 45 | 4 + 100 | 80 |
| GERPU | 2 | 20 | 100 | 45 | 2 + 100 | 75 |

### Example 29: Synergistic Herbicidal Action of the Composition of the Compound I-1 and Pendimethalin (PRE)

Pendimethalin was used as an SC formulation, having an active ingredient concentration of 400 g/l.

| | | | | | combination | |
|---|---|---|---|---|---|---|
| | solo application | | | | Compound I-1 + | |
| | Compound I-1 | | Pendimethalin | | Pendimethalin | |
| | use rate | % | use rate | % | use rate | % |
| weed | (gai/ha) | activity | (gai/ha) | activity | (gai/ha) | activity |
| LOLMU | 1 | 35 | 200 | 0 | 1 + 200 | 40 |
| GALAP | 1 | 0 | 200 | 0 | 1 + 200 | 35 |
| POLCO | 1 | 50 | 800 | 70 | 1 + 800 | 90 |

### Example 30: Synergistic Herbicidal Action of the Composition of the Compound I-3 and Pendimethalin (PRE)

Pendimethalin was used as an SC formulation, having an active ingredient concentration of 400 g/l.

| | | | | | combination | |
|---|---|---|---|---|---|---|
| | solo application | | | | Compound I-3 + | |
| | Compound I-3 | | Pendimethalin | | Pendimethalin | |
| | use rate | % | use rate | % | use rate | % |
| weed | (gai/ha) | activity | (gai/ha) | activity | (gai/ha) | activity |
| LOLMU | 2 | 40 | 200 | 0 | 2 + 200 | 50 |
| COMBE | 8 | 75 | 800 | 50 | 8 + 800 | 100 |
| COMBE | 2 | 0 | 800 | 50 | 2 + 800 | 60 |
| COMBE | 2 | 0 | 200 | 40 | 2 + 200 | 60 |
| GALAP | 8 | 75 | 800 | 10 | 8 + 800 | 98 |
| GALAP | 2 | 15 | 800 | 10 | 2 + 800 | 65 |
| ABUTH | 2 | 65 | 200 | 65 | 2 + 200 | 100 |

### Example 31: Synergistic Herbicidal Action of the Composition of the Compound I-1 and Pretilachlor (PRE)

Pretilachlor was used as an SC formulation, having an active ingredient concentration of 500 g/l.

| | | | | | combination | |
|---|---|---|---|---|---|---|
| | solo application | | | | Compound I-1 + | |
| | Compound I-1 | | Pretilachlor | | Pretilachlor | |
| | use rate | % | use rate | % | use rate | % |
| weed | (gai/ha) | activity | (gai/ha) | activity | (gai/ha) | activity |
| BRADC | 1 | 0 | 200 | 40 | 1 + 200 | 50 |
| BRADC | 1 | 0 | 25 | 0 | 1 + 25 | 40 |
| GERPU | 4 | 10 | 200 | 45 | 4 + 200 | 65 |
| GALAP | 1 | 0 | 200 | 15 | 1 + 200 | 60 |
| EPPHL | 1 | 0 | 200 | 10 | 1 + 200 | 65 |
| EPPHL | 1 | 0 | 25 | 0 | 1 + 25 | 55 |
| POLCO | 1 | 50 | 200 | 30 | 1 + 200 | 90 |
| POLCO | 1 | 50 | 25 | 0 | 1 + 25 | 98 |

### Example 32: Synergistic Herbicidal Action of the Composition of the Compound I-2 and Pretilachlor (PRE)

Pretilachlor was used as an SC formulation, having an active ingredient concentration of 500 g/l.

| | | | | | combination | |
|---|---|---|---|---|---|---|
| | solo application | | | | Compound I-2 + | |
| | Compound I-2 | | Pretilachlor | | Pretilachlor | |
| | use rate | % | use rate | % | use rate | % |
| weed | (gai/ha) | activity | (gai/ha) | activity | (gai/ha) | activity |
| LOLMU | 8 | 60 | 25 | 0 | 8 + 25 | 75 |
| BRADC | 8 | 70 | 25 | 0 | 8 + 25 | 80 |
| GERPU | 8 | 0 | 200 | 45 | 8 + 200 | 90 |
| GALAP | 8 | 15 | 200 | 15 | 8 + 200 | 98 |
| POLCO | 8 | 80 | 25 | 0 | 8 + 25 | 98 |

### Example 33: Synergistic Herbicidal Action of the Composition of the Compound I-1 and Bixlozone (PRE)

Bixlozone used as an SC formulation, having an active ingredient concentration of 400 g/l.

| | | | | | combination | |
|---|---|---|---|---|---|---|
| | solo application | | | | Compound I-1 + | |
| | Compound I-1 | | Bixlozone | | Bixlozone | |
| | use rate | % | use rate | % | use rate | % |
| weed | (gai/ha) | activity | (gai/ha) | activity | (gai/ha) | activity |
| GALAP | 1 | 0 | 60 | 50 | 1 + 60 | 65 |
| EPPHL | 4 | 70 | 60 | 0 | 4 + 60 | 80 |
| POLCO | 1 | 50 | 60 | 0 | 1 + 60 | 75 |

### Example 34: Synergistic Herbicidal Action of the Composition of the Compound I-3 and Bixlozone (PRE)

Bixlozone used as an SC formulation, having an active ingredient concentration of 400 g/l.

| | | | | | combination | |
|---|---|---|---|---|---|---|
| | solo application | | | | Compound I-3 + | |
| | Compound I-3 | | Bixlozone | | Bixlozone | |
| | use rate | % | use rate | % | use rate | % |
| weed | (gai/ha) | activity | (gai/ha) | activity | (gai/ha) | activity |
| GALAP | 8 | 75 | 60 | 50 | 8 + 60 | 100 |
| ABUTH | 2 | 65 | 60 | 0 | 2 + 60 | 80 |
| EPPHL | 8 | 80 | 60 | 0 | 8 + 60 | 90 |
| EPPHL | 2 | 45 | 15 | 0 | 2 + 15 | 60 |

### Example 35: Synergistic Herbicidal Action of the Composition of the Compound I-1 and Aclonifen (PRE)

Aclonifen was used as an SC formulation, having an active ingredient concentration of 600 g/l.

| | | | | | combination | |
|---|---|---|---|---|---|---|
| | solo application | | | | Compound I-1 + | |
| | Compound I-1 | | Aclonifen | | Aclonifen | |
| | use rate | % | use rate | % | use rate | % |
| weed | (gai/ha) | activity | (gai/ha) | activity | (gai/ha) | activity |
| ALOMY | 1 | 15 | 300 | 0 | 1 + 300 | 50 |
| LOLMU | 1 | 20 | 300 | 10 | 1 + 300 | 50 |
| AVEFA | 4 | 70 | 300 | 0 | 4 + 300 | 90 |
| COMBE | 4 | 0 | 1200 | 85 | 4 + 1200 | 95 |
| GERPU | 4 | 20 | 1200 | 65 | 4 + 1200 | 90 |
| GERPU | 4 | 20 | 300 | 30 | 4 + 300 | 55 |
| GALAP | 1 | 0 | 1200 | 45 | 1 + 1200 | 60 |
| ABUTH | 1 | 75 | 1200 | 35 | 1 + 1200 | 98 |
| EPHHL | 4 | 25 | 300 | 20 | 4 + 300 | 85 |

### Example 36: Synergistic Herbicidal Action of the Composition of the Compound I-3 and Aclonifen (PRE)

Aclonifen was used as an SC formulation, having an active ingredient concentration of 600 g/l.

| | | | | | combination | |
|---|---|---|---|---|---|---|
| | solo application | | | | Compound I-3 + | |
| | Compound I-3 | | Aclonifen | | Aclonifen | |
| | use rate | % | use rate | % | use rate | % |
| weed | (gai/ha) | activity | (gai/ha) | activity | (gai/ha) | activity |
| ALOMY | 2 | 25 | 1200 | 50 | 2 + 1200 | 80 |
| ALOMY | 2 | 25 | 300 | 0 | 2 + 300 | 40 |
| AVEFA | 2 | 20 | 1200 | 0 | 2 + 1200 | 60 |
| GERPU | 8 | 15 | 1200 | 65 | 8 + 1200 | 90 |
| GERPU | 2 | 0 | 1200 | 65 | 2 + 1200 | 85 |
| GERPU | 8 | 15 | 300 | 30 | 8 + 300 | 70 |
| GERPU | 2 | 0 | 300 | 30 | 2 + 300 | 65 |
| EPHHL | 2 | 10 | 1200 | 50 | 2 + 1200 | 85 |
| EPHHL | 8 | 55 | 300 | 20 | 8 + 300 | 80 |
| IPOHE | 8 | 35 | 1200 | 0 | 8 + 1200 | 55 |

### Example 37: Synergistic Herbicidal Action of the Composition of the Compound I-1 and Butachlor (PRE)

Butachlor was used as an EW formulation, having an active ingredient concentration of 50%.

| | | | | | combination | |
|---|---|---|---|---|---|---|
| | solo application | | | | Compound I-1 + | |
| | Compound I-1 | | Butachlor | | Butachlor | |
| | use rate | % | use rate | % | use rate | % |
| weed | (gai/ha) | activity | (gai/ha) | activity | (gai/ha) | activity |
| LOLMU | 4 | 85 | 200 | 0 | 4 + 200 | 98 |
| LOLMU | 4 | 85 | 50 | 0 | 4 + 50 | 98 |
| AVEFA | 4 | 70 | 50 | 0 | 4 + 50 | 80 |
| SETFA | 1 | 60 | 50 | 25 | 1 + 50 | 85 |
| GERPU | 4 | 20 | 200 | 25 | 4 + 200 | 85 |
| GERPU | 4 | 20 | 50 | 55 | 4 + 50 | 80 |
| ABUTH | 1 | 75 | 50 | 0 | 1 + 50 | 85 |

### Example 38: Synergistic Herbicidal Action of the Composition of the Compound I-2 and Butachlor (PRE)

Butachlor was used as an EW formulation, having an active ingredient concentration of 50%.

| | | | | | combination | |
|---|---|---|---|---|---|---|
| | solo application | | | | Compound I-2 + | |
| | Compound I-2 | | Butachlor | | Butachlor | |
| | use rate | % | use rate | % | use rate | % |
| weed | (gai/ha) | activity | (gai/ha) | activity | (gai/ha) | activity |
| ALOMY | 8 | 70 | 200 | 0 | 8 + 200 | 80 |
| LOLMU | 2 | 35 | 200 | 0 | 2 + 200 | 50 |
| AVEFA | 8 | 50 | 200 | 0 | 8 + 200 | 80 |
| AVEFA | 8 | 50 | 50 | 0 | 8 + 50 | 75 |
| BRADC | 8 | 80 | 200 | 30 | 8 + 200 | 98 |
| COMBE | 8 | 25 | 50 | 70 | 8 + 50 | 95 |
| GERPU | 8 | 0 | 200 | 25 | 8 + 200 | 85 |
| EPHHL | 2 | 20 | 200 | 5 | 2 + 200 | 60 |

### Example 39: Synergistic Herbicidal Action of the Composition of the Compound I-1 and Isoxaben (PRE)

Isoxaben was used as an SC formulation, having an active ingredient concentration of 500 g/l.

| | | | | | combination | |
|---|---|---|---|---|---|---|
| | solo application | | | | Compound I-1 + | |
| | Compound I-1 | | Isoxaben | | Isoxaben | |
| | use rate | % | use rate | % | use rate | % |
| weed | (gai/ha) | activity | (gai/ha) | activity | (gai/ha) | activity |
| LOLMU | 4 | 85 | 400 | 0 | 4 + 400 | 98 |
| LOLMU | 4 | 85 | 100 | 0 | 4 + 100 | 98 |
| AVEFA | 4 | 70 | 400 | 0 | 4 + 400 | 80 |
| AVEFA | 4 | 70 | 100 | 0 | 4 + 100 | 85 |
| GERPU | 4 | 20 | 100 | 15 | 4 + 100 | 80 |
| GERPU | 1 | 0 | 100 | 15 | 1 + 100 | 50 |

### Example 40: Synergistic Herbicidal Action of the Composition of the Compound I-3 and Isoxaben (PRE)

Isoxaben was used as an SC formulation, having an active ingredient concentration of 500 g/l.

| | | | | | combination | |
|---|---|---|---|---|---|---|
| | solo application | | | | Compound I-3 + | |
| | Compound I-3 | | Isoxaben | | Isoxaben | |
| | use rate | % | use rate | % | use rate | % |
| weed | (gai/ha) | activity | (gai/ha) | activity | (gai/ha) | activity |
| ALOMY | 2 | 25 | 400 | 15 | 2 + 400 | 65 |
| BRADC | 2 | 30 | 400 | 0 | 2 + 400 | 70 |
| GERPU | 8 | 15 | 100 | 15 | 8 + 100 | 60 |
| GERPU | 2 | 0 | 100 | 15 | 2 + 100 | 55 |

### Example 41: Synergistic Herbicidal Action of the Composition of the Compound I-1 and Mesotrione (PRE)

Mesotrione was used as an SC formulation, having an active ingredient concentration of 100 g/l.

| | | | | | combination | |
|---|---|---|---|---|---|---|
| | solo application | | | | Compound I-1 + | |
| | Compound I-1 | | Mesotrione | | Mesotrione | |
| | use rate | % | use rate | % | use rate | % |
| weed | (gai/ha) | activity | (gai/ha) | activity | (gai/ha) | activity |
| COMBE | 1 | 35 | 4 | 25 | 1 + 4 | 75 |
| EPHHL | 4 | 20 | 16 | 45 | 4 + 16 | 75 |

### Example 42: Synergistic Herbicidal Action of the Composition of the Compound I-3 and Mesotrione (PRE)

Mesotrione was used as an SC formulation, having an active ingredient concentration of 100 g/l.

| | | | | | combination | |
|---|---|---|---|---|---|---|
| | solo application | | | | Compound I-3 + | |
| | Compound I-3 | | Mesotrione | | Mesotrione | |
| | use rate | % | use rate | % | use rate | % |
| weed | (gai/ha) | activity | (gai/ha) | activity | (gai/ha) | activity |
| COMBE | 8 | 60 | 4 | 25 | 8 + 4 | 90 |
| EPHHL | 8 | 45 | 16 | 45 | 8 + 16 | 85 |
| EPHHL | 8 | 45 | 4 | 20 | 8 + 4 | 75 |
| EPHHL | 2 | 25 | 4 | 20 | 2 + 4 | 60 |

### Example 43: Synergistic Herbicidal Action of the Composition of the Compound I-1 and Isoxaflutole (PRE)

Isoxaflutole was used as an WG formulation, having an active ingredient concentration of 75%.

| | | | | | combination | |
|---|---|---|---|---|---|---|
| | solo application | | | | Compound I-1 + | |
| | Compound I-1 | | Isoxaflutole | | Isoxaflutole | |
| | use rate | % | use rate | % | use rate | % |
| weed | (gai/ha) | activity | (gai/ha) | activity | (gai/ha) | activity |
| ALOMY | 1 | 30 | 25 | 0 | 1 + 25 | 60 |
| ALOMY | 4 | 90 | 6.3 | 0 | 4 + 6.3 | 98 |
| EPHHL | 4 | 20 | 25 | 75 | 4 + 25 | 90 |
| EPHHL | 4 | 20 | 6.3 | 45 | 4 + 6.3 | 65 |

### Example 44: Synergistic Herbicidal Action of the Composition of the Compound I-2 and Isoxaflutole (PRE)

Isoxaflutole was used as an WG formulation, having an active ingredient concentration of 75%.

| | | | | | combination | |
|---|---|---|---|---|---|---|
| | solo application | | | | Compound I-2 + | |
| | Compound I-2 | | Isoxaflutole | | Isoxaflutole | |
| | use rate | % | use rate | % | use rate | % |
| weed | (gai/ha) | activity | (gai/ha) | activity | (gai/ha) | activity |
| ALOMY | 8 | 85 | 6.3 | 0 | 8 + 6.3 | 95 |
| LOLMU | 2 | 30 | 6.3 | 0 | 2 + 6.3 | 60 |
| EPHHL | 2 | 0 | 6.3 | 45 | 2 + 6.3 | 60 |
| ABUTH | 2 | 20 | 6.3 | 45 | 2 + 6.3 | 65 |
| AMBEL | 2 | 30 | 6.3 | 25 | 2 + 6.3 | 65 |

### Example 45: Synergistic Herbicidal Action of the Composition of the Compound I-1 and Profoxydim (POST)

Profoxydim was used as an EC formulation, having an active ingredient concentration of 200 g/l.

| | | | | | combination | |
|---|---|---|---|---|---|---|
| | solo application | | | | Compound I-1 + | |
| | Compound I-1 | | Profoxydim | | Profoxydim | |
| | use rate | % | use rate | % | use rate | % |
| weed | (gai/ha) | activity | (gai/ha) | activity | (gai/ha) | activity |
| ECHCG | 1 | 30 | 12.5 | 85 | 1 + 12.5 | 100 |
| DIGSA | 4 | 25 | 6.3 | 60 | 4 + 6.3 | 90 |
| DIGSA | 1 | 5 | 6.3 | 60 | 1 + 6.3 | 70 |
| GERPU | 4 | 55 | 6.3 | 0 | 4 + 6.3 | 70 |

### Example 46: Synergistic Herbicidal Action of the Composition of the Compound I-3 and Profoxydim (POST)

Profoxydim was used as an EC formulation, having an active ingredient concentration of 200 g/l.

| | | | | | combination | |
|---|---|---|---|---|---|---|
| | solo application | | | | Compound I-3 + | |
| | Compound I-3 | | Profoxydim | | Profoxydim | |
| | use rate | % | use rate | % | use rate | % |
| weed | (gai/ha) | activity | (gai/ha) | activity | (gai/ha) | activity |
| ECHCG | 8 | 35 | 12.5 | 85 | 8 + 12.5 | 100 |
| ECHCG | 8 | 35 | 6.3 | 80 | 8 + 6.3 | 100 |
| DIGSA | 8 | 75 | 6.3 | 60 | 8 + 6.3 | 95 |
| DIGSA | 2 | 10 | 6.3 | 60 | 2 + 6.3 | 80 |
| ABUTH | 8 | 85 | 6.3 | 20 | 8 + 6.3 | 98 |

### Example 47: Synergistic Herbicidal Action of the Composition of the Compound I-1 and Dimethenamid-P (POST)

Dimethenamid-P was used as an EC formulation, having an active ingredient concentration of 720 g/l.

| | | | | | combination | |
|---|---|---|---|---|---|---|
| | solo application | | | | Compound I-3 + | |
| | Compound I-3 | | Dimethenamid-P | | Dimethenamid-P | |
| | use rate | % | use rate | % | use rate | % |
| weed | (gai/ha) | activity | (gai/ha) | activity | (gai/ha) | activity |
| ABUTH | 2 | 20 | 200 | 25 | 2 + 200 | 50 |
| ABUTH | 2 | 20 | 50 | 0 | 2 + 50 | 30 |
| AMARE | 8 | 75 | 200 | 0 | 8 + 200 | 98 |
| AMARE | 2 | 60 | 200 | 0 | 2 + 200 | 70 |

### Example 48: Synergistic Herbicidal Action of the Composition of the Compound I-4 and Cyclopyrimorate (POST)

Cyclopyrimorate was used as an SC formulation, having an active ingredient concentration of 20%

| | | | | | combination | | |
|---|---|---|---|---|---|---|---|
| | solo application | | | | Compound I-4 + Cyclopyrimorate | | |
| | Compound I-4 | | Cyclopyrimorate | | | | COLBY |
| | use rate | | use rate | | use rate | | expected |
| weed | (gai/ha) | % activity | (gai/ha) | % activity | (gai/ha) | % activity | % activity |
| DIGSA | 2 | 10 | 200 | 40 | 2 + 200 | 55 | 46 |
| DIGSA | 2 | 10 | 25 | 10 | 2 + 25 | 40 | 19 |
| ABUTH | 2 | 0 | 25 | 5 | 2 + 25 | 35 | 5 |
| IPOHE | 2 | 40 | 25 | 40 | 2 + 25 | 95 | 64 |

### Example 49: Synergistic Herbicidal Action of the Composition of the Compound I-3 and Tetflupyrolimet (POST)

Tetflupyrolimet was used as an 5% EC formulation.

| | | | | | combination | |
|---|---|---|---|---|---|---|
| | solo application | | | | Compound I-3 + | |
| | Compound I-3 | | Tetflupyrolimet | | Tetflupyrolimet | |
| | use rate | % | use rate | % | use rate | % |
| weed | (gai/ha) | activity | (gai/ha) | activity | (gai/ha) | activity |
| ABUTH | 2 | 20 | 250 | 5 | 2 + 250 | 45 |
| AMARE | 8 | 75 | 250 | 35 | 8 + 250 | 98 |
| EPHHL | 8 | 60 | 250 | 0 | 8 + 250 | 75 |
| EPHHL | 8 | 60 | 31.25 | 0 | 8 + 31.25 | 70 |
| IPOHE | 2 | 65 | 31.25 | 0 | 2 + 31.25 | 85 |

### Example 50: Synergistic Herbicidal Action of the Composition of the Compound I-3 and Diflufenzopyr (PRE)

Diflufenzopyr was used as an SP formulation, having an active ingredient concentration of 86%.

| | | | | | combination | |
|---|---|---|---|---|---|---|
| | solo application | | | | Compound I-4 + | |
| | Compound I-4 | | Diflufenzopyr | | Diflufenzopyr | |
| | use rate | % | use rate | % | use rate | % |
| weed | (gai/ha) | activity | (gai/ha) | activity | (gai/ha) | activity |
| LOLMU | 8 | 35 | 3.8 | 0 | 8 + 3.8 | 45 |
| SETVI | 2 | 50 | 15 | 50 | 2 + 15 | 90 |
| EPHHL | 8 | 40 | 3.8 | 0 | 8 + 3.8 | 80 |
| ABUTH | 2 | 10 | 15 | 0 | 2 + 15 | 35 |
| ABUTH | 8 | 80 | 3.8 | 0 | 8 + 3.8 | 95 |
| ABUTH | 2 | 10 | 3.8 | 0 | 2 + 3.8 | 30 |

### Example 51: Synergistic Herbicidal Action of the Composition of the Compound I-4 and Epyrifenacil (POST)

Epyrifenacil was used as an E % EC formulation.

| | | | | | combination | |
|---|---|---|---|---|---|---|
| | solo application | | | | Compound I-4 + | |
| | Compound I-4 | | Epyrifenacil | | Epyrifenacil | |
| | use rate | % | use rate | % | use rate | % |
| weed | (gai/ha) | activity | (gai/ha) | activity | (gai/ha) | activity |
| ECHCG | 2 | 0 | 1 | 45 | 2 + 1 | 55 |
| DIGSA | 8 | 25 | 1 | 55 | 8 + 1 | 85 |
| DIGSA | 8 | 25 | 0.5 | 20 | 8 + 0.5 | 70 |

### Example 52: Synergistic Herbicidal Action of the Composition of the Compound I-3 and 2,4-D (POST)

2,4-D was used as an EC formulation, having an active ingredient concentration of 600 g/l.

| | | | | | combination | |
|---|---|---|---|---|---|---|
| | solo application | | | | LS Compound I-3 + | |
| | LS Compound I-3 | | 2,4-D | | 2,4-D | |
| | use rate | % | use rate | % | use rate | % |
| weed | (gai/ha) | activity | (gai/ha) | activity | (gai/ha) | activity |
| ECHCG | 2 | 10 | 37.5 | 20 | 2 + 37.5 | 50 |
| EPHHL | 8 | 65 | 150 | 65 | 8 + 150 | 100 |
| GERPU | 8 | 70 | 150 | 70 | 8 + 150 | 98 |
| GERPU | 2 | 30 | 150 | 70 | 2 + 150 | 90 |

### Example 53: Synergistic Herbicidal Action of the Composition of the Compound I-3 and Metribuzin (POST)

Metribuzin was used as an WG formulation, having an active ingredient concentration of 70%.

| | | | | | combination | |
|---|---|---|---|---|---|---|
| | solo application | | | | Compound I-3 + | |
| | Compound I-3 | | Metribuzin | | Metribuzin | |
| | use rate | % | use rate | % | use rate | % |
| weed | (gai/ha) | activity | (gai/ha) | activity | (gai/ha) | activity |
| GERPU | 8 | 50 | 31.25 | 70 | 8 + 31.25 | 100 |
| GERPU | 2 | 40 | 31.25 | 70 | 2 + 31.25 | 100 |

### Example 54: Synergistic Herbicidal Action of the Composition of the Compound I-4 and Metribuzin (PRE)

Metribuzin was used as an WG formulation, having an active ingredient concentration of 70%.

| | | | | | combination | |
|---|---|---|---|---|---|---|
| | solo application | | | | Compound I-4 + | |
| | Compound I-4 | | Metribuzin | | Metribuzin | |
| | use rate | % | use rate | % | use rate | % |
| weed | (gai/ha) | activity | (gai/ha) | activity | (gai/ha) | activity |
| COMBE | 8 | 10 | 62.5 | 20 | 8 + 62.5 | 80 |
| COMBE | 8 | 10 | 31.25 | 10 | 8 + 31.25 | 70 |

### Example 55: Synergistic Herbicidal Action of the Composition of the Compound I-3 and Cyhalofop-Butyl (POST)

Cyhalofop-butyl was used as an EC formulation, having an active ingredient concentration of 200 g/l.

| | | | | | combination | |
|---|---|---|---|---|---|---|
| | solo application | | | | Compound I-3 + | |
| | Compound I-3 | | Cyhalofop-butyl | | Cyhalofop-butyl | |
| | use rate | % | use rate | % | use rate | % |
| weed | (gai/ha) | activity | (gai/ha) | activity | (gai/ha) | activity |
| ECHCG | 8 | 40 | 6.25 | 80 | 8 + 6.25 | 100 |
| ECHCG | 2 | 25 | 6.25 | 80 | 2 + 6.25 | 98 |
| DIGSA | 8 | 50 | 25 | 70 | 8 + 25 | 100 |
| DIGSA | 2 | 0 | 25 | 70 | 2 + 25 | 98 |
| DIGSA | 8 | 50 | 6.25 | 35 | 8 + 6.25 | 98 |
| DIGSA | 2 | 0 | 6.25 | 35 | 2 + 6.25 | 95 |

### Example 56: Synergistic Herbicidal Action of the Composition of the Compound I-4 and Penoxsulam (POST)

Penoxsulam was used as an 00 formulation, having an active ingredient concentration of 20.4 g/l.

| | | | | | combination | |
|---|---|---|---|---|---|---|
| | solo application | | | | Compound I-4 + | |
| | Compound I-4 | | Penoxsulam | | Penoxsulam | |
| | use rate | % | use rate | % | use rate | % |
| weed | (gai/ha) | activity | (gai/ha) | activity | (gai/ha) | activity |
| ECHCG | 2 | 15 | 4 | 35 | 2 + 4 | 85 |
| ECHCG | 2 | 15 | 2 | 10 | 2 + 2 | 60 |
| DIGSA | 8 | 35 | 4 | 10 | 8 + 4 | 75 |
| DIGSA | 8 | 35 | 2 | 0 | 8 + 2 | 50 |
| ABUTH | 2 | 35 | 4 | 0 | 2 + 4 | 75 |

### Example 57: Synergistic Herbicidal Action of the Composition of the Compound I-4 and Florpyrauxifen-Benzyl (PRE)

Florpyrauxifen-benzyl was used as an EC formulation, having an active ingredient concentration of 25 g/l.

| | solo application | | | | combination | |
|---|---|---|---|---|---|---|
| | | | Florpyrauxifen- | | Compound I-4 + | |
| | Compound I-4 | | benzyl | | Florpyrauxifen-benzyl | |
| | use rate | % | use rate | % | use rate | % |
| weed | (gai/ha) | activity | (gai/ha) | activity | (gai/ha) | activity |
| COMBE | 8 | 40 | 5 | 45 | 8 + 5 | 80 |
| AMARE | 2 | 70 | 5 | 0 | 2 + 5 | 85 |
| AMBEL | 8 | 15 | 5 | 45 | 8 + 5 | 90 |
| AMBEL | 8 | 15 | 1.25 | 30 | 8 + 1.25 | 85 |

### Example 58: Synergistic Herbicidal Action of the Composition of the Compound I-3 and Metamifop (POST)

Metamifop was used as an 5% EC formulation

| | | | | | combination | |
|---|---|---|---|---|---|---|
| | solo application | | | | Compound I-3 + | |
| | Compound I-3 | | Metamifop | | Metamifop | |
| | use rate | % | use rate | % | use rate | % |
| weed | (gai/ha) | activity | (gai/ha) | activity | (gai/ha) | activity |
| ECHCG | 8 | 40 | 6.25 | 50 | 8 + 6.25 | 75 |
| DIGSA | 8 | 50 | 25 | 85 | 8 + 25 | 100 |
| DIGSA | 2 | 0 | 25 | 85 | 2 + 25 | 98 |

### Example 59: Synergistic Herbicidal Action of the Composition of the Compound I-3 and Flufenacet (PRE and POST)

Flufenacet was used as an SC formulation, having an active ingredient concentration of 508.8 g/l. Assessed 20 days after treatment (DAT)

### Pre

| | | | | | combination | | |
|---|---|---|---|---|---|---|---|
| | solo application | | | | COMPOUND I-3 + Flufenacet | | |
| | COMPOUND I-3 | | Flufenacet | | | | COLBY |
| | use rate | | use rate | | use rate | | expected |
| weed | (gai/ha) | % activity | (gai/ha) | % activity | (gai/ha) | % activity | % activity |
| SETVI | 2 | 60 | 25 | 65 | 2 + 25 | 95 | 86 |
| COMBE | 8 | 75 | 25 | 35 | 8 + 25 | 100 | 84 |
| EPHHL | 8 | 50 | 12.5 | 10 | 8 + 12.5 | 60 | 55 |

### Post

| | | | | | combination | | |
|---|---|---|---|---|---|---|---|
| | solo application | | | | COMPOUND I-3 + Flufenacet | | |
| | COMPOUND I-3 | | Flufenacet | | | | COLBY |
| | use rate | | use rate | | use rate | | expected |
| weed | (gai/ha) | % activity | (gai/ha) | % activity | (gai/ha) | % activity | % activity |
| EPHHL | 2 | 25 | 12.5 | 0 | 2 + 12.5 | 60 | 25 |

### Example 60: Synergistic Herbicidal Action of the Composition of the Compound I-2 and Flufenacet (PRE and POST)

Flufenacet was used as an SC formulation, having an active ingredient concentration of 508.8 g/l. Assessed 20 days after treatment (DAT).

### Pre

| | | | | | combination | | |
|---|---|---|---|---|---|---|---|
| | solo application | | | | COMPOUND I-2 + Flufenacet | | |
| | COMPOUND I-2 | | Flufenacet | | | | COLBY |
| | use rate | | use rate | | use rate | | expected |
| weed | (gai/ha) | % activity | (gai/ha) | % activity | (gai/ha) | % activity | % activity |
| LOLMU | 8 | 15 | 25 | 35 | 8 + 25 | 75 | 45 |
| LOLMU | 8 | 15 | 12.5 | 0 | 8 + 12.5 | 85 | 15 |
| LOLMU | 2 | 10 | 12.5 | 0 | 2 + 12.5 | 15 | 10 |
| SETVI | 2 | 10 | 25 | 65 | 2 + 25 | 95 | 69 |
| COMBE | 8 | 60 | 25 | 35 | 8 + 25 | 100 | 74 |
| COMBE | 2 | 20 | 25 | 35 | 2 + 25 | 85 | 48 |
| COMBE | 8 | 60 | 12.5 | 10 | 8 + 12.5 | 80 | 64 |
| COMBE | 2 | 20 | 12.5 | 10 | 2 + 12.5 | 35 | 28 |
| EPHHL | 8 | 10 | 25 | 10 | 8 + 25 | 70 | 19 |
| EPHHL | 8 | 10 | 12.5 | 10 | 8 + 12.5 | 45 | 19 |
| ABUTH | 8 | 65 | 12.5 | 0 | 8 + 12.5 | 100 | 65 |
| AMARE | 2 | 70 | 12.5 | 0 | 2 + 12.5 | 98 | 70 |
| AMBEL | 8 | 90 | 12.5 | 0 | 8 + 12.5 | 100 | 90 |
| AMBEL | 2 | 35 | 12.5 | 0 | 2 + 12.5 | 45 | 35 |

### Post

| | | | | | combination | | |
|---|---|---|---|---|---|---|---|
| | solo application | | | | COMPOUND I-2 + Flufenacet | | |
| | COMPOUND I-2 | | Flufenacet | | | | COLBY |
| | use rate | | use rate | | use rate | | expected % |
| weed | (gai/ha) | % activity | (gai/ha) | % activity | (gai/ha) | % activity | activity |
| ECHCG | 2 | 0 | 25 | 85 | 2 + 25 | 90 | 85 |
| ABUTH | 2 | 10 | 25 | 0 | 2 + 25 | 25 | 10 |
| AMARE | 8 | 65 | 25 | 25 | 8 + 25 | 95 | 74 |
| AMARE | 8 | 65 | 12.5 | 15 | 8 + 12.5 | 98 | 70 |
| AMARE | 2 | 65 | 12.5 | 15 | 2 + 12.5 | 80 | 70 |
| EPHHL | 2 | 10 | 12.5 | 0 | 2 + 12.5 | 40 | 10 |
| IPOHE | 2 | 30 | 25 | 0 | 2 + 25 | 60 | 30 |
| IPOHE | 8 | 80 | 12.5 | 0 | 8 + 12.5 | 90 | 80 |
| IPOHE | 2 | 30 | 12.5 | 0 | 2 + 12.5 | 70 | 30 |
| GERPU | 2 | 20 | 12.5 | 5 | 2 + 12.5 | 50 | 24 |

### Example 61: Synergistic herbicidal action of the composition of the compound I-3 and 2-[2-[[3-chloro-6-[3,6-dihydro-3-methyl-2,6-dioxo-4-(trifluoromethyl)-1(2H)-pyrimidinyl]-5-fluoro-2-pyridinyl]oxy]phenoxy]acetic acid ethyl ester (PRE and POST)

### 2-[2-[[3-chloro-6-[3,6-dihydro-3-methyl-2,6-dioxo-4-(trifluoromethyl)-1(2H)-pyrimidinyl]-5-fluoro-2-pyridinyl]oxy]phenoxy]acetic acid ethyl ester was used as an 5% EC formulation. Assessed 20 days after treatment (DAT)

### Pre

| | solo application | | | | | | |
|---|---|---|---|---|---|---|---|
| | | | 2-[2-[[3-chloro-6- | | | | |
| | | | [3,6-dihydro-3- | | combination | | |
| | | | methyl-2,6-dioxo- | | COMPOUND I-3 + 2-[2-[[3-chloro-6-[3,6- | | |
| | | | 4-(trifluoromethyl)- | | dihydro-3-methyl-2,6-dioxo-4- | | |
| | | | 1(2H)-pyrimidinyl]- | | (trifluoromethyl)-1(2H)-pyrimidinyl]-5- | | |
| | | | 5-fluoro-2- | | fluoro-2-pyridinyl]oxy]phenoxy] acetic acid | | |
| | | | pyridinyl]oxy]phenoxy] | | ethyl ester | | |
| | COMPOUND I-3 | | acetic acid ethyl ester | | | | COLBY |
| | use rate | | use rate | | use rate | | expected % |
| weed | (gai/ha) | % activity | (gai/ha) | % activity | (gai/ha) | % activity | activity |
| LOLMU | 8 | 90 | 0.25 | 0 | 8 + 0.25 | 98 | 90 |
| COMBE | 2 | 0 | 0.5 | 0 | 2 + 0.5 | 10 | 0 |
| COMBE | 8 | 75 | 0.25 | 0 | 8 + 0.25 | 95 | 75 |
| EPHHL | 2 | 0 | 0.5 | 0 | 2 + 0.5 | 15 | 0 |
| EPHHL | 2 | 0 | 0.25 | 5 | 2 + 0.25 | 15 | 5 |
| AMBEL | 2 | 50 | 0.5 | 0 | 2 + 0.5 | 70 | 50 |
| AMBEL | 2 | 50 | 0.25 | 0 | 2 + 0.25 | 100 | 50 |

### Post

| | solo application | | | | | | |
|---|---|---|---|---|---|---|---|
| | | | 2-[2-[[3-chloro-6- | | | | |
| | | | [3,6-dihydro-3- | | combination | | |
| | | | methyl-2,6-dioxo-4- | | COMPOUND I-3 + 2-[2-[[3-chloro-6-[3,6- | | |
| | | | (trifluoromethyl)- | | dihydro-3-methyl-2,6-dioxo-4- | | |
| | | | 1(2H)-pyrimidinyl]- | | (trifluoromethyl)-1(2H)-pyrimidinyl]-5- | | |
| | | | 5-fluoro-2- | | fluoro-2-pyridinyl]oxy]phenoxy] acetic | | |
| | | | pyridinyl]oxy]phenoxy] | | acid ethyl ester | | |
| | COMPOUND I-3 | | acetic acid ethyl ester | | | | COLBY |
| | use rate | | use rate | | use rate | | expected |
| weed | (gai/ha) | % activity | (gai/ha) | % activity | (gai/ha) | % activity | % activity |
| ECHCG | 2 | 10 | 0.5 | 80 | 2 + 0.5 | 90 | 82 |
| ECHCG | 8 | 55 | 0.25 | 15 | 8 + 0.25 | 98 | 62 |
| ECHCG | 2 | 10 | 0.25 | 15 | 2 + 0.25 | 65 | 24 |
| DIGSA | 8 | 40 | 0.5 | 80 | 8 + 0.5 | 98 | 88 |
| EPHHL | 2 | 25 | 0.25 | 50 | 2 + 0.25 | 80 | 63 |
| GERPU | 2 | 25 | 0.5 | 85 | 2 + 0.5 | 100 | 89 |

### Example 62: Synergistic herbicidal action of the composition of the compound I-2 and 2-[2-[[3-chloro-6-[3,6-dihydro-3-methyl-2,6-dioxo-4-(trifluoromethyl)-1(2H)-pyrimidinyl]-5-fluoro-2-pyridinyl]oxy]phenoxy]acetic acid ethyl ester (PRE and POST)

### 2-[2-[[3-chloro-6-[3,6-dihydro-3-methyl-2,6-dioxo-4-(trifluoromethyl)-1(2H)-pyrimidinyl]-5-fluoro-2-pyridinyl]oxy]phenoxy]acetic acid ethyl ester was used as an 5% EC formulation. Assessed 20 days after treatment (DAT)

### Pre

| | solo application | | | | | | |
|---|---|---|---|---|---|---|---|
| | | | 2-[2-[[3-chloro-6- | | | | |
| | | | [3,6-dihydro-3- | | combination | | |
| | | | methyl-2,6-dioxo- | | COMPOUND I-2 + 2-[2-[[3-chloro-6-[3,6- | | |
| | | | 4-(trifluoromethyl)- | | dihydro-3-methyl-2,6-dioxo-4- | | |
| | | | 1(2H)-pyrimidinyl]- | | (trifluoromethyl)-1(2H)-pyrimidinyl]-5- | | |
| | | | 5-fluoro-2- | | fluoro-2-pyridinyl]oxy]phenoxy] acetic acid | | |
| | | | pyridinyl]oxy]phenoxy] | | ethyl ester | | |
| | COMPOUND I-2 | | acetic acid ethyl ester | | | | COLBY |
| | use rate | | use rate | | use rate | | expected |
| weed | (gai/ha) | % activity | (gai/ha) | % activity | (gai/ha) | % activity | % activity |
| LOLMU | 8 | 15 | 0.5 | 0 | 8 + 0.5 | 40 | 15 |
| LOLMU | 8 | 15 | 0.25 | 0 | 8 + 0.25 | 75 | 15 |
| SETVI | 2 | 10 | 0.5 | 0 | 2 + 0.5 | 15 | 10 |
| SETVI | 2 | 10 | 0.25 | 0 | 2 + 0.25 | 15 | 10 |
| COMBE | 2 | 20 | 0.5 | 0 | 2 + 0.5 | 60 | 20 |
| EPHHL | 8 | 10 | 0.5 | 0 | 8 + 0.5 | 40 | 10 |
| EPHHL | 2 | 10 | 0.25 | 5 | 2 + 0.25 | 25 | 15 |
| ABUTH | 8 | 65 | 0.5 | 10 | 8 + 0.5 | 90 | 69 |
| ABUTH | 2 | 10 | 0.25 | 0 | 2 + 0.25 | 15 | 10 |
| AMARE | 2 | 70 | 0.5 | 0 | 2 + 0.5 | 75 | 70 |
| AMBEL | 8 | 90 | 0.25 | 0 | 8 + 025 | 100 | 90 |

### Post

| | solo application | | | | | | |
|---|---|---|---|---|---|---|---|
| | | | 2-[2-[[3-chloro-6- | | | | |
| | | | [3,6-dihydro-3- | | combination | | |
| | | | methyl-2,6-dioxo- | | COMPOUND I-2 + 2-[2-[[3-chloro-6-[3,6- | | |
| | | | 4-(trifluoromethyl)- | | dihydro-3-methyl-2,6-dioxo-4- | | |
| | | | 1(2H)-pyrimidinyl]- | | (trifluoromethyl)-1(2H)-pyrimidinyl]-5- | | |
| | | | 5-fluoro-2- | | fluoro-2-pyridinyl]oxy]phenoxy] acetic acid | | |
| | | | pyridinyl]oxy]phenoxy] | | ethyl ester | | |
| | COMPOUND I-2 | | acetic acid ethyl ester | | | | COLBY |
| | use rate | | use rate | | use rate | | expected |
| weed | (gai/ha) | % activity | (gai/ha) | % activity | (gai/ha) | % activity | % activity |
| DIGSA | 2 | 5 | 0.25 | 15 | 2 + 0.25 | 40 | 19 |
| EPHHL | 2 | 10 | 0.25 | 50 | 2 + 0.25 | 100 | 55 |
| GERPU | 8 | 25 | 0.5 | 85 | 8 + 0.5 | 100 | 89 |
| GERPU | 2 | 20 | 0.5 | 85 | 2 + 0.5 | 100 | 88 |

### Example 63: Synergistic Herbicidal Action of the Composition of the Compound I-3 and Tri-Allate (PRE and POST)

Tri-allate was used as an CS formulation, having an active ingredient concentration of 450 g/l. Assessed 20 days after treatment (DAT).

### Pre

| | | | | | combination | | |
|---|---|---|---|---|---|---|---|
| | solo application | | | | COMPOUND I-3 + Tri-allate | | |
| | COMPOUND I-3 | | Tri-allate | | | | COLBY |
| | use rate | | use rate | | use rate | | expected |
| weed | (gai/ha) | % activity | (gai/ha) | % activity | (gai/ha) | % activity | % activity |
| LOLMU | 8 | 90 | 600 | 0 | 8 + 600 | 95 | 90 |
| LOLMU | 2 | 70 | 600 | 0 | 2 + 600 | 90 | 70 |
| SETVI | 2 | 60 | 600 | 0 | 2 + 600 | 90 | 60 |
| COMBE | 2 | 0 | 600 | 0 | 2 + 600 | 10 | 0 |
| EPHHL | 8 | 50 | 1200 | 10 | 8 + 1200 | 60 | 55 |
| EPHHL | 2 | 0 | 1200 | 10 | 2 + 1200 | 25 | 10 |
| EPHHL | 8 | 50 | 600 | 10 | 8 + 600 | 70 | 55 |
| EPHHL | 2 | 0 | 600 | 10 | 2 + 600 | 15 | 10 |
| AMBEL | 2 | 50 | 1200 | 25 | 2 + 1200 | 80 | 63 |
| AMBEL | 2 | 50 | 600 | 10 | 2 + 600 | 80 | 55 |

### Post

| | solo application | | | | combination | | |
|---|---|---|---|---|---|---|---|
| | | | | | COMPOUND I-3 + Tri-allate | | |
| | COMPOUND I-3 | | Tri-allate | | | | COLBY |
| | use rate | % | use rate | % | use rate | % | expected % |
| weed | (gai/ha) | activity | (gai/ha) | activity | (gai/ha) | activity | activity |
| ABUTH | 2 | 30 | 1200 | 0 | 2 + 1200 | 35 | 30 |
| EPHHL | 2 | 25 | 1200 | 10 | 2 + 1200 | 50 | 33 |
| IPOHE | 2 | 90 | 1200 | 0 | 2 + 1200 | 95 | 90 |

### Example 64: Synergistic Herbicidal Action of the Composition of the Compound I-2 and Tri-Allate (PRE and POST)

Tri-allate was used as an CS formulation, having an active ingredient concentration of 450 g/l. Assessed 20 days after treatment (DAT).

### Pre

| | solo application | | | | combination | | |
|---|---|---|---|---|---|---|---|
| | | | | | COMPOUND I-2 + Tri-allate | | |
| | COMPOUND I-2 | | Tri-allate | | | | COLBY |
| | use rate | % | use rate | % | use rate | % | expected % |
| weed | (gai/ha) | activity | (gai/ha) | activity | (gai/ha) | activity | activity |
| ALOMY | 2 | 10 | 1200 | 0 | 2 + 1200 | 50 | 10 |
| LOLMU | 2 | 10 | 1200 | 10 | 2 + 1200 | 70 | 19 |
| LOLMU | 8 | 15 | 600 | 0 | 8 + 600 | 100 | 15 |
| LOLMU | 2 | 10 | 600 | 0 | 2 + 600 | 35 | 10 |
| SETVI | 2 | 10 | 600 | 0 | 2 + 600 | 15 | 10 |
| COMBE | 8 | 60 | 600 | 0 | 8 + 600 | 75 | 60 |
| EPHHL | 8 | 10 | 1200 | 10 | 8 + 1200 | 60 | 19 |
| ABUTH | 8 | 65 | 600 | 10 | 8 + 600 | 100 | 69 |
| AMARE | 2 | 70 | 1200 | 10 | 2 + 1200 | 90 | 73 |
| AMARE | 2 | 70 | 600 | 10 | 2 + 600 | 90 | 73 |
| AMBEL | 2 | 35 | 1200 | 25 | 2 + 1200 | 85 | 51 |
| AMBEL | 8 | 90 | 600 | 10 | 8 + 600 | 100 | 91 |
| AMBEL | 2 | 35 | 600 | 10 | 2 + 600 | 75 | 42 |

### Post

| | solo application | | | | combination | | |
|---|---|---|---|---|---|---|---|
| | | | | | COMPOUND I-2 + Tri-allate | | |
| | COMPOUND I-2 | | Tri-allate | | | | COLBY |
| | use rate | % | use rate | % | use rate | % | expected % |
| weed | (gai/ha) | activity | (gai/ha) | activity | (gai/ha) | activity | activity |
| AMARE | 8 | 65 | 1200 | 45 | 8 + 1200 | 100 | 81 |
| AMARE | 2 | 65 | 1200 | 45 | 2 + 1200 | 100 | 81 |
| AMARE | 8 | 65 | 600 | 25 | 8 + 600 | 100 | 74 |
| EPHHL | 2 | 10 | 1200 | 10 | 2 + 1200 | 65 | 19 |
| EPHHL | 2 | 10 | 600 | 10 | 2 + 600 | 35 | 19 |
| IPOHE | 2 | 30 | 1200 | 0 | 2 + 1200 | 90 | 30 |
| IPOHE | 8 | 80 | 600 | 10 | 8 + 600 | 95 | 82 |
| IPOHE | 2 | 30 | 600 | 10 | 2 + 600 | 90 | 37 |
| GERPU | 8 | 25 | 600 | 10 | 8 + 600 | 75 | 33 |

### Example 65: Synergistic Herbicidal Action of the Composition of the Compound I-3 and Imazamox (PRE and POST)

Imazamox was used as an SL formulation, having an active ingredient concentration of 120 g/l. Assessed 20 days after treatment (DAT).

### Pre

| | solo application | | | | combination | | |
|---|---|---|---|---|---|---|---|
| | | | | | COMPOUND I-3 + Imazamox | | |
| | COMPOUND I-3 | | Imazamox | | | | COLBY |
| | use rate | % | use rate | % | use rate | % | expected % |
| weed | (gai/ha) | activity | (gai/ha) | activity | (gai/ha) | activity | activity |
| LOLMU | 8 | 90 | 1 | 0 | 8 + 1 | 100 | 90 |
| SETVI | 2 | 60 | 2 | 5 | 2 + 2 | 80 | 62 |
| COMBE | 2 | 0 | 2 | 0 | 2 + 2 | 25 | 0 |
| COMBE | 8 | 75 | 1 | 0 | 8 + 1 | 90 | 75 |
| COMBE | 2 | 0 | 1 | 0 | 2 + 1 | 10 | 0 |
| EPHHL | 2 | 0 | 2 | 15 | 2 + 2 | 30 | 15 |
| EPHHL | 2 | 0 | 1 | 10 | 2 + 1 | 20 | 10 |
| AMBEL | 2 | 50 | 2 | 0 | 2 + 2 | 60 | 50 |

### Post

| | solo application | | | | combination | | |
|---|---|---|---|---|---|---|---|
| | | | | | COMPOUND I-3 + Imazamox | | |
| | COMPOUND I-3 | | Imazamox | | | | COLBY |
| | use rate | % | use rate | % | use rate | % | expected % |
| weed | (gai/ha) | activity | (gai/ha) | activity | (gai/ha) | activity | activity |
| ECHCG | 2 | 10 | 2 | 55 | 2 + 2 | 70 | 60 |
| DIGSA | 8 | 40 | 2 | 55 | 8 + 2 | 80 | 73 |
| EPHHL | 8 | 60 | 2 | 10 | 8 + 2 | 70 | 64 |
| EPHHL | 2 | 25 | 2 | 10 | 2 + 2 | 40 | 33 |
| EPHHL | 2 | 25 | 1 | 10 | 2 + 1 | 60 | 33 |

### Example 65: Synergistic Herbicidal Action of the Composition of the Compound I-2 and Imazamox (PRE and POST)

Imazamox was used as an SL formulation, having an active ingredient concentration of 120 g/l. Assessed 20 days after treatment (DAT).

### Pre

| | solo application | | | | combination | | |
|---|---|---|---|---|---|---|---|
| | | | | | COMPOUND I-2 + Imazamox | | |
| | COMPOUND I-2 | | Imazamox | | | | COLBY |
| | use rate | % | use rate | % | use rate | % | expected % |
| weed | (gai/ha) | activity | (gai/ha) | activity | (gai/ha) | activity | activity |
| LOLMU | 8 | 15 | 1 | 0 | 8 + 1 | 95 | 15 |
| ECHCG | 2 | 55 | 1 | 0 | 2 + 1 | 60 | 55 |
| EPHHL | 8 | 10 | 2 | 15 | 8 + 2 | 50 | 24 |
| ABUTH | 8 | 65 | 1 | 10 | 8 + 1 | 90 | 69 |
| AMARE | 2 | 70 | 2 | 25 | 2 + 2 | 85 | 78 |
| AMBEL | 8 | 90 | 2 | 0 | 8 + 2 | 100 | 90 |
| AMBEL | 2 | 35 | 2 | 0 | 2 + 2 | 40 | 35 |
| AMBEL | 8 | 90 | 1 | 0 | 8 + 1 | 95 | 90 |
| AMBEL | 2 | 35 | 1 | 0 | 2 + 1 | 50 | 35 |

### Post

| | solo application | | | | combination | | |
|---|---|---|---|---|---|---|---|
| | | | | | COMPOUND I-2 + Imazamox | | |
| | COMPOUND I-2 | | Imazamox | | | | COLBY |
| | use rate | % | use rate | % | use rate | % | expected % |
| weed | (gai/ha) | activity | (gai/ha) | activity | (gai/ha) | activity | activity |
| ECHCG | 8 | 50 | 2 | 55 | 8 + 2 | 90 | 78 |

### Example 66: Synergistic Herbicidal Action of the Composition of the Compound I-3 and Quizalofop-Ethyl (PRE and POST)

Quizalofop-ethyl was used as an 5% EC formulation. Assessed 20 days after treatment (DAT).

### Pre

| | solo application | | | | combination | | |
|---|---|---|---|---|---|---|---|
| | | | | | COMPOUND I-3 + Quizalofop-ethyl | | |
| | COMPOUND I-3 | | Quizalofop-ethyl | | | | COLBY |
| | use rate | % | use rate | % | use rate | % | expected % |
| weed | (gai/ha) | activity | (gai/ha) | activity | (gai/ha) | activity | activity |
| COMBE | 2 | 10 | 4 | 0 | 2 + 4 | 15 | 10 |
| COMBE | 2 | 10 | 2 | 0 | 2 + 2 | 15 | 10 |
| AMARE | 2 | 90 | 4 | 0 | 2 + 4 | 100 | 90 |
| AMBEL | 2 | 15 | 4 | 0 | 2 + 4 | 25 | 15 |

### Post

| | solo application | | | | combination | | |
|---|---|---|---|---|---|---|---|
| | | | | | COMPOUND I-3 + LS 161459 | | |
| | COMPOUND I-3 | | LS 161459 | | | | COLBY |
| | use rate | % | use rate | % | use rate | % | expected % |
| weed | (gai/ha) | activity | (gai/ha) | activity | (gai/ha) | activity | activity |
| ABUTH | 2 | 10 | 4 | 15 | 2 + 4 | 60 | 24 |
| EPHHL | 2 | 55 | 4 | 25 | 2 + 4 | 80 | 66 |

### Example 67: Synergistic Herbicidal Action of the Composition of the Compound I-2 and Quizalofop-Ethyl (PRE and POST)

Quizalofop-ethyl was used as an 5% EC formulation. Assessed 20 days after treatment (DAT).

### Pre

| | solo application | | | | combination | | |
|---|---|---|---|---|---|---|---|
| | | | | | COMPOUND I-2 + Quizalofop-ethyl | | |
| | COMPOUND I-2 | | Quizalofop-ethyl | | | | COLBY |
| | use rate | % | use rate | % | use rate | % | expected % |
| weed | (gai/ha) | activity | (gai/ha) | activity | (gai/ha) | activity | activity |
| ALOMY | 8 | 5 | 2 | 0 | 8 + 2 | 25 | 5 |
| LOLMU | 2 | 5 | 4 | 0 | 2 + 4 | 15 | 5 |
| LOLMU | 8 | 50 | 2 | 0 | 8 + 2 | 60 | 50 |
| LOLMU | 2 | 5 | 2 | 0 | 2 + 2 | 15 | 5 |
| COMBE | 8 | 10 | 4 | 0 | 8 + 4 | 40 | 10 |
| COMBE | 2 | 0 | 4 | 0 | 2 + 4 | 10 | 0 |
| EPHHL | 8 | 10 | 4 | 5 | 8 + 4 | 35 | 15 |
| AMARE | 2 | 70 | 4 | 0 | 2 + 4 | 75 | 70 |
| AMBEL | 2 | 0 | 2 | 0 | 2 + 2 | 10 | 0 |

### Post

| | solo application | | | | combination | | |
|---|---|---|---|---|---|---|---|
| | | | | | COMPOUND I-2 + LS 161459 | | |
| | COMPOUND I-2 | | LS 161459 | | | | COLBY |
| | use rate | % | use rate | % | use rate | % | expected % |
| weed | (gai/ha) | activity | (gai/ha) | activity | (gai/ha) | activity | activity |
| ECHCG | 8 | 20 | 4 | 30 | 8 + 4 | 50 | 44 |
| DIGSA | 2 | 20 | 4 | 45 | 2 + 4 | 70 | 56 |
| IPOHE | 8 | 70 | 2 | 0 | 8 + 2 | 75 | 70 |

### Example 68: Synergistic Herbicidal Action of the Composition of the Compound I-3 and Terbutylazine (PRE and POST)

Terbutylazine) was used as an SC formulation, having an active ingredient concentration of 500 g/l. Assessed 20 days after treatment (DAT).

### Pre

| | solo application | | | | combination | | |
|---|---|---|---|---|---|---|---|
| | | | | | COMPOUND I-3 + Terbutylazine | | |
| | COMPOUND I-3 | | Terbutylazine | | | | COLBY |
| | use rate | % | use rate | % | use rate | % | expected % |
| weed | (gai/ha) | activity | (gai/ha) | activity | (gai/ha) | activity | activity |
| ALOMY | 8 | 70 | 62.5 | 0 | 8 + 62.5 | 85 | 70 |
| ALOMY | 8 | 70 | 15.6 | 0 | 8 + 15.6 | 75 | 70 |
| COMBE | 2 | 10 | 62.5 | 0 | 2 + 62.5 | 25 | 10 |
| COMBE | 2 | 10 | 15.6 | 0 | 2 + 15.6 | 15 | 10 |
| ABUTH | 8 | 70 | 62.5 | 0 | 8 + 62.5 | 95 | 70 |
| ABUTH | 8 | 70 | 15.6 | 0 | 8 + 15.6 | 85 | 70 |
| AMARE | 2 | 90 | 62.5 | 0 | 2 + 62.5 | 100 | 90 |
| AMBEL | 2 | 15 | 15.6 | 0 | 2 + 15.6 | 30 | 15 |

### Post

| | solo application | | | | combination | | |
|---|---|---|---|---|---|---|---|
| | | | | | COMPOUND I-3 + Terbutylazine | | |
| | COMPOUND I-3 | | Terbutylazine | | | | COLBY |
| | use rate | % | use rate | % | use rate | % | expected % |
| weed | (gai/ha) | activity | (gai/ha) | activity | (gai/ha) | activity | activity |
| ABUTH | 2 | 10 | 62.5 | 0 | 2 + 62.5 | 70 | 10 |
| IPOHE | 8 | 90 | 15.6 | 0 | 8 + 15.6 | 95 | 90 |

### Example 69: Synergistic Herbicidal Action of the Composition of the Compound I-2 and Terbutylazine (PRE and POST)

Terbutylazine) was used as an SC formulation, having an active ingredient concentration of 500 g/l. Assessed 20 days after treatment (DAT).

### Pre

| | solo application | | | | combination | | |
|---|---|---|---|---|---|---|---|
| | | | | | COMPOUND I-2 + Terbutylazine | | |
| | COMPOUND I-2 | | Terbutylazine | | | | COLBY |
| | use rate | % | use rate | % | use rate | % | expected % |
| weed | (gai/ha) | activity | (gai/ha) | activity | (gai/ha) | activity | activity |
| ALOMY | 8 | 5 | 62.5 | 0 | 8 + 62.5 | 10 | 5 |
| ALOMY | 2 | 0 | 62.5 | 0 | 2 + 62.5 | 10 | 0 |
| ALOMY | 8 | 5 | 15.6 | 0 | 8 + 15.6 | 65 | 5 |
| ALOMY | 2 | 0 | 15.6 | 0 | 2 + 15.6 | 5 | 0 |
| LOLMU | 8 | 50 | 15.6 | 0 | 8 + 15.6 | 70 | 50 |
| COMBE | 8 | 10 | 62.5 | 0 | 8 + 62.5 | 35 | 10 |
| COMBE | 2 | 0 | 62.5 | 0 | 2 + 62.5 | 10 | 0 |
| COMBE | 8 | 10 | 15.6 | 0 | 8 + 15.6 | 20 | 10 |
| EPHHL | 8 | 10 | 62.5 | 0 | 8 + 62.5 | 20 | 10 |
| ABUTH | 8 | 50 | 62.5 | 0 | 8 + 62.5 | 80 | 50 |
| ABUTH | 8 | 50 | 15.6 | 0 | 8 + 15.6 | 85 | 50 |
| AMARE | 2 | 70 | 62.5 | 0 | 2 + 62.5 | 85 | 70 |
| AMBEL | 2 | 0 | 15.6 | 0 | 2 + 15.6 | 10 | 0 |

### Post

| | solo application | | | | combination | | |
|---|---|---|---|---|---|---|---|
| | | | | | COMPOUND I-2 + Terbutylazine | | |
| | COMPOUND I-2 | | Terbutylazine | | | | COLBY |
| | use rate | % | use rate | % | use rate | % | expected % |
| weed | (gai/ha) | activity | (gai/ha) | activity | (gai/ha) | activity | activity |
| AMARE | 2 | 35 | 62.5 | 60 | 2 + 62.5 | 100 | 74 |

### Example 70: Synergistic Herbicidal Action of the Composition of the Compound I-3 Thiencarbazone-Methyl and a Safener (Mefenpyr-Diethyl) (PRE and POST)

Thiencarbazone-methyl and the safener mefenpyr-diethyl were used as an EC formulation, having an active ingredient concentration of 10 g/l (herbicide) and 60 g/L (safener). Assessed 20 days after treatment (DAT).

### Pre

| | | | | | combination | | |
|---|---|---|---|---|---|---|---|
| | | | | | COMPOUND I-3 + | | |
| | solo application | | | | Thiencarbazone- | | |
| | | | Thiencarbazone- | | methyl + | | |
| | | | methyl + | | Mefenpyr-diethyl | | |
| | COMPOUND I-3 | | Mefenpyr-diethyl | | | | COLBY |
| | use rate | % | use rate | % | use rate | % | expected % |
| weed | (gai/ha) | activity | (gai/ha) | activity | (gai/ha) | activity | activity |
| ALOMY | 8 | 70 | 1 + 6 | 0 | 8 + 1 + 6 | 95 | 70 |
| ALOMY | 2 | 10 | 1 + 6 | 0 | 2 + 1 + 6 | 25 | 10 |
| LOLMU | 2 | 30 | 1 + 6 | 0 | 2 + 1 + 6 | 60 | 30 |
| LOLMU | 2 | 30 | 0.5 + 3 | 0 | 2 + 0.5 + 3 | 35 | 30 |
| COMBE | 2 | 10 | 0.5 + 3 | 0 | 2 + 0.5 + 3 | 80 | 10 |
| ABUTH | 8 | 70 | 1 + 6 | 0 | 8 + 1 + 6 | 95 | 70 |
| ABUTH | 8 | 70 | 0.5 + 3 | 0 | 8 + 0.5 + 3 | 100 | 70 |
| AMBEL | 2 | 15 | 1 + 6 | 0 | 2 + 1 + 6 | 25 | 15 |

### Post

| | | | | | combination | | |
|---|---|---|---|---|---|---|---|
| | | | | | COMPOUND I-3 + | | |
| | solo application | | | | Thiencarbazone- | | |
| | | | Thiencarbazone- | | methyl + | | |
| | | | methyl + | | Mefenpyr-diethyl | | |
| | COMPOUND I-3 | | Mefenpyr-diethyl | | | | COLBY |
| | use rate | % | use rate | % | use rate | % | expected % |
| weed | (gai/ha) | activity | (gai/ha) | activity | (gai/ha) | activity | activity |
| ECHCG | 2 | 15 | 0.5 + 3 | 75 | 2 + 0.5 + 3 | 85 | 79 |
| GERPU | 8 | 75 | 1 + 6 | 80 | 8 + 1 + 6 | 100 | 95 |
| GERPU | 2 | 10 | 1 + 6 | 80 | 2 + 1 + 6 | 98 | 82 |

### Example 71: Synergistic Herbicidal Action of the Composition of the Compound I-2 Thiencarbazone-Methyl and a Safener (Mefenpyr-Diethyl) (PRE and POST)

Thiencarbazone-methyl and the safener mefenpyr-diethyl wereused as an EC formulation, having an active ingredient concentration of 10 g/l (herbicide) and 60 g/L (safener). Assessed 20 days after treatment (DAT).

### Pre

| | | | | | combination | | |
|---|---|---|---|---|---|---|---|
| | | | | | COMPOUND I-2 + | | |
| | solo application | | | | Thiencarbazone- | | |
| | | | Thiencarbazone- | | methyl + | | |
| | | | methyl + | | Mefenpyr-diethyl | | |
| | COMPOUND I-2 | | Mefenpyr-diethyl | | | | COLBY |
| | use rate | % | use rate | % | use rate | % | expected % |
| weed | (gai/ha) | activity | (gai/ha) | activity | (gai/ha) | activity | activity |
| ALOMY | 8 | 5 | 1 + 6 | 0 | 8 + 1 + 6 | 45 | 5 |
| ALOMY | 2 | 0 | 1 + 6 | 0 | 2 + 1 + 6 | 10 | 0 |
| ALOMY | 8 | 5 | 0.5 + 3 | 0 | 8 + 0.5 + 3 | 70 | 5 |
| COMBE | 8 | 10 | 0.5 + 3 | 0 | 8 + 0.5 + 3 | 25 | 10 |
| EPHHL | 8 | 10 | 1 + 6 | 0 | 8 + 1 + 6 | 30 | 10 |
| EPHHL | 8 | 10 | 0.5 + 3 | 0 | 8 + 0.5 + 3 | 20 | 10 |
| AMBEL | 2 | 0 | 0.5 + 3 | 0 | 2 + 0.5 + 3 | 10 | 0 |

### Post

| | | | | | combination | | |
|---|---|---|---|---|---|---|---|
| | | | | | COMPOUND I-2 + | | |
| | solo application | | | | Thiencarbazone- | | |
| | | | Thiencarbazone- | | methyl + | | |
| | | | methyl + | | Mefenpyr-diethyl | | |
| | COMPOUND I-2 | | Mefenpyr-diethyl | | | | COLBY |
| | use rate | % | use rate | % | use rate | % | expected % |
| weed | (gai/ha) | activity | (gai/ha) | activity | (gai/ha) | activity | activity |
| ECHCG | 8 | 20 | 0.5 + 3 | 75 | 8 + 0.5 + 3 | 90 | 80 |
| DIGSA | 8 | 65 | 1 + 6 | 65 | 8 + 1 + 6 | 95 | 88 |
| DIGSA | 2 | 20 | 1 + 6 | 65 | 2 + 1 + 6 | 95 | 72 |
| DIGSA | 2 | 20 | 0.5 + 3 | 55 | 2 + 0.5 + 3 | 75 | 64 |
| ABUTH | 2 | 10 | 0.5 + 3 | 65 | 2 + 0.5 + 3 | 75 | 69 |

### Example 72: Synergistic Herbicidal Action of the Composition of the Compound I-3 and Cycloxydim (PRE and POST)

Cycloxydim was used as an EC formulation, having an active ingredient concentration of 100 g/l. Assessed 20 days after treatment (DAT).

### Pre

| | solo application | | | | combination | | |
|---|---|---|---|---|---|---|---|
| | | | | | COMPOUND I-3 + Cycloxydim | | |
| | COMPOUND I-3 | | Cycloxydim | | | | COLBY |
| | use rate | % | use rate | % | use rate | % | expected % |
| weed | (gai/ha) | activity | (gai/ha) | activity | (gai/ha) | activity | activity |
| ALOMY | 2 | 20 | 20 | 60 | 2 + 20 | 90 | 68 |
| EPHHL | 2 | 10 | 5 | 5 | 2 + 5 | 50 | 15 |
| ABUTH | 8 | 85 | 5 | 0 | 8 + 5 | 95 | 85 |

### Post

| | solo application | | | | combination | | |
|---|---|---|---|---|---|---|---|
| | | | | | COMPOUND I-3 + Cycloxydim | | |
| | COMPOUND I-3 | | Cycloxydim | | | | COLBY |
| | use rate | % | use rate | % | use rate | % | expected % |
| weed | (gai/ha) | activity | (gai/ha) | activity | (gai/ha) | activity | activity |
| ABUTH | 8 | 50 | 5 | 0 | 8 + 5 | 60 | 50 |
| IPOHE | 2 | 50 | 5 | 0 | 2 + 5 | 60 | 50 |

### Example 73: Synergistic Herbicidal Action of the Composition of the Compound I-4 and Cycloxydim (PRE and POST)

Cycloxydim was used as an EC formulation, having an active ingredient concentration of 100 g/l. Assessed 20 days after treatment (DAT).

### Pre

| | solo application | | | | combination | | |
|---|---|---|---|---|---|---|---|
| | | | | | COMPOUND I-4 + Cycloxydim | | |
| | COMPOUND I-4 | | Cycloxydim | | | | COLBY |
| | use rate | % | use rate | % | use rate | % | expected % |
| weed | (gai/ha) | activity | (gai/ha) | activity | (gai/ha) | activity | activity |
| ALOMY | 8 | 25 | 20 | 60 | 8 + 20 | 90 | 70 |
| ALOMY | 2 | 5 | 20 | 60 | 2 + 20 | 85 | 62 |
| ALOMY | 8 | 25 | 5 | 15 | 8 + 5 | 85 | 36 |
| EPHHL | 8 | 10 | 20 | 10 | 8 + 20 | 60 | 19 |
| EPHHL | 8 | 10 | 5 | 5 | 8 + 5 | 55 | 15 |
| EPHHL | 2 | 0 | 5 | 5 | 2 + 5 | 10 | 5 |
| ABUTH | 8 | 90 | 5 | 0 | 8 + 5 | 98 | 90 |
| AMBEL | 8 | 30 | 20 | 0 | 8 + 20 | 90 | 30 |
| AMBEL | 2 | 0 | 20 | 0 | 2 + 20 | 10 | 0 |
| AMBEL | 8 | 30 | 5 | 0 | 8 + 5 | 90 | 30 |
| AMBEL | 2 | 0 | 5 | 0 | 2 + 5 | 5 | 0 |

### Post

| | solo application | | | | combination | | |
|---|---|---|---|---|---|---|---|
| | | | | | COMPOUND I-4 + Cycloxydim | | |
| | COMPOUND I-4 | | Cycloxydim | | | | COLBY |
| | use rate | % | use rate | % | use rate | % | expected % |
| weed | (gai/ha) | activity | (gai/ha) | activity | (gai/ha) | activity | activity |
| ABUTH | 8 | 10 | 20 | 0 | 8 + 20 | 70 | 10 |
| ABUTH | 8 | 10 | 5 | 0 | 8 + 5 | 30 | 10 |
| AMARE | 8 | 75 | 5 | 0 | 8 + 5 | 90 | 75 |
| AMARE | 2 | 80 | 5 | 0 | 2 + 5 | 90 | 80 |
| EPHHL | 8 | 35 | 20 | 0 | 8 + 20 | 75 | 35 |
| IPOHE | 8 | 80 | 20 | 0 | 8 + 20 | 95 | 80 |
| IPOHE | 8 | 80 | 5 | 0 | 8 + 5 | 98 | 80 |
| GERPU | 8 | 25 | 5 | 5 | 8 + 5 | 70 | 29 |

### Example 74: Synergistic Herbicidal Action of the Composition of the Compound I-3 and Clethodim (PRE and POST)

Clethodim was used as an EC formulation, having an active ingredient concentration of 240 g/l. Assessed 20 days after treatment (DAT).

### Pre

| | solo application | | | | combination | | |
|---|---|---|---|---|---|---|---|
| | | | | | COMPOUND I-3 + Clethodim | | |
| | COMPOUND I-3 | | Clethodim | | | | COLBY |
| | use rate | % | use rate | % | use rate | % | expected % |
| weed | (gai/ha) | activity | (gai/ha) | activity | (gai/ha) | activity | activity |
| SETVI | 2 | 20 | 5 | 25 | 2 + 5 | 60 | 40 |
| ABUTH | 8 | 85 | 5 | 0 | 8 + 5 | 95 | 85 |

### Post

| | solo application | | | | combination | | |
|---|---|---|---|---|---|---|---|
| | | | | | COMPOUND I-3 + Clethodim | | |
| | COMPOUND I-3 | | Clethodim | | | | COLBY |
| | use rate | % | use rate | % | use rate | % | expected % |
| weed | (gai/ha) | activity | (gai/ha) | activity | (gai/ha) | activity | activity |
| ECHCG | 8 | 10 | 5 | 80 | 8 + 5 | 90 | 82 |
| DIGSA | 2 | 0 | 10 | 80 | 2 + 10 | 95 | 80 |
| EPHHL | 8 | 50 | 10 | 0 | 8 + 10 | 60 | 50 |
| EPHHL | 2 | 20 | 10 | 0 | 2 + 10 | 25 | 20 |

### Example 75: Synergistic Herbicidal Action of the Composition of the Compound I-4 and Clethodim (PRE and POST)

Clethodim was used as an EC formulation, having an active ingredient concentration of 240 g/l. Assessed 20 days after treatment (DAT).

### Pre

| | solo application | | | | combination | | |
|---|---|---|---|---|---|---|---|
| | | | | | COMPOUND I-4 + Clethodim | | |
| | COMPOUND I-4 | | Clethodim | | | | COLBY |
| | use rate | % | use rate | % | use rate | % | expected % |
| weed | (gai/ha) | activity | (gai/ha) | activity | (gai/ha) | activity | activity |
| ALOMY | 8 | 25 | 10 | 75 | 8 + 10 | 95 | 81 |
| ALOMY | 8 | 25 | 5 | 60 | 8 + 5 | 98 | 70 |
| LOLMU | 8 | 60 | 5 | 60 | 8 + 5 | 98 | 84 |
| LOLMU | 2 | 5 | 5 | 60 | 2 + 5 | 85 | 62 |
| SETVI | 8 | 75 | 5 | 25 | 8 + 5 | 98 | 81 |
| SETVI | 2 | 5 | 5 | 25 | 2 + 5 | 85 | 29 |
| COMBE | 8 | 10 | 10 | 0 | 8 + 10 | 40 | 10 |
| COMBE | 8 | 10 | 5 | 0 | 8 + 5 | 40 | 10 |
| EPHHL | 8 | 10 | 10 | 0 | 8 + 10 | 45 | 10 |
| EPHHL | 2 | 0 | 10 | 0 | 2 + 10 | 5 | 0 |
| EPHHL | 8 | 10 | 5 | 0 | 8 + 5 | 70 | 10 |
| EPHHL | 2 | 0 | 5 | 0 | 2 + 5 | 5 | 0 |
| ABUTH | 8 | 90 | 5 | 0 | 8 + 5 | 98 | 90 |
| AMBEL | 8 | 30 | 10 | 0 | 8 + 10 | 85 | 30 |
| AMBEL | 8 | 30 | 5 | 0 | 8 + 5 | 95 | 30 |
| AMBEL | 2 | 0 | 5 | 0 | 2 + 5 | 20 | 0 |

### Post

| | solo application | | | | combination | | |
|---|---|---|---|---|---|---|---|
| | | | | | COMPOUND I-4 + Clethodim | | |
| | COMPOUND I-4 | | Clethodim | | | | COLBY |
| | use rate | % | use rate | % | use rate | % | expected % |
| weed | (gai/ha) | activity | (gai/ha) | activity | (gai/ha) | activity | activity |
| DIGSA | 2 | 0 | 10 | 80 | 2 + 10 | 90 | 80 |
| ABUTH | 8 | 10 | 10 | 0 | 8 + 10 | 50 | 10 |
| AMARE | 8 | 75 | 10 | 0 | 8 + 10 | 85 | 75 |
| AMARE | 8 | 75 | 5 | 0 | 8 + 5 | 95 | 75 |
| EPHHL | 8 | 35 | 10 | 0 | 8 + 10 | 50 | 35 |
| EPHHL | 2 | 30 | 10 | 0 | 2 + 10 | 50 | 30 |
| EPHHL | 8 | 35 | 5 | 0 | 8 + 5 | 40 | 35 |
| EPHHL | 2 | 30 | 5 | 0 | 2 + 5 | 35 | 30 |
| IPOHE | 8 | 80 | 5 | 0 | 8 + 5 | 85 | 80 |
| GERPU | 2 | 5 | 10 | 0 | 2 + 10 | 10 | 5 |
| GERPU | 2 | 5 | 5 | 0 | 2 + 5 | 10 | 5 |

### Example 76: Synergistic Herbicidal Action of the Composition of the Compound I-3 and Bentazone (PRE and POST)

Bentazone) was used as an SL formulation, having an active ingredient concentration of 480 g/l. Assessed 20 days after treatment (DAT).

### Pre

| | solo application | | | | combination | | |
|---|---|---|---|---|---|---|---|
| | | | | | COMPOUND I-3 + Bentazone | | |
| | COMPOUND I-3 | | Bentazone | | | | COLBY |
| | use rate | % | use rate | % | use rate | % | expected % |
| weed | (gai/ha) | activity | (gai/ha) | activity | (gai/ha) | activity | activity |
| ALOMY | 2 | 20 | 240 | 15 | 2 + 240 | 40 | 32 |
| ABUTH | 8 | 85 | 240 | 30 | 8 + 240 | 100 | 90 |

### Post

| | solo application | | | | combination | | |
|---|---|---|---|---|---|---|---|
| | | | | | COMPOUND I-3 + Bentazone | | |
| | COMPOUND I-3 | | Bentazone | | | | COLBY |
| | use rate | % | use rate | % | use rate | % | expected % |
| weed | (gai/ha) | activity | (gai/ha) | activity | (gai/ha) | activity | activity |
| DIGSA | 2 | 0 | 240 | 0 | 2 + 240 | 40 | 0 |
| ABUTH | 2 | 10 | 480 | 10 | 2 + 480 | 90 | 19 |
| EPHHL | 8 | 50 | 480 | 0 | 8 + 480 | 75 | 50 |
| EPHHL | 2 | 20 | 480 | 0 | 2 + 480 | 65 | 20 |
| EPHHL | 8 | 50 | 240 | 0 | 8 + 240 | 75 | 50 |

### Example 77: Synergistic Herbicidal Action of the Composition of the Compound I-4 and Bentazone (PRE and POST)

Bentazone) was used as an SL formulation, having an active ingredient concentration of 480 g/l. Assessed 20 days after treatment (DAT).

### Pre

| | solo application | | | | combination | | |
|---|---|---|---|---|---|---|---|
| | | | | | COMPOUND I-4 + Bentazone | | |
| | COMPOUND I-4 | | Bentazone | | | | COLBY |
| | use rate | % | use rate | % | use rate | % | expected % |
| weed | (gai/ha) | activity | (gai/ha) | activity | (gai/ha) | activity | activity |
| SETVI | 8 | 75 | 480 | 0 | 8 + 480 | 95 | 75 |
| SETVI | 2 | 5 | 480 | 0 | 2 + 480 | 10 | 5 |
| SETVI | 8 | 75 | 240 | 10 | 8 + 240 | 85 | 78 |
| COMBE | 8 | 10 | 240 | 0 | 8 + 240 | 25 | 10 |
| EPHHL | 8 | 10 | 480 | 5 | 8 + 480 | 75 | 15 |
| EPHHL | 2 | 0 | 480 | 5 | 2 + 480 | 40 | 5 |
| EPHHL | 8 | 10 | 240 | 5 | 8 + 240 | 75 | 15 |
| EPHHL | 2 | 0 | 240 | 5 | 2 + 240 | 35 | 5 |
| AMBEL | 8 | 30 | 480 | 0 | 8 + 480 | 100 | 30 |
| AMBEL | 2 | 0 | 480 | 0 | 2 + 480 | 70 | 0 |
| AMBEL | 8 | 30 | 240 | 0 | 8 + 240 | 100 | 30 |
| AMBEL | 2 | 0 | 240 | 0 | 2 + 240 | 25 | 0 |

### Post

| | solo application | | | | combination | | |
|---|---|---|---|---|---|---|---|
| | | | | | COMPOUND I-4 + Bentazone | | |
| | COMPOUND I-4 | | Bentazone | | | | COLBY |
| | use rate | % | use rate | % | use rate | % | expected % |
| weed | (gai/ha) | activity | (gai/ha) | activity | (gai/ha) | activity | activity |
| ECHCG | 8 | 5 | 480 | 30 | 8 + 480 | 60 | 34 |
| ECHCG | 8 | 5 | 240 | 10 | 8 + 240 | 20 | 15 |
| ECHCG | 2 | 0 | 240 | 10 | 2 + 240 | 20 | 10 |
| ABUTH | 8 | 10 | 480 | 10 | 8 + 480 | 75 | 19 |
| ABUTH | 2 | 10 | 480 | 10 | 2 + 480 | 65 | 19 |
| EPHHL | 8 | 35 | 480 | 0 | 8 + 480 | 80 | 35 |
| EPHHL | 2 | 30 | 480 | 0 | 2 + 480 | 35 | 30 |
| EPHHL | 8 | 35 | 240 | 0 | 8 + 240 | 98 | 35 |
| EPHHL | 2 | 30 | 240 | 0 | 2 + 240 | 40 | 30 |
| IPOHE | 8 | 80 | 240 | 0 | 8 + 240 | 98 | 80 |

### Example 78: Synergistic Herbicidal Action of the Composition of the Compound I-3 and Flumioxazin (PRE and POST)

Flumioxazin was used as an WG formulation, having an active ingredient concentration of 500 g/kg. Assessed 20 days after treatment (DAT).

### Pre

| | solo application | | | | combination | | |
|---|---|---|---|---|---|---|---|
| | | | | | COMPOUND I-3 + Flumioxazin | | |
| | COMPOUND I-3 | | Flumioxazin | | | | COLBY |
| | use rate | % | use rate | % | use rate | % | expected % |
| weed | (gai/ha) | activity | (gai/ha) | activity | (gai/ha) | activity | activity |
| ALOMY | 2 | 20 | 0.25 | 0 | 2 + 0.25 | 45 | 20 |
| SETVI | 2 | 20 | 1 | 0 | 2 + 1 | 65 | 20 |
| EPHHL | 8 | 50 | 1 | 5 | 8 + 1 | 80 | 53 |
| EPHHL | 2 | 10 | 1 | 5 | 2 + 1 | 20 | 15 |
| EPHHL | 8 | 50 | 0.25 | 0 | 8 + 0.25 | 60 | 50 |
| ABUTH | 8 | 85 | 1 | 0 | 8 + 1 | 90 | 85 |
| ABUTH | 8 | 85 | 0.25 | 0 | 8 + 0.25 | 100 | 85 |

### Post

| | solo application | | | | combination | | |
|---|---|---|---|---|---|---|---|
| | | | | | COMPOUND I-3 + Flumioxazin | | |
| | COMPOUND I-3 | | Flumioxazin | | | | COLBY |
| | use rate | % | use rate | % | use rate | % | expected % |
| weed | (gai/ha) | activity | (gai/ha) | activity | (gai/ha) | activity | activity |
| ECHCG | 8 | 10 | 2 | 30 | 8 + 2 | 70 | 37 |
| ECHCG | 2 | 0 | 1 | 5 | 2 + 1 | 10 | 5 |
| ECHCG | 2 | 0 | 0.5 | 0 | 2 + 0.5 | 20 | 0 |
| DIGSA | 2 | 0 | 2 | 25 | 2 + 2 | 35 | 25 |
| DIGSA | 8 | 10 | 1 | 10 | 8 + 1 | 40 | 19 |
| DIGSA | 2 | 0 | 1 | 10 | 2 + 1 | 15 | 10 |
| ABUTH | 2 | 10 | 2 | 70 | 2 + 2 | 95 | 73 |
| EPHHL | 8 | 50 | 1 | 60 | 8 + 1 | 85 | 80 |
| EPHHL | 2 | 20 | 1 | 60 | 2 + 1 | 75 | 68 |

### Example 79: Synergistic Herbicidal Action of the Composition of the Compound I-4 and Flumioxazin (PRE and POST)

Flumioxazin was used as an WG formulation, having an active ingredient concentration of 500 g/kg. Assessed 20 days after treatment (DAT).

### Pre

| | solo application | | | | combination | | |
|---|---|---|---|---|---|---|---|
| | | | | | COMPOUND I-4 + Flumioxazin | | |
| | COMPOUND I-4 | | Flumioxazin | | | | COLBY |
| | use rate | % | use rate | % | use rate | % | expected % |
| weed | (gai/ha) | activity | (gai/ha) | activity | (gai/ha) | activity | activity |
| ALOMY | 8 | 25 | 0.5 | 0 | 8 + 0.5 | 85 | 25 |
| ALOMY | 2 | 5 | 0.5 | 0 | 2 + 0.5 | 30 | 5 |
| LOLMU | 8 | 60 | 0.5 | 0 | 8 + 0.5 | 95 | 60 |
| LOLMU | 2 | 5 | 0.5 | 0 | 2 + 0.5 | 20 | 5 |
| SETVI | 8 | 75 | 2 | 0 | 8 + 2 | 95 | 75 |
| SETVI | 2 | 5 | 2 | 0 | 2 + 2 | 10 | 5 |
| SETVI | 8 | 75 | 0.5 | 0 | 8 + 0.5 | 95 | 75 |
| SETVI | 2 | 5 | 0.5 | 0 | 2 + 0.5 | 15 | 5 |
| EPHHL | 8 | 10 | 2 | 10 | 8 + 2 | 30 | 19 |
| EPHHL | 8 | 10 | 0.5 | 5 | 8 + 0.5 | 85 | 15 |
| ABUTH | 8 | 90 | 0.5 | 0 | 8 + 0.5 | 98 | 90 |
| AMBEL | 8 | 30 | 2 | 0 | 8 + 2 | 100 | 30 |
| AMBEL | 2 | 0 | 2 | 0 | 2 + 2 | 15 | 0 |
| AMBEL | 8 | 30 | 0.5 | 0 | 8 + 0.5 | 100 | 30 |
| AMBEL | 2 | 0 | 0.5 | 0 | 2 + 0.5 | 25 | 0 |

### Post

| | solo application | | | | combination | | |
|---|---|---|---|---|---|---|---|
| | | | | | COMPOUND I-4 + Flumioxazin | | |
| | COMPOUND I-4 | | Flumioxazin | | | | COLBY |
| | use rate | % | use rate | % | use rate | % | expected % |
| weed | (gai/ha) | activity | (gai/ha) | activity | (gai/ha) | activity | activity |
| ECHCG | 8 | 5 | 2 | 30 | 8 + 2 | 80 | 34 |
| ECHCG | 8 | 5 | 0.5 | 0 | 8 + 0.5 | 90 | 5 |
| ECHCG | 2 | 0 | 0.5 | 0 | 2 + 0.5 | 5 | 0 |
| DIGSA | 8 | 0 | 2 | 25 | 8 + 2 | 70 | 25 |
| DIGSA | 2 | 0 | 2 | 25 | 2 + 2 | 65 | 25 |
| ABUTH | 8 | 10 | 2 | 70 | 8 + 2 | 85 | 73 |
| ABUTH | 2 | 10 | 2 | 70 | 2 + 2 | 85 | 73 |
| GERPU | 8 | 25 | 2 | 45 | 8 + 2 | 65 | 59 |
| GERPU | 2 | 5 | 2 | 45 | 2 + 2 | 60 | 48 |

### Example 80: Synergistic Herbicidal Action of the Composition of the Compound I-3 and Fomesafen (PRE and POST)

Fomesafen) was used as an SL formulation, having an active ingredient concentration of 250 g/l. Assessed 20 days after treatment (DAT).

### Pre

| | solo application | | | | combination | | |
|---|---|---|---|---|---|---|---|
| | | | | | COMPOUND I-3 + Fomesafen | | |
| | COMPOUND I-3 | | Fomesafen | | | | COLBY |
| | use rate | % | use rate | % | use rate | % | expected % |
| weed | (gai/ha) | activity | (gai/ha) | activity | (gai/ha) | activity | activity |
| ALOMY | 8 | 90 | 10 | 0 | 8 + 10 | 98 | 90 |
| ALOMY | 2 | 5 | 10 | 0 | 2 + 10 | 10 | 5 |
| ALOMY | 8 | 90 | 2.5 | 0 | 8 + 2.5 | 95 | 90 |
| ALOMY | 2 | 5 | 2.5 | 0 | 2 + 2.5 | 60 | 5 |
| LOLMU | 2 | 50 | 2.5 | 0 | 2 + 2.5 | 55 | 50 |
| ECHCG | 2 | 5 | 10 | 0 | 2 + 10 | 10 | 5 |
| ECHCG | 8 | 95 | 2.5 | 0 | 8 + 2.5 | 100 | 95 |
| ECHCG | 2 | 5 | 2.5 | 0 | 2 + 2.5 | 10 | 5 |
| COMBE | 8 | 10 | 10 | 10 | 8 + 10 | 50 | 19 |
| COMBE | 2 | 10 | 10 | 10 | 2 + 10 | 85 | 19 |
| COMBE | 8 | 10 | 2.5 | 10 | 8 + 2.5 | 75 | 19 |
| EPHHL | 2 | 5 | 10 | 0 | 2 + 10 | 15 | 5 |
| EPHHL | 2 | 5 | 2.5 | 0 | 2 + 2.5 | 15 | 5 |
| ABUTH | 8 | 80 | 10 | 0 | 8 + 10 | 95 | 80 |
| ABUTH | 2 | 25 | 10 | 0 | 2 + 10 | 40 | 25 |
| ABUTH | 8 | 80 | 2.5 | 0 | 8 + 2.5 | 100 | 80 |
| ABUTH | 2 | 25 | 2.5 | 0 | 2 + 2.5 | 30 | 25 |
| AMARE | 2 | 60 | 10 | 25 | 2 + 10 | 95 | 70 |
| AMARE | 2 | 60 | 2.5 | 0 | 2 + 2.5 | 80 | 60 |
| AMBEL | 8 | 45 | 10 | 0 | 8 + 10 | 75 | 45 |
| AMBEL | 2 | 10 | 10 | 0 | 2 + 10 | 25 | 10 |
| AMBEL | 8 | 45 | 2.5 | 0 | 8 + 2.5 | 95 | 45 |
| AMBEL | 2 | 10 | 2.5 | 0 | 2 + 2.5 | 25 | 10 |

### Post

| | solo application | | | | combination | | |
|---|---|---|---|---|---|---|---|
| | | | | | COMPOUND I-3 + Fomesafen | | |
| | COMPOUND I-3 | | Fomesafen | | | | COLBY |
| | use rate | % | use rate | % | use rate | % | expected % |
| weed | (gai/ha) | activity | (gai/ha) | activity | (gai/ha) | activity | activity |
| DIGSA | 2 | 10 | 10 | 25 | 2 + 10 | 40 | 33 |
| ABUTH | 2 | 10 | 10 | 20 | 2 + 10 | 95 | 28 |

### Example 81: Synergistic Herbicidal Action of the Composition of the Compound I-2 and Fomesafen (PRE and POST)

Fomesafen) was used as an SL formulation, having an active ingredient concentration of 250 g/l. Assessed 20 days after treatment (DAT).

### Pre

| | solo application | | | | combination | | |
|---|---|---|---|---|---|---|---|
| | | | | | COMPOUND I-2 + Fomesafen | | |
| | COMPOUND I-2 | | Fomesafen | | | | COLBY |
| | use rate | % | use rate | % | use rate | % | expected % |
| weed | (gai/ha) | activity | (gai/ha) | activity | (gai/ha) | activity | activity |
| ALOMY | 8 | 75 | 2.5 | 0 | 8 + 2.5 | 90 | 75 |
| LOLMU | 2 | 15 | 10 | 0 | 2 + 10 | 30 | 15 |
| ECHCG | 2 | 0 | 10 | 0 | 2 + 10 | 10 | 0 |
| ECHCG | 8 | 90 | 2.5 | 0 | 8 + 2.5 | 95 | 90 |
| ECHCG | 2 | 0 | 2.5 | 0 | 2 + 2.5 | 10 | 0 |
| COMBE | 8 | 45 | 10 | 10 | 8 + 10 | 60 | 51 |
| COMBE | 8 | 45 | 2.5 | 10 | 8 + 2.5 | 85 | 51 |
| EPHHL | 8 | 15 | 10 | 0 | 8 + 10 | 20 | 15 |
| EPHHL | 2 | 0 | 10 | 0 | 2 + 10 | 10 | 0 |
| EPHHL | 2 | 0 | 2.5 | 0 | 2 + 2.5 | 10 | 0 |
| ABUTH | 8 | 55 | 2.5 | 0 | 8 + 2.5 | 85 | 55 |
| AMARE | 2 | 70 | 10 | 25 | 2 + 10 | 90 | 78 |
| AMBEL | 2 | 0 | 10 | 0 | 2 + 10 | 30 | 0 |
| AMBEL | 2 | 0 | 2.5 | 0 | 2 + 2.5 | 10 | 0 |

### Post

| | solo application | | | | combination | | |
|---|---|---|---|---|---|---|---|
| | | | | | COMPOUND I-2 + Fomesafen | | |
| | COMPOUND I-2 | | Fomesafen | | | | COLBY |
| | use rate | % | use rate | % | use rate | % | expected % |
| weed | (gai/ha) | activity | (gai/ha) | activity | (gai/ha) | activity | activity |
| DIGSA | 8 | 20 | 10 | 25 | 8 + 10 | 70 | 40 |
| DIGSA | 2 | 0 | 10 | 25 | 2 + 10 | 30 | 25 |
| ABUTH | 8 | 40 | 10 | 20 | 8 + 10 | 80 | 52 |
| ABUTH | 8 | 40 | 2.5 | 20 | 8 + 2.5 | 98 | 52 |
| AMARE | 2 | 40 | 10 | 25 | 2 + 10 | 60 | 55 |

### Example 82: Synergistic Herbicidal Action of the Composition of the Compound I-3 and S-Metolachlor (PRE and POST)

S-Metolachlor was used as an EC formulation, having an active ingredient concentration of 960 g/l. Assessed 20 days after treatment (DAT).

### Pre

| | solo application | | | | combination | | |
|---|---|---|---|---|---|---|---|
| | | | | | COMPOUND I-3 + S-Metolachlor | | |
| | COMPOUND I-3 | | S-Metolachlor | | | | COLBY |
| | use rate | % | use rate | % | use rate | % | expected % |
| weed | (gai/ha) | activity | (gai/ha) | activity | (gai/ha) | activity | activity |
| ALOMY | 8 | 90 | 50 | 0 | 8 + 50 | 95 | 90 |
| ALOMY | 2 | 5 | 50 | 0 | 2 + 50 | 30 | 5 |
| ALOMY | 8 | 90 | 25 | 0 | 8 + 25 | 95 | 90 |
| ALOMY | 2 | 5 | 25 | 0 | 2 + 25 | 75 | 5 |
| ECHCG | 2 | 5 | 50 | 50 | 2 + 50 | 80 | 53 |
| SETVI | 2 | 50 | 25 | 10 | 2 + 25 | 60 | 55 |
| COMBE | 8 | 10 | 25 | 10 | 8 + 25 | 95 | 19 |
| COMBE | 2 | 10 | 25 | 10 | 2 + 25 | 30 | 19 |
| EPHHL | 2 | 5 | 50 | 0 | 2 + 50 | 40 | 5 |
| EPHHL | 2 | 5 | 25 | 0 | 2 + 25 | 10 | 5 |
| ABUTH | 8 | 80 | 50 | 0 | 8 + 50 | 90 | 80 |
| ABUTH | 8 | 80 | 25 | 0 | 8 + 25 | 90 | 80 |
| AMARE | 2 | 60 | 25 | 20 | 2 + 25 | 100 | 68 |
| AMBEL | 8 | 45 | 50 | 0 | 8 + 50 | 85 | 45 |
| AMBEL | 2 | 10 | 50 | 0 | 2 + 50 | 15 | 10 |
| AMBEL | 8 | 45 | 25 | 0 | 8 + 25 | 100 | 45 |
| AMBEL | 2 | 10 | 25 | 0 | 2 + 25 | 35 | 10 |

### Post

| | solo application | | | | combination | | |
|---|---|---|---|---|---|---|---|
| | | | | | COMPOUND I-3 + S-Metolachlor | | |
| | COMPOUND I-3 | | S-Metolachlor | | | | COLBY |
| | use rate | % | use rate | % | use rate | % | expected % |
| weed | (gai/ha) | activity | (gai/ha) | activity | (gai/ha) | activity | activity |
| ABUTH | 2 | 10 | 50 | 0 | 2 + 50 | 85 | 10 |
| IPOHE | 8 | 70 | 50 | 0 | 8 + 50 | 85 | 70 |
| IPOHE | 8 | 70 | 25 | 0 | 8 + 25 | 80 | 70 |

### Example 83: Synergistic Herbicidal Action of the Composition of the Compound I-2 and S-Metolachlor (PRE and POST)

S-Metolachlor was used as an EC formulation, having an active ingredient concentration of 960 g/l. Assessed 20 days after treatment (DAT).

### Pre

| | solo application | | | | combination | | |
|---|---|---|---|---|---|---|---|
| | | | | | COMPOUND I-2 + S-Metolachlor | | |
| | COMPOUND I-2 | | S-Metolachlor | | | | COLBY |
| | use rate | % | use rate | % | use rate | % | expected % |
| weed | (gai/ha) | activity | (gai/ha) | activity | (gai/ha) | activity | activity |
| ALOMY | 8 | 75 | 50 | 0 | 8 + 50 | 90 | 75 |
| ALOMY | 2 | 20 | 50 | 0 | 2 + 50 | 50 | 20 |
| ALOMY | 8 | 75 | 25 | 0 | 8 + 25 | 95 | 75 |
| ALOMY | 2 | 20 | 25 | 0 | 2 + 25 | 35 | 20 |
| LOLMU | 8 | 90 | 50 | 0 | 8 + 50 | 95 | 90 |
| LOLMU | 2 | 15 | 50 | 0 | 2 + 50 | 35 | 15 |
| LOLMU | 8 | 90 | 25 | 0 | 8 + 25 | 95 | 90 |
| LOLMU | 2 | 15 | 25 | 0 | 2 + 25 | 25 | 15 |
| ECHCG | 8 | 90 | 50 | 50 | 8 + 50 | 100 | 95 |
| ECHCG | 2 | 0 | 50 | 50 | 2 + 50 | 90 | 50 |
| ECHCG | 8 | 90 | 25 | 20 | 8 + 25 | 100 | 92 |
| ECHCG | 2 | 0 | 25 | 20 | 2 + 25 | 45 | 20 |
| SETVI | 2 | 25 | 50 | 75 | 2 + 50 | 95 | 81 |
| SETVI | 2 | 25 | 25 | 10 | 2 + 25 | 75 | 33 |
| COMBE | 8 | 45 | 25 | 10 | 8 + 25 | 75 | 51 |
| COMBE | 2 | 10 | 25 | 10 | 2 + 25 | 55 | 19 |
| EPHHL | 8 | 15 | 50 | 0 | 8 + 50 | 50 | 15 |
| EPHHL | 2 | 0 | 50 | 0 | 2 + 50 | 20 | 0 |
| EPHHL | 2 | 0 | 25 | 0 | 2 + 25 | 10 | 0 |
| ABUTH | 8 | 55 | 50 | 0 | 8 + 50 | 85 | 55 |
| ABUTH | 2 | 10 | 50 | 0 | 2 + 50 | 20 | 10 |
| ABUTH | 8 | 55 | 25 | 0 | 8 + 25 | 60 | 55 |
| AMARE | 2 | 70 | 50 | 20 | 2 + 50 | 100 | 76 |
| AMARE | 2 | 70 | 25 | 20 | 2 + 25 | 85 | 76 |
| AMBEL | 2 | 0 | 50 | 0 | 2 + 50 | 15 | 0 |
| AMBEL | 2 | 0 | 25 | 0 | 2 + 25 | 40 | 0 |

### Post

| | solo application | | | | combination | | |
|---|---|---|---|---|---|---|---|
| | | | | | COMPOUND I-2 + S-Metolachlor | | |
| | COMPOUND I-2 | | S-Metolachlor | | | | COLBY |
| | use rate | % | use rate | % | use rate | % | expected % |
| weed | (gai/ha) | activity | (gai/ha) | activity | (gai/ha) | activity | activity |
| DIGSA | 8 | 20 | 50 | 10 | 8 + 50 | 70 | 28 |
| DIGSA | 8 | 20 | 25 | 0 | 8 + 25 | 95 | 20 |
| DIGSA | 2 | 0 | 25 | 0 | 2 + 25 | 10 | 0 |
| ABUTH | 8 | 40 | 50 | 0 | 8 + 50 | 50 | 40 |
| ABUTH | 2 | 15 | 50 | 0 | 2 + 50 | 30 | 15 |
| ABUTH | 8 | 40 | 25 | 0 | 8 + 25 | 85 | 40 |
| AMARE | 8 | 75 | 50 | 60 | 8 + 50 | 98 | 90 |
| AMARE | 8 | 75 | 25 | 5 | 8 + 25 | 85 | 76 |
| AMARE | 2 | 40 | 25 | 5 | 2 + 25 | 60 | 43 |
| EPHHL | 8 | 30 | 50 | 5 | 8 + 50 | 60 | 34 |
| EPHHL | 8 | 30 | 25 | 0 | 8 + 25 | 75 | 30 |

### Example 84: Synergistic Herbicidal Action of the Composition of the Compound I-3 and Saflufenacil (PRE and POST)

Saflufenacil was used as an CS formulation, having an active ingredient concentration of 130 g/l. Assessed 20 days after treatment (DAT).

### Pre

| | solo application | | | | combination | | |
|---|---|---|---|---|---|---|---|
| | | | | | COMPOUND I-3 + Saflufenacil | | |
| | COMPOUND I-3 | | Saflufenacil | | | | COLBY |
| | use rate | % | use rate | % | use rate | % | expected % |
| weed | (gai/ha) | activity | (gai/ha) | activity | (gai/ha) | activity | activity |
| ALOMY | 8 | 90 | 5 | 10 | 8 + 5 | 100 | 91 |
| ALOMY | 2 | 5 | 5 | 10 | 2 + 5 | 40 | 15 |
| ALOMY | 8 | 90 | 1.25 | 20 | 8 + 1.25 | 100 | 92 |
| ALOMY | 2 | 5 | 1.25 | 20 | 2 + 1.25 | 40 | 24 |
| LOLMU | 8 | 95 | 1.25 | 0 | 8 + 1.25 | 100 | 95 |
| ECHCG | 2 | 5 | 5 | 0 | 2 + 5 | 25 | 5 |
| COMBE | 8 | 10 | 1.25 | 5 | 8 + 1.25 | 60 | 15 |
| EPHHL | 2 | 5 | 5 | 50 | 2 + 5 | 60 | 53 |
| EPHHL | 2 | 5 | 1.25 | 5 | 2 + 1.25 | 25 | 10 |
| AMBEL | 8 | 45 | 5 | 50 | 8 + 5 | 100 | 73 |
| AMBEL | 2 | 10 | 5 | 50 | 2 + 5 | 80 | 55 |
| AMBEL | 8 | 45 | 1.25 | 0 | 8 + 1.25 | 98 | 45 |
| AMBEL | 2 | 10 | 1.25 | 0 | 2 + 1.25 | 15 | 10 |

### Post

| | solo application | | | | combination | | |
|---|---|---|---|---|---|---|---|
| | | | | | COMPOUND I-3 + Saflufenacil | | |
| | COMPOUND I-3 | | Saflufenacil | | | | COLBY |
| | use rate | % | use rate | % | use rate | % | expected % |
| weed | (gai/ha) | activity | (gai/ha) | activity | (gai/ha) | activity | activity |
| ABUTH | 2 | 10 | 5 | 10 | 2 + 5 | 50 | 19 |
| ABUTH | 2 | 10 | 1.25 | 5 | 2 + 1.25 | 30 | 15 |
| AMARE | 2 | 45 | 5 | 0 | 2 + 5 | 55 | 45 |
| IPOHE | 8 | 70 | 5 | 10 | 8 + 5 | 100 | 73 |
| IPOHE | 2 | 80 | 5 | 10 | 2 + 5 | 100 | 82 |
| IPOHE | 8 | 70 | 1.25 | 0 | 8 + 1.25 | 98 | 70 |

### Example 85: Synergistic Herbicidal Action of the Composition of the Compound I-2 and Saflufenacil (PRE and POST)

Saflufenacil was used as an CS formulation, having an active ingredient concentration of 130 g/l. Assessed 20 days after treatment (DAT).

### Pre

| | solo application | | | | combination | | |
|---|---|---|---|---|---|---|---|
| | | | | | COMPOUND I-2 + Saflufenacil | | |
| | COMPOUND I-2 | | Saflufenacil | | | | COLBY |
| | use rate | % | use rate | % | use rate | % | expected % |
| weed | (gai/ha) | activity | (gai/ha) | activity | (gai/ha) | activity | activity |
| ALOMY | 8 | 75 | 5 | 10 | 8 + 5 | 85 | 78 |
| ALOMY | 2 | 20 | 5 | 10 | 2 + 5 | 40 | 28 |
| ALOMY | 8 | 75 | 1.25 | 20 | 8 + 1.25 | 95 | 80 |
| LOLMU | 2 | 15 | 5 | 0 | 2 + 5 | 35 | 15 |
| LOLMU | 8 | 90 | 1.25 | 0 | 8 + 1.25 | 100 | 90 |
| LOLMU | 2 | 15 | 1.25 | 0 | 2 + 1.25 | 70 | 15 |
| ECHCG | 2 | 0 | 5 | 0 | 2 + 5 | 55 | 0 |
| ECHCG | 8 | 90 | 1.25 | 0 | 8 + 1.25 | 98 | 90 |
| ECHCG | 2 | 0 | 1.25 | 0 | 2 + 1.25 | 50 | 0 |
| SETVI | 2 | 25 | 5 | 0 | 2 + 5 | 90 | 25 |
| SETVI | 2 | 25 | 1.25 | 0 | 2 + 1.25 | 85 | 25 |
| COMBE | 8 | 45 | 1.25 | 5 | 8 + 1.25 | 100 | 48 |
| COMBE | 2 | 10 | 1.25 | 5 | 2 + 1.25 | 70 | 15 |
| EPHHL | 2 | 0 | 5 | 50 | 2 + 5 | 60 | 50 |
| EPHHL | 8 | 15 | 1.25 | 5 | 8 + 1.25 | 70 | 19 |
| EPHHL | 2 | 0 | 1.25 | 5 | 2 + 1.25 | 30 | 5 |
| ABUTH | 8 | 55 | 1.25 | 10 | 8 + 1.25 | 100 | 60 |
| ABUTH | 2 | 10 | 1.25 | 10 | 2 + 1.25 | 70 | 19 |
| AMARE | 2 | 70 | 1.25 | 0 | 2 + 1.25 | 100 | 70 |
| AMBEL | 2 | 0 | 5 | 50 | 2 + 5 | 80 | 50 |
| AMBEL | 2 | 0 | 1.25 | 0 | 2 + 1.25 | 35 | 0 |

### Post

| | solo application | | | | combination | | |
|---|---|---|---|---|---|---|---|
| | | | | | COMPOUND I-2 + Saflufenacil | | |
| | COMPOUND I-2 | | Saflufenacil | | | | COLBY |
| | use rate | % | use rate | % | use rate | % | expected % |
| weed | (gai/ha) | activity | (gai/ha) | activity | (gai/ha) | activity | activity |
| DIGSA | 8 | 20 | 5 | 0 | 8 + 5 | 85 | 20 |
| DIGSA | 2 | 0 | 5 | 0 | 2 + 5 | 20 | 0 |
| ABUTH | 8 | 40 | 5 | 10 | 8 + 5 | 75 | 46 |
| ABUTH | 2 | 15 | 5 | 10 | 2 + 5 | 60 | 24 |
| ABUTH | 8 | 40 | 1.25 | 5 | 8 + 1.25 | 95 | 43 |
| ABUTH | 2 | 15 | 1.25 | 5 | 2 + 1.25 | 40 | 19 |
| AMARE | 8 | 75 | 5 | 0 | 8 + 5 | 100 | 75 |
| AMARE | 2 | 40 | 5 | 0 | 2 + 5 | 50 | 40 |
| AMARE | 2 | 40 | 1.25 | 0 | 2 + 1.25 | 60 | 40 |
| IPOHE | 2 | 30 | 1.25 | 0 | 2 + 1.25 | 50 | 30 |

### Example 86: Synergistic Herbicidal Action of the Composition of the Compound I-3 and Rimisoxafen (PRE and POST)

Rimisoxafen was used as an 5% EC formulation. Assessed 20 days after treatment (DAT).

### Pre

| | solo application | | | | combination | | |
|---|---|---|---|---|---|---|---|
| | | | | | COMPOUND I-3 + Rimisoxafen | | |
| | COMPOUND I-3 | | Rimisoxafen | | | | COLBY |
| | use rate | % | use rate | % | use rate | % | expected % |
| weed | (gai/ha) | activity | (gai/ha) | activity | (gai/ha) | activity | activity |
| ALOMY | 8 | 90 | 32 | 0 | 8 + 32 | 98 | 90 |
| ALOMY | 2 | 5 | 32 | 0 | 2 + 32 | 50 | 5 |
| ALOMY | 8 | 90 | 16 | 0 | 8 + 16 | 95 | 90 |
| ALOMY | 2 | 5 | 16 | 0 | 2 + 16 | 25 | 5 |
| ALOMY | 8 | 90 | 8 | 0 | 8 + 8 | 95 | 90 |
| ALOMY | 8 | 90 | 4 | 0 | 8 + 4 | 95 | 90 |
| ALOMY | 2 | 5 | 4 | 0 | 2 + 4 | 10 | 5 |
| ECHCG | 2 | 5 | 32 | 0 | 2 + 32 | 20 | 5 |
| ECHCG | 2 | 5 | 16 | 0 | 2 + 16 | 25 | 5 |
| ECHCG | 2 | 5 | 8 | 0 | 2 + 8 | 15 | 5 |
| ECHCG | 8 | 95 | 4 | 0 | 8 + 4 | 100 | 95 |
| SETVI | 2 | 50 | 16 | 35 | 2 + 16 | 90 | 68 |
| COMBE | 8 | 10 | 32 | 30 | 8 + 32 | 75 | 37 |
| COMBE | 2 | 10 | 32 | 30 | 2 + 32 | 70 | 37 |
| COMBE | 8 | 10 | 16 | 0 | 8 + 16 | 75 | 10 |
| COMBE | 2 | 10 | 16 | 0 | 2 + 16 | 30 | 10 |
| COMBE | 8 | 10 | 8 | 10 | 8 + 8 | 35 | 19 |
| COMBE | 8 | 10 | 4 | 0 | 8 + 4 | 75 | 10 |
| EPHHL | 8 | 50 | 16 | 0 | 8 + 16 | 60 | 50 |
| EPHHL | 2 | 5 | 16 | 0 | 2 + 16 | 20 | 5 |
| ABUTH | 2 | 25 | 32 | 35 | 2 + 32 | 60 | 51 |
| ABUTH | 8 | 80 | 16 | 5 | 8 + 16 | 100 | 81 |
| ABUTH | 8 | 80 | 4 | 0 | 8 + 4 | 98 | 80 |
| AMARE | 2 | 60 | 16 | 75 | 2 + 16 | 95 | 90 |
| AMARE | 2 | 60 | 8 | 25 | 2 + 8 | 100 | 70 |
| AMBEL | 8 | 45 | 32 | 0 | 8 + 32 | 100 | 45 |
| AMBEL | 2 | 10 | 32 | 0 | 2 + 32 | 15 | 10 |
| AMBEL | 8 | 45 | 16 | 0 | 8 + 16 | 100 | 45 |
| AMBEL | 2 | 10 | 16 | 0 | 2 + 16 | 15 | 10 |
| AMBEL | 8 | 45 | 8 | 0 | 8 + 8 | 85 | 45 |
| AMBEL | 2 | 10 | 8 | 0 | 2 + 8 | 25 | 10 |
| AMBEL | 8 | 45 | 4 | 0 | 8 + 4 | 100 | 45 |
| AMBEL | 2 | 10 | 4 | 0 | 2 + 4 | 30 | 10 |

### Post

| | solo application | | | | combination | | |
|---|---|---|---|---|---|---|---|
| | | | | | COMPOUND I-3 + Rimisoxafen | | |
| | COMPOUND I-3 | | Rimisoxafen | | | | COLBY |
| | use rate | % | use rate | % | use rate | % | expected % |
| weed | (gai/ha) | activity | (gai/ha) | activity | (gai/ha) | activity | activity |
| DIGSA | 8 | 85 | 32 | 20 | 8 + 32 | 95 | 88 |
| DIGSA | 8 | 85 | 16 | 10 | 8 + 16 | 95 | 87 |
| DIGSA | 8 | 85 | 8 | 5 | 8 + 8 | 98 | 86 |
| DIGSA | 8 | 85 | 4 | 5 | 8 + 4 | 100 | 86 |

### Example 87: Synergistic Herbicidal Action of the Composition of the Compound I-2 and Rimisoxafen (PRE and POST)

Rimisoxafen was used as an 5% EC formulation. Assessed 20 days after treatment (DAT).

### Pre

| | solo application | | | | combination | | |
|---|---|---|---|---|---|---|---|
| | | | | | COMPOUND I-2 + Rimisoxafen | | |
| | COMPOUND I-2 | | Rimisoxafen | | | | COLBY |
| | use rate | % | use rate | % | use rate | % | expected % |
| weed | (gai/ha) | activity | (gai/ha) | activity | (gai/ha) | activity | activity |
| ALOMY | 2 | 20 | 16 | 0 | 2 + 16 | 30 | 20 |
| ALOMY | 2 | 20 | 8 | 0 | 2 + 8 | 25 | 20 |
| LOLMU | 2 | 15 | 8 | 0 | 2 + 8 | 25 | 15 |
| ECHCG | 2 | 0 | 16 | 0 | 2 + 16 | 20 | 0 |
| ECHCG | 2 | 0 | 8 | 0 | 2 + 8 | 20 | 0 |
| SETVI | 2 | 25 | 8 | 35 | 2 + 8 | 60 | 51 |
| COMBE | 2 | 10 | 16 | 0 | 2 + 16 | 55 | 10 |
| COMBE | 8 | 45 | 8 | 10 | 8 + 8 | 60 | 51 |
| EPHHL | 8 | 15 | 16 | 0 | 8 + 16 | 50 | 15 |
| EPHHL | 2 | 0 | 16 | 0 | 2 + 16 | 25 | 0 |
| EPHHL | 8 | 15 | 8 | 0 | 8 + 8 | 20 | 15 |
| EPHHL | 2 | 0 | 8 | 0 | 2 + 8 | 20 | 0 |
| ABUTH | 8 | 55 | 16 | 5 | 8 + 16 | 70 | 57 |
| ABUTH | 2 | 10 | 16 | 5 | 2 + 16 | 30 | 15 |
| ABUTH | 8 | 55 | 8 | 5 | 8 + 8 | 90 | 57 |
| AMARE | 2 | 70 | 16 | 75 | 2 + 16 | 100 | 93 |
| AMARE | 2 | 70 | 8 | 25 | 2 + 8 | 85 | 78 |
| AMBEL | 2 | 0 | 16 | 0 | 2 + 16 | 30 | 0 |
| AMBEL | 2 | 0 | 8 | 0 | 2 + 8 | 30 | 0 |

### Post

| | solo application | | | | combination | | |
|---|---|---|---|---|---|---|---|
| | | | | | COMPOUND I-2 + Rimisoxafen | | |
| | COMPOUND I-2 | | Rimisoxafen | | | | COLBY |
| | use rate | % | use rate | % | use rate | % | expected % |
| weed | (gai/ha) | activity | (gai/ha) | activity | (gai/ha) | activity | activity |
| DIGSA | 8 | 20 | 16 | 10 | 8 + 16 | 85 | 28 |
| DIGSA | 2 | 0 | 16 | 10 | 2 + 16 | 25 | 10 |
| ABUTH | 8 | 40 | 16 | 80 | 8 + 16 | 98 | 88 |
| EPHHL | 8 | 30 | 16 | 15 | 8 + 16 | 100 | 41 |

### Example 88: Synergistic Herbicidal Action of the Composition of the Compound I-3 and Propanil (PRE and POST)

Propanil was used as an EC formulation, having an active ingredient concentration of 480 g/l. Assessed 18 days after treatment (DAT).

### Pre

| | solo application | | | | combination | | |
|---|---|---|---|---|---|---|---|
| | | | | | COMPOUND I-3 + Propanil | | |
| | COMPOUND I-3 | | Propanil | | | | COLBY |
| | use rate | % | use rate | % | use rate | % | expected % |
| weed | (gai/ha) | activity | (gai/ha) | activity | (gai/ha) | activity | activity |
| LOLMU | 2 | 10 | 500 | 0 | 2 + 500 | 25 | 10 |
| LOLMU | 8 | 70 | 250 | 0 | 8 + 250 | 95 | 70 |

### Post

| | solo application | | | | combination | | |
|---|---|---|---|---|---|---|---|
| | | | | | COMPOUND I-3 + Propanil | | |
| | COMPOUND I-3 | | Propanil | | | | COLBY |
| | use rate | % | use rate | % | use rate | % | expected % |
| weed | (gai/ha) | activity | (gai/ha) | activity | (gai/ha) | activity | activity |
| ECHCG | 2 | 0 | 500 | 0 | 2 + 500 | 15 | 0 |
| ECHCG | 2 | 0 | 250 | 0 | 2 + 250 | 10 | 0 |
| DIGSA | 8 | 10 | 250 | 10 | 8 + 250 | 60 | 19 |
| DIGSA | 2 | 10 | 250 | 10 | 2 + 250 | 30 | 19 |

### Example 89: Synergistic Herbicidal Action of the Composition of the Compound I-2 and Propanil (PRE and POST)

Propanil was used as an EC formulation, having an active ingredient concentration of 480 g/l. Assessed 18 days after treatment (DAT).

### Pre

| | solo application | | | | combination | | |
|---|---|---|---|---|---|---|---|
| | | | | | COMPOUND I-2 + Propanil | | |
| | COMPOUND I-2 | | Propanil | | | | COLBY |
| | use rate | % | use rate | % | use rate | % | expected % |
| weed | (gai/ha) | activity | (gai/ha) | activity | (gai/ha) | activity | activity |
| ALOMY | 8 | 75 | 500 | 0 | 8 + 500 | 80 | 75 |
| ALOMY | 8 | 75 | 250 | 0 | 8 + 250 | 90 | 75 |
| LOLMU | 8 | 30 | 500 | 0 | 8 + 500 | 70 | 30 |
| LOLMU | 2 | 0 | 500 | 0 | 2 + 500 | 10 | 0 |
| LOLMU | 8 | 30 | 250 | 0 | 8 + 250 | 95 | 30 |
| ECHCG | 8 | 25 | 500 | 0 | 8 + 500 | 95 | 25 |
| ECHCG | 8 | 25 | 250 | 0 | 8 + 250 | 90 | 25 |
| COMBE | 8 | 25 | 250 | 0 | 8 + 250 | 85 | 25 |
| EPHHL | 8 | 35 | 250 | 0 | 8 + 250 | 40 | 35 |
| EPHHL | 2 | 10 | 250 | 0 | 2 + 250 | 20 | 10 |
| ABUTH | 8 | 50 | 500 | 0 | 8 + 500 | 60 | 50 |
| AMARE | 2 | 80 | 500 | 0 | 2 + 500 | 95 | 80 |
| AMBEL | 8 | 70 | 500 | 0 | 8 + 500 | 85 | 70 |
| AMBEL | 8 | 70 | 250 | 0 | 8 + 250 | 100 | 70 |

### Post

| | solo application | | | | combination | | |
|---|---|---|---|---|---|---|---|
| | | | | | COMPOUND I-2 + Propanil | | |
| | COMPOUND I-2 | | Propanil | | | | COLBY |
| | use rate | % | use rate | % | use rate | % | expected % |
| weed | (gai/ha) | activity | (gai/ha) | activity | (gai/ha) | activity | activity |
| ECHCG | 8 | 15 | 500 | 0 | 8 + 500 | 45 | 15 |
| ECHCG | 2 | 0 | 500 | 0 | 2 + 500 | 5 | 0 |
| ECHCG | 8 | 15 | 250 | 0 | 8 + 250 | 50 | 15 |
| ECHCG | 2 | 0 | 250 | 0 | 2 + 250 | 5 | 0 |
| DIGSA | 2 | 0 | 500 | 10 | 2 + 500 | 50 | 10 |
| DIGSA | 2 | 0 | 250 | 10 | 2 + 250 | 20 | 10 |
| ABUTH | 8 | 20 | 500 | 5 | 8 + 500 | 50 | 24 |
| ABUTH | 2 | 20 | 500 | 5 | 2 + 500 | 30 | 24 |
| ABUTH | 8 | 20 | 250 | 0 | 8 + 250 | 65 | 20 |
| ABUTH | 2 | 20 | 250 | 0 | 2 + 250 | 40 | 20 |
| AMARE | 8 | 70 | 500 | 0 | 8 + 500 | 95 | 70 |
| AMARE | 2 | 55 | 500 | 0 | 2 + 500 | 65 | 55 |
| AMARE | 8 | 70 | 250 | 0 | 8 + 250 | 75 | 70 |
| EPHHL | 2 | 25 | 250 | 0 | 2 + 250 | 55 | 25 |
| GERPU | 8 | 50 | 500 | 40 | 8 + 500 | 98 | 70 |

### Example 90: Synergistic Herbicidal Action of the Composition of the Compound I-3 and Bromoxynil (PRE and POST)

Bromoxynil was used as an EC formulation, having an active ingredient concentration of 225 g/l. Assessed 18 days after treatment (DAT).

### Pre

| | solo application | | | | combination | | |
|---|---|---|---|---|---|---|---|
| | | | | | COMPOUND I-3 + Bromoxynil | | |
| | COMPOUND I-3 | | Bromoxynil | | | | COLBY |
| | use rate | % | use rate | % | use rate | % | expected % |
| weed | (gai/ha) | activity | (gai/ha) | activity | (gai/ha) | activity | activity |
| LOLMU | 8 | 70 | 120 | 0 | 8 + 120 | 75 | 70 |
| LOLMU | 8 | 70 | 30 | 0 | 8 + 30 | 80 | 70 |
| ECHCG | 2 | 25 | 30 | 0 | 2 + 30 | 50 | 25 |
| EPHHL | 8 | 75 | 30 | 0 | 8 + 30 | 90 | 75 |

### Post

| | solo application | | | | combination | | |
|---|---|---|---|---|---|---|---|
| | | | | | COMPOUND I-3 + Bromoxynil | | |
| | COMPOUND I-3 | | Bromoxynil | | | | COLBY |
| | use rate | % | use rate | % | use rate | % | expected % |
| weed | (gai/ha) | activity | (gai/ha) | activity | (gai/ha) | activity | activity |
| ECHCG | 2 | 0 | 30 | 0 | 2 + 30 | 20 | 0 |
| DIGSA | 8 | 10 | 120 | 15 | 8 + 120 | 30 | 24 |
| DIGSA | 2 | 10 | 30 | 0 | 2 + 30 | 15 | 10 |
| GERPU | 2 | 25 | 30 | 5 | 2 + 30 | 40 | 29 |

### Example 91: Synergistic Herbicidal Action of the Composition of the Compound I-2 and Bromoxynil (PRE and POST)

Bromoxynil was used as an EC formulation, having an active ingredient concentration of 225 g/l. Assessed 18 days after treatment (DAT).

### Pre

| | solo application | | | | combination | | |
|---|---|---|---|---|---|---|---|
| | | | | | COMPOUND I-2 + Bromoxynil | | |
| | COMPOUND I-2 | | Bromoxynil | | | | COLBY |
| | use rate | % | use rate | % | use rate | % | expected % |
| weed | (gai/ha) | activity | (gai/ha) | activity | (gai/ha) | activity | activity |
| ALOMY | 8 | 75 | 120 | 0 | 8 + 120 | 85 | 75 |
| ALOMY | 2 | 5 | 120 | 0 | 2 + 120 | 50 | 5 |
| ALOMY | 2 | 5 | 30 | 0 | 2 + 30 | 45 | 5 |
| LOLMU | 8 | 30 | 120 | 0 | 8 + 120 | 40 | 30 |
| LOLMU | 2 | 0 | 120 | 0 | 2 + 120 | 5 | 0 |
| LOLMU | 2 | 0 | 30 | 0 | 2 + 30 | 10 | 0 |
| ECHCG | 8 | 25 | 120 | 0 | 8 + 120 | 95 | 25 |
| ECHCG | 8 | 25 | 30 | 0 | 8 + 30 | 75 | 25 |
| ECHCG | 2 | 10 | 30 | 0 | 2 + 30 | 20 | 10 |
| COMBE | 8 | 25 | 30 | 0 | 8 + 30 | 40 | 25 |
| ABUTH | 8 | 50 | 120 | 0 | 8 + 120 | 65 | 50 |

### Post

| | solo application | | | | combination | | |
|---|---|---|---|---|---|---|---|
| | | | | | COMPOUND I-2 + Bromoxynil | | |
| | COMPOUND I-2 | | Bromoxynil | | | | COLBY |
| | use rate | % | use rate | % | use rate | % | expected % |
| weed | (gai/ha) | activity | (gai/ha) | activity | (gai/ha) | activity | activity |
| ECHCG | 2 | 0 | 30 | 0 | 2 + 30 | 5 | 0 |
| DIGSA | 2 | 0 | 120 | 15 | 2 + 120 | 20 | 15 |
| DIGSA | 2 | 0 | 30 | 0 | 2 + 30 | 10 | 0 |
| AMARE | 8 | 70 | 30 | 0 | 8 + 30 | 100 | 70 |
| EPHHL | 2 | 25 | 30 | 70 | 2 + 30 | 85 | 78 |
| GERPU | 8 | 50 | 120 | 20 | 8 + 120 | 100 | 60 |
| GERPU | 2 | 40 | 120 | 20 | 2 + 120 | 100 | 52 |
| GERPU | 8 | 50 | 30 | 5 | 8 + 30 | 98 | 53 |
| GERPU | 2 | 40 | 30 | 5 | 2 + 30 | 60 | 43 |

### Example 92: Synergistic Herbicidal Action of the Composition of the Compound I-3 and Propyzamide (PRE and POST)

Propyzamide was used as an SC formulation, having an active ingredient concentration of 400 g/l. Assessed 18 days after treatment (DAT).

### Pre

| | solo application | | | | combination | | |
|---|---|---|---|---|---|---|---|
| | | | | | COMPOUND I-3 + Propyzamide | | |
| | COMPOUND I-3 | | Propyzamide | | | | COLBY |
| | use rate | % | use rate | % | use rate | % | expected % |
| weed | (gai/ha) | activity | (gai/ha) | activity | (gai/ha) | activity | activity |
| EPHHL | 2 | 15 | 1000 | 15 | 2 + 1000 | 65 | 28 |
| ABUTH | 2 | 70 | 250 | 0 | 2 + 250 | 80 | 70 |

### Post

| | solo application | | | | combination | | |
|---|---|---|---|---|---|---|---|
| | | | | | COMPOUND I-3 + Propyzamide | | |
| | COMPOUND I-3 | | Propyzamide | | | | COLBY |
| | use rate | % | use rate | % | use rate | % | expected % |
| weed | (gai/ha) | activity | (gai/ha) | activity | (gai/ha) | activity | activity |
| ABUTH | 8 | 65 | 1000 | 5 | 8 + 1000 | 90 | 67 |
| AMARE | 8 | 90 | 1000 | 50 | 8 + 1000 | 100 | 95 |
| GERPU | 2 | 25 | 1000 | 20 | 2 + 1000 | 100 | 40 |

### Example 93: Synergistic Herbicidal Action of the Composition of the Compound I-2 and Propyzamide (PRE and POST)

Propyzamide was used as an SC formulation, having an active ingredient concentration of 400 g/l. Assessed 18 days after treatment (DAT).

### Pre

| | solo application | | | | combination | | |
|---|---|---|---|---|---|---|---|
| | | | | | COMPOUND I-2 + Propyzamide | | |
| | COMPOUND I-2 | | Propyzamide | | | | COLBY |
| | use rate | % | use rate | % | use rate | % | expected % |
| weed | (gai/ha) | activity | (gai/ha) | activity | (gai/ha) | activity | activity |
| EPHHL | 2 | 10 | 250 | 10 | 2 + 250 | 25 | 19 |
| ABUTH | 8 | 50 | 1000 | 10 | 8 + 1000 | 70 | 55 |
| ABUTH | 8 | 50 | 250 | 0 | 8 + 250 | 100 | 50 |
| ABUTH | 2 | 30 | 250 | 0 | 2 + 250 | 60 | 30 |
| AMBEL | 8 | 70 | 250 | 0 | 8 + 250 | 100 | 70 |

### Post

| | solo application | | | | combination | | |
|---|---|---|---|---|---|---|---|
| | | | | | COMPOUND I-2 + Propyzamide | | |
| | COMPOUND I-2 | | Propyzamide | | | | COLBY |
| | use rate | % | use rate | % | use rate | % | expected % |
| weed | (gai/ha) | activity | (gai/ha) | activity | (gai/ha) | activity | activity |
| ECHCG | 8 | 15 | 1000 | 30 | 8 + 1000 | 65 | 41 |
| ECHCG | 8 | 15 | 250 | 0 | 8 + 250 | 25 | 15 |
| ECHCG | 2 | 0 | 250 | 0 | 2 + 250 | 20 | 0 |
| AMARE | 8 | 70 | 250 | 20 | 8 + 250 | 98 | 76 |
| AMARE | 2 | 55 | 250 | 20 | 2 + 250 | 70 | 64 |
| EPHHL | 2 | 25 | 250 | 0 | 2 + 250 | 30 | 25 |

### Example 94: Synergistic Herbicidal Action of the Composition of the Compound I-3 and Indaziflam (PRE and POST)

Indaziflam was used as an SC formulation, having an active ingredient concentration of 200 g/l. Assessed 18 days after treatment (DAT).

### Pre

| | solo application | | | | combination | | |
|---|---|---|---|---|---|---|---|
| | | | | | COMPOUND I-3 + Indaziflam | | |
| | COMPOUND I-3 | | Indaziflam | | | | COLBY |
| | use rate | % | use rate | % | use rate | % | expected % |
| weed | (gai/ha) | activity | (gai/ha) | activity | (gai/ha) | activity | activity |
| LOLMU | 8 | 70 | 4 | 40 | 8 + 4 | 95 | 82 |
| LOLMU | 2 | 10 | 4 | 40 | 2 + 4 | 60 | 46 |
| LOLMU | 8 | 70 | 2 | 10 | 8 + 2 | 85 | 73 |
| LOLMU | 2 | 10 | 1 | 10 | 2 + 1 | 35 | 19 |
| ECHCG | 2 | 25 | 8 | 80 | 2 + 8 | 95 | 85 |
| ECHCG | 2 | 25 | 1 | 30 | 2 + 1 | 55 | 48 |
| COMBE | 2 | 50 | 8 | 40 | 2 + 8 | 98 | 70 |
| COMBE | 2 | 50 | 2 | 10 | 2 + 2 | 85 | 55 |
| EPHHL | 2 | 15 | 4 | 5 | 2 + 4 | 35 | 19 |

### Post

| | solo application | | | | combination | | |
|---|---|---|---|---|---|---|---|
| | | | | | COMPOUND I-3 + Indaziflam | | |
| | COMPOUND I-3 | | Indaziflam | | | | COLBY |
| | use rate | % | use rate | % | use rate | % | expected % |
| weed | (gai/ha) | activity | (gai/ha) | activity | (gai/ha) | activity | activity |
| ECHCG | 2 | 0 | 8 | 60 | 2 + 8 | 95 | 60 |
| ECHCG | 2 | 0 | 4 | 20 | 2 + 4 | 40 | 20 |
| ECHCG | 2 | 0 | 2 | 0 | 2 + 2 | 15 | 0 |
| ECHCG | 2 | 0 | 1 | 0 | 2 + 1 | 20 | 0 |
| DIGSA | 8 | 10 | 8 | 20 | 8 + 8 | 75 | 28 |
| DIGSA | 8 | 10 | 2 | 5 | 8 + 2 | 35 | 15 |
| DIGSA | 2 | 10 | 2 | 5 | 2 + 2 | 25 | 15 |
| ABUTH | 8 | 65 | 4 | 30 | 8 + 4 | 90 | 76 |
| ABUTH | 2 | 35 | 4 | 30 | 2 + 4 | 60 | 55 |
| ABUTH | 8 | 65 | 2 | 15 | 8 + 2 | 98 | 70 |
| GERPU | 2 | 25 | 8 | 50 | 2 + 8 | 98 | 63 |
| GERPU | 2 | 25 | 4 | 50 | 2 + 4 | 100 | 63 |

### Example 94: Synergistic Herbicidal Action of the Composition of the Compound I-3 and Indaziflam (PRE and POST)

Indaziflam was used as an SC formulation, having an active ingredient concentration of 200 g/l. Assessed 18 days after treatment (DAT).

### Pre

| | solo application | | | | combination | | |
|---|---|---|---|---|---|---|---|
| | | | | | COMPOUND I-2 + Indaziflam | | |
| | COMPOUND I-2 | | Indaziflam | | | | COLBY |
| | use rate | % | use rate | % | use rate | % | expected % |
| weed | (gai/ha) | activity | (gai/ha) | activity | (gai/ha) | activity | activity |
| ALOMY | 2 | 5 | 4 | 75 | 2 + 4 | 85 | 76 |
| ALOMY | 8 | 75 | 1 | 10 | 8 + 1 | 85 | 78 |
| ALOMY | 2 | 5 | 1 | 10 | 2 + 1 | 30 | 15 |
| LOLMU | 8 | 30 | 1 | 10 | 8 + 1 | 75 | 37 |
| LOLMU | 2 | 0 | 1 | 10 | 2 + 1 | 20 | 10 |
| ECHCG | 2 | 10 | 4 | 85 | 2 + 4 | 95 | 87 |
| ECHCG | 8 | 25 | 1 | 30 | 8 + 1 | 100 | 48 |
| ECHCG | 2 | 10 | 1 | 30 | 2 + 1 | 70 | 37 |
| SETVI | 2 | 70 | 1 | 40 | 2 + 1 | 95 | 82 |
| COMBE | 8 | 25 | 1 | 20 | 8 + 1 | 60 | 40 |
| EPHHL | 8 | 35 | 1 | 10 | 8 + 1 | 55 | 42 |
| EPHHL | 2 | 10 | 1 | 10 | 2 + 1 | 25 | 19 |
| ABUTH | 8 | 50 | 4 | 25 | 8 + 4 | 75 | 63 |
| ABUTH | 8 | 50 | 1 | 0 | 8 + 1 | 90 | 50 |
| ABUTH | 2 | 30 | 1 | 0 | 2 + 1 | 35 | 30 |
| AMARE | 2 | 80 | 4 | 50 | 2 + 4 | 100 | 90 |
| AMARE | 2 | 80 | 1 | 10 | 2 + 1 | 98 | 82 |

### Post

| | solo application | | | | combination | | |
|---|---|---|---|---|---|---|---|
| | | | | | COMPOUND I-2 + Indaziflam | | |
| | COMPOUND I-2 | | Indaziflam | | | | COLBY |
| | use rate | % | use rate | % | use rate | % | expected % |
| weed | (gai/ha) | activity | (gai/ha) | activity | (gai/ha) | activity | activity |
| ECHCG | 8 | 15 | 4 | 20 | 8 + 4 | 80 | 32 |
| ECHCG | 2 | 0 | 4 | 20 | 2 + 4 | 50 | 20 |
| ECHCG | 8 | 15 | 1 | 0 | 8 + 1 | 40 | 15 |
| ECHCG | 2 | 0 | 1 | 0 | 2 + 1 | 20 | 0 |
| DIGSA | 2 | 0 | 1 | 0 | 2 + 1 | 5 | 0 |
| ABUTH | 8 | 20 | 4 | 30 | 8 + 4 | 60 | 44 |
| AMARE | 8 | 70 | 1 | 65 | 8 + 1 | 100 | 90 |
| EPHHL | 2 | 25 | 4 | 40 | 2 + 4 | 60 | 55 |

### Example 96: Synergistic Herbicidal Action of the Composition of the Compound I-3 and Prosulfocarb (PRE and POST)

Prosulfocarb) was used as an EC formulation, having an active ingredient concentration of 800 g/l. Assessed 20 days after treatment (DAT).

### Pre

| | solo application | | | | combination | | |
|---|---|---|---|---|---|---|---|
| | | | | | COMPOUND I-3 + Prosulfocarb | | |
| | COMPOUND I-3 | | Prosulfocarb | | | | COLBY |
| | use rate | % | use rate | % | use rate | % | expected % |
| weed | (gai/ha) | activity | (gai/ha) | activity | (gai/ha) | activity | activity |
| LOLMU | 2 | 25 | 600 | 20 | 2 + 600 | 50 | 40 |
| EPHHL | 8 | 20 | 150 | 5 | 8 + 150 | 35 | 24 |
| ABUTH | 2 | 10 | 600 | 40 | 2 + 600 | 75 | 46 |

### Post

| | solo application | | | | combination | | |
|---|---|---|---|---|---|---|---|
| | | | | | COMPOUND I-3 + Prosulfocarb | | |
| | COMPOUND I-3 | | Prosulfocarb | | | | COLBY |
| | use rate | % | use rate | % | use rate | % | expected % |
| weed | (gai/ha) | activity | (gai/ha) | activity | (gai/ha) | activity | activity |
| DIGSA | 2 | 5 | 600 | 5 | 2 + 600 | 45 | 10 |
| GERPU | 8 | 10 | 600 | 20 | 8 + 600 | 60 | 28 |

### Example 97: Synergistic Herbicidal Action of the Composition of the Compound I-4 and Prosulfocarb (PRE)

Prosulfocarb) was used as an EC formulation, having an active ingredient concentration of 800 g/l. Assessed 20 days after treatment (DAT).

### Pre

| | solo application | | | | combination | | |
|---|---|---|---|---|---|---|---|
| | | | | | COMPOUND I-4 + Prosulfocarb | | |
| | COMPOUND I-4 | | Prosulfocarb | | | | COLBY |
| | use rate | % | use rate | % | use rate | % | expected % |
| weed | (gai/ha) | activity | (gai/ha) | activity | (gai/ha) | activity | activity |
| LOLMU | 2 | 10 | 600 | 20 | 2 + 600 | 45 | 28 |
| LOLMU | 2 | 10 | 150 | 15 | 2 + 150 | 30 | 24 |
| EPHHL | 8 | 5 | 600 | 5 | 8 + 600 | 60 | 10 |
| AMBEL | 8 | 35 | 600 | 10 | 8 + 600 | 60 | 42 |

### Example 98: Synergistic Herbicidal Action of the Composition of the Compound I-3 and Trifluralin (PRE and POST)

Trifluralin was used as an 5% EC formulation. Assessed 20 days after treatment (DAT).

### Pre

| | solo application | | | | combination | | |
|---|---|---|---|---|---|---|---|
| | | | | | COMPOUND I-3 + Trifluralin | | |
| | COMPOUND I-3 | | Trifluralin | | | | COLBY |
| | use rate | % | use rate | % | use rate | % | expected % |
| weed | (gai/ha) | activity | (gai/ha) | activity | (gai/ha) | activity | activity |
| LOLMU | 2 | 25 | 1000 | 15 | 2 + 1000 | 65 | 36 |
| LOLMU | 2 | 25 | 500 | 5 | 2 + 500 | 40 | 29 |
| EPHHL | 8 | 20 | 1000 | 35 | 8 + 1000 | 60 | 48 |
| ABUTH | 2 | 10 | 500 | 25 | 2 + 500 | 40 | 33 |

### Post

| | solo application | | | | combination | | |
|---|---|---|---|---|---|---|---|
| | | | | | COMPOUND I-3 + Trifluralin | | |
| | COMPOUND I-3 | | Trifluralin | | | | COLBY |
| | use rate | % | use rate | % | use rate | % | expected % |
| weed | (gai/ha) | activity | (gai/ha) | activity | (gai/ha) | activity | activity |
| ABUTH | 8 | 80 | 500 | 15 | 8 + 500 | 95 | 83 |
| ABUTH | 2 | 50 | 500 | 15 | 2 + 500 | 75 | 58 |
| GERPU | 8 | 10 | 1000 | 85 | 8 + 1000 | 98 | 87 |
| GERPU | 2 | 20 | 1000 | 85 | 2 + 1000 | 95 | 88 |
| GERPU | 8 | 10 | 500 | 25 | 8 + 500 | 98 | 33 |
| GERPU | 2 | 20 | 500 | 25 | 2 + 500 | 80 | 40 |

### Example 99: Synergistic Herbicidal Action of the Composition of the Compound I-4 and Trifluralin (PRE and POST)

Trifluralin was used as an 5% EC formulation. Assessed 20 days after treatment (DAT).

### Pre

| | solo application | | | | combination | | |
|---|---|---|---|---|---|---|---|
| | | | | | COMPOUND I-4 + Trifluralin | | |
| | COMPOUND I-4 | | Trifluralin | | | | COLBY |
| | use rate | % | use rate | % | use rate | % | expected % |
| weed | (gai/ha) | activity | (gai/ha) | activity | (gai/ha) | activity | activity |
| ALOMY | 2 | 50 | 1000 | 65 | 2 + 1000 | 90 | 83 |
| LOLMU | 2 | 10 | 1000 | 15 | 2 + 1000 | 65 | 24 |
| LOLMU | 8 | 65 | 500 | 5 | 8 + 500 | 80 | 67 |
| COMBE | 2 | 10 | 1000 | 80 | 2 + 1000 | 90 | 82 |
| ABUTH | 2 | 35 | 500 | 25 | 2 + 500 | 60 | 51 |
| AMBEL | 8 | 35 | 500 | 10 | 8 + 500 | 55 | 42 |

### Post

| | solo application | | | | combination | | |
|---|---|---|---|---|---|---|---|
| | | | | | COMPOUND I-4 + Trifluralin | | |
| | COMPOUND I-4 | | Trifluralin | | | | COLBY |
| | use rate | % | use rate | % | use rate | % | expected % |
| weed | (gai/ha) | activity | (gai/ha) | activity | (gai/ha) | activity | activity |
| ABUTH | 2 | 20 | 1000 | 70 | 2 + 1000 | 85 | 76 |
| GERPU | 8 | 30 | 1000 | 85 | 8 + 1000 | 98 | 90 |
| GERPU | 2 | 10 | 1000 | 85 | 2 + 1000 | 95 | 87 |
| GERPU | 8 | 30 | 500 | 25 | 8 + 500 | 95 | 48 |
| GERPU | 2 | 10 | 500 | 25 | 2 + 500 | 70 | 33 |

### Example 100: Synergistic Herbicidal Action of the Composition of the Compound I-3 and Pyroxsulam (PRE)

Pyroxsulam was used as an WG formulation, having an active ingredient concentration of 215 g/kg. Assessed 20 days after treatment (DAT).

### Pre

| | solo application | | | | combination | | |
|---|---|---|---|---|---|---|---|
| | | | | | COMPOUND I-3 + Pyroxsulam | | |
| | COMPOUND I-3 | | Pyroxsulam | | | | COLBY |
| | use rate | % | use rate | % | use rate | % | expected % |
| weed | (gai/ha) | activity | (gai/ha) | activity | (gai/ha) | activity | activity |
| ABUTH | 2 | 10 | 0.5 | 5 | 2 + 0.5 | 60 | 15 |
| ABUTH | 2 | 10 | 0.25 | 0 | 2 + 0.25 | 95 | 10 |

### Example 101: Synergistic Herbicidal Action of the Composition of the Compound I-4 and Pyroxsulam (PRE)

Pyroxsulam was used as an WG formulation, having an active ingredient concentration of 215 g/kg. Assessed 20 days after treatment (DAT).

### Pre

| | | | | | combination | | |
|---|---|---|---|---|---|---|---|
| | solo application | | | | COMPOUND I-4 + Pyroxsulam | | |
| | COMPOUND I-4 | | Pyroxsulam | | | | COLBY |
| | use rate | | use rate | | use rate | | expected % |
| weed | (gai/ha) | % activity | (gai/ha) | % activity | (gai/ha) | % activity | activity |
| SETVI | 8 | 80 | 0.25 | 10 | 8 + 0.25 | 90 | 82 |
| COMBE | 2 | 10 | 0.25 | 10 | 2 + 0.25 | 30 | 19 |
| ABUTH | 2 | 35 | 0.25 | 0 | 2 + 0.25 | 50 | 35 |
| AMBEL | 8 | 35 | 0.25 | 15 | 8 + 0.25 | 60 | 45 |

### Example 100: Synergistic Herbicidal Action of the Composition of the Compound I-3 and Bispyribac-Sodium (PRE)

Bispyribac-Sodium was used as an SC formulation, having an active ingredient concentration of 100 g/l. Assessed 20 days after treatment (DAT).

### Pre

| | | | | | combination | | |
|---|---|---|---|---|---|---|---|
| | | | | | COMPOUND I-3 + | | |
| | solo application | | | | Bispyribac-Sodium | | |
| | COMPOUND I-3 | | Bispyribac-Sodium | | | | COLBY |
| | use rate | | use rate | | use rate | | expected % |
| weed | (gai/ha) | % activity | (gai/ha) | % activity | (gai/ha) | % activity | activity |
| COMBE | 2 | 10 | 15 | 80 | 2 + 15 | 90 | 82 |
| ABUTH | 2 | 10 | 15 | 45 | 2 + 15 | 75 | 51 |
| ABUTH | 2 | 10 | 7.5 | 5 | 2 + 7.5 | 55 | 15 |

### Example 102: Synergistic Herbicidal Action of the Composition of the Compound I-3 and Bispyribac-Sodium (PRE)

Bispyribac-Sodium was used as an SC formulation, having an active ingredient concentration of 100 g/l. Assessed 20 days after treatment (DAT).

### Pre

| | | | | | combination | | |
|---|---|---|---|---|---|---|---|
| | | | | | COMPOUND I-4 + | | |
| | solo application | | | | Bispyribac-Sodium | | |
| | COMPOUND I-4 | | Bispyribac-Sodium | | | | COLBY |
| | use rate | | use rate | | use rate | | expected % |
| weed | (gai/ha) | % activity | (gai/ha) | % activity | (gai/ha) | % activity | activity |
| GERPU | 2 | 10 | 7.5 | 75 | 2 + 7.5 | 90 | 78 |

### Example 103: Synergistic Herbicidal Action of the Composition of the Compound I-3 and Mesosulfuron-Methyl (PRE)

Mesosulfuron-methyl was used as an WG formulation, having an active ingredient concentration of 45 g/kg. Assessed 20 days after treatment (DAT).

### Pre

| | | | | | combination | | |
|---|---|---|---|---|---|---|---|
| | | | | | COMPOUND I-3 + | | |
| | solo application | | | | Mesosulfuron-methyl | | |
| | COMPOUND I-3 | | Mesosulfuron-methyl | | | | COLBY |
| | use rate | | use rate | | use rate | | expected % |
| weed | (gai/ha) | % activity | (gai/ha) | % activity | (gai/ha) | % activity | activity |
| ALOMY | 2 | 65 | 1 | 10 | 2 + 1 | 80 | 69 |
| LOLMU | 2 | 20 | 1 | 0 | 2 + 1 | 30 | 20 |
| LOLMU | 2 | 20 | 0.25 | 0 | 2 + 0.25 | 25 | 20 |
| COMBE | 8 | 35 | 0.25 | 35 | 8 + 0.25 | 70 | 58 |

### Example 104: Synergistic Herbicidal Action of the Composition of the Compound I-2 and Mesosulfuron-Methyl (PRE)

Mesosulfuron-methyl was used as an WG formulation, having an active ingredient concentration of 45 g/kg. Assessed 20 days after treatment (DAT).

### Pre

| | | | | | combination | | |
|---|---|---|---|---|---|---|---|
| | | | | | COMPOUND I-2 + | | |
| | solo application | | | | Mesosulfuron-methyl | | |
| | COMPOUND I-2 | | Mesosulfuron-methyl | | | | COLBY |
| | use rate | | use rate | | use rate | | expected % |
| weed | (gai/ha) | % activity | (gai/ha) | % activity | (gai/ha) | % activity | activity |
| ALOMY | 2 | 40 | 0.25 | 0 | 2 + 0.25 | 45 | 40 |
| LOLMU | 8 | 85 | 0.25 | 0 | 8 + 0.25 | 90 | 85 |

### Example 105: Synergistic Herbicidal Action of the Composition of the Compound I-3 and Pyraclonil (PRE)

Pyraclonil was used as an 5% EC formulation. Assessed 20 days after treatment (DAT).

### Pre

| | | | | | combination | | |
|---|---|---|---|---|---|---|---|
| | solo application | | | | COMPOUND I-3 + Pyraclonil | | |
| | COMPOUND I-3 | | Pyraclonil | | | | COLBY |
| | use rate | | use rate | | use rate | | expected % |
| weed | (gai/ha) | % activity | (gai/ha) | % activity | (gai/ha) | % activity | activity |
| LOLMU | 2 | 20 | 12.5 | 0 | 2 + 12.5 | 25 | 20 |
| AMBEL | 8 | 90 | 12.5 | 0 | 8 + 12.5 | 95 | 90 |

### Example 106: Synergistic Herbicidal Action of the Composition of the Compound I-2 and Pyraclonil (PRE and POST)

Pyraclonil was used as an 5% EC formulation. Assessed 20 days after treatment (DAT)

### Pre

| | | | | | combination | | |
|---|---|---|---|---|---|---|---|
| | solo application | | | | COMPOUND I-2 + Pyraclonil | | |
| | COMPOUND I-2 | | Pyraclonil | | | | COLBY |
| | use rate | | use rate | | use rate | | expected % |
| weed | (gai/ha) | % activity | (gai/ha) | % activity | (gai/ha) | % activity | activity |
| AMAPA | 8 | 75 | 3.1 | 50 | 8 + 3.1 | 95 | 88 |
| AMAPA | 2 | 40 | 3.1 | 50 | 2 + 3.1 | 75 | 70 |

### Post

| | | | | | combination | | |
|---|---|---|---|---|---|---|---|
| | solo application | | | | COMPOUND I-2 + Pyraclonil | | |
| | COMPOUND I-2 | | Pyraclonil | | | | COLBY |
| | use rate | | use rate | | use rate | | expected % |
| weed | (gai/ha) | % activity | (gai/ha) | % activity | (gai/ha) | % activity | activity |
| AMAPA | 2 | 30 | 12.5 | 90 | 2 + 12.5 | 98 | 93 |

### Example 107: Synergistic Herbicidal Action of the Composition of the Compound I-2 and Ethofumesate (PRE)

Ethofumesate was used as an SC formulation, having an active ingredient concentration of 500 g/l. Assessed 20 days after treatment (DAT).

### Pre

| | | | | | combination | | |
|---|---|---|---|---|---|---|---|
| | solo application | | | | COMPOUND I-2 + Ethofumesate | | |
| | COMPOUND I-2 | | Ethofumesate | | | | COLBY |
| | use rate | | use rate | | use rate | | expected % |
| weed | (gai/ha) | % activity | (gai/ha) | % activity | (gai/ha) | % activity | activity |
| LOLMU | 2 | 20 | 1000 | 60 | 2 + 1000 | 90 | 68 |
| AMBEL | 8 | 80 | 250 | 0 | 8 + 250 | 90 | 80 |

### Example 108: Synergistic Herbicidal Action of the Composition of the Compound I-3 and Quinclorac (PRE)

Quinclorac was used as an SC formulation, having an active ingredient concentration of 250 g/l. Assessed 20 days after treatment (DAT).

### Pre

| | | | | | combination | | |
|---|---|---|---|---|---|---|---|
| | solo application | | | | COMPOUND I-3 + Quinclorac | | |
| | COMPOUND I-3 | | Quinclorac | | | | COLBY |
| | use rate | | use rate | | use rate | | expected % |
| weed | (gai/ha) | % activity | (gai/ha) | % activity | (gai/ha) | % activity | activity |
| COMBE | 8 | 35 | 500 | 65 | 8 + 500 | 90 | 77 |
| AMAPA | 8 | 60 | 500 | 70 | 8 + 500 | 100 | 88 |
| AMAPA | 8 | 60 | 250 | 65 | 8 + 250 | 100 | 86 |
| AMAPA | 8 | 60 | 125 | 65 | 8 + 125 | 100 | 86 |
| AMAPA | 8 | 60 | 62.5 | 60 | 8 + 62.5 | 100 | 84 |

### Example 109: Synergistic Herbicidal Action of the Composition of the Compound I-2 and Quinclorac (PRE)

Quinclorac was used as an SC formulation, having an active ingredient concentration of 250 g/l. Assessed 20 days after treatment (DAT).

### Pre

| | | | | | combination | | |
|---|---|---|---|---|---|---|---|
| | solo application | | | | COMPOUND I-2 + Quinclorac | | |
| | COMPOUND I-2 | | Quinclorac | | | | COLBY |
| | use rate | | use rate | | use rate | | expected % |
| weed | (gai/ha) | % activity | (gai/ha) | % activity | (gai/ha) | % activity | activity |
| AMAPA | 8 | 75 | 500 | 70 | 8 + 500 | 98 | 93 |
| AMAPA | 2 | 40 | 125 | 65 | 2 + 125 | 85 | 79 |

### Post

| | | | | | combination | | |
|---|---|---|---|---|---|---|---|
| | solo application | | | | COMPOUND I-2 + Quinclorac | | |
| | COMPOUND I-2 | | Quinclorac | | | | COLBY |
| | use rate | | use rate | | use rate | | expected % |
| weed | (gai/ha) | % activity | (gai/ha) | % activity | (gai/ha) | % activity | activity |
| AMARE | 2 | 75 | 125 | 50 | 2 + 125 | 95 | 88 |

### Example 110: Synergistic Herbicidal Action of the Composition of the Compound I-3 and Icafolin (PRE)

Icafolin was used as an 5% EC formulation. Assessed 10 days after treatment (DAT).

### Pre

| | | | | | combination | | |
|---|---|---|---|---|---|---|---|
| | solo application | | | | COMPOUND I-3 + Icafolin | | |
| | COMPOUND I-3 | | Icafolin | | | | COLBY |
| | use rate | | use rate | | use rate | | expected % |
| weed | (gai/ha) | % activity | (gai/ha) | % activity | (gai/ha) | % activity | activity |
| ECHCG | 8 | 20 | 50 | 30 | 8 + 50 | 85 | 44 |
| ECHCG | 4 | 20 | 50 | 30 | 4 + 50 | 85 | 44 |
| ECHCG | 2 | 10 | 50 | 30 | 2 + 50 | 60 | 37 |
| ECHCG | 1 | 10 | 50 | 30 | 1 + 50 | 50 | 37 |
| ECHCG | 8 | 20 | 12.5 | 25 | 8 + 12.5 | 95 | 40 |
| ECHCG | 4 | 20 | 12.5 | 25 | 4 + 12.5 | 65 | 40 |
| ECHCG | 2 | 10 | 12.5 | 25 | 2 + 12.5 | 65 | 33 |
| AMAPA | 2 | 60 | 25 | 10 | 2 + 25 | 85 | 64 |
| AMAPA | 1 | 40 | 25 | 10 | 1 + 25 | 70 | 46 |
| AMBEL | 8 | 65 | 25 | 10 | 8 + 25 | 90 | 69 |
| AMBEL | 2 | 10 | 25 | 10 | 2 + 25 | 75 | 19 |

### Example 111: Synergistic Herbicidal Action of the Composition of the Compound I-2 and Icafolin (PRE)

Icafolin was used as an 5% EC formulation. Assessed 10 days after treatment (DAT).

### Pre

| | | | | | combination | | |
|---|---|---|---|---|---|---|---|
| | solo application | | | | COMPOUND I-2 + Icafolin | | |
| | COMPOUND I-2 | | Icafolin | | | | COLBY |
| | use rate | | use rate | | use rate | | expected % |
| weed | (gai/ha) | % activity | (gai/ha) | % activity | (gai/ha) | % activity | activity |
| ECHCG | 16 | 25 | 50 | 30 | 16 + 50 | 95 | 48 |
| ECHCG | 8 | 20 | 50 | 30 | 8 + 50 | 80 | 44 |
| ECHCG | 4 | 20 | 50 | 30 | 4 + 50 | 70 | 44 |
| AMAPA | 16 | 75 | 25 | 10 | 16 + 25 | 98 | 78 |
| AMAPA | 8 | 70 | 25 | 10 | 8 + 25 | 90 | 73 |
| AMAPA | 4 | 40 | 25 | 10 | 4 + 25 | 70 | 46 |
| AMBEL | 16 | 50 | 25 | 10 | 16 + 25 | 60 | 55 |
| AMBEL | 8 | 35 | 25 | 10 | 8 + 25 | 55 | 42 |
| AMBEL | 4 | 20 | 25 | 10 | 4 + 25 | 40 | 28 |
| AMBEL | 2 | 20 | 25 | 10 | 2 + 25 | 40 | 28 |

### Example 112: Synergistic Herbicidal Action of the Composition of the Compound I-4 and Icafolin (PRE)

Icafolin was used as an 5% EC formulation. Assessed 10 days after treatment (DAT).

### Pre

| | | | | | combination | | |
|---|---|---|---|---|---|---|---|
| | solo application | | | | COMPOUND I-4 + Icafolin | | |
| | COMPOUND I-4 | | Icafolin | | | | COLBY |
| | use rate | | use rate | | use rate | | expected % |
| weed | (gai/ha) | % activity | (gai/ha) | % activity | (gai/ha) | % activity | activity |
| ABUTH | 16 | 70 | 12.5 | 20 | 16 + 12.5 | 90 | 76 |
| ABUTH | 8 | 50 | 12.5 | 20 | 8 + 12.5 | 80 | 60 |
| AMBEL | 4 | 10 | 50 | 15 | 4 + 50 | 40 | 24 |

1. An herbicidal combination comprising:
at least one compound A) of the formula (I) 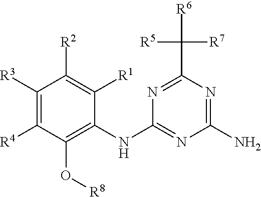
wherein
R¹ is F;
R² is selected from the group consisting of H, halogen, CR^{2A};
wherein R^{2A} is H or halogen;
R³ is H, F;
R⁴ is selected from the group consisting of F, Cl, Br, I, CR^{4A} wherein R^{4A} is H or halogen;
R⁵ is selected from the group consisting of H, halogen, CN, C₁-C₆-alkyl, (C₁-C₆-alkoxy)-C₁-C₆-alkyl, C₃-C₆-cycloalkyl, (C₃-C₆-cycloalkyl)-C₁-C₄-alkyl, C₁-C₆-alkoxy, C₂-C₆-alkenyloxy, C₂-C₆-alkynyloxy, C₃-C₆-cycloalkoxy, (C₃-C₆-cycloalkyl)-C₁-C₄-alkoxy, where the aliphatic and cycloaliphatic parts of the radicals are unsubstituted, partly or completely halogenated;
R⁶ is selected from the group consisting of H, halogen, CN, C₁-C₆-alkyl, C₁-C₆-haloalkyl, C₁-C₆-alkoxy and C₁-C₆-haloalkoxy;
R⁷ is selected from the group consisting of halogen, CN, C₁-C₆-alkyl, C₂-C₆-alkenyl, C₃-C₆-alkynyl, C₃-C₆-cycloalkyl, (C₃-C₆-cycloalkyl)-C₁-C₄-alkyl, C₃-C₆-cycloalkenyl and C₁-C₆-alkoxy-C₁-C₆-alkyl, where the aliphatic and cycloaliphatic parts of the radicals are unsubstituted, partly or completely halogenated;
R⁶ and R⁷ together with the carbon atom to which they are attached form a moiety selected from the group consisting of carbonyl, C₃-C₆-cycloalkyl, C₃-C₆-cycloalkenyl, three- to six-membered saturated or partially unsaturated heterocyclyl, and the moiety >C=CR^{x}R^{y}, where R^{x} and R^{y} are hydrogen, C₁-C₄-alkyl, C₁-C₄-haloalkyl, C₃-C₆-cycloalkyl or CR^{x}R^{y} form a 3- to 6-membered cycloalkyl;
R⁸ is selected from the group consisting of C₁-C₆-alkyl, C₂-C₆-alkenyl, C₂-C₆-alkynyl, (C₁-C₆-alkoxy)-C₁-C₆-alkyl, (C₁-C₆-alkoxy)-C₂-C₆-alkenyl, (C₁-C₆-alkoxy)-C₂-C₆-alkynyl, (C₁-C₆-cycloalkyl)-C₂-C₆-alkynyl, (C₃-C₆-cycloalkyl)-C₁-C₄-alkyl, (C₃-C₆-cycloalkoxy)-C₁-C₄-alkyl, where the aforementioned radicals are unsubstituted, partly or completely halogenated and where the cycloaliphatic parts of the last 6 mentioned radicals may carry 1, 2, 3, 4, 5 or 6 methyl groups,
and at least one further compound selected from herbicide compounds b) and safeners c) and mixtures thereof;
wherein the further herbicidally active compounds b) is selected from the compounds of the following class b1) to b15):
b1) lipid biosynthesis inhibitors;
b2) acetolactate synthase inhibitors;
b3) photosynthesis inhibitors;
b4) protoporphyrinogen-IX oxidase inhibitors,
b5) bleacher herbicides;
b6) enolpyruvyl shikimate 3-phosphate synthase inhibitors;
b7) glutamine synthetase inhibitors;
b8) 7,8-dihydropteroate synthase inhibitors;
b9) mitosis inhibitors;
b10) inhibitors of the synthesis of very long chain fatty acids;
b11) cellulose biosynthesis inhibitors;
b12) decoupler herbicides;
b13) auxinic herbicides;
b14) auxin transport inhibitors and
b15) other herbicides selected from the group consisting of bromobutide, chlorflurenol, chlorflurenol-methyl, cinmethylin, cumyluron, dalapon, dazomet, difenzoquat, difenzoquat-metilsulfate, dimethipin, DSMA, dymron, endothal and its salts, etobenzanid, flamprop, flamprop-isopropyl, flamprop-methyl, flamprop-M-isopropyl, flamprop-M-methyl, flurenol, flurenol-butyl, flurprimidol, fosamine, fosamine-ammonium, indanofan, indaziflam, maleic hydrazide, mefluidide, metam, methiozolin, methyl azide, methyl bromide, methyl-dymron, methyl iodide, MSMA, oleic acid, oxaziclomefone, pelargonic acid, pyributicarb, quinoclamine, tetflupyrolimet, triaziflam, tridiphane and 6-chloro-3-(2-cyclopropyl-6-methylphenoxy)-4-pyridazinol and its salts and esters including their agriculturally acceptable salts or derivatives; and wherein
compound C) is selected from the group consisting of benoxacor, cloquintocet, cyometrinil, cyprosulfamide, dichlormid, dicyclonon, dietholate, fenchlorazole, fenclorim, flurazole, fluxofenim, furilazole, isoxadifen, mefenpyr, mephenate, naphthalic anhydride, oxabetrinil, 4-(dichloroacetyl)-1-oxa-4-azaspiro[4.5]decane, 2,2,5-trimethyl-3-(dichloroacetyl)-1,3-oxazolidine and N-(2-methoxybenzoyl)-4-[(methylaminocarbonyl)amino]benzenesulfon-amide.

2. The combination as claimed in claim 1, wherein the further herbicidally active compounds b) is selected from the compounds of the following class b1) to b15):
b1) selected from the group of lipid biosynthesis inhibitors:
ACC-herbicides selected from the group consisting of alloxydim, alloxydim-sodium, butroxydim, clethodim, clodinafop, clodinafop-propargyl, cycloxydim, cyhalofop, cyhalofop-butyl, diclofop, diclofop-methyl, fenoxaprop, fenoxaprop-ethyl, fenoxaprop-P, fenoxaprop-P-ethyl, fluazifop, fluazifop-butyl, fluazifop-P, fluazifop-P-butyl, haloxyfop, haloxyfop-methyl, haloxyfop-P, haloxyfop-P-methyl, metamifop, pinoxaden, profoxydim, propaquizafop, quizalofop, quizalofop-ethyl, quizalofop-tefuryl, quizalofop-P, quizalofop-P-ethyl, quizalofop-P-tefuryl, sethoxydim, tepraloxydim, tralkoxydim, 4-(4′-Chloro-4-cyclopropyl-2′-fluoro[1,1′-biphenyl]-3-yl)-5-hydroxy-2,2,6,6-tetramethyl-2H-pyran-3(6H)-one (CAS 1312337-72-6); 4-(2′,4′-Dichloro-4-cyclopropyl[1,1′-biphenyl]-3-yl)-5-hydroxy-2,2,6,6-tetramethyl-2H-pyran-3(6H)-one (CAS 1312337-45-3); 4-(4′-Chloro-4-ethyl-2′-fluoro[1,1′-biphenyl]-3-yl)-5-hydroxy-2,2,6,6-tetramethyl-2H-pyran-3(6H)-one (CAS 1033757-93-5); 4-(2′,4′-Dichloro-4-ethyl[1,1′-biphenyl]-3-yl)-2,2,6,6-tetramethyl-2H-pyran-3,5(4H,6H)-dione (CAS 1312340-84-3); 5-(Acetyloxy)-4-(4′-chloro-4-cyclopropyl-2′-fluoro[1,1′-biphenyl]-3-yl)-3,6-dihydro-2,2,6,6-tetramethyl-2H-pyran-3-one (CAS 1312337-48-6); 5-(Acetyloxy)-4-(2′,4′-dichloro-4-cyclopropyl-[1,1′-biphenyl]-3-yl)-3,6-dihydro-2,2,6,6-tetramethyl-2H-pyran-3-one; 5-(Acetyloxy)-4-(4′-chloro-4-ethyl-2′-fluoro[1,1′-biphenyl]-3-yl)-3,6-dihydro-2,2,6,6-tetramethyl-2H-pyran-3-one (CAS 1312340-82-1); 5-(Acetyloxy)-4-(2′,4′-dichloro-4-ethyl[1,1′-biphenyl]-3-yl)-3,6-dihydro-2,2,6,6-tetramethyl-2H-pyran-3-one (CAS 1033760-55-2); 4-(4′-Chloro-4-cyclopropyl-2′-fluoro[1,1′-biphenyl]-3-yl)-5,6-dihydro-2,2,6,6-tetramethyl-5-oxo-2H-pyran-3-yl carbonic acid methyl ester (CAS 1312337-51-1); 4-(2′,4′-Dichloro-4-cyclopropyl-[1,1′-biphenyl]-3-yl)-5,6-dihydro-2,2,6,6-tetramethyl-5-oxo-2H-pyran-3-yl carbonic acid methyl ester; 4-(4′-Chloro-4-ethyl-2′-fluoro[1,1′-biphenyl]-3-yl)-5,6-dihydro-2,2,6,6-tetramethyl-5-oxo-2H-pyran-3-yl carbonic acid methyl ester (CAS 1312340-83-2); 4-(2′,4′-Dichloro-4-ethyl[1,1′-biphenyl]-3-yl)-5,6-dihydro-2,2,6,6-tetramethyl-5-oxo-2H-pyran-3-yl carbonic acid methyl ester (CAS 1033760-58-5); and non ACC herbicides selected from the group consisting of benfuresate, butylate, cycloate, dalapon, dimepiperate, EPTC, esprocarb, ethofumesate, flupropanate, molinate, orbencarb, pebulate, prosulfocarb, TCA, thiobencarb, tiocarbazil, triallate, and vernolate;
b2) is selected from the group of ALS inhibitors:
sulfonylureas selected from the group consisting of amidosulfuron, azimsulfuron, bensulfuron, bensulfuron-methyl, chlorimuron, chlorimuron-ethyl, chlorsulfuron, cinosulfuron, cyclosulfamuron, ethametsulfuron, ethametsulfuron-methyl, ethoxysulfuron, flazasulfuron, flucetosulfuron, flupyrsulfuron, flupyrsulfuron-methyl-sodium, foramsulfuron, halosulfuron, halosulfuron-methyl, imazosulfuron, iodosulfuron, iodosulfuron-methyl-sodium, iofensulfuron, iofensulfuron-sodium, mesosulfuron, metazosulfuron, metsulfuron, metsulfuron-methyl, nicosulfuron, orthosulfamuron, oxasulfuron, primisulfuron, primisulfuron-methyl, propyrisulfuron, prosulfuron, pyrazosulfuron, pyrazosulfuron-ethyl, rimsulfuron, sulfometuron, sulfometuron-methyl, sulfosulfuron, thifensulfuron, thifensulfuron-methyl, triasulfuron, tribenuron, tribenuron-methyl, trifloxysulfuron, triflusulfuron, triflusulfuron-methyl, and tritosulfuron,
imidazolinones selected from the group consisting of imazamethabenz, imazamethabenz-methyl, imazamox, imazapic, imazapyr, imazaquin and imazethapyr, triazolopyrimidine herbicides and sulfonanilides selected from the group consisting of cloransulam, cloransulam-methyl, diclosulam, flumetsulam, florasulam, metosulam, penoxsulam, pyrimisulfan, and pyroxsulam,
pyrimidinylbenzoates selected from the group consisting of bispyribac, bispyribac-sodium, pyribenzoxim, pyriflubenzoxin, pyriftalid, pyriminobac, pyriminobac-methyl, pyrithiobac, pyrithiobac-sodium, 4-[[[2-[(4,6-dimethoxy-2-pyrimidinyl)oxy]phenyl]methyl]amino]-benzoic acid-1-methylethyl ester (CAS 420138-41-6), 4-[[[2-[(4,6-dimethoxy-2-pyrimidinyl)oxy]phenyl]methyl]amino]-benzoic acid propyl ester (CAS 420138-40-5), and N-(4-bromophenyl)-2-[(4,6-dimethoxy-2-pyrimidinyl)oxy]benzenemethanamine (CAS 420138-01-8),
sulfonylaminocarbonyl-triazolinone herbicides selected from the group consisting of flucarbazone, flucarbazone-sodium, propoxycarbazone, propoxycarbazone-sodium, thiencarbazone, and thiencarbazone-methyl; and triafamone;
b3) is selected from the group of photosynthesis inhibitors:
amicarbazone, inhibitors of the photosystem II selected from the group consisting of 1-(6-tert-butylpyrimidin-4-yl)-2-hydroxy-4-methoxy-3-methyl-2H-pyrrol-5-one (CAS 1654744-66-7), 1-(5-tert-butylisoxazol-3-yl)-2-hydroxy-4-methoxy-3-methyl-2H-pyrrol-5-one (CAS 1637455-12-9), 1-(5-tert-butylisoxazol-3-yl)-4-chloro-2-hydroxy-3-methyl-2H-pyrrol-5-one (CAS 1637453-94-1), 1-(5-tert-butyl-1-methyl-pyrazol-3-yl)-4-chloro-2-hydroxy-3-methyl-2H-pyrrol-5-one (CAS 1654057-29-0), 1-(5-tert-butyl-1-methyl-pyrazol-3-yl)-3-chloro-2-hydroxy-4-methyl-2H-pyrrol-5-one (CAS 1654747-80-4), 4-hydroxy-1-methoxy-5-methyl-3-[4-(trifluoromethyl)-2-pyridyl]imidazolidin-2-one; (CAS 2023785-78-4), 4-hydroxy-1,5-dimethyl-3-[4-(trifluoromethyl)-2-pyridyl]imidazolidin-2-one (CAS 2023785-79-5), 5-ethoxy-4-hydroxy-1-methyl-3-[4-(trifluoromethyl)-2-pyridyl]imidazolidin-2-one (CAS 1701416-69-4), 4-hydroxy-1-methyl-3-[4-(trifluoromethyl)-2-pyridyl]imidazolidin-2-one (CAS 1708087-22-2), 4-hydroxy-1,5-dimethyl-3-[1-methyl-5-(trifluoromethyl)pyrazol-3-yl]imidazolidin-2-one (CAS 2023785-80-8), 1-(5-tert-butylisoxazol-3-yl)-4-ethoxy-5-hydroxy-3-methyl-imidazolidin-2-one (CAS 1844836-64-1), triazine herbicides selected from the group consisting of chlorotriazine, triazinones, triazindiones, methylthiotriazines and pyridazinones selected from the group consisting of ametryn, atrazine, chloridazone, cyanazine, desmetryn, dimethametryn, hexazinone, metribuzin, prometon, prometryn, propazine, simazine, simetryn, terbumeton, terbuthylazin, terbutryn, and trietazin, aryl urea selected from the group consisting of chlorobromuron, chlorotoluron, chloroxuron, dimefuron, diuron, fluometuron, isoproturon, isouron, linuron, metamitron, methabenzthiazuron, metobenzuron, metoxuron, monolinuron, neburon, siduron, tebuthiuron and thiadiazuron, phenyl carbamates selected from the group consisting of desmedipham, karbutilat, phenmedipham, phenmedipham-ethyl, nitrile herbicides selected from the group consisting of bromofenoxim, bromoxynil and its salts and esters, ioxynil and its salts and esters, uraciles selected from the group consisting of bromacil, lenacil, and terbacil, and bentazon and bentazon-sodium, pyridate, pyridafol, pentanochlor and propanil and inhibitors of the photosystem I selected from the group consisting of diquat, diquat-dibromide, paraquat, paraquat-dichloride, and paraquat-dimetilsulfate;
b4) is selected from the group of protoporphyrinogen-IX oxidase inhibitors:
acifluorfen, acifluorfen-sodium, azafenidin, bencarbazone, benzfendizone, bifenox, butafenacil, carfentrazone, carfentrazone-ethyl, chlomethoxyfen, chlorphthalim, cinidon-ethyl, cyclopyranil, fluazolate, flufenoximacil, flufenpyr, flufenpyr-ethyl, flumiclorac, flumiclorac-pentyl, flumioxazin, fluoroglycofen, fluoroglycofen-ethyl, fluthiacet, fluthiacet-methyl, fomesafen, halosafen, lactofen, oxadiargyl, oxadiazon, oxyfluorfen, pentoxazone, profluazol, pyraclonil, pyraflufen, pyraflufen-ethyl, saflufenacil, sulfentrazone, thidiazimin, tiafenacil, trifludimoxazin, epyrifenacil, N-ethyl-3-(2,6-dichloro-4-trifluoromethylphenoxy)-5-methyl-1H-pyrazole-1-carboxamide (CAS 452098-92-9), N-tetrahydrofurfuryl-3-(2,6-dichloro-4-trifluoromethylphenoxy)-5-methyl-1H-pyrazole-1-carboxamide (CAS 915396-43-9), N-ethyl-3-(2-chloro-6-fluoro-4-trifluoromethylphenoxy)-5-methyl-1H-pyrazole-1-carboxamide (CAS 452099-05-7), N-tetrahydrofurfuryl-3-(2-chloro-6-fluoro-4-trifluoromethylphenoxy)-5-methyl-1H-pyrazole-1-carboxamide (CAS 452100-03-7), 3-[7-fluoro-3-oxo-4-(prop-2-ynyl)-3,4-dihydro-2H-benzo[1,4]oxazin-6-yl]-1,5-dimethyl-6-thioxo-[1,3,5]triazinan-2,4-dione (CAS 451484-50-7) 2-(2,2,7-trifluoro-3-oxo-4-prop-2-ynyl-3,4-dihydro-2H-benzo[1,4]oxazin-6-yl)-4,5,6,7-tetrahydro-isoindole-1,3-dione (CAS 1300118-96-0), 1-methyl-6-trifluoromethyl-3-(2,2,7-trifluoro-3-oxo-4-prop-2-ynyl-3,4-dihydro-2H-benzo[1,4]oxazin-6-yl)-1H-pyrimidine-2,4-dione (CAS 1304113-05-0), methyl (E)-4-[2-chloro-5-[4-chloro-5-(difluoromethoxy)-1H-methyl-pyrazol-3-yl]-4-fluoro-phenoxy]-3-methoxy-but-2-enoate (CAS 948893-00-3), and 3-[7-chloro-5-fluoro-2-(trifluoromethyl)-1H-benzimidazol-4-yl]-1-methyl-6-(trifluoromethyl)-1H-pyrimidine-2,4-dione (CAS 212754-02-4),
2-[2-chloro-5-[3-chloro-5-(trifluoromethyl)-2-pyridinyl]-4-fluorophenoxy]-2-methoxy-acetic acid methyl ester (CAS 1970221-16-9), 2-[2-[[3-chloro-6-[3,6-dihydro-3-methyl-2,6-dioxo-4-(trifluoromethyl)-1(2H)-pyrimidinyl]-5-fluoro-2-pyridinyl]oxy]phenoxy]-acetic acid methyl ester (CAS 2158274-96-3), 2-[2-[[3-chloro-6-[3,6-dihydro-3-methyl-2,6-dioxo-4-(trifluoromethyl)-1(2H)-pyrimidinyl]-5-fluoro-2-pyridinyl]oxy]phenoxy]acetic acid ethyl ester (CAS 2158274-50-9), methyl 2-[[3-[2-chloro-5-[4-(difluoromethyl)-3-methyl-5-oxo-1,2,4-triazol-1-yl]-4-fluoro-phenoxy]-2-pyridyl]oxy]acetate (CAS 2271389-22-9), ethyl 2-[[3-[2-chloro-5-[4-(difluoromethyl)-3-methyl-5-oxo-1,2,4-triazol-1-yl]-4-fluoro-phenoxy]-2-pyridyl]oxy]acetate (CAS 2230679-62-4), 2-[[3-[[3-chloro-6-[3,6-dihydro-3-methyl-2,6-dioxo-4-(trifluoromethyl)-1(2H)-pyrimidinyl]-5-fluoro-2-pyridinyl]oxy]-2-pyridinyl]oxy]-acetic acid methyl ester (CAS 2158275-73-9), 2-[[3-[[3-chloro-6-[3,6-dihydro-3-methyl-2,6-dioxo-4-(trifluoromethyl)-1(2H)-pyrimidinyl]-5-fluoro-2-pyridinyl]oxy]-2-pyridinyl]oxy]acetic acid ethyl ester (CAS 2158274-56-5), 2-[2-[[3-chloro-6-[3,6-dihydro-3-methyl-2,6-dioxo-4-(trifluoromethyl)-1(2H)-pyrimidinyl]-5-fluoro-2-pyridinyl]oxy]phenoxy]-N-(methylsulfonyl)-acetamide (CAS 2158274-53-2), 2-[[3-[[3-chloro-6-[3,6-dihydro-3-methyl-2,6-dioxo-4-(trifluoromethyl)-1(2H)-pyrimidinyl]-5-fluoro-2-pyridinyl]oxy]-2-pyridinyl]oxy]-N-(methylsulfonyl)-acetamide (CAS 2158276-22-1),
3-[2-chloro-5-[3,6-dihydro-3-methyl-2,6-dioxo-4-(trifluoromethyl)-1(2H)-pyrimidinyl]-4-fluorophenyl]-4,5-dihydro-5-methyl-5-isoxazolecarboxylic acid ethyl ester (CAS 1949837-17-5);
b5) is selected from the group of bleacher herbicides:
PDS inhibitors: beflubutamid, diflufenican, fluridone, flurochloridone, flurtamone, norflurazon, picolinafen, 4-(3-trifluoromethylphenoxy)-2-(4-trifluoromethylphenyl)pyrimidine (CAS 180608-33-7), rimisoxafen, HPPD inhibitors: benzobicyclon, benzofenap, bicyclopyrone, clomazone, fenquinotrione, isoxaflutole, mesotrione, oxotrione (CAS 1486617-21-3), pyrasulfotole, pyrazolynate, pyrazoxyfen, sulcotrione, tefuryltrione, tembotrione, tolpyralate, topramezone, bipyrazone, fenpyrazone, cypyrafluone, tripyrasulfone, benquitrione, dioxopyritrione; bleacher, unknown target: aclonifen, amitrole, flumeturon,2-chloro-3-methylsulfanyl-N-(1-methyltetrazol-5-yl)-4-(trifluoromethyl)benzamide (CAS 1361139-71-0), bixlozone and 2-(2,5-dichlorophenyl)methyl-4,4-dimethyl-3-isoxazolidinone (CAS 81778-66-7), broclozone, flusulfinam, iptriazopyrid, and pyraquinate,
b6) from the group of EPSP synthase inhibitors:
glyphosate, glyphosate-isopropylammonium, glyposate-potassium, and glyphosate-trimesium (sulfosate);
b7) from the group of glutamine synthase inhibitors:
bilanaphos (bialaphos), bilanaphos-sodium, glufosinate, glufosinate-P, glufosinate-ammonium, and glufosinate-P-ammonium.
b8) from the group of DHP synthase inhibitors:
asulam;
b9) is selected from the group of mitosis inhibitors:
compounds of group K1: dinitroanilines selected from the group consisting of benfluralin, butralin, dinitramine, ethalfluralin, fluchloralin, oryzalin, pendimethalin, prodiamine and trifluralin, phosphoramidates selected from the group consisting of amiprophos, amiprophos-methyl, and butamiphos, benzoic acid herbicides selected from the group consisting of chlorthal, chlorthal-dimethyl, pyridines selected from the group consisting of dithiopyr and thiazopyr, benzamides selected from the group consisting of propyzamide and tebutam; compounds selected from the group consisting of K2: carbetamide, chlorpropham, flamprop, flamprop-isopropyl, flamprop-methyl, flamprop-M-isopropyl, flamprop-M-methyl, and propham; and icafolin;
b10) is selected from the group of VLCFA inhibitors:
chloroacetamides selected from the group consisting of acetochlor, alachlor, amidochlor, butachlor, dimethachlor, dimethenamid, dimethenamid-P, metazachlor, metolachlor, metolachlor-S, pethoxamid, pretilachlor, propachlor, propisochlor and thenylchlor, oxyacetanilides selected from the group consisting of flufenacet and mefenacet, acetanilides selected from the group consisting of diphenamid, naproanilide, napropamide and napropamide-M, tetrazolinones selected from the group consisting of fentrazamide, and other herbicides selected from the group consisting of anilofos, cafenstrole, fenoxasulfone, ipfencarbazone, piperophos, pyroxasulfone, dimesulfazet, and isoxazoline compounds of the formulae II.1, II.2, II.3, II.4, II.5, II.6, II.7, II.8., and II.9 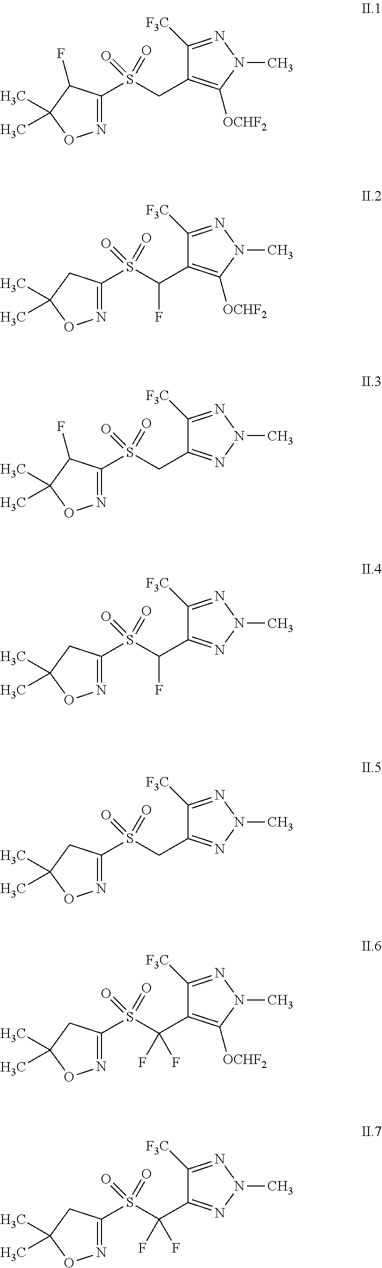 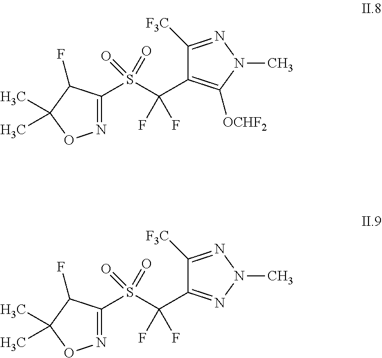
b11) is selected from the group of cellulose biosynthesis inhibitors:
chlorthiamid, dichlobenil, flupoxam, indaziflam, isoxaben, triaziflam₁ and 1-cyclohexyl-5-pentafluorphenyloxy-14-[1,2,4,6]thiatriazin-3-ylamine (CAS 175899-01-1);
b12) from the group of decoupler herbicides:
dinoseb, dinoterb, and DNOC and its salts;
b13) is selected from the group of auxinic herbicides:
2,4-D and its salts and esters selected from the group consisting of clacyfos, 2,4-DB and its salts and esters, aminocyclopyrachlor and its salts and esters, aminopyralid and its salts selected from the group consisting of aminopyralid-dimethylammonium, aminopyralid-tris(2-hydroxypropyl)ammonium and its esters, benazolin, benazolin-ethyl, chloramben and its salts and esters, clomeprop, clopyralid and its salts and esters, dicamba and its salts and esters, dichlorprop and its salts and esters, dichlorprop-P and its salts and esters, flopyrauxifen, fluroxypyr, fluroxypyr-butometyl, fluroxypyr-meptyl, halauxifen and its salts and esters (CAS 943832-60-8), MCPA and its salts and esters, MCPA-thioethyl, MCPB and its salts and esters, mecoprop and its salts and esters, mecoprop-P and its salts and esters, picloram and its salts and esters, quinclorac, quinmerac, TBA (2,3,6) and its salts and esters, triclopyr and its salts and esters, florpyrauxifen), 4-amino-3-chloro-5-fluoro-6-(7-fluoro-1H-indol-6-yl)picolinic acid (CAS 1629965-65-6), and fluchloraminopyr;
b14) from the group of auxin transport inhibitors: fluchloraminopyr, diflufenzopyr, diflufenzopyr-sodium, naptalam, and naptalam-sodium;
b15) is selected from the group of other herbicides: bromobutide, chlorflurenol, chlorflurenol-methyl, cinmethylin, cumyluron, cyclopyrimorate and its salts and esters, dalapon, dazomet, difenzoquat, difenzoquat-metilsulfate, dimethipin, DSMA, dymron, endothal and its salts, etobenzanid, flurenol, flurenol-butyl, flurprimidol, fosamine, fosamine-ammonium, indanofan, maleic hydrazide, mefluidide, metam, methiozolin, methyl azide, methyl bromide, methyl-dymron, methyl iodide, MSMA, oleic acid, oxaziclomefone, pelargonic acid, pyributicarb, quinoclamine, tetflupyrolimet, tridiphane, and 6-chloro-4-(2,7-dimethyl-1-naphthyl)-5-hydroxy-2-methyl-pyridazin-3-one (CAS 2414510-21-5).

3. The combination as claimed in claim 1, wherein active compound b) comprises at least one compound (II) selected from the compounds of group b1): clethodim, clodinafop-propargyl, cyhalofop-butyl, metamifop, profoxydim, quizalofop-ethyl, sethoxydim, prosulfocarb, and triallate.

4. The combination as claimed in claim 14, wherein active compound b) comprises at least one compound (II) selected from the compounds of group b2): mesosulfuron, pyrazosulfuron-ethyl, imazamox, imazethapyr, diclosulam, penoxsulam, pyroxsulam, bispyribac-sodium, thiencarbazone-methyl, and triafamone.

5. The combination as claimed in claim 1, wherein active compound b) comprises at least one compound (II) selected from the compounds of group b3): atrazine, metribuzin, terbuthylazin, bromoxynil and its salts and esters bentazon and bentazon-sodium, and propanil.

6. The combination as claimed in claim 1, wherein active compound b) comprises at least one compound (II) selected from the compounds of group b4): flumioxazin, saflufenacil, trifludimoxazin, epyrifenacil, and 2-[2-[[3-chloro-6-[3,6-dihydro-3-methyl-2,6-dioxo-4-(trifluoromethyl)-1(2H)-pyrimidinyl]-5-fluoro-2-pyridinyl]oxy]phenoxy]acetic acid ethyl ester (CAS 2158274-50-9).

7. The combination as claimed in claim 1, wherein active compound b) comprises at least one compound (II) selected from the compounds of group b5): diflufenican, picolinafen, clomazone, isoxaflutole, mesotrione, topramezone, aclonifen, and bixlozone.

8. The combination as claimed in claim 1, wherein active compound b) comprises at least one compound (II) selected from the compounds of group b6) and b7): glyphosate, glyphosate-isopropylammonium, glyposate-potassium and glyphosate-trimesium (sulfosate)glufosinate, glufosinate-P, glufosinate-ammonium, and glufosinate-P-ammonium.

9. The combination as claimed in claim 1, wherein active compound b) comprises at least one compound (II) selected from the compounds of group b9): pendimethalin, trifluralin, and propyzamide.

10. The combination as claimed in claim 1, wherein active compound b) comprises at least one compound (II) selected from the compounds of group b10):
acetochlor, butachlor, dimethenamid-P, metazachlor, metolachlor, metolachlor-S, pretilachlor, and flufenacet pyroxasulfone.

11. The combination as claimed in claim 1, wherein active compound b) comprises at least one compound (II) selected from the compounds of group b11): indaziflamand isoxaben.

12. The combination as claimed in claim 1, wherein active compound b) comprises at least one compound (II) selected from the compounds of group b13):
2,4-D and its salts and esters, dicamba and its salts and esters.

13. The combination as claimed in claim 1, wherein active compound b) comprises at least one compound (II) selected from the compounds of group b15):
cinmethylin, oxaziclomefone, cyclopyrimorate, tetflupyrolimet, and 6-chloro-4-(2,7-dimethyl-1-naphthyl)-5-hydroxy-2-methyl-pyridazin-3-one (CAS 2414510-21-5).

14. A method for controlling undesirable vegetation comprising applying a combination of claim 1 to the undesirable vegetation.

15. The method as claimed in claim 14 for controlling undesirable vegetation in crop plants.
